(19) United States
(12) Patent Application Publication
(10) Pub. No.: US 2003/0158827 A1
(43) Pub. Date: Aug. 21, 2003

(54) Processing device with intuitive learning capability

(75) Inventors: Arif M. Ansari, Los Angeles, CA (US); Yusuf Sulaiman M. Shiek Ansari, Costa Mesa, CA (US)

Correspondence Address: Michael J. Bolan, 14 Trinity, Irvine, CA, 92612, US

(73) Assignee: INTUITION INTELLIGENCE, INC.

(21) Appl. No.: 10/185,239

(22) Filed: Jun. 26, 2002

Related U.S. Application Data
(60) Provisional application No. 60/301,381, filed on Jun. 26, 2001.
(60) Provisional application No. 60/316,923, filed on Aug. 31, 2001.
(60) Provisional application No. 60/378,255, filed on May 6, 2002.

(51) Int. Cl. G06F 15/18

(52) U.S. Cl. 706/12

(57) ABSTRACT

A method and apparatus for providing learning capability to processing device, such as a computer game, is provided. One of a plurality of computer actions to be performed on the computer-based device is selected. In the case of a computer game, the computer actions can take the form of moves taken by a computer-manipulated object. A user input indicative of a user action, such as a move by a user-manipulated object, is received. An outcome value of the selected computer action is determined based on the user action. For example, in the case of a computer game, an intersection between the computer-manipulated object and the user-manipulated object may generate an outcome value indicative of a failure, whereas the non-intersection therebetween may generate an outcome value indicative of a success. An action probability distribution that includes probability values corresponding to said plurality of computer actions is updated based on the determined outcome value. The next computer action will be selected based on this updated action probability distribution. For example, the probability value of the last computer action taken can be increased if the outcome value represents a success, thereby increasing the chance that such computer action will be selected in the future. In contrast, the probability value of the last computer action taken can be decreased if the outcome value represents a failure, thereby decreasing the chance that such computer action will be selected in the future. In this manner, the computer-based device learns the strategy of the user. This learning is directed to achieve one or more objectives of the processing device. For example, in the case of a computer game, the objective may be to match the skill level of the player with that of the game.

### RELATED APPLICATIONS

This application claims priority from U.S. Provisional Application Ser. No. 60/301,381, filed Jun. 26, 2001, U.S. Provisional Application Ser. No. 60/316,923, filed Aug. 31, 2001, and U.S. Provisional Application Ser. No. 60/378,255, filed May 6, 2002, all of which are hereby fully and expressly incorporated herein by reference.

### COMPUTER PROGRAM LISTING APPENDIX

A Computer Program Listing Appendix is filed herewith, which comprises an original compact disc containing the MS Word files “Intuition Intelligence-duckgame1.doc” of size 119 Kbytes, created on Jun. 26, 2002, and “Intuition Intelligence-duckgame2.doc” of size 119 Kbytes, created on Jun. 26, 2002, and a duplicate compact disc containing the same. The source code contained in these files has been written in Visual Basic 6.0. The original compact disc also contains the MS Word files “Intuition Intelligence-incomingphone.doc” of size 60.5 Kbytes, created on Jun. 26, 2002, and “Intuition Intelligence-outgoingphone.doc” of size 81 Kbytes, created on Jun. 26, 2002. The source code contained in these files has been written in PHP. The Computer Program Listing Appendix is fully and expressly incorporated herein by reference.

### TECHNICAL FIELD OF THE INVENTION

The present inventions relate to methodologies for providing learning capability to processing devices, e.g., computers, microprocessors, microcontrollers, embedded systems, network processors, and data processing systems, and those products containing such devices.

### BACKGROUND OF THE INVENTION

The era of smart interactive computer-based devices has dawned. There is a demand to increasingly develop common household items, such as computerized games and toys, smart gadgets and home appliances, personal digital assistants (PDA's), and mobile telephones, with new features, improved functionality, and built-in intelligence and/or intuition, and simpler user interfaces. The development of such products, however, has been hindered for a variety of reasons, including high cost, increased processing requirements, speed of response, and difficulty of use.

For example, in order to attain a share in the computer market today, computer game manufacturers must produce games that are challenging and maintain the interest of players over a significant period of time. If not, the games will be considered too easy, and consumers as a whole will opt not to purchase such games. In order to maintain a player's interest in single-player games (i.e., the player plays against the game program), manufacturers design different levels of difficulty into the game program. As the player learns the game, thus improving his or her skill level, he or she moves onto the next level. In this respect, the player learns the moves and strategy of the game program, but the game program does not learn the moves and strategy of the player, but rather increases its skill level in discrete step. Thus, most of today's commercial computer games cannot learn or, at the most, have rudimentary learning capacity. As a result, player's interest in the computer game will not be sustained, since, once mastered, the player will no longer be interested in the game. Even if the computer games do learn, the learning process is generally slow, ineffective, and not instantaneous, and does not have the ability to apply what has been learned.

Even if the player never attains the highest skill level, the ability of the game program to change difficulty levels does not dynamically match the game program's level of play with the game player's level of play, and thus, at any given time, the difficulty level of the game program is either too low or too high for the game player. As a result, the game player is not provided with a smooth transition from novice to expert status. As for multi-player computer games (i.e., players that play against each other), today's learning technologies are not well understood and are still in the conceptual stage. Again, the level of play amongst the multiple players are not matched with other, thereby making it difficult to sustain the players' level of interest in the game.

As for PDA's and mobile phones, their user applications, which are increasing at an exponential rate, cannot be simultaneously implemented due to the limitation in memory, processing, and display capacity. As for smart gadgets and home appliances, the expectations of both the consumers and product manufacturers that these new advanced products will be easier to use have not been met. In fact, the addition of more features in these devices has forced the consumer to read and understand an often-voluminous user manual to program the product. Most consumers find it is extremely hard to understand the product and its features, and instead use a minimal set of features, so that they do not have to endure the problem of programming the advanced features. Thus, instead of manufacturing a product that adapts to the consumers' needs, the consumers have adapted to a minimum set of features that they can understand.

Audio/video devices, such as home entertainment systems, provide an added dimension of problems. A home entertainment system, which typically comprises a television, stereo, audio and video recorders, digital videodisc player, cable or satellite box, and game console is commonly controlled by a single remote control or other similar device. Because individuals in a family typically have differing preferences, however, the settings of the home entertainment system must be continuously reset through the remote control or similar device to satisfy the preferences of the particular individual that is using the system at the time. Such preferences may include, e.g., sound level, color, choice of programs and content, etc. Even if only a single individual is using the system, the hundreds of television channels provided by satellite and cable television providers makes it difficult for such individual to recall and store all of his or her favorite channels in the remote control. Even if stored, the remote control cannot dynamically update the channels to fit the individual's ever changing preferences.

To a varying extent, current learning technologies, such as artificial intelligence, neural networks, and fuzzy logic, have attempted to solve the afore-described problems, but have been generally unsuccessful because they are either too costly, not adaptable to multiple users (e.g., in a family), not versatile enough, unreliable, exhibit a slow learning capability, require too much time and effort to design into a particular product, require increased memory, or cost too much to implement. In addition, learning automata theory, whereby a single unique optimum action is to be determined over time, has been applied to solve certain problems, e.g., economic problems, but have not been applied to improve the functionality of the afore-mentioned electronic devices. Rather, the sole function of the processing devices incorporating this learning automata theory is the determination of the optimum action.

There, thus, remains a need to develop an improved learning technology for processors.

### SUMMARY OF THE INVENTION

The present inventions are directed to an enabling technology that utilizes sophisticated learning methodologies that can be applied intuitively to improve the performance of most computer applications. This enabling technology can either operate on a stand-alone platform or co-exist with other technologies. For example, the present inventions can enable any dumb gadget/device (i.e., a basic device without any intelligence or learning capacity) to learn in a manner similar to human learning without the use of other technologies, such as artificial intelligence, neural networks, and fuzzy logic based applications. As another example, the present inventions can also be implemented as the top layer of intelligence to enhance the performance of these other technologies.

The present inventions can give or enhance the intelligence of almost any product. For example, it may allow a product to dynamically adapt to a changing environment (e.g., a consumer changing style, taste, preferences, and usage) and learn on-the-fly by applying efficiently what it has previously learned, thereby enabling the product to become smarter, more personalized, and easier to use as its usage continues. Thus, a product enabled with the present inventions can self-customize itself to its current user or each of a group of users (in the case of multiple-users), or can program itself in accordance with a consumer's needs, thereby eliminating the need for the consumer to continuously program the product. As further examples, the present inventions can allow a product to train a consumer to learn more complex and advanced features or levels quickly, can allow a product to replicate or mimic the consumer's actions, or can assist or advise the consumer as to which actions to take.

The present inventions can be applied to virtually any computer-based device, and although the mathematical theory used is complex, the present inventions provide an elegant solution to the foregoing problems. The hardware and software overhead requirements for the present inventions are minimal compared to the current technologies, and although the implementation of the present inventions within most every products takes very little time, the value that they add to a product increases exponentially.

A learning methodology in accordance with the present inventions can be utilized in a computer game program. Thus, the learning methodology acquires a game-player's strategies and tactics, enabling the game program to adjust its strategies and tactics to continuously challenge the player. Thus, as the player learns and improves his or her skill, the game program will match the skills of the player, providing him or her with a smooth transition from novice to expert level.

### BRIEF DESCRIPTION OF THE DRAWINGS

In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is a block diagram of a generalized single-user learning software program constructed in accordance with the present inventions, wherein a single-input, single output (SISO) model is assumed;

FIG. 2 is a diagram illustrating the generation of probability values for three actions over time in a prior art learning automaton;

FIG. 3 is a diagram illustrating the generation of probability values for three actions over time in the single-user learning software program of FIG. 1;

FIG. 4 is a flow diagram illustrating a preferred method performed by the program of FIG. 1;

FIG. 5 is a block diagram of a single-player duck hunting game to which the generalized program of FIG. 1 can be applied;

FIG. 6 is a plan view of a computer screen used in the duck hunting game of FIG. 5, wherein a gun is particularly shown shooting a duck;

FIG. 7 is a plan view of a computer screen used in the duck hunting game of FIG. 5, wherein a duck is particularly shown moving away from a gun;

FIG. 8 is a block diagram of a single-player learning software game program employed in the duck hunting game of FIG. 5;

FIG. 9 is a flow diagram illustrating a preferred method performed by the game program of FIG. 8;

FIG. 10 is a flow diagram illustrating an alternative preferred method performed by the game program of FIG. 8;

FIG. 11 is a block diagram of a generalized multiple-user learning software program constructed in accordance with the present inventions, wherein a single-input, multiple-output (SIMO) learning model is assumed;

FIG. 12 is a flow diagram a preferred method performed by the program of FIG. 11;

FIG. 13 is a block diagram of a multiple-player duck hunting game to which the generalized program of FIG. 11 can be applied, wherein the players simultaneously receive a single game action;

FIG. 14 is a block diagram of a multiple-player learning software game program employed in the duck hunting game of FIG. 13, wherein a SIMO learning model is assumed;

FIG. 15 is a flow diagram illustrating a preferred method performed by the game program of FIG. 14;

FIG. 16 is a block diagram of another generalized multiple-user learning software program constructed in accordance with the present inventions, wherein a multiple-input, multiple-output (MIMO) learning model is assumed;

FIG. 17 is a flow diagram illustrating a preferred method performed by the program of FIG. 16;

FIG. 18 is a block diagram of another multiple-player duck hunting game to which the generalized program of FIG. 16 can be applied, wherein the players simultaneously receive multiple game actions;

FIG. 19 is a block diagram of another multiple-player learning software game program employed in the duck hunting game of FIG. 18, wherein a MIMO learning model is assumed;

FIG. 20 is a flow diagram illustrating a preferred method performed by the game program of FIG. 19;

FIG. 21 is a block diagram of a first system for distributing the processing power of the duck hunting game of FIG. 18;

FIG. 22 is a block diagram of a second preferred system for distributing the processing power of the duck hunting game of FIG. 18;

FIG. 23 is a block diagram of a third preferred system for distributing the processing power of the duck hunting game of FIG. 18;

FIG. 24 is a block diagram of a fourth preferred system for distributing the processing power of the duck hunting game of FIG. 18;

FIG. 25 is a block diagram of a fifth preferred system for distributing the processing power of the duck hunting game of FIG. 18;

FIG. 26 is a block diagram of still another generalized multiple-user learning software program constructed in accordance with the present inventions, wherein multiple SISO learning models are assumed;

FIG. 27 is a flow diagram illustrating a preferred method performed by the program of FIG. 26;

FIG. 28 is a block diagram of still another multiple-player duck hunting game to which the generalized program of FIG. 26 can be applied, wherein multiple SISO learning models are assumed;

FIG. 29 is a block diagram of still another multiple-player learning software game program employed in the duck hunting game of FIG. 28;

FIG. 30 is a flow diagram illustrating a preferred method performed by the game program of FIG. 29;

FIG. 31 is a plan view of a mobile phone to which the generalized program of FIG. 1 can be applied;

FIG. 32 is a block diagram illustrating the components of the mobile phone of FIG. 31;

FIG. 33 is a block diagram of a priority listing program employed in the mobile phone of FIG. 31, wherein a SISO learning model is assumed;

FIG. 34 is a flow diagram illustrating a preferred method performed by the priority listing program of FIG. 33;

FIG. 35 is a flow diagram illustrating an alternative preferred method performed by the priority listing program of FIG. 33;

FIG. 36 is a flow diagram illustrating still another preferred method performed by the priority listing program of FIG. 33;

FIG. 37 is a block diagram illustrating the components of a mobile phone system to which the generalized program of FIG. 16 can be applied;

FIG. 38 is a block diagram of a priority listing program employed in the mobile phone system of FIG. 37, wherein multiple SISO learning models are assumed;

FIG. 39 is a block diagram of yet another multiple-user learning software program constructed in accordance with the present inventions, wherein a maximum probability of majority approval (MPMA) learning model is assumed;

FIG. 40 is a flow diagram illustrating a preferred method performed by the program of FIG. 26;

FIG. 41 is a block diagram of yet another multiple-player learning software game program that can be employed in the duck hunting game of FIG. 13, wherein a MPMA learning model is assumed;

FIG. 42 is a flow diagram illustrating a preferred method performed by the game program of FIG. 41;

FIG. 43 is a block diagram of yet another multiple-player learning software game program that can be employed in a war game, wherein a MPMA learning model is assumed;

FIG. 44 is a flow diagram illustrating a preferred method performed by the game program of FIG. 43;

FIG. 45 is a block diagram of yet another multiple-player learning software game program that can be employed to generate revenue, wherein a MPMA learning model is assumed;

FIG. 46 is a flow diagram illustrating a preferred method performed by the game program of FIG. 45;

FIG. 47 is a block diagram of yet another multiple-user learning software program constructed in accordance with the present inventions, wherein a maximum number of teachers approving (MNTA) learning model is assumed;

FIG. 48 is a flow diagram illustrating a preferred method performed by the program of FIG. 47;

FIG. 49 is a block diagram of yet another multiple-player learning software game program that can be employed in the duck hunting game of FIG. 13, wherein a MNTA learning model is assumed;

FIG. 50 is a flow diagram illustrating a preferred method performed by the game program of FIG. 49;

FIG. 51 is a block diagram of yet another multiple-user learning software program constructed in accordance with the present inventions, wherein a teacher-action pair (TAP) learning model is assumed;

FIG. 52 is a flow diagram illustrating a preferred method performed by the program of FIG. 51;

FIG. 53 is a block diagram of yet another multiple-player learning software game program that can be employed in the duck hunting game of FIG. 13, wherein a TAP learning model is assumed; and

FIG. 54 is a flow diagram illustrating a preferred method performed by the game program of FIG. 53.

### DETAILED DESCRIPTION OF THE PREFERRED EMBODIMENTS

Generalized Single-User Learning Program (Single Processor Action-Multiple User Actions)

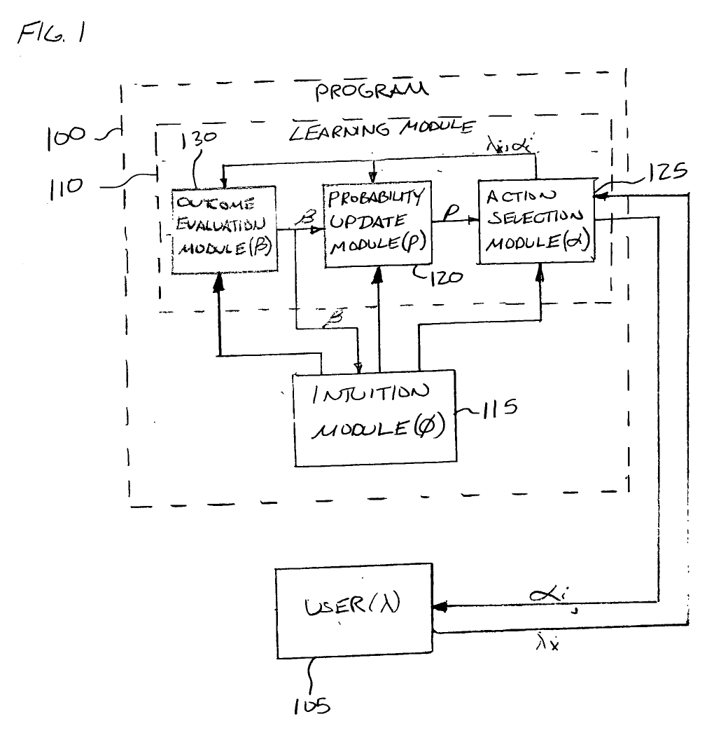

Referring to FIG. 1, a single-user learning program 100 developed in accordance with the present inventions can be generally implemented to provide intuitive learning capability to any variety of processing devices, e.g., computers, microprocessors, microcontrollers, embedded systems, network processors, and data processing systems. In this embodiment, a single user 105 interacts with the program 100 by receiving a program action αᵢ from a program action set α within the program 100, selecting a user action λₓ from a user action set λ based on the received program action αᵢ, and transmitting the selected user action λₓ to the program 100. It should be noted that in alternative embodiments, the user 105 need not receive the program action αᵢ to select a user action λₓ, the selected user action λₓ need not be based on the received program action αᵢ, and/or the program action αᵢ may be selected in response to the selected user action λₓ. The significance is that a program action αᵢ and a user action λₓ are selected.

The program 100 is capable of learning based on the measured success or failure of the selected program action αᵢ in response to a selected user action λₓ, which, for the purposes of this specification, can be measured as an outcome value β. As will be described in further detail below, program 100 directs its learning capability by dynamically modifying the model that it uses to learn based on a performance index φ to achieve one or more objectives.

To this end, the program 100 generally includes a probabilistic learning module 110 and an intuition module 115. The probabilistic learning module 110 includes a probability update module 120, an action selection module 125, and an outcome evaluation module 130. Briefly, the probability update module 120 uses learning automata theory as its learning mechanism with the probabilistic learning module 110 configured to generate and update an action probability distribution p based on the outcome value β. The action selection module 125 is configured to pseudo-randomly select the program action αᵢ based on the probability values contained within the action probability distribution p internally generated and updated in the probability update module 120. The outcome evaluation module 130 is configured to determine and generate the outcome value β based on the relationship between the selected program action αᵢ and user action λₓ. The intuition module 115 modifies the probabilistic learning module 110 (e.g., selecting or modifying parameters of algorithms used in learning module 110) based on one or more generated performance indexes φ to achieve one or more objectives. A performance index φ can be generated directly from the outcome value β or from something dependent on the outcome value β, e.g., the action probability distribution p, in which case the performance index φ may be a function of the action probability distribution p, or the action probability distribution p may be used as the performance index φ. A performance index φ can be cumulative (e.g., it can be tracked and updated over a series of outcome values β or instantaneous (e.g., a new performance index φ can be generated for each outcome value β).

Modification of the probabilistic learning module 110 can be accomplished by modifying the functionalities of (1) the probability update module 120 (e.g., by selecting from a plurality of algorithms used by the probability update module 120, modifying one or more parameters within an algorithm used by the probability update module 120, transforming or otherwise modifying the action probability distribution p); (2) the action selection module 125 (e.g., limiting or expanding selection of the action α corresponding to a subset of probability values contained within the action probability distribution p); and/or (3) the outcome evaluation module 130 (e.g., modifying the nature of the outcome value β or otherwise the algorithms used to determine the outcome value β).

Having now briefly discussed the components of the program 100, we will now describe the functionality of the program 100 in more detail. Beginning with the probability update module 120, the action probability distribution p that it generates can be represented by the following equation:

p(k)=[p₁(k), p₂(k), p₃(k) . . . pₙ(k)], [1]

where

pᵢ is the action probability value assigned to a specific program action αᵢ; n is the number of program actions αᵢ within the program action set α, and k is the incremental time at which the action probability distribution was updated.

Preferably, the action probability distribution p at every time k should satisfy the following requirement:

$${\sum }_{i = 1}^{n} {p}_{i} ( k ) = 1 , 0 \leq {p}_{i} ( k ) \leq 1. \qquad [ 2 ]$$

Thus, the internal sum of the action probability distribution p, i.e., the action probability values p₁ for all program actions αᵢ within the program action set α is always equal “1,” as dictated by the definition of probability. It should be noted that the number n of program actions αᵢ need not be fixed, but can be dynamically increased or decreased during operation of the program 100.

The probability update module 120 uses a stochastic learning automaton, which is an automaton that operates in a random environment and updates its action probabilities in accordance with inputs received from the environment so as to improve its performance in some specified sense. A learning automaton can be characterized in that any given state of the action probability distribution p determines the state of the next action probability distribution p. For example, the probability update module 120 operates on the action probability distribution p(k) to determine the next action probability distribution p(k+1), i.e., the next action probability distribution p(k+1) is a function of the current action probability distribution p(k). Advantageously, updating of the action probability distribution p using a learning automaton is based on a frequency of the program actions αᵢ and/or user actions λₓ, as well as the time ordering of these actions. This can be contrasted with purely operating on a frequency of program actions αᵢ or user actions λₓ, and updating the action probability distribution p(k) based thereon. Although the present inventions, in their broadest aspects, should not be so limited, it has been found that the use of a learning automaton provides for a more dynamic, accurate, and flexible means of teaching the probability learning module 110.

In this scenario, the probability update module 120 uses a single learning automaton with a single input to a single-teacher environment (with the user 105 as the teacher), and thus, a single-input, single-output (SISO) model is assumed.

To this end, the probability update module 120 is configured to update the action probability distribution p based on the law of reinforcement, the basic idea of which is to reward a favorable action and to penalize an unfavorable action. A specific program action αᵢ is rewarded by increasing the corresponding current probability value pᵢ(k) and decreasing all other current probability values pⱼ(k), while a specific program action αᵢ is penalized by decreasing the corresponding current probability value pᵢ(k) and increasing all other current probability values pⱼ(k). Whether the selected program action αᵢ is rewarded or punished will be based on the outcome value β generated by the outcome evaluation module 130.

To this end, the probability update module 120 uses a learning methodology to update the action probability distribution p, which can mathematically be defined as:

p(k+1)=T[p(k), αᵢ(k), β(k)], [3]

where

p(k+1) is the updated action probability distribution, T is the reinforcement scheme, p(k) is the current action probability distribution, αᵢ(k) is the previous program action, β(k) is latest outcome value, and k is the incremental time at which the action probability distribution was updated.

Alternatively, instead of using the immediately previous program action αᵢ(k), any set of previous program action, e.g., α(k−1), α(k−2), α(k−3), etc., can be used for lag learning, and/or a set of future program action, e.g., α(k+1), α(k+2), α(k+3), etc., can be used for lead learning. In the case of lead learning, a future program action is selected and used to determine the updated action probability distribution p(k+1).

The types of learning methodologies that can be utilized by the probability update module 120 are numerous, and depend on the particular application. For example, the nature of the outcome value β can be divided into three types: (1) P-type, wherein the outcome value β can be equal to “1” indicating success of the program action αᵢ, and “0” indicating failure of the program action αᵢ; (2) Q-type, wherein the outcome value β can be one of a finite number of values between “0” and “1” indicating a relative success or failure of the program action αᵢ; or (3) S-Type, wherein the outcome value β can be a continuous value in the interval [0,1] also indicating a relative success or failure of the program action αᵢ. The time dependence of the reward and penalty probabilities of the actions α can also vary. For example, they can be stationary if the probability of success for a program action αᵢ does not depend on the index k, and non-stationary if the probability of success for the program action αᵢ depends on the index k. Additionally, the equations used to update the action probability distribution p can be linear or non-linear. Also, a program action αᵢ can be rewarded only, penalized only, or a combination thereof. The convergence of the learning methodology can be of any type, including ergodic, absolutely expedient, ε-optimal, or optimal. The learning methodology can also be a discretized, estimator, pursuit, hierarchical, pruning, growing or any combination thereof.

Of special importance is the estimator learning methodology, which can advantageously make use of estimator tables and algorithms should it be desired to reduce the processing otherwise requiring for updating the action probability distribution for every program action αᵢ that is received. For example, an estimator table may keep track of the number of successes and failures for each program action αᵢ received, and then the action probability distribution p can then be periodically updated based on the estimator table by, e.g., performing transformations on the estimator table. Estimator tables are especially useful when multiple users are involved, as will be described with respect to the multi-user embodiments described later.

In the preferred embodiment, a reward function gⱼ and a penalization function hⱼ is used to accordingly update the current action probability distribution p(k). For example, a general updating scheme applicable to P-type, Q-type and S-type methodologies can be given by the following SISO equations:

$$\begin{matrix}{p}_{j} ( k + 1 ) = {p}_{j} ( k ) - β ( k ) {g}_{j} ( p ( k ) ) + ( 1 - β ( k ) ) {h}_{j} ( p ( k ) ) , if α ( k ) \neq {α}_{i} & [ 4 ] \\ {p}_{i} ( k + 1 ) = {p}_{i} ( k ) + β ( k ) {\sum }_{{j = 1}_{j \neq i }}^{n} {g}_{j} ( p ( k ) ) - ( 1 - β ( k ) ) {\sum }_{{j = 1}_{j \neq i }}^{n} {h}_{j} ( p ( k ) ) , if α ( k ) = {α}_{i} & [ 5 ]\end{matrix}$$

where

i is an index for the currently selected program action αᵢ, and j is an index for the non-selected program actions αᵢ. Assuming a P-type methodology, equations [4] and [5] can be broken down into the following equations:

$${p}_{i} ( k + 1 ) = {p}_{i} ( k ) + {\sum }_{{j = 1}_{j \neq i }}^{n} {g}_{j} ( p ( k ) ) ; and \qquad [ 6 ]$$

pⱼ(k+1)=pⱼ(k)−gⱼ(p(k)), [7]

when

β(k)=1 and αᵢ is selected

$${p}_{i} ( k + 1 ) = {p}_{i} ( k ) - {\sum }_{{j = 1}_{j \neq i }}^{n} {h}_{j} ( p ( k ) ) ; and \qquad [ 8 ]$$

pⱼ(k+1)=pⱼ(k)+hᵢ(p(k)), [9]

when

β(k)=0 and αᵢ is selected

Preferably, the gⱼ and hⱼ functions are continuous and nonnegative for purposes of mathematical convenience and to maintain the reward and penalty nature of the updating scheme. Also, the gⱼ and hⱼ functions are preferably constrained by the following equations to ensure that all of the components of p(k+1) remain in the (0,1) interval when p(k) is in the (0,1) interval:

$$0 < {g}_{j} ( p ) < {p}_{j} ;$$

$$0 < {\sum }_{j \neq 1}^{n} ( {p}_{j} + {h}_{j} ( p ) ) < 1$$

for all pⱼε(0,1) and all j=1,2, . . . n.

The updating scheme can be of the reward-penalty type, in which case, both gⱼ and hⱼ are non-zero. Thus, in the case of a P-type methodology, the first two updating equations [6] and [7] will be used to reward the program action αᵢ when successful, and the last two updating equations [8] and [9] will be used to penalize program action αᵢ when unsuccessful. Alternatively, the updating scheme is of the reward-inaction type, in which case, gⱼ is nonzero and hⱼ is zero. Thus, the first two general updating equations [6] and [7] will be used to reward the program action αᵢ when successful, whereas the last two general updating equations [8] and [9] will not be used to penalize program action αᵢ when unsuccessful. More alternatively, the updating scheme is of the penalty-inaction type, in which case, gⱼ is zero and hⱼ is nonzero. Thus, the first two general updating equations [6] and [7] will not be used to reward the program action αᵢ when successful, whereas the last two general updating equations [8] and [9] will be used to penalize program action αᵢ when unsuccessful. The updating scheme can even be of the reward-reward type (in which case, the program action αᵢ is rewarded more when it is successful than when it is not) or penalty-penalty type (in which case, the program action αᵢ is penalized more when it is not successful than when it is).

It should be noted that with respect to the probability distribution p as a whole, any typical updating scheme will have both a reward aspect and a penalty aspect to the extent that a particular program action αᵢ that is rewarded will penalize the remaining program actions αᵢ, and any particular program action αᵢ that penalized will reward the remaining program actions αᵢ. This is because any increase in a probability value pᵢ will relatively decrease the remaining probability values pᵢ, and any decrease in a probability value pᵢ will relatively increase the remaining probability values pᵢ. For the purposes of this specification, however, a particular program action αᵢ is only rewarded if its corresponding probability value pᵢ is increased in response to an outcome value β associated with it, and a program action αᵢ is only penalized if its corresponding probability value pᵢ is decreased in response to an outcome value β associated with it.

The nature of the updating scheme is also based on the functions gⱼ and hⱼ themselves. For example, the functions gⱼ and hⱼ can be linear, in which case, e.g., they can be characterized by the following equations:

$$\begin{matrix}{g}_{j} ( p ( k ) ) = {ap}_{j} ( k ) , 0 < a < 1 ; and & [ 10 ] \\ {h}_{j} ( p ( k ) ) = \frac{b}{n - 1} - {bp}_{j} ( k ) , 0 < b < 1 & [ 11 ]\end{matrix}$$

where

a is the reward parameter, and b is the penalty parameter.

The functions gⱼ and hⱼ can alternatively be absolutely expedient, in which case, e.g., they can be characterized by the following equations:

$$\begin{matrix}\frac{{g}_{1} ( p )}{{p}_{1}} = \frac{{g}_{2} ( p )}{{p}_{2}} = … = \frac{{g}_{n} ( p )}{{p}_{n}} ; & [ 12 ] \\ \frac{{h}_{1} ( p )}{{p}_{1}} = \frac{{h}_{2} ( p )}{{p}_{2}} = … = \frac{{h}_{n} ( p )}{{p}_{n}} & [ 13 ]\end{matrix}$$

The functions gⱼ and hⱼ can alternatively be non-linear, in which case, e.g., they can be characterized by the following equations:

$$\begin{matrix}{g}_{j} ( p ( k ) ) = {p}_{j} ( k ) - F ( {p}_{j} ( k ) ) ; & [ 14 ] \\ {h}_{j} ( p ( k ) ) = \frac{{p}_{i} ( k ) - F ( {p}_{i} ( k ) )}{n - 1} & [ 15 ]\end{matrix}$$

and F(s)=ax^{m}, m=2,3, . . .

Further details on learning methodologies are disclosed in “Learning Automata An Introduction,” Chapter 4, Narendra, Kumpati, Prentice Hall (1989) and “Learning Algorithms-Theory and Applications in Signal Processing, Control and Communications,” Chapter 2, Mars, Phil, CRC Press (1996), which are both expressly incorporated herein by reference.

The intuition module 115 directs the learning of the program 100 towards one or more objectives by dynamically modifying the probabilistic learning module 110. The intuition module 115 specifically accomplishes this by operating on one or more of the probability update module 120, action selection module 125, or outcome evaluation module 130 based on the performance index φ, which, as briefly stated, is a measure of how well the program 100 is performing in relation to the one or more objective to be achieved. The intuition module 115 may, e.g., take the form of any combination of a variety of devices, including an (1) evaluator, data miner, analyzer, feedback device, stabilizer; (2) decision maker; (3) expert or rule-based system; (4) artificial intelligence, fuzzy logic, neural network, or genetic methodology; (5) directed learning device; (6) statistical device, estimator, predictor, regressor, or optimizer. These devices may be deterministic, pseudo-deterministic, or probabilistic.

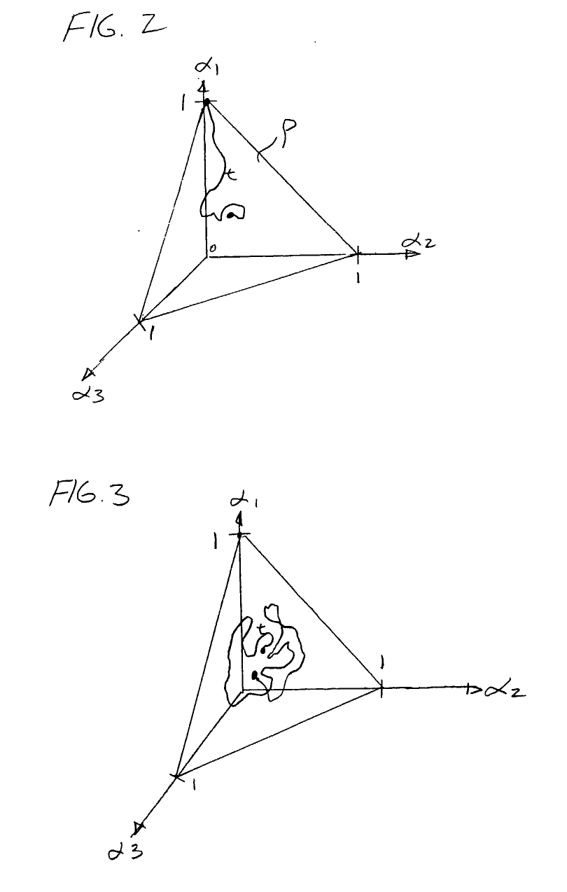

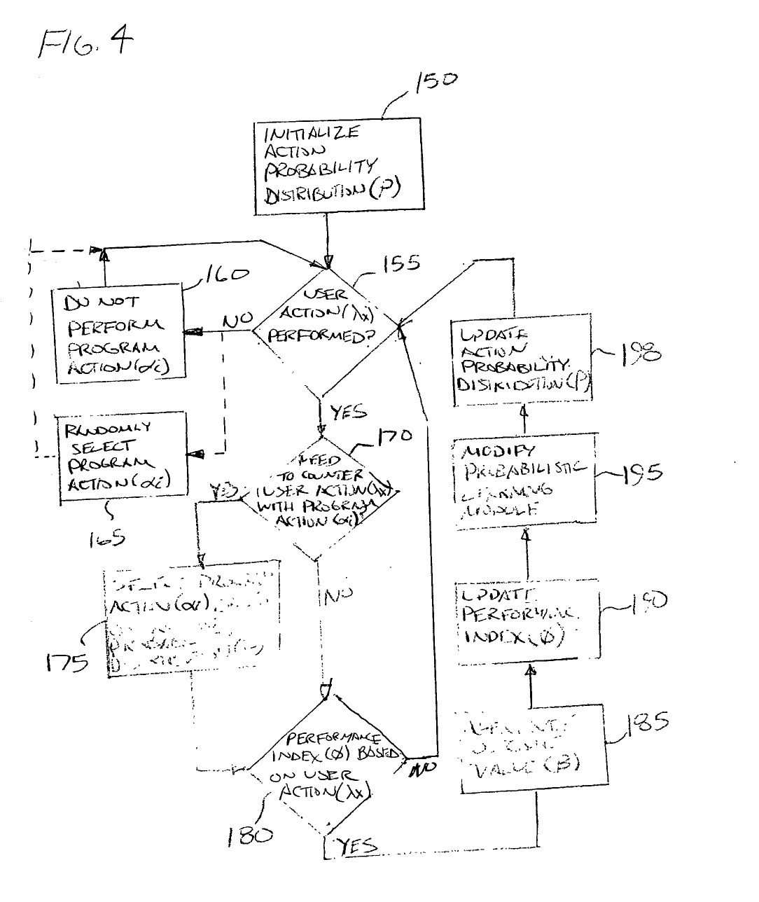

It is worth noting that absent modification by the intuition module 115, the probabilistic learning module 110 would attempt to determine a single best action or a group of best actions for a given predetermined environment as per the objectives of basic learning automata theory. That is, if there is a unique action that is optimal, the unmodified probabilistic learning module 110 will substantially converge to it. If there is a set of actions that are optimal, the unmodified probabilistic learning module 110 will substantially converge to one of them, or oscillate (by pure happenstance) between them. In the case of a changing environment, however, the performance of an unmodified learning module 110 would ultimately diverge from the objectives to be achieved. FIGS. 2 and 3 are illustrative of this point. Referring specifically to FIG. 2, a graph illustrating the action probability values pᵢ of three different actions α₁, α₂, and α₃, as generated by a prior art learning automaton over time t, is shown. As can be seen, the action probability values pᵢ for the three actions are equal at the beginning of the process, and meander about on the probability plane p, until they eventually converge to unity for a single action, in this case, α₁. Thus, the prior art learning automaton assumes that there is always a single best action over time t and works to converge the selection to this best action. Referring specifically to FIG. 3, a graph illustrating the action probability values pᵢ of three different actions α₁, α₂, and α₃, as generated by the program 100 over time t, is shown. Like with the prior art learning automaton, action probability values pᵢ for the three action are equal at t=0. Unlike with the prior art learning automaton, however, the action probability values pᵢ for the three actions meander about on the probability plane p without ever converging to a single action. Thus, the program 100 does not assume that there is a single best action over time t, but rather assumes that there is a dynamic best action that changes over time t. Because the action probability value for any best action will not be unity, selection of the best action at any given time t is not ensured, but will merely tend to occur, as dictated by its corresponding probability value. Thus, the program 100 ensures that the objective(s) to be met are achieved over time t.

Having now described the interrelationships between the components of the program 100 and the user 105, we now generally describe the methodology of the program 100. Referring to FIG. 4, the action probability distribution p is initialized (step 150). Specifically, the probability update module 120 initially assigns equal probability values to all program actions αᵢ, in which case, the initial action probability distribution p(k) can be represented by

$${p}_{1} ( 0 ) = {p}_{2} ( 0 ) = {p}_{2} ( 0 ) = ⋯ {p}_{n} ( 0 ) = \frac{1}{n} .$$

Thus, each of the program actions αᵢ has an equal chance of being selected by the action selection module 125. Alternatively, the probability update module 120 initially assigns unequal probability values to at least some of the program actions αᵢ, e.g., if the programmer desires to direct the learning of the program 100 towards one or more objectives quicker. For example, if the program 100 is a computer game and the objective is to match a novice game player's skill level, the easier program action αᵢ, and in this case game moves, may be assigned higher probability values, which as will be discussed below, will then have a higher probability of being selected. In contrast, if the objective is to match an expert game player's skill level, the more difficult game moves may be assigned higher probability values.

Once the action probability distribution p is initialized at step 150, the action selection module 125 determines if a user action λₓ has been selected from the user action set λ (step 155). If not, the program 100 does not select a program action αᵢ from the program action set α (step 160), or alternatively selects a program action αᵢ, e.g., randomly, notwithstanding that a user action λₓ has not been selected (step 165), and then returns to step 155 where it again determines if a user action λₓ has been selected. If a user action λₓ has been selected at step 155, the action selection module 125 determines the nature of the selected user action λₓ, i.e., whether the selected user action λₓ is of the type that should be countered with a program action αᵢ and/or whether the performance index φ can be based, and thus whether the action probability distribution p should be updated. For example, again, if the program 100 is a game program, e.g., a shooting game, a selected user action λₓ that merely represents a move may not be a sufficient measure of the performance index φ, but should be countered with a program action αᵢ, while a selected user action λₓ that represents a shot may be a sufficient measure of the performance index φ.

Specifically, the action selection module 125 determines whether the selected user action λₓ is of the type that should be countered with a program action αᵢ (step 170). If so, the action selection module 125 selects a program action αᵢ from the program action set α based on the action probability distribution p (step 175). After the performance of step 175 or if the action selection module 125 determines that the selected user action λₓ is not of the type that should be countered with a program action αᵢ, the action selection module 125 determines if the selected user action λₓ is of the type that the performance index φ is based on (step 180).

If so, the outcome evaluation module 130 quantifies the performance of the previously selected program action αᵢ relative to the currently selected user action λₓ by generating an outcome value β(step 185). The intuition module 115 then updates the performance index φ based on the outcome value β, unless the performance index φ is an instantaneous performance index that is represented by the outcome value β itself (step 190). The intuition module 115 then modifies the probabilistic learning module 110 by modifying the functionalities of the probability update module 120, action selection module 125, or outcome evaluation module 130 (step 195). It should be noted that step 190 can be performed before the outcome value β is generated by the outcome evaluation module 130 at step 180, e.g., if the intuition module 115 modifies the probabilistic learning module 110 by modifying the functionality of the outcome evaluation module 130. The probability update module 120 then, using any of the updating techniques described herein, updates the action probability distribution p based on the generated outcome value β (step 198).

The program 100 then returns to step 155 to determine again whether a user action λₓ has been selected from the user action set λ. It should be noted that the order of the steps described in FIG. 4 may vary depending on the specific application of the program 100.

Single-Player Learning Game Program (Single Game Action-Single Player Action)

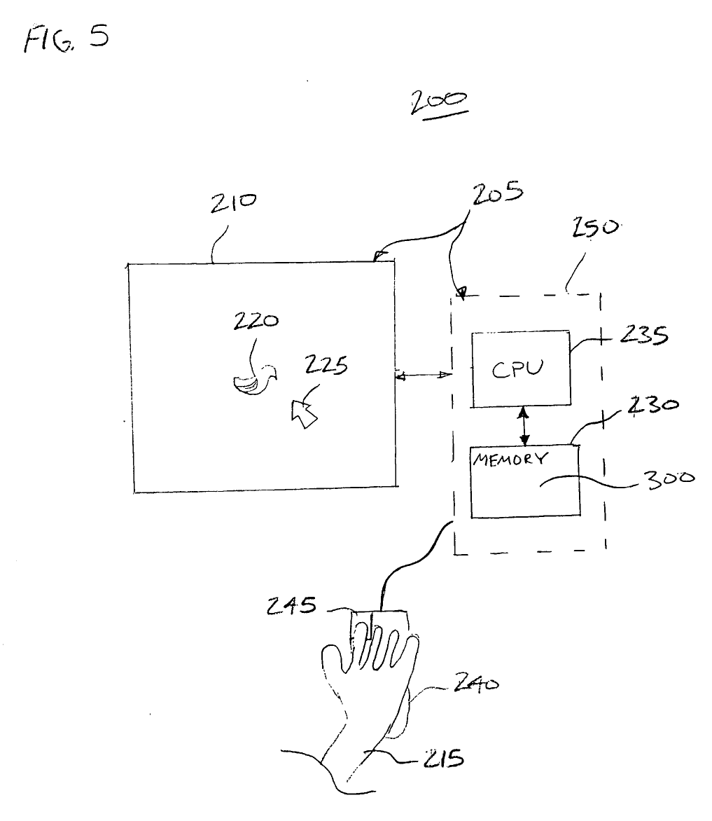

Having now generally described the components and functionality of the learning program 100, we now describe one of its various applications. Referring to FIG. 5, a single-player learning game program 300 (shown in FIG. 8) developed in accordance with the present inventions is described in the context of a duck hunting game 200. The game 200 comprises a computer system 205, which, e.g., takes the form of a personal desktop or laptop computer. The computer system 205 includes a computer screen 210 for displaying the visual elements of the game 200 to a player 215, and specifically, a computer animated duck 220 and a gun 225, which is represented by a mouse cursor. For the purposes of this specification, the duck 220 and gun 225 can be broadly considered to be computer and user-manipulated objects, respectively. The computer system 205 further comprises a computer console 250, which includes memory 230 for storing the game program 300, and a CPU 235 for executing the game program 300. The computer system 205 further includes a computer mouse 240 with a mouse button 245, which can be manipulated by the player 215 to control the operation of the gun 225, as will be described immediately below. It should be noted that although the game 200 has been illustrated as being embodied in a standard computer, it can very well be implemented in other types of hardware environments, such as a video game console that receives video game cartridges and connects to a television screen, or a video game machine of the type typically found in video arcades.

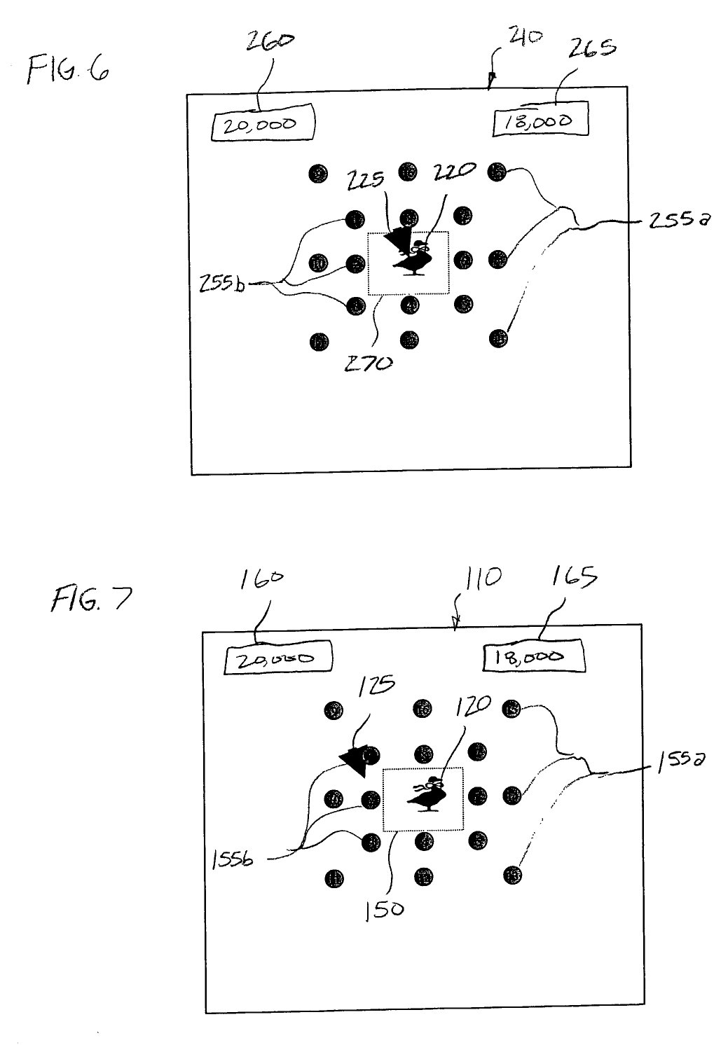

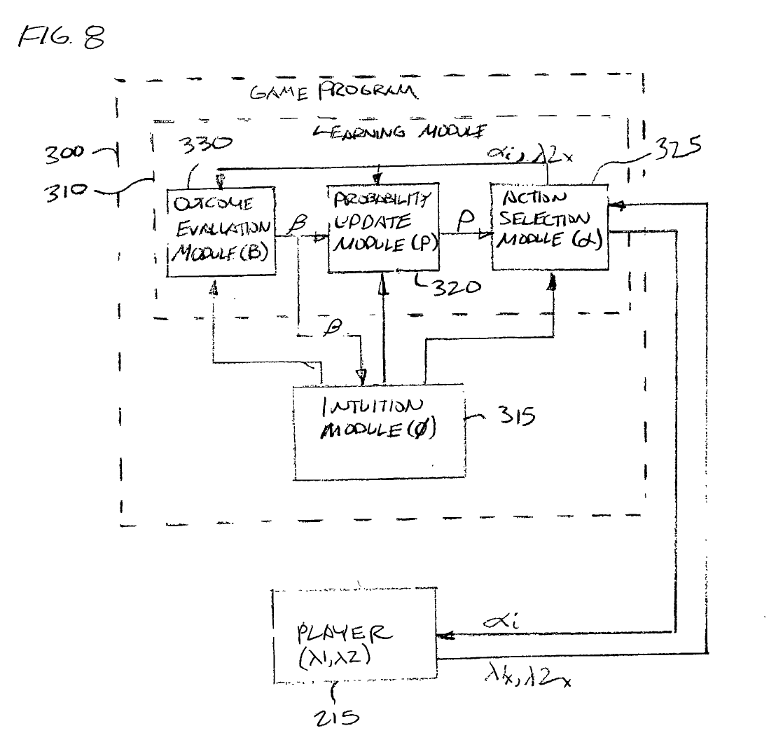

Referring specifically to the computer screen 210 of FIGS. 6 and 7, the rules and objective of the duck hunting game 200 will now be described. The objective of the player 215 is to shoot the duck 220 by moving the gun 225 towards the duck 220, intersecting the duck 220 with the gun 225, and then firing the gun 225 (FIG. 6). The player 215 accomplishes this by laterally moving the mouse 240, which correspondingly moves the gun 225 in the direction of the mouse movement, and clicking the mouse button 245, which fires the gun 225. The objective of the duck 220, on the other hand, is to avoid from being shot by the gun 225. To this end, the duck 220 is surrounded by a gun detection region 270, the breach of which by the gun 225 prompts the duck 220 to select and make one of seventeen moves 255 (eight outer moves 255a, eight inner moves 255b, and a non-move) after a preprogrammed delay (move 3 in FIG. 7). The length of the delay is selected, such that it is not so long or short as to make it too easy or too difficult to shoot the duck 220. In general, the outer moves 255a more easily evade the gun 225 than the inner moves 255b, thus, making it more difficult for the player 215 to shot the duck 220.

For purposes of this specification, the movement and/or shooting of the gun 225 can broadly be considered to be a player action, and the discrete moves of the duck 220 can broadly be considered to be computer or game actions, respectively. Optionally or alternatively, different delays for a single move can also be considered to be game actions. For example, a delay can have a low and high value, a set of discrete values, or a range of continuous values between two limits. The game 200 maintains respective scores 260 and 265 for the player 215 and duck 220. To this end, if the player 215 shoots the duck 220 by clicking the mouse button 245 while the gun 225 coincides with the duck 220, the player score 260 is increased. In contrast, if the player 215 fails to shoot the duck 220 by clicking the mouse button 245 while the gun 225 does not coincide with the duck 220, the duck score 265 is increased. The increase in the score can be fixed, one of a multitude of discrete values, or a value within a continuous range of values.

As will be described in further detail below, the game 200 increases its skill level by learning the player's 215 strategy and selecting the duck's 220 moves based thereon, such that it becomes more difficult to shoot the duck 220 as the player 215 becomes more skillful. The game 200 seeks to sustain the player's 215 interest by challenging the player 215. To this end, the game 200 continuously and dynamically matches its skill level with that of the player 215 by selecting the duck's 220 moves based on objective criteria, such as, e.g., the difference between the respective player and game scores 260 and 265. In other words, the game 200 uses this score difference as a performance index φ in measuring its performance in relation to its objective of matching its skill level with that of the game player. In the regard, it can be said that the performance index φ is cumulative. Alternatively, the performance index φ can be a function of the action probability distribution p.

Referring further to FIG. 8, the game program 300 generally includes a probabilistic learning module 310 and an intuition module 315, which are specifically tailored for the game 200. The probabilistic learning module 310 comprises a probability update module 320, an action selection module 325, and an outcome evaluation module 330. Specifically, the probability update module 320 is mainly responsible for learning the player's 215 strategy and formulating a counterstrategy based thereon, with the outcome evaluation module 330 being responsible for evaluating actions performed by the game 200 relative to actions performed by the player 215. The action selection module 325 is mainly responsible for using the updated counterstrategy to move the duck 220 in response to moves by the gun 225. The intuition module 315 is responsible for directing the learning of the game program 300 towards the objective, and specifically, dynamically and continuously matching the skill level of the game 200 with that of the player 215. In this case, the intuition module 315 operates on the action selection module 325, and specifically selects the methodology that the action selection module 325 will use to select a game action αᵢ from the game action set α as will be discussed in further detail below. In the preferred embodiment, the intuition module 315 can be considered deterministic in that it is purely rule-based. Alternatively, however, the intuition module 315 can take on a probabilistic nature, and can thus be quasi-deterministic or entirely probabilistic.

To this end, the action selection module 325 is configured to receive a player action λ1ₓ from the player 215, which takes the form of a mouse 240 position, i.e., the position of the gun 225, at any given time. In this embodiment, the player action λ1ₓ can be selected from a virtual infinite player action set λ1, i.e., the number of player actions λ1ₓ are only limited by the resolution of the mouse 240. Based on this, the action selection module 325 detects whether the gun 225 is within the detection region 270, and if so, selects a game action αᵢ from the game action set α, and specifically, one of the seventeen moves 255 that the duck 220 can make. The game action αᵢ manifests itself to the player 215 as a visible duck movement.

The action selection module 325 selects the game action αᵢ based on the updated game strategy. To this end, the action selection module 325 is further configured to receive the action probability distribution p from the probability update module 320, and pseudo-randomly selecting the game action αᵢ based thereon. The action probability distribution p is similar to equation [1] and can be represented by the following equation:

p(k)=[p₁(k), p₂(k), p₃(k) . . . pₙ(k)], [1-1]

where

p₁ is the action probability value assigned to a specific game action αᵢ; n is the number of game actions αᵢ within the game action set α, and k is the incremental time at which the action probability distribution was updated.

It is noted that pseudo-random selection of the game action αᵢ allows selection and testing of any one of the game actions αᵢ, with those game actions αᵢ corresponding to the highest probability values being selected more often. Thus, without the modification, the action selection module 325 will tend to more often select the game action αᵢ to which the highest probability value pᵢ corresponds, so that the game program 300 continuously improves its strategy, thereby continuously increasing its difficulty level.

Because the objective of the game 200 is sustainability, i.e., dynamically and continuously matching the respective skill levels of the game 200 and player 215, the intuition module 315 is configured to modify the functionality of the action selection module 325 based on the performance index φ, and in this case, the current skill level of the player 215 relative to the current skill level of the game 200. In the preferred embodiment, the performance index φ is quantified in terms of the score difference value Δ between the player score 260 and the duck score 265. The intuition module 315 is configured to modify the functionality of the action selection module 325 by subdividing the action set α into a plurality of action subsets αₛ, one of which will be selected by the action selection module 325. In an alternative embodiment, the action selection module 325 may also select the entire action set α. In another alternative embodiment, the number and size of the action subsets αₛ can be dynamically determined.

In the preferred embodiment, if the score difference value Δ is substantially positive (i.e., the player score 260 is substantially higher than the duck score 265), the intuition module 315 will cause the action selection module 325 to select an action subset αₛ, the corresponding average probability value of which will be relatively high, e.g., higher than the median probability value of the action probability distribution p. As a further example, an action subset αₛ corresponding to the highest probability values within the action probability distribution p can be selected. In this manner, the skill level of the game 200 will tend to quickly increase in order to match the player's 215 higher skill level.

If the score difference value Δ is substantially negative (i.e., the player score 260 is substantially lower than the duck score 265), the intuition module 315 will cause the action selection module 325 to select an action subset αₛ, the corresponding average probability value of which will be relatively low, e.g., lower than the median probability value of the action probability distribution p. As a further example, an action subset αₛ, corresponding to the lowest probability values within the action probability distribution p can be selected. In this manner, the skill level of the game 200 will tend to quickly decrease in order to match the player's 215 lower skill level.

If the score difference value Δ is substantially low, whether positive or negative (i.e., the player score 260 is substantially equal to the duck score 265), the intuition module 315 will cause the action selection module 325 to select an action subset αₛ, the average probability value of which will be relatively medial, e.g., equal to the median probability value of the action probability distribution p. In this manner, the skill level of the game 200 will tend to remain the same, thereby continuing to match the player's 215 skill level. The extent to which the score difference value Δ is considered to be losing or winning the game 200 may be provided by player feedback and the game designer.

Alternatively, rather than selecting an action subset αₛ, based on a fixed reference probability value, such as the median probability value of the action probability distribution p, selection of the action set αₛ can be based on a dynamic reference probability value that moves relative to the score difference value Δ. To this end, the intuition module 315 increases and decreases the dynamic reference probability value as the score difference value Δ becomes more positive or negative, respectively. Thus, selecting an action subset αₛ, the corresponding average probability value of which substantially coincides with the dynamic reference probability value, will tend to match the skill level of the game 200 with that of the player 215. Without loss of generality, the dynamic reference probability value can also be learning using the learning principles disclosed herein.

In the illustrated embodiment, (1) if the score difference value Δ is substantially positive, the intuition module 315 will cause the action selection module 325 to select an action subset αₛ composed of the top five corresponding probability values; (2) if the score difference value Δ is substantially negative, the intuition module 315 will cause the action selection module 325 to select an action subset αₛ composed of the bottom five corresponding probability values; and (3) if the score difference value Δ is substantially low, the intuition module 315 will cause the action selection module 325 to select an action subset αₛ composed of the middle seven corresponding probability values, or optionally an action subset αₛ composed of all seventeen corresponding probability values, which will reflect a normal game where all actions are available for selection.

Whether the reference probability value is fixed or dynamic, hysteresis is preferably incorporated into the action subset αₛ selection process by comparing the score difference value Δ to upper and lower score difference thresholds N_{S1} and N_{S2}, e.g., −1000 and 1000, respectively. Thus, the intuition module 315 will cause the action selection module 325 to select the action subset in accordance with the following criteria:

If Δ<N_{S1}, then select action subset αₛ with relatively low probability values;

If Δ>N_{S2}, then select action subset αₛ with relatively high probability values; and

If N_{S1}≦Δ≦N_{S2}, then select action subset αₛ with relatively medial probability values.

Alternatively, rather than quantify the relative skill level of the player 215 in terms of the score difference value Δ between the player score 260 and the duck score 265, as just previously discussed, the relative skill level of the player 215 can be quantified from a series (e.g., ten) of previous determined outcome values β. For example, if a high percentage of the previous determined outcome values β is equal to “0,” indicating a high percentage of unfavorable game actions αᵢ, the relative player skill level can be quantified as be relatively high. In contrast, if a low percentage of the previous determined outcome values β is equal to “0,” indicating a low percentage of unfavorable game actions αᵢ, the relative player skill level can be quantified as be relatively low. Thus, based on this information, a game action αᵢ can be pseudo-randomly selected, as hereinbefore described.

The action selection module 325 is configured to pseudo-randomly select a single game action αᵢ from the action subset αₛ, thereby minimizing a player detectable pattern of game action αᵢ selections, and thus increasing interest in the game 200. Such pseudo-random selection can be accomplished by first normalizing action subset αₛ, and then summing, for each game action αᵢ within the action subset αₛ, the corresponding probability value with the preceding probability values (for the purposes of this specification, this is considered to be a progressive sum of the probability values). For example, the following Table 1 sets forth the unnormalized probability values, normalized probability values, and progressive sum of an exemplary subset of five actions:

TABLE 1
Progressive Sum of Probability Values For
Five Exemplary Game Actions in SISO
Format

| | Unnormalized | Normalized | Progressive |
|---|---|---|---|
| Game Action | Probability Value | Probability Value | Sum |
| α₁ | 0.05 | 0.09 | 0.09 |
| α₂ | 0.05 | 0.09 | 0.18 |
| α₃ | 0.10 | 0.18 | 0.36 |
| α₄ | 0.15 | 0.27 | 0.63 |
| α₅ | 0.20 | 0.37 | 1.00 |

The action selection module 325 then selects a random number between “0” and “1,” and selects the game action αᵢ corresponding to the next highest progressive sum value. For example, if the randomly selected number is 0.38, game action α₄ will be selected.

The action selection module 325 is further configured to receive a player action λ2ₓ from the player 215 in the form of a mouse button 245 click/mouse 240 position combination, which indicates the position of the gun 225 when it is fired. The outcome evaluation module 330 is configured to determine and output an outcome value β that indicates how favorable the game action at is in comparison with the received player action λ2ₓ.

To determine the extent of how favorable a game action α₁ is, the outcome evaluation module 330 employs a collision detection technique to determine whether the duck's 220 last move was successful in avoiding the gunshot. Specifically, if the gun 225 coincides with the duck 220 when fired, a collision is detected. On the contrary, if the gun 225 does not coincide with the duck 220 when fired, a collision is not detected. The outcome of the collision is represented by a numerical value, and specifically, the previously described outcome value β. In the illustrated embodiment, the outcome value β equals one of two predetermined values: “1” if a collision is not detected (i.e., the duck 220 is not shot), and “0” if a collision is detected (i.e., the duck 220 is shot). Of course, the outcome value β can equal “0” if a collision is not detected, and “1” if a collision is detected, or for that matter one of any two predetermined values other than a “0” or “1,” without straying from the principles of the invention. In any event, the extent to which a shot misses the duck 220 (e.g., whether it was a near miss) is not relevant, but rather that the duck 220 was or was not shot. Alternatively, the outcome value β can be one of a range of finite integers or real numbers, or one of a range of continuous values. In these cases, the extent to which a shot misses or hits the duck 220 is relevant. Thus, the closer the gun 225 comes to shooting the duck 220, the less the outcome value β is, and thus, a near miss will result in a relatively low outcome value β, whereas a far miss will result in a relatively high outcome value β. Of course, alternatively, the closer the gun 225 comes to shooting the duck 220, the greater the outcome value β is. What is significant is that the outcome value β correctly indicates the extent to which the shot misses the duck 220. More alternatively, the extent to which a shot hits the duck 220 is relevant. Thus, the less damage the duck 220 incurs, the less the outcome value β is, and the more damage the duck 220 incurs, the greater the outcome value β is.

The probability update module 320 is configured to receive the outcome value β from the outcome evaluation module 330 and output an updated game strategy (represented by action probability distribution p) that the duck 220 will use to counteract the player's 215 strategy in the future. In the preferred embodiment, the probability update module 320 utilizes a linear reward-penalty P-type update. As an example, given a selection of the seventeen different moves 255, assume that the gun 125 fails to shoot the duck 120 after it takes game action α₃, thus creating an outcome value β=1. In this case, general updating equations [6] and [7] can be expanded using equations [10] and [11], as follows:

$$\begin{matrix}{p}_{3} ( k + 1 ) = {p}_{3} ( k ) + {\sum }_{{j = 1}_{j \neq 3}}^{17} {ap}_{j} ( k ) ; \\ {p}_{1} ( k + 1 ) = {p}_{1} ( k ) - {ap}_{1} ( k ) ; \\ {p}_{2} ( k + 1 ) = {p}_{2} ( k ) - {ap}_{2} ( k ) ; \\ {p}_{4} ( k + 1 ) = {p}_{4} ( k ) - {ap}_{4} ( k ) ; \\ ⋮ \\ {p}_{17} ( k + 1 ) = {p}_{17} ( k ) - {ap}_{17} ( k )\end{matrix}$$

Thus, since the game action α₃ resulted in a successful outcome, the corresponding probability value p₃ is increased, and the action probability values pᵢ corresponding to the remaining game actions αᵢ are decreased.

If, on the other hand, the gun 125 shoots the duck 120 after it takes game action α₃, thus creating an outcome value β=0, general updating equations [8] and [9] can be expanded, using equations [10] and [11], as follows:

$$\begin{matrix}{p}_{3} ( k + 1 ) = {p}_{3} ( k ) - {\sum }_{{j = 1}_{j \neq 3}}^{17} ( \frac{b}{16} - {bp}_{j} ( k ) ) \\ {p}_{1} ( k + 1 ) = {p}_{1} ( k ) + \frac{b}{16} - {bp}_{1} ( k ) ; \\ {p}_{2} ( k + 1 ) = {p}_{2} ( k ) + \frac{b}{16} - {bp}_{2} ( k ) ; \\ {p}_{4} ( k + 1 ) = {p}_{4} ( k ) + \frac{b}{16} - {bp}_{4} ( k ) ; \\ ⋮ \\ {p}_{17} ( k + 1 ) = {p}_{17} ( k ) + \frac{b}{16} - {bp}_{17} ( k )\end{matrix}$$

It should be noted that in the case where the gun 125 shoots the duck 120, thus creating an outcome value β=0, rather than using equations [8], [9], and [11], a value proportional to the penalty parameter b can simply be subtracted from the selection game action, and can then be equally distributed among the remaining game actions αⱼ. It has been empirically found that this method ensures that no probability value pᵢ converges to “1,” which would adversely result in the selection of a single action αᵢ every time. In this case, equations [8] and [9] can be modified to read:

$$\begin{matrix}{p}_{i} ( k + 1 ) = {p}_{i} ( k ) - {bp}_{i} ( k ) & \text{[8a]} \\ {p}_{j} ( k + 1 ) = {p}_{j} ( k ) + \frac{1}{n - 1} {bp}_{i} ( k ) & \text{[9a]}\end{matrix}$$

Assuming game action α₃ results in an outcome value β=0, equations [8a] and [9a] can be expanded as follows:

$$\begin{matrix}{p}_{3} ( k + 1 ) = {p}_{3} ( k ) - {bp}_{3} ( k ) \\ {p}_{1} ( k + 1 ) = {p}_{1} ( k ) + \frac{b}{16} {p}_{1} ( k ) ; \\ {p}_{2} ( k + 1 ) = {p}_{2} ( k ) + \frac{b}{16} {p}_{2} ( k ) ; \\ {p}_{4} ( k + 1 ) = {p}_{4} ( k ) + \frac{b}{16} {p}_{4} ( k ) ; \\ ⋮ \\ {p}_{17} ( k + 1 ) = {p}_{17} ( k ) + \frac{b}{16} {p}_{17} ( k )\end{matrix}$$

In any event, since the game action α₃ resulted in an unsuccessful outcome, the corresponding probability value p₃ is decreased, and the action probability values pᵢ corresponding to the remaining game actions αⱼ are increased. The values of a and b are selected based on the desired speed and accuracy that the learning module 310 learns, which may depend on the size of the game action set α. For example, if the game action set α is relatively small, the game 200 preferably must learn quickly, thus translating to relatively high a and b values. On the contrary, if the game action set α is relatively large, the game 200 preferably learns more accurately, thus translating to relatively low a and b values. In other words, the greater the values selected for a and b, the faster the action probability value distribution p changes, whereas the lesser the values selected for a and b, the slower the action probability value distribution p changes. In the preferred embodiment, the values of a and b have been chosen to be 0.1 and 0.5, respectively.

In the preferred embodiment, the reward-penalty update scheme allows the skill level of the game 200 to track that of the player 215 during gradual changes in the player's 215 skill level. Alternatively, a reward-inaction update scheme can be employed to constantly make the game 200 more difficult, e.g., if the game 200 has a training mode to train the player 215 to become progressively more skillful. More alternatively, a penalty-inaction update scheme can be employed, e.g., to quickly reduce the skill level of the game 200 if a different less skillful player 215 plays the game 200. In any event, the intuition module 315 may operate on the probability update module 320 to dynamically select any one of these update schemes depending on the objective to be achieved.

It should be noted that rather than, or in addition to, modifying the functionality of the action selection module 325 by subdividing the action set α into a plurality of action subsets αₛ, the respective skill levels of the game 200 and player 215 can be continuously and dynamically matched by modifying the functionality of the probability update module 320 by modifying or selecting the algorithms employed by it. For example, the respective reward and penalty parameters a and b may be dynamically modified.

For example, if the difference between the respective player and game scores 260 and 265 (i.e., the score difference value Δ) is substantially positive, the respective reward and penalty parameters a and b can be increased, so that the skill level of the game 200 more rapidly increases. That is, if the gun 125 shoots the duck 120 after it takes a particular game action αᵢ, thus producing an unsuccessful outcome, an increase in the penalty parameter b will correspondingly decrease the chances that the particular action αᵢ is selected again relative to the chances that it would have been selected again if the penalty parameter b had not been modified. If the gun 125 fails to shoot the duck 120 after it takes a particular game action αᵢ, thus producing a successful outcome, an increase in the reward parameter a will correspondingly increase the chances that the particular action αᵢ is selected again relative to the chances that it would have been selected again if the penalty parameter a had not been modified. Thus, in this scenario, the game 200 will learn at a quicker rate.

On the contrary, if the score difference value Δ is substantially negative, the respective reward and penalty parameters a and b can be decreased, so that the skill level of the game 200 less rapidly increases. That is, if the gun 125 shoots the duck 120 after it takes a particular game action αᵢ, thus producing an unsuccessful outcome, a decrease in the penalty parameter b will correspondingly increase the chances that the particular action αᵢ is selected again relative to the chances that it would have been selected again if the penalty parameter b had not been modified. If the gun 125 fails to shoot the duck 120 after it takes a particular game action αᵢ, thus producing a successful outcome, a decrease in the reward parameter a will correspondingly decrease the chances that the particular action αᵢ is selected again relative to the chances that it would have been selected again if the reward parameter a had not been modified. Thus, in this scenario, the game 200 will learn at a slower rate.

If the score difference value Δ is low, whether positive or negative, the respective reward and penalty parameters a and b can remain unchanged, so that the skill level of the game 200 will tend to remain the same. Thus, in this scenario, the game 200 will learn at the same rate.

It should be noted that an increase or decrease in the reward and penalty parameters a and b can be effected in various ways. For example, the values of the reward and penalty parameters a and b can be incrementally increased or decreased a fixed amount, e.g., 0.1. Or the reward and penalty parameters a and b can be expressed in the functional form y=f(x), with the performance index p being one of the independent variables, and the penalty and reward parameters a and b being at least one of the dependent variables. In this manner, there is a smoother and continuous transition in the reward and penalty parameters a and b.

Optionally, to further ensure that the skill level of the game 200 rapidly decreases when the score difference value Δ substantially negative, the respective reward and penalty parameters a and b can be made negative. That is, if the gun 125 shoots the duck 120 after it takes a particular game action αᵢ, thus producing an unsuccessful outcome, forcing the penalty parameter b to a negative number will increase the chances that the particular action αᵢ is selected again in the absolute sense. If the gun 125 fails to shoot the duck 120 after it takes a particular game action αᵢ, thus producing a successful outcome, forcing the reward parameter a to a negative number will decrease the chances that the particular action αᵢ is selected again in the absolute sense. Thus, in this scenario, rather than learn at a slower rate, the game 200 will actually unlearn. It should be noted in the case where negative probability values pᵢ result, the probability distribution p is preferably normalized to keep the action probability values pᵢ within the [0,1] range.

More optionally, to ensure that the skill level of the game 200 substantially decreases when the score difference value Δ is substantially negative, the respective reward and penalty equations can be switched. That is, the reward equations, in this case equations [6] and [7], can be used when there is an unsuccessful outcome (i.e., the gun 125 shoots the duck 120). The penalty equations, in this case equations [8] and [9] (or [8a] or [8b]), can be used when there is a successful outcome (i.e., when the gun 125 misses the duck 120). Thus, the probability update module 320 will treat the previously selected αᵢ as producing an unsuccessful outcome, when in fact, it has produced a successful outcome, and will treat the previously selected αᵢ as producing a successful outcome, when in fact, it has produced an unsuccessful outcome. In this case, when the score difference value Δ is substantially negative, the respective reward and penalty parameters a and b can be increased, so that the skill level of the game 200 more rapidly decreases.

Alternatively, rather than actually switching the penalty and reward equations, the functionality of the outcome evaluation module 330 can be modified with similar results. For example, the outcome evaluation module 330 may be modified to output an outcome value β=0 when the current action α is successful, i.e., the gun 125 does not shoot the duck 120, and to output an outcome value β=1 when the current action αᵢ is unsuccessful, i.e., the gun 125 shoots the duck 120. Thus, the probability update module 320 will interpret the outcome value β as an indication of an unsuccessful outcome, when in fact, it is an indication of a successful outcome, and will interpret the outcome value β as an indication of a successful outcome, when in fact, it is an indication of an unsuccessful outcome. In this manner, the reward and penalty equations are effectively switched.

Rather than modifying or switching the algorithms used by the probability update module 320, the action probability distribution p can be transformed. For example, if the score difference value Δ is substantially positive, it is assumed that the actions αᵢ corresponding to a set of the highest probability values pᵢ are too easy, and the actions αᵢ corresponding to a set of the lowest probability values pᵢ are too hard. In this case, the actions αᵢ corresponding to the set of highest probability values pᵢ can be switched with the actions corresponding to the set of lowest probability values pᵢ, thereby increasing the chances that that the harder actions αᵢ (and decreasing the chances that the easier actions αᵢ) are selected relative to the chances that they would have been selected again if the action probability distribution p had not been transformed. Thus, in this scenario, the game 200 will learn at a quicker rate. In contrast, if the score difference value Δ is substantially negative, it is assumed that the actions αᵢ corresponding to the set of highest probability values pᵢ are too hard, and the actions αᵢ corresponding to the set of lowest probability values pᵢ are too easy. In this case, the actions αᵢ corresponding to the set of highest probability values pᵢ can be switched with the actions corresponding to the set of lowest probability values pᵢ, thereby increasing the chances that that the easier actions αᵢ (and decreasing the chances that the harder actions αᵢ) are selected relative to the chances that they would have been selected again if the action probability distribution p had not been transformed. Thus, in this scenario, the game 200 will learn at a slower rate. If the score difference value Δ is low, whether positive or negative, it is assumed that the actions αᵢ corresponding to the set of highest probability values pᵢ are not too hard, and the actions αᵢ corresponding to the set of lowest probability values pᵢ are not too easy, in which case, the actions αᵢ corresponding to the set of highest probability values pᵢ and set of lowest probability values pᵢ are not switched. Thus, in this scenario, the game 200 will learn at the same rate.

It should be noted that although the performance index φ has been described as being derived from the score difference value Δ, the performance index φ can also be derived from other sources, such as the action probability distribution p. If it is known that the outer moves 255a or more difficult than the inner moves 255b, the performance index φ, and in this case, the skill level of the player 215 relative to the skill level the game 200, may be found in the present state of the action probability values pᵢ assigned to the moves 255. For example, if the combined probability values pᵢ corresponding to the outer moves 255a is above a particular threshold value, e.g., 0.7 (or alternatively, the combined probability values pᵢ corresponding to the inner moves 255b is below a particular threshold value, e.g., 0.3), this may be an indication that the skill level of the player 215 is substantially greater than the skill level of the game 200. In contrast, if the combined probability values pᵢ corresponding to the outer moves 255a is below a particular threshold value, e.g., 0.4 (or alternatively, the combined probability values pᵢ corresponding to the inner moves 255b is above a particular threshold value, e.g., 0.6), this may be an indication that the skill level of the player 215 is substantially less than the skill level of the game 200. Similarly, if the combined probability values pᵢ corresponding to the outer moves 255a is within a particular threshold range, e.g., 0.4-0.7 (or alternatively, the combined probability values pᵢ corresponding to the inner moves 255b is within a particular threshold range, e.g., 0.3-0.6), this may be an indication that the skill level of the player 215 and skill level of the game 200 are substantially matched. In this case, any of the afore-described probabilistic learning module modification techniques can be used with this performance index φ.

Alternatively, the probabilities values pᵢ corresponding to one or more actions αᵢ can be limited to match the respective skill levels of the player 215 and game 200. For example, if a particular probability value pᵢ is too high, it is assumed that the corresponding action αᵢ may be too hard for the player 215. In this case, one or more probabilities values pᵢ can be limited to a high value, e.g., 0.4, such that when a probability value pᵢ reaches this number, the chances that that the corresponding action αᵢ is selected again will decrease relative to the chances that it would be selected if the corresponding action probability pᵢ had not been limited. Similarly, one or more probabilities values pᵢ can be limited to a low value, e.g., 0.01, such that when a probability value pᵢ reaches this number, the chances that that the corresponding action αᵢ is selected again will increase relative to the chances that it would be selected if the corresponding action probability pᵢ had not been limited. It should be noted that the limits can be fixed, in which case, only the performance index φ that is a function of the action probability distribution p is used to match the respective skill levels of the player 215 and game 200, or the limits can vary, in which case, such variance may be based on a performance index φ external to the action probability distribution p.

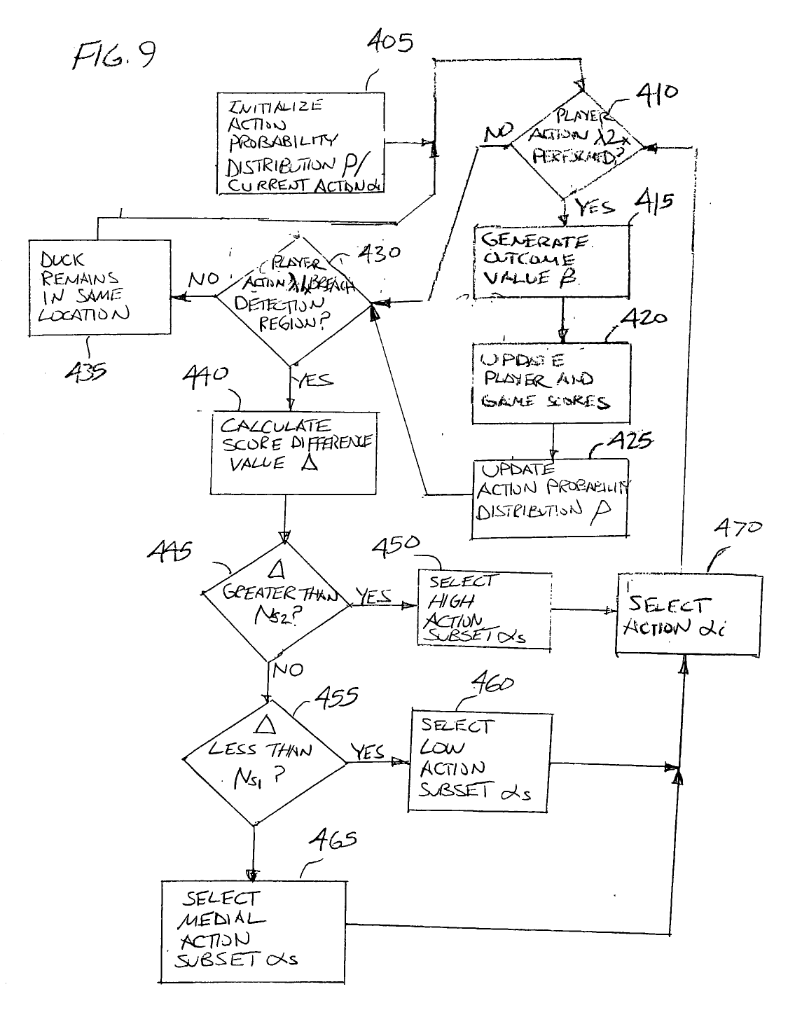

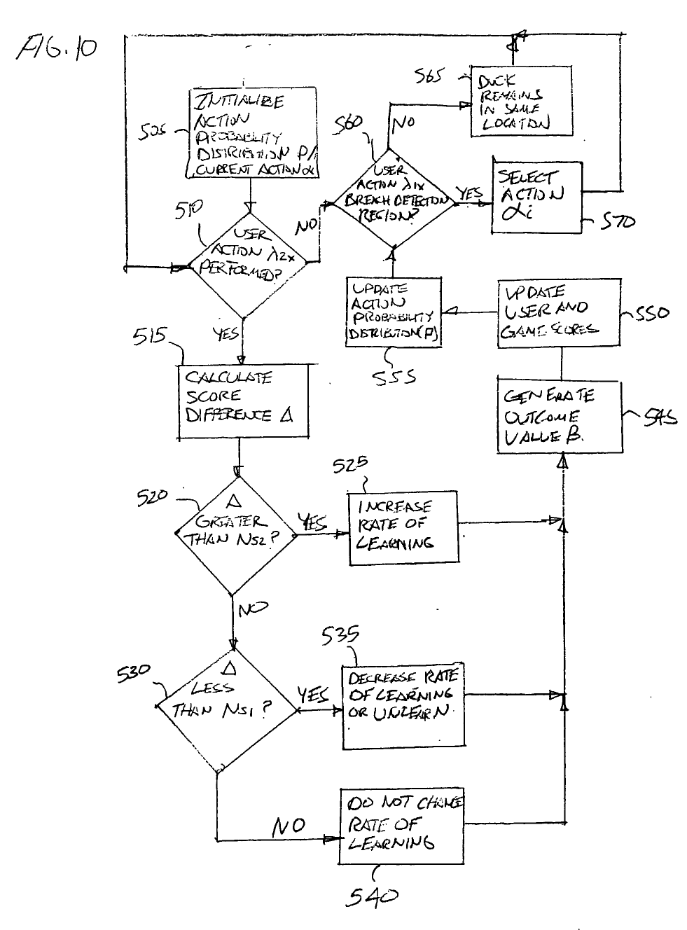

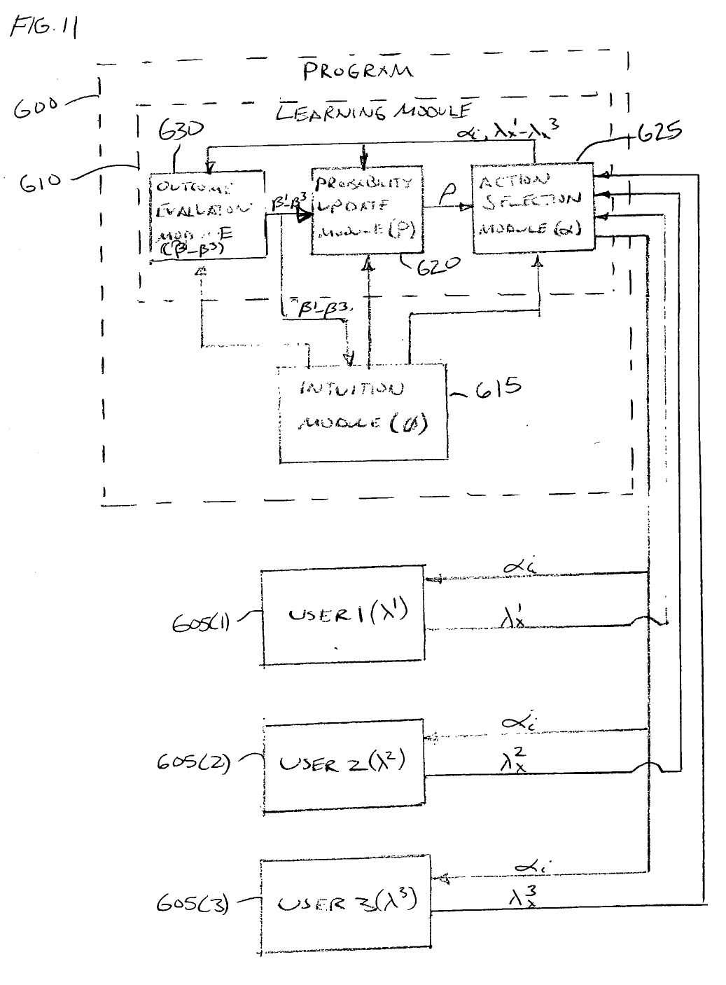

Having now described the structure of the game program 300, the steps performed by the game program 300 will be described with reference to FIG. 9. First, the action probability distribution p is initialized (step 405). Specifically, the probability update module 320 initially assigns an equal probability value to each of the game actions αᵢ, in which case, the initial action probability distribution p(k) can be represented by

$${p}_{1} ( 0 ) = {p}_{2} ( 0 ) = {p}_{2} ( 0 ) = ⋯ {p}_{n} ( 0 ) = \frac{1}{n} .$$

Thus, all of the game actions αᵢ have an equal chance of being selected by the action selection module 325. Alternatively, probability update module 320 initially assigns unequal probability values to at least some of the game actions αᵢ. For example, the outer moves 255a may be initially assigned a lower probability value than that of the inner moves 255b, so that the selection of any of the outer moves 255a as the next game action αᵢ will be decreased. In this case, the duck 220 will not be too difficult to shoot when the game 200 is started. In addition to the action probability distribution p, the current action αᵢ to be updated is also initialized by the probability update module 320 at step 405.

Then, the action selection module 325 determines whether a player action 22, has been performed, and specifically whether the gun 225 has been fired by clicking the mouse button 245 (step 410). If a player action λ2ₓ has been performed, the outcome evaluation module 330 determines whether the last game action αᵢ was successful by performing a collision detection, and then generates the outcome value β in response thereto (step 415). The intuition module 315 then updates the player score 260 and duck score 265 based on the outcome value β (step 420). The probability update module 320 then, using any of the updating techniques described herein, updates the action probability distribution p based on the generated outcome value β (step 425).

After step 425, or if a player action λ2ₓ has not been performed at step 410, the action selection module 325 determines if a player action λ2ₓ has been performed, i.e., gun 225, has breached the gun detection region 270 (step 430). If the gun 225 has not breached the gun detection region 270, the action selection module 325 does not select any game action αᵢ from the game action subset α and the duck 220 remains in the same location (step 435). Alternatively, the game action αᵢ may be randomly selected, allowing the duck 220 to dynamically wander. The game program 300 then returns to step 410 where it is again determined if a player action λ2ₓ has been performed. If the gun 225 has breached the gun detection region 270 at step 430, the intuition module 315 modifies the functionality of the action selection module 325 based on the performance index φ, and the action selection module 325 selects a game action αᵢ from the game action set α.

Specifically, the intuition module 315 determines the relative player skill level by calculating the score difference value Δ between the player score 260 and duck score 265 (step 440). The intuition module 315 then determines whether the score difference value Δ is greater than the upper score difference threshold N_{S2} (step 445). If Δ is greater than N_{S2}, the intuition module 315, using any of the action subset selection techniques described herein, selects an action subset αₛ, a corresponding average probability of which is relatively high (step 450). If Δ is not greater than N_{S2}, the intuition module 315 then determines whether the score difference value Δ is less than the lower score difference threshold N_{S1} (step 455). If Δ is less than N_{S1}, the intuition module 315, using any of the action subset selection techniques described herein, selects an action subset αₛ, a corresponding average probability of which is relatively low (step 460). If Δ is not less than N_{S1}, it is assumed that the score difference value Δ is between N_{S1} and N_{S2}, in which case, the intuition module 315, using any of the action subset selection techniques described herein, selects an action subset αₛ, a corresponding average probability of which is relatively medial (step 465). In any event, the action selection module 325 then pseudo-randomly selects a game action αᵢ from the selected action subset αₛ, and accordingly moves the duck 220 in accordance with the selected game action αᵢ (step 470). The game program 300 then returns to step 410, where it is determined again if a player action λ2ₓ has been performed.

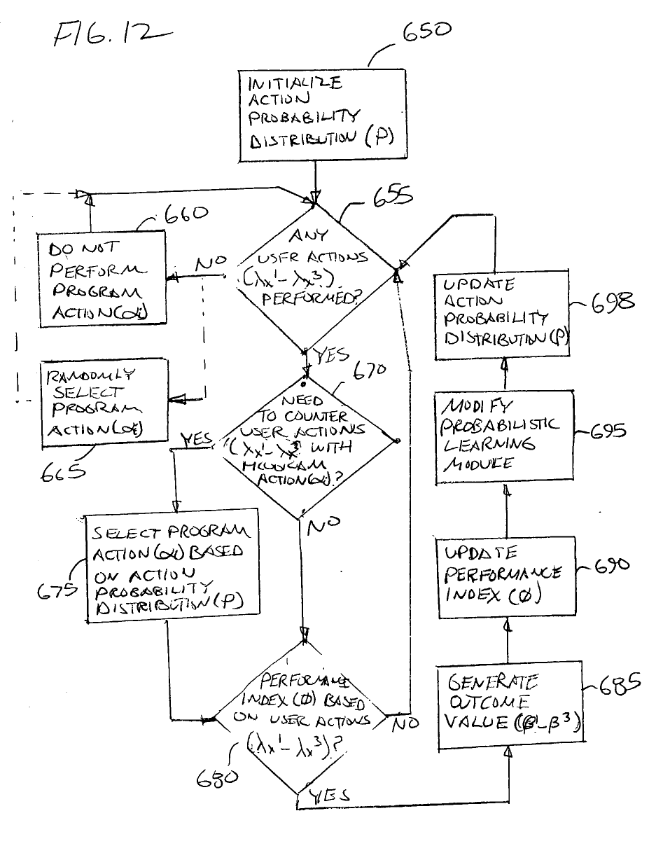

It should be noted that, rather than use the action subset selection technique, the other afore-described techniques used to dynamically and continuously match the skill level of the player 215 with the skill level of the game 200 can be alternatively or optionally be used as well. For example, and referring to FIG. 10, the probability update module 320 initializes the action probability distribution p and current action αᵢ similarly to that described in step 405 of FIG. 9. The initialization of the action probability distribution p and current action αᵢ is similar to that performed in step 405 of FIG. 9. Then, the action selection module 325 determines whether a player action λ2ₓ has been performed, and specifically whether the gun 225 has been fired by clicking the mouse button 245 (step 510). If a player action λ2ₓ has been performed, the intuition module 315 modifies the functionality of the probability update module 320 based on the performance index φ.

Specifically, the intuition module 315 determines the relative player skill level by calculating the score difference value Δ between the player score 260 and duck score 265 (step 515). The intuition module 315 then determines whether the score difference value Δ is greater than the upper score difference threshold N_{S2} (step 520). If Δ is greater than N_{S2}, the intuition module 315 modifies the functionality of the probability update module 320 to increase the game's 200 rate of learning using any of the techniques described herein (step 525). For example, the intuition module 315 may modify the parameters of the learning algorithms, and specifically, increase the reward and penalty parameters a and b.

If A is not greater than N_{S2}, the intuition module 315 then determines whether the score difference value Δ is less than the lower score difference threshold N_{S1} (step 530). If Δ is less than N_{S1}, the intuition module 315 modifies the functionality of the probability update module 320 to decrease the game's 200 rate of learning (or even make the game 200 unlearn) using any of the techniques described herein (step 535). For example, the intuition module 315 may modify the parameters of the learning algorithms, and specifically, decrease the reward and penalty parameters a and b. Alternatively or optionally, the intuition module 315 may assign the reward and penalty parameters a and b negative numbers, switch the reward and penalty learning algorithms, or even modify the outcome evaluation module 330 to output an outcome value β=0 when the selection action αᵢ is actually successful, and output an outcome value β=1 when the selected action αᵢ is actually unsuccessful.

If Δ is not less than N_{S2}, it is assumed that the score difference value Δ is between N_{S1} and N_{S2}, in which case, the intuition module 315 does not modify the probability update module 320 (step 540).

In any event, the outcome evaluation module 330 then determines whether the last game action αᵢ was successful by performing a collision detection, and then generates the outcome value β in response thereto (step 545). Of course, if the intuition module 315 modifies the functionality of the outcome evaluation module 330 during any of the steps 525 and 535, step 545 will preferably be performed during these steps. The intuition module 315 then updates the player score 260 and duck score 265 based on the outcome value β (step 550). The probability update module 320 then, using any of the updating techniques described herein, updates the action probability distribution p based on the generated outcome value β (step 555).

After step 555, or if a player action λ2ₓ has not been performed at step 510, the action selection module 325 determines if a player action λ1ₓ has been performed, i.e., gun 225, has breached the gun detection region 270 (step 560). If the gun 225 has not breached the gun detection region 270, the action selection module 325 does not select a game action αᵢ from the game action set α and the duck 220 remains in the same location (step 565). Alternatively, the game action αᵢ may be randomly selected, allowing the duck 220 to dynamically wander. The game program 300 then returns to step 510 where it is again determined if a player action λ2ₓ has been performed. If the gun 225 has breached the gun detection region 270 at step 560, the action selection module 325 pseudo-randomly selects a game action αᵢ from the action set α and accordingly moves the duck 220 in accordance with the selected game action αᵢ (step 570). The game program 300 then returns to step 510, where it is determined again if a player action λ2ₓ has been performed.

More specific details on the above-described operation of the duck game 100 can found in the Computer Program Listing Appendix attached hereto and previously incorporated herein by reference. It is noted that each of the files “Intuition Intelligence-duckgame1.doc” and “Intuition Intelligence-duckgame2.doc” represents the game program 300, with file “Intuition Intelligence-duckgame1.doc” utilizing the action subset selection technique to continuously and dynamically match the respective skill levels of the game 200 and player 215, and file “Intuition “Intuition Intelligence-duckgame2.doc” utilizing the learning algorithm modification technique (specifically, modifying the respective reward and penalty parameters a and b when the score difference value Δ is too positive or too negative, and switching the respective reward and penalty equations when the score difference value Δ is too negative) to similarly continuously and dynamically match the respective skill levels of the game 200 and player 215.

Generalized Multi-User Learning Program (Single Processor Action-Multiple User Actions)

Hereintobefore, intuitive learning methodologies directed to single-user or teacher learning scenarios have been described. Referring to FIG. 11, a multi-user learning program 600 developed in accordance with the present inventions can be generally implemented to provide intuitive learning capability to any variety of processing devices. In this embodiment, multiple users 605(1)-(3) (here, three) interact with the program 600 by receiving the same program action αᵢ from a program action set α within the program 600, each independently selecting corresponding user actions λₓ¹-λₓ³ from respective user action sets λ¹-λ³ based on the received program action αᵢ (i.e., user 605(1) selects a user action λₓ¹ from the user action set λ¹, user 605(2) selects a user action λₓ² from the user action set λ², and user 605(3) selects a user action λₓ³ from the user action set λ³), and transmitting the selected user actions λₓ¹-λₓ³ to the program 600. Again, in alternative embodiments, the users 605 need not receive the program action αᵢ to select the respective user actions λₓ¹-λₓ³, the selected user actions λₓ¹-λₓ³ need not be based on the received program action αᵢ, and/or the program action αᵢ may be selected in response to the selected user actions λₓ¹-λₓ³. The significance is that program actions αᵢ and user actions λₓ¹-λₓ³ are selected. The program 600 is capable of learning based on the measured success or failure of the selected program action αᵢ based on selected user actions λₓ¹-λₓ³, which, for the purposes of this specification, can be measured as outcome values β¹-β³. As will be described in further detail below, program 600 directs its learning capability by dynamically modifying the model that it uses to learn based on a performance index φ to achieve one or more objectives.

To this end, the program 600 generally includes a probabilistic learning module 610 and an intuition module 615. The probabilistic learning module 610 includes a probability update module 620, an action selection module 625, and an outcome evaluation module 630. Briefly, the probability update module 620 uses learning automata theory as its learning mechanism, and is configured to generate and update an action probability distribution p based on the outcome values β¹-β³. In this scenario, the probability update module 620 uses a single stochastic learning automaton with a single input to a multi-teacher environment (with the users 605(1)-(3) as the teachers), and thus, a single-input, multiple-output (SIMO) model is assumed. Exemplary equations that can be used for the SIMO model will be described in further detail below.

In essence, the program 600 collectively learns from the users 605(1)-(3) notwithstanding that the users 605(1)-(3) provide independent user actions λₓ¹-λₓ³. The action selection module 625 is configured to select the program action αᵢ from the program action set α based on the probability values contained within the action probability distribution p internally generated and updated in the probability update module 620. The outcome evaluation module 630 is configured to determine and generate the outcome values β¹-β³ based on the relationship between the selected program action αᵢ and user actions λₓ¹-λₓ³. The intuition module 615 modifies the probabilistic learning module 610 (e.g., selecting or modifying parameters of algorithms used in learning module 610) based on one or more generated performance indexes φ to achieve one or more objectives. As previously discussed, the performance index φ can be generated directly from the outcome values β¹-β³ or from something dependent on the outcome values β¹-β³, e.g., the action probability distribution p, in which case the performance index φ may be a function of the action probability distribution p, or the action probability distribution p may be used as the performance index φ.

The modification of the probabilistic learning module 610 is generally accomplished similarly to that described with respect to the afore-described probabilistic learning module 110. That is, the functionalities of (1) the probability update module 620 (e.g., by selecting from a plurality of algorithms used by the probability update module 620, modifying one or more parameters within an algorithm used by the probability update module 620, transforming or otherwise modifying the action probability distribution p); (2) the action selection module 625 (e.g., limiting or expanding selection of the action αᵢ corresponding to a subset of probability values contained within the action probability distribution p); and/or (3) the outcome evaluation module 630 (e.g., modifying the nature of the outcome values β¹-β³ or otherwise the algorithms used to determine the outcome values β¹-β³), are modified.

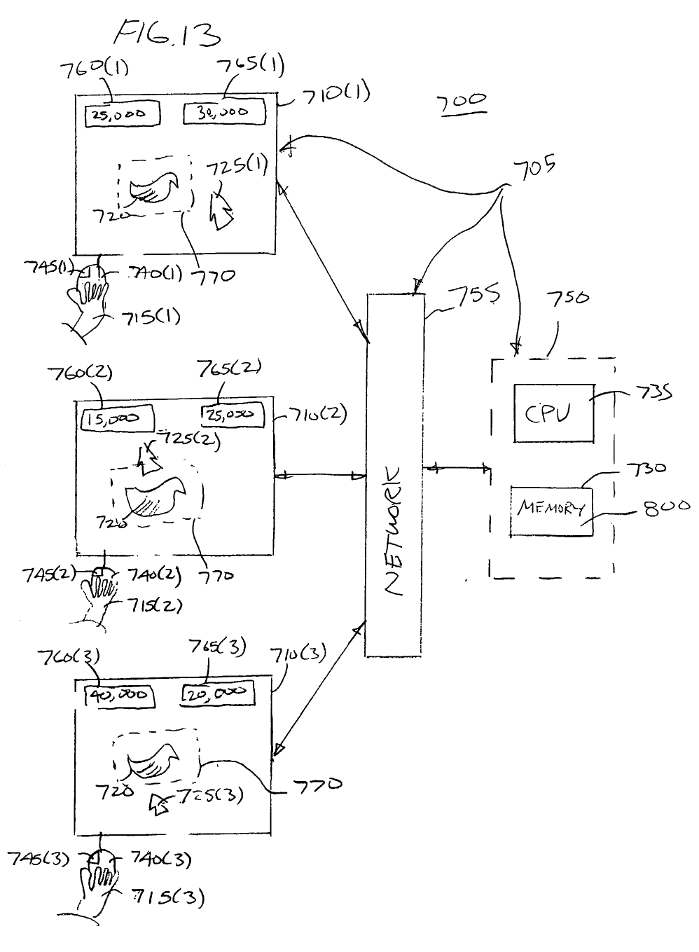

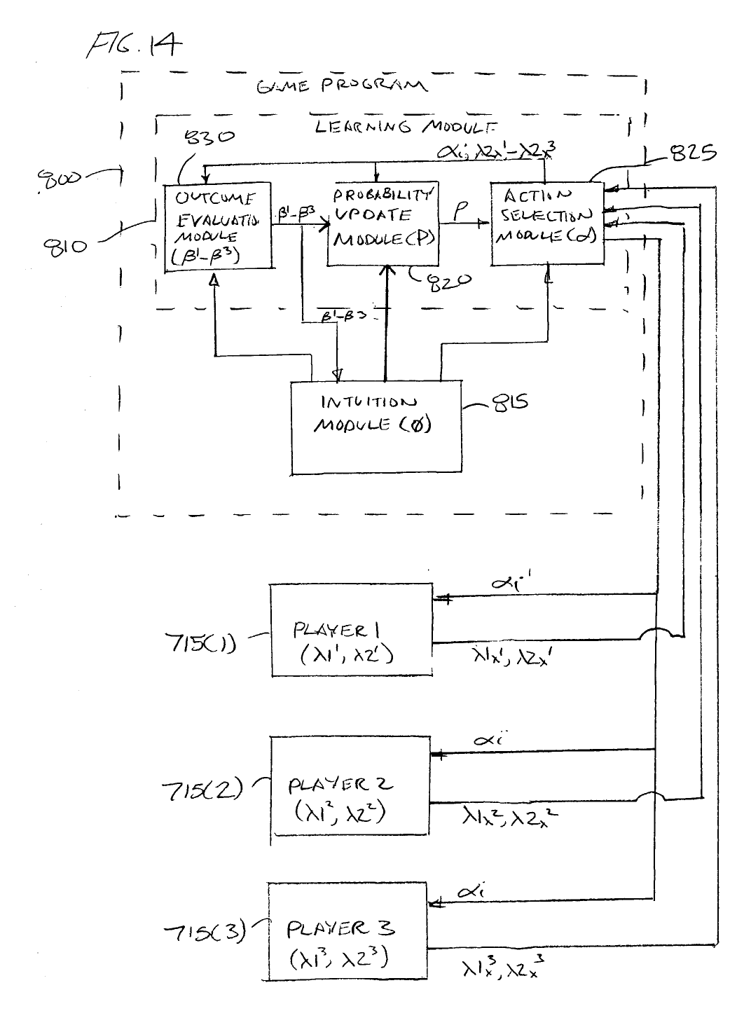

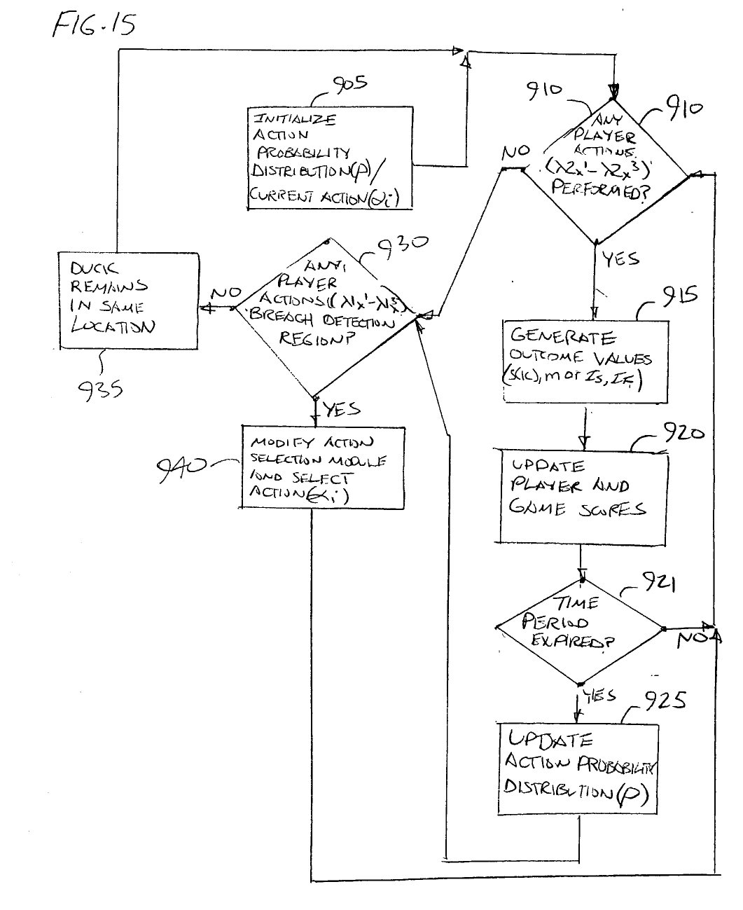

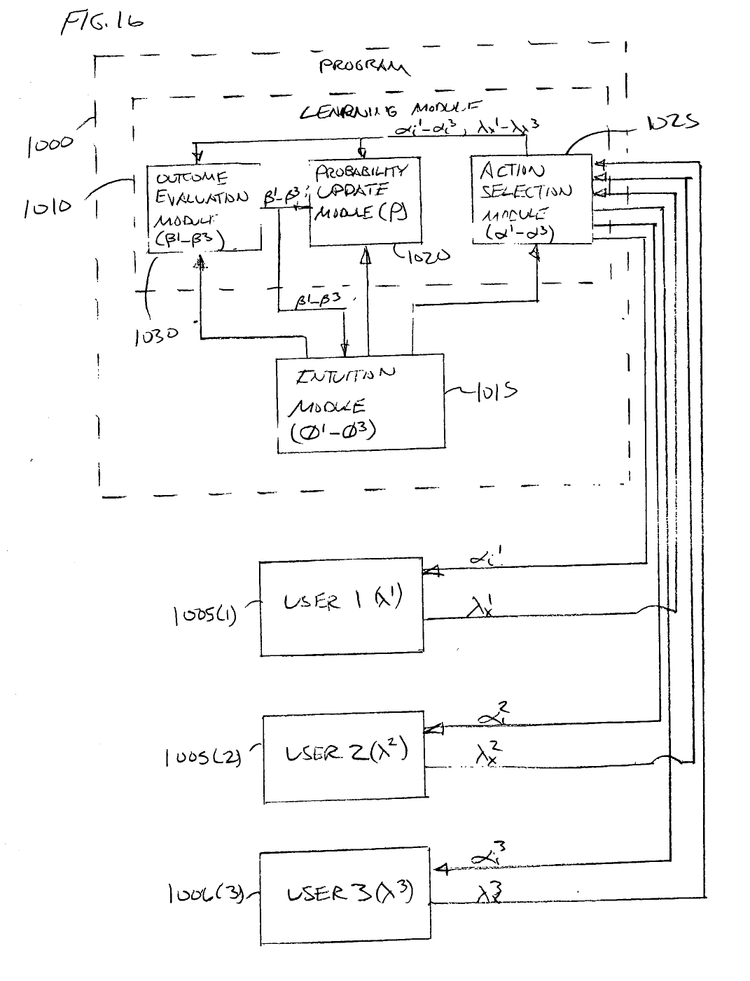

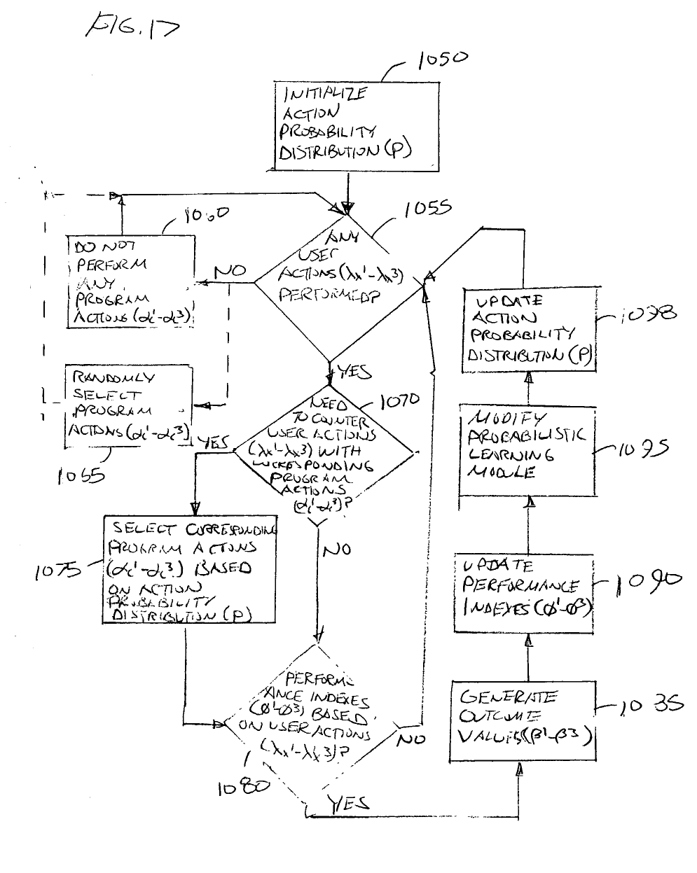

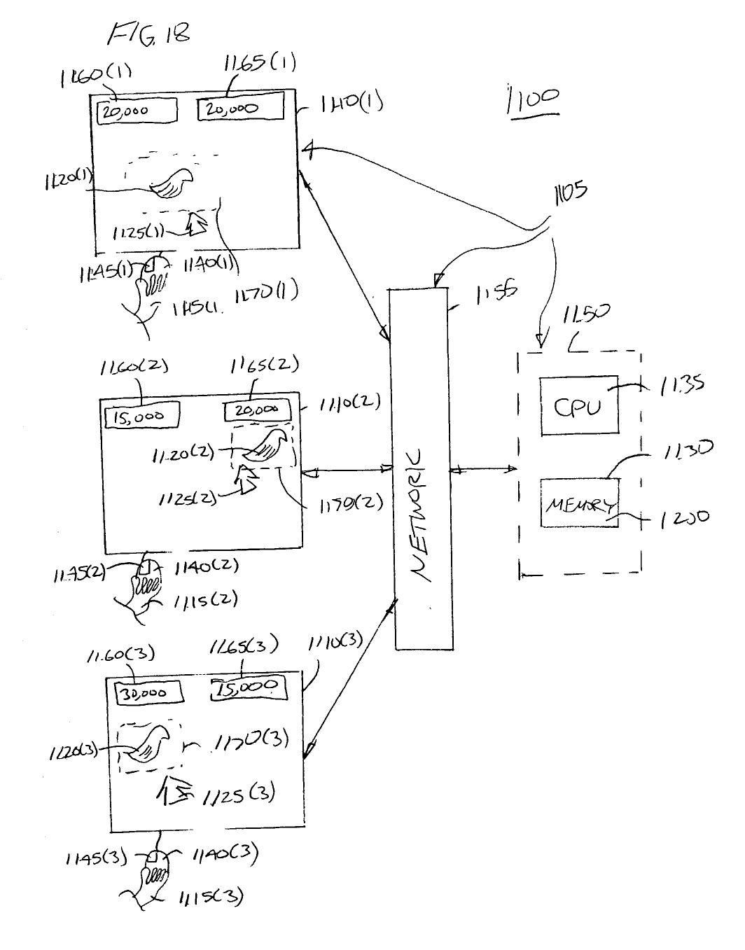

The various different types of learning methodologies previously described herein can be applied to the probabilistic learning module 610. The operation of the program 600 is similar to that of the program 100 described with respect to FIG. 4, with the exception that the program 600 takes into account all of the selected user actions λₓ¹-λₓ³ when performing the steps. Specifically, referring to FIG. 12, the probability update module 620 initializes the action probability distribution p (step 650) similarly to that described with respect to step 150 of FIG. 4. The action selection module 625 then determines if one or more of the user actions λₓ¹-λₓ³ have been selected from the respective user action sets λ¹-λ² (step 655). If not, the program 600 does not select a program action αᵢ from the program action set α (step 660), or alternatively selects a program action αᵢ, e.g., randomly, notwithstanding that none of the user actions λₓ¹-λₓ³ has been selected (step 665), and then returns to step 655 where it again determines if one or more of the user actions λₓ¹-λₓ³ have been selected. If one or more of the user actions λₓ¹-λₓ³ have been performed at step 655, the action selection module 625 determines the nature of the selected ones of the user actions λₓ¹-λₓ³.

Specifically, the action selection module 625 determines whether any of the selected ones of the user actions λₓ¹-λₓ³ are of the type that should be countered with a program action αᵢ (step 670). If so, the action selection module 625 selects a program action αᵢ from the program action set α based on the action probability distribution p (step 675). After the performance of step 675 or if the action selection module 625 determines that none of the selected user actions λₓ¹-λₓ³ is of the type that should be countered with a program action αᵢ, the action selection module 625 determines if any of the selected user actions λₓ¹-λₓ³ are of the type that the performance index φ is based on (step 680).

If not, the program returns to step 655 to determine again whether any of the user actions λₓ¹-λₓ³ have been selected. If so, the outcome evaluation module 630 quantifies the performance of the previously selected program action αᵢ relative to the currently selected user actions λₓ¹-λₓ³ by generating outcome values β¹-β³ (step 685). The intuition module 615 then updates the performance index φ based on the outcome values β¹-β³, unless the performance index φ is an instantaneous performance index that is represented by the outcome values β¹-β³ themselves (step 690), and modifies the probabilistic learning module 610 by modifying the functionalities of the probability update module 620, action selection module 625, or outcome evaluation module 630 (step 695). The probability update module 620 then, using any of the updating techniques described herein, updates the action probability distribution p based on the generated outcome values β¹-β³ (step 698).

The program 600 then returns to step 655 to determine again whether any of the user actions λₓ¹-λₓ³ have been selected. It should be noted that the order of the steps described in FIG. 12 may vary depending on the specific application of the program 600.

Multi-Player Learning Game Program (Single Game Action-Multiple Player Actions)

Having now generally described the components and functionality of the learning program 600, we now describe one of its various applications. Referring to FIG. 13, a multiple-player learning software game program 800 (shown in FIG. 14) developed in accordance with the present inventions is described in the context of a duck hunting game 700. The game 700 comprises a computer system 705, which can be used in an Internet-type scenario. The computer system 705 includes multiple computers 710(1)-(3), which merely act as dumb terminals or computer screens for displaying the visual elements of the game 700 to multiple players 715(1)-(3), and specifically, a computer animated duck 720 and guns 725(1)-(3), which are represented by mouse cursors. It is noted that in this embodiment, the positions and movements of the duck 720 at any given time are identically displayed on all three of the computer screens 715(1)-(3). Thus, in essence, each of the players 715(1)-(3) visualize the same duck 720 and are all playing against the same duck 720. As previously noted with respect to the duck 220 and gun 225 of the game 200, the duck 720 and guns 725(1)-(3) can be broadly considered to be computer and user-manipulated objects, respectively. The computer system 705 further comprises a server 750, which includes memory 730 for storing the game program 800, and a CPU 735 for executing the game program 800. The server 750 and computers 710(1)-(3) remotely communicate with each other over a network 755, such as the Internet. The computer system 705 further includes computer mice 740(1)-(3) with respective mouse buttons 745(1)-(3), which can be respectively manipulated by the players 715(1)-(3) to control the operation of the guns 725(1)-(3).

It should be noted that although the game 700 has been illustrated in a multi-computer screen environment, the game 700 can be embodied in a single-computer screen environment similar to the computer system 205 of the game 200, with the exception that the hardware provides for multiple inputs from the multiple players 715(1)-(3). The game 700 can also be embodied in other multiple-input hardware environments, such as a video game console that receives video game cartridges and connects to a television screen, or a video game machine of the type typically found in video arcades.

Referring specifically to the computer screens 710(1)-(3), the rules and objective of the duck hunting game 700 are similar to those of the game 200. That is, the objective of the players 715(1)-(3) is to shoot the duck 720 by moving the guns 725(1)-(3) towards the duck 720, intersecting the duck 720 with the guns 725(1)-(3), and then firing the guns 725(1)-(3). The objective of the duck 720, on the other hand, is to avoid from being shot by the guns 725(1)-(3). To this end, the duck 720 is surrounded by a gun detection region 770, the breach of which by any of the guns 725(1)-(3) prompts the duck 720 to select and make one of previously described seventeen moves. The game 700 maintains respective scores 760(1)-(3) for the players 715(1)-(3) and scores 765(1)-(3) for the duck 720. To this end, if any one of the players 715(1)-(3) shoots the duck 720 by clicking the corresponding one of the mouse buttons 745(1)-(3) while the corresponding one of the guns 725(1)-(3) coincides with the duck 720, the corresponding one of the player scores 760(1)-(3) is increased. In contrast, if any one of the players 715(1)-(3) fails to shoot the duck 720 by clicking the corresponding one of the mouse buttons 745(1)-(3) while the corresponding one of the guns 725(1)-(3) does not coincide with the duck 720, the corresponding one of the duck scores 765(1)-(3) is increased. As previously discussed with respect to the game 200, the increase in the score can be fixed, one of a multitude of discrete values, or a value within a continuous range of values. It should be noted that although the players 715(1)-(3) have been described as individually playing against the duck 720, such that the players 715(1)-(3) have their own individual scores 760(1)-(3) with corresponding individual duck scores 765(1)-(3), the game 700 can be modified, so that the players 715(1)-(3) can play against the duck 720 as a team, such that there is only one player score and one duck score that is identically displayed on all three computers 760(1)-(3).

As will be described in further detail below, the game 700 increases its skill level by learning the players' 715(1)-(3) strategy and selecting the duck's 720 moves based thereon, such that it becomes more difficult to shoot the duck 720 as the players 715(1)-(3) become more skillful. The game 700 seeks to sustain the players' 715(1)-(3) interest by collectively challenging the players 715(1)-(3). To this end, the game 700 continuously and dynamically matches its skill level with that of the players 715(1)-(3) by selecting the duck's 720 moves based on objective criteria, such as, e.g., the difference between a function of the player scores 760(1)-(3) (e.g., the average) and a function (e.g., the average) of the duck scores 765(1)-(3). In other words, the game 700 uses this score difference as a performance index φ in measuring its performance in relation to its objective of matching its skill level with that of the game players. Alternatively, the performance index φ can be a function of the action probability distribution p.

Referring further to FIG. 14, the game program 800 generally includes a probabilistic learning module 810 and an intuition module 815, which are specifically tailored for the game 700. The probabilistic learning module 810 comprises a probability update module 820, an action selection module 825, and an outcome evaluation module 830. Specifically, the probability update module 820 is mainly responsible for learning the players' 715(1)-(3) strategy and formulating a counterstrategy based thereon, with the outcome evaluation module 830 being responsible for evaluating actions performed by the game 700 relative to actions performed by the players 715(1)-(3). The action selection module 825 is mainly responsible for using the updated counterstrategy to move the duck 720 in response to moves by the guns 725(1)-(3). The intuition module 815 is responsible for directing the learning of the game program 800 towards the objective, and specifically, dynamically and continuously matching the skill level of the game 700 with that of the players 715(1)-(3). In this case, the intuition module 815 operates on the action selection module 825, and specifically selects the methodology that the action selection module 825 will use to select a game action αᵢ from the game action set α as will be discussed in further detail below. In the preferred embodiment, the intuition module 815 can be considered deterministic in that it is purely rule-based. Alternatively, however, the intuition module 815 can take on a probabilistic nature, and can thus be quasi-deterministic or entirely probabilistic.

To this end, the action selection module 825 is configured to receive player actions λ1ₓ¹-λ1ₓ³ from the players 715(1)-(3), which takes the form of mouse 740(1)-(3) positions, i.e., the positions of the guns 725(1)-(3) at any given time. Based on this, the action selection module 825 detects whether any one of the guns 725(1)-(3) is within the detection region 770, and if so, selects the game action αᵢ from the game action set α and specifically, one of the seventeen moves that the duck 720 will make.

Like with the game program 300, the action selection module 825 selects the game action αᵢ based on the updated game strategy, and is thus, further configured to receive the action probability distribution p from the probability update module 820, and pseudo-randomly selecting the game action αᵢ based thereon. The intuition module 815 is configured to modify the functionality of the action selection module 825 based on the performance index φ, and in this case, the current skill levels of the players 715(1)-(3) relative to the current skill level of the game 700. In the preferred embodiment, the performance index φ is quantified in terms of the score difference value Δ between the average of the player scores 760(1)-(3) and the duck scores 765(1)-(3). Although in this case the player scores 760(1)-(3) equally affect the performance index φ in an incremental manner, it should be noted that the effect that these scores have on the performance index φ may be weighted differently. In the manner described above with respect to game 200, the intuition module 815 is configured to modify the functionality of the action selection module 825 by subdividing the action set α into a plurality of action subsets αₛ, selecting one of the action subsets αₛ based on the score difference value Δ (or alternatively, based on a series of previous determined outcome values β¹-β³ or equivalent or some other parameter indicative of the performance index φ). The action selection module 825 is configured to pseudo-randomly select a single game action α from the selected action subset αₛ.

The action selection module 825 is further configured to receive player actions λ2ₓ¹-λ2ₓ³ from the players 715(1)-(3) in the form of mouse button 745(1)-(3) click/mouse 740(1)-(3) position combinations, which indicate the positions of the guns 725(1)-(3) when they are fired. The outcome evaluation module 830 is further configured to determine and output outcome values β¹-β³ that indicate how favorable the selected game action αᵢ in comparison with the received player actions λ2ₓ¹-λ2ₓ³ is, respectively.

As previously described with respect to the game 200, the outcome evaluation module 830 employs a collision detection technique to determine whether the duck's 720 last move was successful in avoiding the gunshots, with each of the outcome values β¹-β³ equaling one of two predetermined values, e.g., “1” if a collision is not detected (i.e., the duck 720 is not shot), and “0” if a collision is detected (i.e., the duck 720 is shot), or alternatively, one of a range of finite integers or real numbers, or one of a range of continuous values.

The probability update module 820 is configured to receive the outcome values β¹-β³ from the outcome evaluation module 830 and output an updated game strategy (represented by action probability distribution p) that the duck 720 will use to counteract the players' 715(1)-(3) strategy in the future. As will be described in further detail below, the action probability distribution p is updated periodically, e.g., every second, during which each of any number of the players 715(1)-(3) may provide a corresponding number of player actions λ2ₓ¹-λ2ₓ³. In this manner, the player actions λ2ₓ¹-λ2ₓ³ asynchronously performed by the players 715(1)-(3) may be synchronized to a time period. For the purposes of the specification, a player that the probability update module 820 takes into account when updating the action probability distribution p at any given time is considered a participating player. It should be noted that in other types of games, where the player actions λ2ₓ need not be synchronized to a time period, such as, e.g., strategy games, the action probability distribution p may be updated after all players have performed a player action λ2ₓ.

It is noted that in the preferred embodiment, the intuition module 815, probability update module 820, action selection module 825, and evaluation module 830 are all stored in the memory 730 of the server 750, in which case, player actions λ1ₓ¹-λ1ₓ³, player actions λ2ₓ¹-λ2ₓ³, and the selected game actions αᵢ can be transmitted between the user computers 710(1)-(3) and the server 750 over the network 755.

In this case, the game program 800 may employ the following unweighted P-type SIMO equations:

$$\begin{matrix}{p}_{j} ( k + 1 ) = {p}_{j} ( k ) - \frac{s ( k )}{m} {g}_{j} ( p ( k ) ) + ( 1 - \frac{s ( k )}{m} ) {h}_{j} ( p ( k ) ) , if α ( k ) \neq {α}_{i} & [ 16 ] \\ {p}_{i} ( k + 1 ) = {p}_{i} ( k ) + \frac{s ( k )}{m} {\sum }_{{j = 1}_{j \neq i }}^{n} {g}_{j} ( p ( k ) ) - ( 1 - \frac{s ( k )}{m} ) {\sum }_{{j = 1}_{j \neq i }}^{n} {h}_{j} ( p ( k ) ) , if α ( k ) = {α}_{i} & [ 17 ]\end{matrix}$$

where

pᵢ(k+1), pᵢ(k), gⱼ(p(k)), hⱼ(p(k)), i,j, k, and n have been previously defined, s(k) is the number of favorable responses (rewards) obtained from the participating players for game action αᵢ, and m is the number of participating players. It is noted that s(k) can be readily determined from the outcome values β¹-β³.

As an example, if there are a total of ten players, seven of which have been determined to be participating, and if two of the participating players shoot the duck 720 and the other five participating players miss the duck 720, m will equal 7, and s(k) will equal 5, and thus equations [16] and [17] can be broken down to:

$$\begin{matrix}{p}_{j} ( k + 1 ) = {p}_{j} ( k ) - \frac{5}{7} {g}_{j} ( p ( k ) ) + \frac{2}{7} {h}_{j} ( p ( k ) ) , if α ( k ) \neq {α}_{i} & \text{[16-1]} \\ {p}_{i} ( k + 1 ) = {p}_{i} ( k ) + \frac{5}{7} {\sum }_{{j = 1}_{j \neq i }}^{n} {g}_{j} ( p ( k ) ) - \frac{2}{7} {\sum }_{{j = 1}_{j \neq i }}^{n} {h}_{j} ( p ( k ) ) , if α ( k ) = {α}_{i} & \text{[17-1]}\end{matrix}$$

It should be noted that a single player may perform more than one player action λ2ₓ in a single probability distribution updating time period, and thus be counted as multiple participating players. Thus, if there are three players, more than three participating players may be considered in equation. In any event, the player action sets λ2¹-λ2³ are unweighted in equation [16], and thus each player affects the action probability distribution p equally.

If it is desired that each player affects the action probability distribution p unequally, the player action sets λ2¹-λ2³ can be weighted. For example, player actions λ2ₓ performed by expert players can be weighted higher than player actions λ2ₓ performed by more novice players, so that the more skillful players affect the action probability distribution p more than the less skillful players. As a result, the relative skill level of the game 700 will tend to increase even though the skill level of the novice players do not increase. On the contrary, player actions λ2ₓ performed by novice players can be weighted higher than player actions λ2ₓ performed by more expert players, so that the less skillful players affect the action probability distribution p more than the more skillful players. As a result, the relative skill level of the game 700 will tend not to increase even though the skill level of the expert players increase.

In this case, the game program 800 may employ the following weighted P-type SIMO equations:

$$\begin{matrix}{p}_{j} ( k + 1 ) = {p}_{j} ( k ) - ( {\sum }_{q = 1}^{m} {w}^{q} {{I}_{S}}^{q} ) {g}_{j} ( p ( k ) ) + ( {\sum }_{q = 1}^{m} {w}^{q} {{I}_{F}}^{q} ) {h}_{j} ( p ( k ) ) , if α ( k ) \neq {α}_{i} & [ 18 ] \\ {p}_{i} ( k + 1 ) = {p}_{i} ( k ) + ( {\sum }_{q = 1}^{m} {w}^{q} {{I}_{S}}^{q} ) {\sum }_{{j = 1}_{j \neq i }}^{n} {g}_{j} ( p ( k ) ) - ( {\sum }_{q = 1}^{m} {w}^{q} {{I}_{S}}^{q} ) {\sum }_{{j = 1}_{j \neq i }}^{n} {h}_{j} ( p ( k ) ) , if α ( k ) = {α}_{i} & [ 19 ]\end{matrix}$$

where

pᵢ(k+1), pᵢ(k), gⱼ(p(k)), hⱼ(k)), i,j, k, and n have been previously defined, q is the ordered one of the participating players, m is the number of participating players, w^{q} is the normalized weight of the qth participating player, I_{S}^{q} is a indicator variable that indicates the occurrence of a favorable response associated with the qth participating player, where I_{S}^{q} is 1 to indicate that a favorable response occurred and 0 to indicate that a favorable response did not occur, and I_{F}^{q} is a variable indicating the occurrence of an unfavorable response associated with the qth participating player, where I_{F}^{q} is 1 to indicate that an unfavorable response occurred and 0 to indicate that an unfavorable response did not occur. It is noted that I_{S}^{q} and I_{F}^{q} can be readily determined from the outcome values β¹-β³.

As an example, consider Table 2, which sets forth exemplary participation, weighting, and outcome results of ten players given a particular action αᵢ.

TABLE 2
Exemplary Outcome Results for Ten
Players in Weighted SIMO Format

| | Weighting | | Weighting | |
|---|---|---|---|---|
| | Normalized | | Normalized | |
| Player | to All | Participating | to Participating | Outcome |
| # | Players | (q) | Players (w) | (S or F) |
| 1 | 0.05 | 1 | 0.077 | S |
| 2 | 0.20 | 2 | 0.307 | S |
| 3 | 0.05 | — | — | — |
| 4 | 0.10 | 3 | 0.154 | F |
| 5 | 0.10 | — | — | — |
| 6 | 0.05 | 4 | 0.077 | F |
| 7 | 0.20 | — | — | — |
| 8 | 0.10 | 5 | 0.154 | S |
| 9 | 0.10 | 6 | 0.154 | S |
| 10 | 0.05 | 7 | 0.077 | S |

In this case,

$${\sum }_{q = 1}^{m} {w}^{q} {{I}_{S}}^{q} = ( .077 ) ( 1 ) + ( .307 ) ( 1 ) + ( .154 ) ( 0 ) + ( .077 ) ( 0 ) + ( .154 ) ( 1 ) + ( .154 ) ( 1 ) + ( .077 ) ( 1 ) = .769 ; and$$

$${\sum }_{q = 1}^{m} {w}^{q} {{I}_{F}}^{q} = ( .077 ) ( 0 ) + ( .307 ) ( 0 ) + ( .154 ) ( 1 ) + ( .077 ) ( 1 ) + ( .154 ) ( 0 ) + ( .154 ) ( 0 ) + ( .077 ) ( 0 ) = .231 ;$$

and thus, equations [18] and [19] can be broken down to:

$$\begin{matrix}{p}_{j} ( k + 1 ) = {p}_{j} ( k ) - 0.769 {g}_{j} ( p ( k ) ) + 0.231 {h}_{j} ( p ( k ) ) , if α ( k ) \neq {α}_{i} & \text{[18-1]} \\ {p}_{i} ( k + 1 ) = {p}_{i} ( k ) + 0.769 {\sum }_{{j = 1}_{j \neq i }}^{n} {g}_{j} ( p ( k ) ) - 0.231 {\sum }_{{j = 1}_{j \neq i }}^{n} {h}_{j} ( p ( k ) ) , if α ( k ) = {α}_{i} & \text{[19-1]}\end{matrix}$$

It should be also noted that although the probability update module 820 may update the action probability distribution p based on a combination of players participating during a given period of time by employing equations [16]-[19], the probability update module 820 may alternatively update the action probability distribution p as each player participates by employing SISO equations [4] and [5]. In general, however, updating the action probability distribution p on a player-by-player participation basis requires more processing power than updating the action probability distribution p on a grouped player participation basis. This processing capability becomes more significant as the number of players increases.

It should also be noted that a single outcome value β can be generated in response to several player actions λ2. In this case, if less than a predetermined number of collisions are detected, or alternatively, less than a predetermined percentage of collisions are detected based on the number of player actions λ2ₓ received, the outcome evaluation module 830 will generate an favorable outcome value β, e.g., “1”, will be generated. In contrast, if a predetermined number of collisions or more are detected, or alternatively, a predetermined percentage of collisions or more are detected based on the number of player actions λ2ₓ received, the outcome evaluation module 830 will generate a favorable outcome value β, e.g., “0.” As will be described in further detail below, a P-type Maximum Probability of Majority Approval (MPMA) SISO equation can be used in this case. Optionally, the extent of the collision or the players that perform the player actions λ2ₓ can be weighted. For example, shots to the head may be weighted higher than shots to the abdomen, or stronger players may be weighted higher than weaker players. Q-type or S-type equations can be used, in which case, the outcome value β may be a value between “0” and “1”.

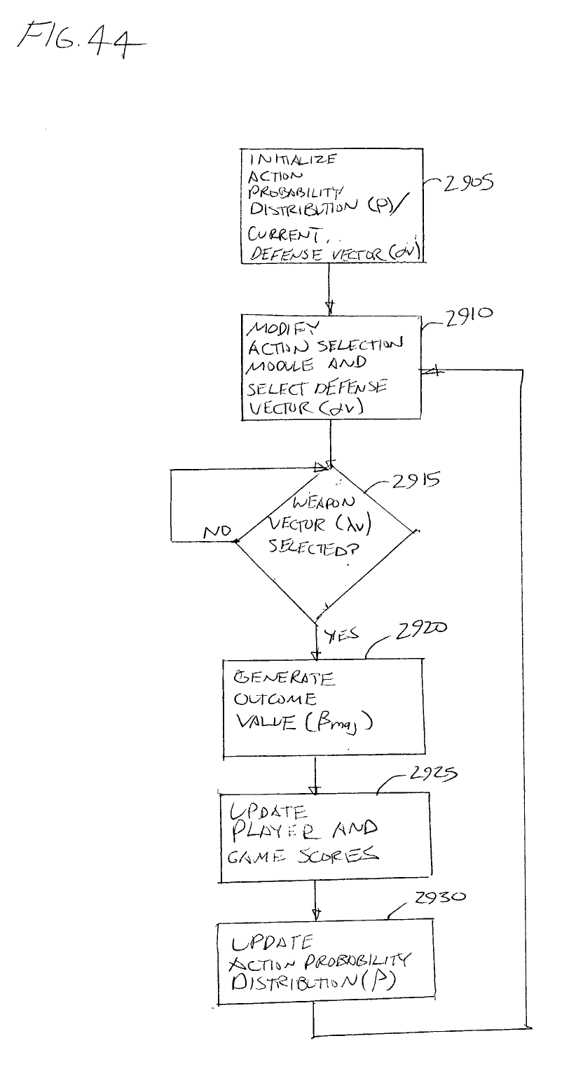

Having now described the structure of the game program 800, the steps performed by the game program 800 will be described with reference to FIG. 15. First, the probability update module 820 initializes the action probability distribution p and current action αᵢ (step 905) similarly to that described in step 405 of FIG. 9. Then, the action selection module 825 determines whether any of the player actions λ2ₓ¹-λ2ₓ³ have been performed, and specifically whether the guns 725(1)-(3) have been fired (step 910). If any of the player actions λ2ₓ¹-λ2ₓ³ have been performed, the outcome evaluation module 830 generates the corresponding outcome values β¹-β³, as represented by s(k) and m values (unweighted case) or I_{S}^{q} and I_{F}^{q} occurrences (weighted case), for the performed ones of the player actions λ2ₓ¹-λ2ₓ³ (step 915), and the intuition module 815 then updates the corresponding player scores 760(1)-(3) and duck scores 765(1)-(3) based on the corresponding outcome values β¹-β³ (step 920), similarly to that described in steps 415 and 420 of FIG. 9. The intuition module 815 then determines if the given time period to which the player actions λ2ₓ¹-λ2ₓ³ are synchronized has expired (step 921). If the time period has not expired, the game program 800 will return to step 910 where the action selection module 825 determines again if any of the player actions λ2ₓ¹-λ2ₓ³ have been performed. If the time period has expired, the probability update module 820 then, using the unweighted SIMO equations [16] and [17] or the weighted SIMO equations [18] and [19], updates the action probability distribution p based on the generated outcome values β¹-β³ (step 925). Alternatively, rather than synchronize the asynchronous performance of the player actions λ2ₓ¹-λ2ₓ³ to the time period at step 921, the probability update module 820 can update the action probability distribution p after each of the asynchronous player actions λ2ₓ¹-λ2ₓ³ is performed using any of the techniques described with respect to the game program 300. Also, it should be noted that if a single outcome value β is to be generated for a group of player actions λ2ₓ¹-λ2ₓ³, outcome values β¹-β³ are not generated as step 920, but rather the single outcome value β is generated only after the time period has expired at step 921, and then the action probability distribution p is updated at step 925. The details on this specific process flow are described with reference to FIG. 42 and the accompanying text.

After step 925, or if none of the player actions λ2ₓ¹-λ2ₓ³ has been performed at step 910, the action selection module 825 determines if any of the player actions λ1ₓ¹-λ1ₓ³ have been performed, i.e., guns 725(1)-(3), have breached the gun detection region 270 (step 930). If none of the guns 725(1)-(3) has breached the gun detection region 270, the action selection module 825 does not select a game action αᵢ from the game action set α and the duck 720 remains in the same location (step 935). Alternatively, the game action αᵢ may be randomly selected, allowing the duck 720 to dynamically wander. The game program 800 then returns to step 910 where it is again determined if any of the player actions λ1ₓ¹-λ1ₓ³ has been performed. If any of the guns 725(1)-(3) have breached the gun detection region 270 at step 930, the intuition module 815 modifies the functionality of the action selection module 825 based on the performance index φ, and the action selection module 825 selects a game action αᵢ from the game action α in the manner previously described with respect to steps 440-470 of FIG. 9 (step 940).

It should be noted that, rather than use the action subset selection technique, other afore-described techniques used to dynamically and continuously match the skill level of the players 715(1)-(3) with the skill level of the game 700, such as that illustrated in FIG. 10, can be alternatively or optionally be used as well in the game program 800.

Generalized Multi-User Learning Program (Multiple Processor Actions-Multiple User Actions)

Referring to FIG. 16, another multi-user learning program 1000 developed in accordance with the present inventions can be generally implemented to provide intuitive learning capability to any variety of processing devices. In this embodiment, multiple users 1005(1)-(3) (here, three) interact with the program 1000 by respectively receiving program actions αᵢ¹-αᵢ³ from respective program action subsets α¹-α³ within the program 1000, each independently selecting corresponding user actions λₓ¹-λₓ³ from respective user action sets λ¹-λ³ based on the received program actions αᵢ¹-αᵢ³ (i.e., user 1005(1) selects a user action λₓ¹ from the user action set λ¹ based on the received program action αᵢ¹, user 1005(2) selects a user action λₓ² from the user action set λ² based on the received program action αᵢ², and user 1005(3) selects a user action λₓ³ from the user action set λ³ based on the received program action αᵢ³), and transmitting the selected user actions λₓ¹-λₓ³ to the program 1000. Again, in alternative embodiments, the users 1005 need not receive the program actions αᵢ¹-αᵢ³, the selected user actions λₓ¹-λₓ³ need not be based on the received program actions αᵢ¹-αᵢ³, and/or the program actions αᵢ¹-αᵢ³ may be selected in response to the selected user actions λₓ¹-λₓ³. The significance is that program actions αᵢ¹-αᵢ³ and user actions λₓ¹-λₓ³ are selected.

It should be noted that the multi-user learning program 1000 differs from the multi-user learning program 600 in that the multiple users 1005(1)-(3) can receive multiple program actions αᵢ¹-αᵢ³ from the program 1000 at any given instance, all of which may be different, whereas the multiple users 605(1)-(3) all receive a single program action αᵢ from the program 600. It should also be noted that the number and nature of the program actions may vary or be the same within the program action sets α¹, α², and ζ³ themselves. The program 1000 is capable of learning based on the measured success or failure of the selected program actions αᵢ¹-αᵢ³ based on selected user actions λₓ¹-λₓ³, which, for the purposes of this specification, can be measured as outcome values β¹-β³. As will be described in further detail below, program 1000 directs its learning capability by dynamically modifying the model that it uses to learn based on performance indexes φ¹-φ³ to achieve one or more objectives.

To this end, the program 1000 generally includes a probabilistic learning module 1010 and an intuition module 1015. The probabilistic learning module 1010 includes a probability update module 1020, an action selection module 1025, and an outcome evaluation module 1030. Briefly, the probability update module 1020 uses learning automata theory as its learning mechanism, and is configured to generate and update an action probability distribution p based on the outcome values β¹-β³. In this scenario, the probability update module 1020 uses a single stochastic learning automaton with multiple inputs to a multi-teacher environment (with the users 1005(1)-(3) as the teachers), and thus, a multiple-input, multiple-output (MIMO) model is assumed. Exemplary equations that can be used for the MIMO model will be described in further detail below.

In essence, as with the program 600, the program 1000 collectively learns from the users 1005(1)-(3) notwithstanding that the users 1005(1)-(3) provide independent user actions user actions λₓ¹-λₓ³. The action selection module 1025 is configured to select the program actions αᵢ¹-αᵢ³ based on the probability values contained within the action probability distribution p internally generated and updated in the probability update module 1020. Alternatively, multiple action selection modules 1025 or multiple portions of the action selection module 1025 may be used to respectively select the program actions αᵢ¹-αᵢ³. The outcome evaluation module 1030 is configured to determine and generate the outcome values β¹-β³ based on the respective relationship between the selected program actions αᵢ¹-αᵢ³ and user actions λₓ¹-λₓ³. The intuition module 1015 modifies the probabilistic learning module 1010 (e.g., selecting or modifying parameters of algorithms used in learning module 1010) based on the generated performance indexes φ¹-φ³ to achieve one or more objectives. Alternatively, a single performance index φ can be used. As previously described, the performance indexes φ¹-φ³ can be generated directly from the outcome values β¹-β³ or from something dependent on the outcome values β¹-β³, e.g., the action probability distribution p, in which case the performance indexes φ¹-φ³ may be a function of the action probability distribution p, or the action probability distribution p may be used as the performance indexes φ¹-φ³.

The modification of the probabilistic learning module 1010 is generally accomplished similarly to that described with respect to the afore-described probabilistic learning module 110. That is, the functionalities of (1) the probability update module 1020 (e.g., by selecting from a plurality of algorithms used by the probability update module 1020, modifying one or more parameters within an algorithm used by the probability update module 1020, transforming or otherwise modifying the action probability distribution p); (2) the action selection module 1025 (e.g., limiting or expanding selection of the program action αᵢ corresponding to a subset of probability values contained within the action probability distribution p); and/or (3) the outcome evaluation module 1030 (e.g., modifying the nature of the outcome values β¹-β³ or otherwise the algorithms used to determine the outcome values β¹-β³), are modified.

The various different types of learning methodologies previously described herein can be applied to the probabilistic learning module 1010. The operation of the program 1000 is similar to that of the program 600 described with respect to FIG. 12, with the exception that the program 1000 individually responds to the user actions λₓ¹-λₓ³ with program actions αᵢ¹-αᵢ³ when performing the steps. Specifically, referring to FIG. 17, the probability update module 1020 initializes the action probability distribution p (step 1050) similarly to that described with respect to step 150 of FIG. 4. The action selection module 1025 then determines if one or more of the user actions λₓ¹-λₓ³ have been selected from the user action sets λ₁-λ³ (step 1055). If not, the program 1000 does not select program actions αᵢ¹-αᵢ³ from the respective program action sets α¹-α³ (step 1060), or alternatively selects program actions αᵢ¹-αᵢ³, e.g., randomly, notwithstanding that none of the user actions λₓ¹-λₓ³ has been selected (step 1065), and then returns to step 1055 where it again determines if one or more of the user actions λₓ¹-λₓ³ have been selected. If one or more of the user actions λₓ¹-λₓ³ have been selected at step 1055, the action selection module 1025 determines the nature of the selected ones of the user actions λₓ¹-λₓ³.

Specifically, the action selection module 1025 determines whether any of the selected ones of the user actions λₓ¹-λₓ³ are of the type that should be countered with the corresponding ones of the program actions αᵢ¹-αᵢ³ (step 1070). If so, the action selection module 1025 selects the program action αᵢ from the corresponding program action sets α¹-α³ based on the action probability distribution p (step 1075). Thus, if user action λ¹ was selected and is of the type that should be countered with a program action αᵢ, a program action αᵢ¹ will be selected from the program action set α¹. If user action λ² was selected and is of the type that should be countered with a program action αᵢ, a program action αᵢ² will be selected from the program action set α². If user action λ³ was selected and is of the type that should be countered with a program action αᵢ, a program action αᵢ³ will be selected from the program action set α³. After the performance of step 1075 or if the action selection module 1025 determines that none of the selected user actions λₓ¹-λₓ³ are of the type that should be countered with a program action αᵢ, the action selection module 1025 determines if any of the selected user actions λₓ¹-λₓ³ are of the type that the performance indexes φ¹-φ³ are based on (step 1080).

If not, the program 1000 returns to step 1055 to determine again whether any of the user actions λₓ¹-λₓ³ have been selected. If so, the outcome evaluation module 1030 quantifies the performance of the previously corresponding selected program actions αᵢ¹-αᵢ³ relative to the currently selected user actions λₓ¹-λₓ³, respectively, by generating outcome values β¹-β³. (step 1085). The intuition module 1015 then updates the performance indexes φ¹-φ³ based on the outcome values β¹-β³ unless the performance indexes φ¹-φ³ are instantaneous performance indexes that are represented by the outcome values β¹-β³ themselves (step 1090), and modifies the probabilistic learning module 1010 by modifying the functionalities of the probability update module 1020, action selection module 1025, or outcome evaluation module 1030 (step 1095). The probability update module 1020 then, using any of the updating techniques described herein, updates the action probability distribution p based on the generated outcome values β¹-β³ (step 1098).

The program 1000 then returns to step 1055 to determine again whether any of the user actions λₓ¹-λₓ³ have been selected. It should be noted that the order of the steps described in FIG. 17 may vary depending on the specific application of the program 1000.

Multi-Player Learning Game Program (Multiple Game Actions-Multiple Player Actions)

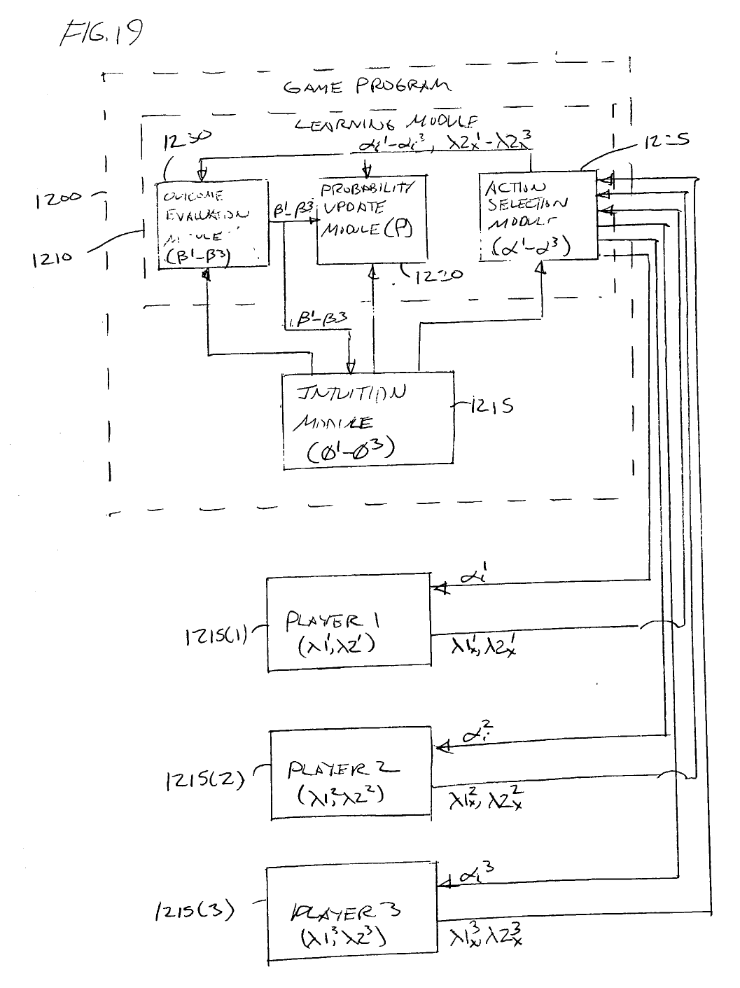

Having now generally described the components and functionality of the learning program 1000, we now describe one of its various applications. Referring to FIG. 18, a multiple-player learning software game program 1200 developed in accordance with the present inventions is described in the context of a duck hunting game 1100. The game 1100 comprises a computer system 1105, which like the computer system 705, can be used in an Internet-type scenario, and includes multiple computers 1110(1)-(3), which display the visual elements of the game 1100 to multiple players 1115(1)-(3), and specifically, different computer animated ducks 1120(1)-(3) and guns 1125(1)-(3), which are represented by mouse cursors. It is noted that in this embodiment, the positions and movements of the corresponding ducks 1120(1)-(3) and guns 1125(1)-(3) at any given time are individually displayed on the corresponding computer screens 1115(1)-(3). Thus, in essence, as compared to the game 700 where each of the players 715(1)-(3) visualizes the same duck 720, the players 1115(1)-(3) in this embodiment visualize different ducks 1120(1)-(3) and the corresponding one of the guns 1125(1)-(3). That is, the player 1115(1) visualizes the duck 1120(1) and gun 1125(1), the player 1115(2) visualizes the duck 1120(2) and gun 1125(2), and the player 1115(3) visualizes the duck 1120(3) and gun 1125(3).

As previously noted with respect to the duck 220 and gun 225 of the game 200, the ducks 1120(1)-(3) and guns 1125(1)-(3) can be broadly considered to be computer and user-manipulated objects, respectively. The computer system 1105 further comprises a server 1150, which includes memory 1130 for storing the game program 1200, and a CPU 1135 for executing the game program 1200. The server 1150 and computers 1110(1)-(3) remotely communicate with each other over a network 1155, such as the Internet. The computer system 1105 further includes computer mice 1140(1)-(3) with respective mouse buttons 1145(1)-(3), which can be respectively manipulated by the players 1115(1)-(3) to control the operation of the guns 1125(1)-(3). As will be described in further detail below, the computers 1110(1)-(3) can be implemented as dumb terminals, or alternatively smart terminals to off-load some of the processing power from the server 1150.

Referring specifically to the computers 1110(1)-(3), the rules and objective of the duck hunting game 1100 are similar to those of the game 700. That is, the objective of the players 1115(1)-(3) is to respectively shoot the ducks 1120(1)-(3) by moving the corresponding guns 1125(1)-(3) towards the ducks 1120(1)-(3), intersecting the ducks 1120(1)-(3) with the 1125(1)-(3), and then firing the guns 1125(1)-(3). The objective of the ducks 1120(1)-(3) other hand, is to avoid from being shot by the guns 1125(1)-(3). To this end, the ducks 1120(1)-(3) are surrounded by respective gun detection regions 1170(1)-(3), the respective breach of which by the guns 1125(1)-(3) prompts the ducks 1120(1)-(3) to select and make one of the previously described seventeen moves. The game 1100 maintains respective scores 1160(1)-(3) for the players 1115(1)-(3) and respective scores 1165(1)-(3) for the ducks 1120(1)-(3). To this end, if the players 1115(1)-(3) respectively shoot the ducks 1120(1)-(3) by clicking the mouse buttons 1145(1)-(3) while the corresponding guns 1125(1)-(3) coincide with the ducks 1120(1)-(3), the player scores 1160(1)-(3) are respectively increased. In contrast, if the players 1115(1)-(3) respectively fail to shoot the ducks 1120(1)-(3) by clicking the mouse buttons 1145(1)-(3) while the guns 1125(1)-(3) do not coincide with the ducks 1120(1)-(3), the duck scores 1165(1)-(3) are respectively increased. As previously discussed with respect to the game 700, the increase in the scores can be fixed, one of a multitude of discrete values, or a value within a continuous range of values.

As will be described in further detail below, the game 1100 increases its skill level by learning the players' 1115(1)-(3) strategy and selecting the respective ducks' 1120(1)-(3) moves based thereon, such that it becomes more difficult to shoot the ducks 1120(1)-(3) as the player 1115(1)-(3) becomes more skillful. The game 1100 seeks to sustain the players' 1115(1)-(3) interest by challenging the players 1115(1)-(3). To this end, the game 1100 continuously and dynamically matches its skill level with that of the players 1115(1)-(3) by selecting the duck's 1120(1)-(3) moves based on objective criteria, such as, e.g., the respective differences between the player scores 1160(1)-(3) and the duck scores 1165(1)-(3). In other words, the game 1100 uses these respective score differences as performance indexes φ¹-φ³ in measuring its performance in relation to its objective of matching its skill level with that of the game players.

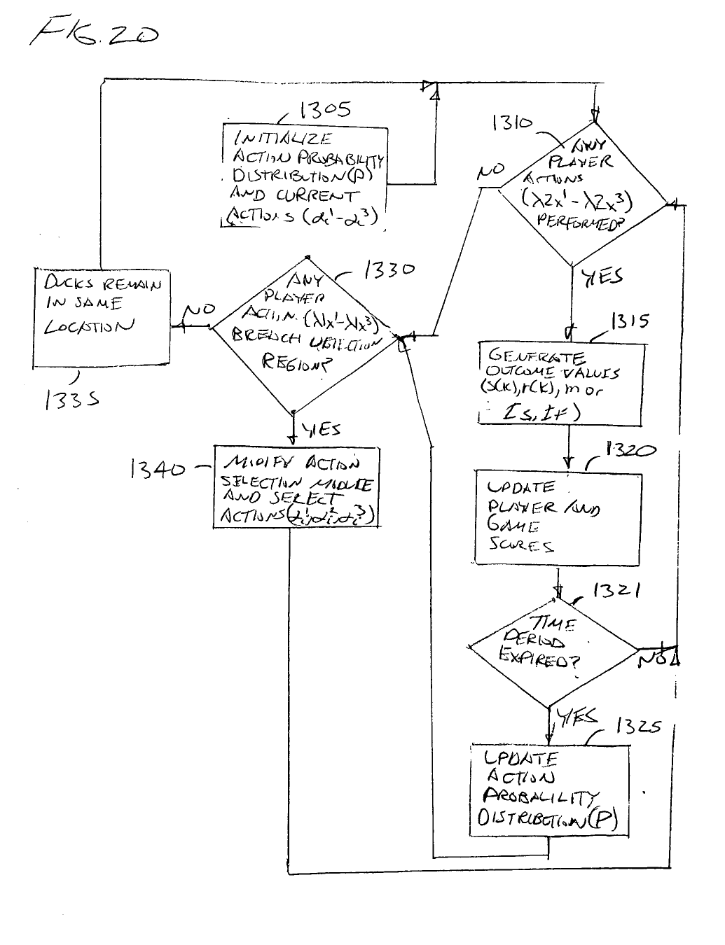

Referring further to FIG. 19, the game program 1200 generally includes a probabilistic learning module 1210 and an intuition module 1215, which are specifically tailored for the game 1100. The probabilistic learning module 1210 comprises a probability update module 1220, an action selection module 1225, and an outcome evaluation module 1230. Specifically, the probability update module 1220 is mainly responsible for learning the players' 1115(1)-(3) strategy and formulating a counterstrategy based thereon, with the outcome evaluation module 1230 being responsible for evaluating actions performed by the game 1100 relative to actions performed by the players 1115(1)-(3). The action selection module 1225 is mainly responsible for using the updated counterstrategy to respectively move the ducks 1120(1)-(3) in response to moves by the guns 1125(1)-(3). The intuition module 1215 is responsible for directing the learning of the game program 1200 towards the objective, and specifically, dynamically and continuously matching the skill level of the game 1100 with that of the players 1115(1)-(3). In this case, the intuition module 1215 operates on the action selection module 1225, and specifically selects the methodology that the action selection module 1225 will use to select game actions αᵢ¹-αᵢ³ from the respective game action sets α¹-α³, as will be discussed in further detail below. In the preferred embodiment, the intuition module 1215 can be considered deterministic in that it is purely rule-based. Alternatively, however, the intuition module 1215 can take on a probabilistic nature, and can thus be quasi-deterministic or entirely probabilistic.

To this end, the action selection module 1225 is configured to receive player actions λ1ₓ¹-λ1ₓ³ from the players 1115(1)-(3), which take the form of mouse 1140(1)-(3) positions, i.e., the positions of the guns 1125(1)-(3) at any given time. Based on this, the action selection module 1225 detects whether any one of the guns 1125(1)-(3) is within the detection regions 1170(1)-(3), and if so, selects game actions αᵢ¹-αᵢ³ from the respective game action sets α¹-α³ and specifically, one of the seventeen moves that the ducks 1120(1)-(3) will make.

The action selection module 1225 respectively selects the game actions αᵢ¹-αᵢ³ based on the updated game strategy, and is thus, further configured to receive the action probability distribution p from the probability update module 1220, and pseudo-randomly selecting the game actions αᵢ¹-αᵢ³ based thereon. The intuition module 1215 modifies the functionality of the action selection module 1225 based on the performance indexes φ¹-φ³ and in this case, the current skill levels of the players 1115(1)-(3) relative to the current skill level of the game 1100. In the preferred embodiment, the performance indexes φ¹-φ³ are quantified in terms of the respective score difference values Δ¹-Δ³ between the player scores 1160(1)-(3) and the duck scores 1165(1)-(3). Although in this case the player scores 1160(1)-(3) equally affect the performance indexes φ¹-φ³ in an incremental manner, it should be noted that the effect that these scores have on the performance indexes φ¹-φ³ may be weighted differently. In the manner described above with respect to game 200, the intuition module 1215 is configured to modify the functionality of the action selection module 1225 by subdividing the game action set α¹ into a plurality of action subsets αₛ¹ and selecting one of the action subsets αₛ¹ based on the score difference value Δ¹; subdividing the game action set α² into a plurality of action subsets αₛ² and selecting one of the action subsets αₛ² based on the score difference value Δ²; and subdividing the game action set α³ into a plurality of action subsets αₛ³ and selecting one of the action subsets αₛ³ based on the score difference value Δ³ (or alternatively, based on a series of previous determined outcome values β¹-β³ or some other parameter indicative of the performance indexes φ¹-φ³). The action selection module 1225 is configured to pseudo-randomly select game actions αᵢ¹-αᵢ³ from the selected ones of the action subsets αₛ¹-αₛ³.

The action selection module 1225 is further configured to receive player actions λ2ₓ¹-λ2ₓ³ from the players 1115(1)-(3) in the form of mouse button 1145(1)-(3) click/mouse 1040(1)-(3) position combinations, which indicate the positions of the guns 1125(1)-(3) when they are fired. The outcome evaluation module 1230 is further configured to determine and output outcome values β¹-β³ that indicate how favorable the selected game action αᵢ¹, αᵢ², and αᵢ³ in comparison with the received player actions λ2ₓ¹-λ2ₓ³ are, respectively.

As previously described with respect to the game 200, the outcome evaluation module 1230 employs a collision detection technique to determine whether the ducks' 1120(1)-(3) last moves were successful in avoiding the gunshots, with the outcome values β¹-β³ equaling one of two predetermined values, e.g., “1” if a collision is not detected (i.e., the ducks 1120(1)-(3) are not shot), and “0” if a collision is detected (i.e., the ducks 1020(1)-(3) are shot), or alternatively, one of a range of finite integers or real numbers, or one of a range of continuous values.

The probability update module 1220 is configured to receive the outcome values β¹-β³ from the outcome evaluation module 1230 and output an updated game strategy (represented by action probability distribution p) that the ducks 1120(1)-(3) will use to counteract the players' 1115(1)-(3) strategy in the future. As will be described in further detail below, the action probability distribution p is updated periodically, e.g., every second, during which each of any number of the players 1115(1)-(3) may provide one or more player actions λ2ₓ¹-λ2ₓ³. In this manner, the player actions λ2ₓ¹-λ2ₓ³ asynchronously performed by the players 1115(1)-(3) may be synchronized to a time period. For the purposes of the specification, a player that the probability update module 1220 takes into account when updating the action probability distribution p at any given time is considered a participating player.

The game program 1200 may employ the following unweighted P-type MIMO learning methodology:

$${p}_{i} ( k + 1 ) = {p}_{i} ( k ) + \frac{{s}_{i} ( k )}{m} {\sum }_{{j = 1}_{j \neq i }}^{n} {g}_{j} ( p ( k ) ) - \frac{( {r}_{i} ( k ) - {s}_{i} ( k ) )}{m} {\sum }_{{j = 1}_{j \neq i }}^{n} {h}_{j} ( p ( k ) ) - \frac{{\sum }_{{j = 1}_{j \neq i }}^{n} {s}_{j} ( k )}{m} {g}_{i} ( p ( k ) ) + \frac{{\sum }_{{j = 1}_{j \neq i }}^{n} ( {r}_{j} ( k ) - {s}_{j} ( k ) )}{m} {h}_{i} ( p ( k ) ) \qquad [ 20 ]$$

where

pᵢ(k+1), pᵢ(k), gⱼ(p(k)), hⱼ(p(k)), i, j, k, and n have been previously defined, rᵢ(k) is the total number of favorable (rewards) and unfavorable responses (penalties) obtained from the participating players for game action αᵢ, sᵢ(k) is the number of favorable responses (rewards) obtained from the participating players for game action αᵢ, rⱼ(k) is the total number of favorable (rewards) and unfavorable responses (penalties) obtained from the participating players for game action αⱼ, sⱼ(k) is the number of favorable responses (rewards) obtained from the participating players for game action αⱼ. It is noted that sᵢ(k) can be readily determined from the outcome values β¹-β³ corresponding to game actions αᵢ and sⱼ(k) can be readily determined from the outcome values β¹-β³ corresponding to game actions αⱼ.

As an example, consider Table 3, which sets forth exemplary participation, outcome results of ten players, and actions αᵢ to which the participating players have responded.

TABLE 3
Exemplary Outcome Results for
Ten Players in Unweighted MIMO Format

| | Action (αₗ) | |
|---|---|---|
| Player # | Responded To | Outcome (S or F) |
| 1 | α₁ | S |
| 2 | — | — |
| 3 | α₁ | F |
| 4 | α₁₅ | S |
| 5 | α₂ | S |
| 6 | — | — |
| 7 | α₂ | S |
| 8 | α₁₃ | F |
| 9 | α₁₅ | F |
| 10 | α₂ | F |

In this case, m=8, r₁(k)=2, s₁(k)=1, r₂(k)=3, s₂(k)=2, r₁₃(k)=1, s₁₃(k)=0, r₁₅(k)=2, s₁₅(k)=1, r_{3-12, 14, 16-17}(k)=0, and r_{3-12, 14, 16-17}(k)=0, and thus, equation [20] can be broken down to:

for actions α₁, α₂, α₁₃, α₁₅:

$${p}_{1} ( k + 1 ) = {p}_{1} ( k ) + \frac{1}{8} {\sum }_{{j = 1}_{j \neq i }}^{n} {g}_{j} ( p ( k ) ) - \frac{1}{8} {\sum }_{{j = 1}_{j \neq i }}^{n} {h}_{j} ( p ( k ) ) - \frac{3}{8} {g}_{1} ( p ( k ) ) + \frac{3}{8} {h}_{1} ( p ( k ) )$$

$${p}_{2} ( k + 1 ) = {p}_{2} ( k ) + \frac{2}{8} {\sum }_{{j = 1}_{j \neq i }}^{n} {g}_{j} ( p ( k ) ) - \frac{1}{8} {\sum }_{{j = 1}_{j \neq i }}^{n} {h}_{j} ( p ( k ) ) - \frac{2}{8} {g}_{2} ( p ( k ) ) + \frac{3}{8} {h}_{2} ( p ( k ) )$$

$${p}_{13} ( k + 1 ) = {p}_{13} ( k ) - \frac{1}{8} {\sum }_{{j = 1}_{j \neq i }}^{n} {h}_{j} ( p ( k ) ) - \frac{4}{8} {g}_{13} ( p ( k ) ) + \frac{3}{8} {h}_{13} ( p ( k ) )$$

$${p}_{15} ( k + 1 ) = {p}_{15} ( k ) + \frac{1}{8} {\sum }_{{j = 1}_{j \neq i }}^{n} {g}_{j} ( p ( k ) ) - \frac{1}{8} {\sum }_{{j = 1}_{j \neq i }}^{n} {h}_{j} ( p ( k ) ) - \frac{3}{8} {g}_{15} ( p ( k ) ) + \frac{3}{8} {h}_{15} ( p ( k ) )$$

$$for actions {α}_{3} - {α}_{12} , {α}_{14} , and {α}_{16} - {α}_{17} \text{:}$$

$${p}_{i} ( k + 1 ) = {p}_{i} ( k ) - \frac{4}{8} {g}_{i} ( p ( k ) ) + \frac{4}{8} {h}_{i} ( p ( k ) )$$

It should be noted that a single player may perform more than one player action λ2ₓ in a single probability distribution updating time period, and thus be counted as multiple participating players. Thus, if there are three players, more than three participating players may be considered in equation. Also, if the action probability distribution p is only updated periodically over several instances of a player action λ2ₓ, as previously discussed, multiple instances of a player actions λ2ₓ will be counted as multiple participating players. Thus, if three player actions λ2ₓ from a single player are accumulated over a period of time, these player actions λ2ₓ will be treated as if three players had each performed a single player action λ2ₓ.

In any event, the player action sets λ2¹-λ2³ are unweighted in equation [20], and thus each player affects the action probability distribution p equally. As with the game program 800, if it is desired that each player affects the action probability distribution p unequally, the player action sets λ2¹-λ2³ can be weighted. In this case, the game program 1200 may employ the following weighted P-type MIMO learning methodology:

$${p}_{i} ( k + 1 ) = {p}_{i} ( k ) + ( {\sum }_{q = 1}^{m} {w}_{q} {{I}_{S}}_{i}^{q} ) ( {\sum }_{{j = 1}_{j \neq i }}^{n} {g}_{j} ( p ( k ) ) ) - ( {\sum }_{q = 1}^{m} {w}_{q} {{I}_{F}}_{i}^{q} ) ( {\sum }_{{j = 1}_{j \neq i }}^{n} {h}_{j} ( p ( k ) ) ) - ( {\sum }_{q = 1}^{m} {\sum }_{{j = 1}_{j \neq i }}^{n} {w}_{q} {{I}_{S}}_{j}^{q} {g}_{i} ( p ( k ) ) ) + ( {\sum }_{q = 1}^{m} {\sum }_{{j = 1}_{j \neq i }}^{n} {w}_{q} {{I}_{F}}_{j}^{q} {h}_{i} ( p ( k ) ) ) \qquad [ 21 ]$$

where

pᵢ(k+1), pᵢ(k), gⱼ(p(k)), hⱼ(p(k)), i, j, k, and n have been previously defined, q is the ordered one of the participating players, m is the number of participating players, w^{q} is the normalized weight of the qth participating player, I_{Si}^{q} is a variable indicating the occurrence of a favorable response associated with the qth participating player and action αᵢ, and I_{Sj}^{q} is a variable indicating the occurrence of a favorable response associated with the qth participating player and action αⱼ, I_{Fi}^{q} is a variable indicating the occurrence of an unfavorable response associated with the qth participating player and action αᵢ, and I_{Fj}^{q} is a variable indicating the occurrence of an unfavorable response associated with the qth participating player and action αⱼ. It is noted that I_{S}^{q} and I_{F}^{q} can be readily determined from the outcome values β¹-β³.

TABLE 4
Exemplary Outcome Results for
Ten Players in Weighted MIMO Format

| | | | | Weighting | |
|---|---|---|---|---|---|
| | Weighting | | | Normalized | |
| | Normalized | Partici- | Action(αᵢ) | to | |
| Player | to All | pating | Responded | Participating | Outcome |
| # | Players | (q) | To | Players (w) | (S or F) |
| 1 | 0.05 | 1 | α₁ | 0.067 | S |
| 2 | 0.20 | — | — | — | — |
| 3 | 0.05 | 2 | α₁ | 0.067 | F |
| 4 | 0.10 | 3 | α₁₅ | 0.133 | S |
| 5 | 0.10 | 4 | α₂ | 0.133 | S |
| 6 | 0.05 | — | — | — | — |
| 7 | 0.20 | 5 | α₂ | 0.267 | S |
| 8 | 0.10 | 6 | α₁₃ | 0.133 | F |
| 9 | 0.10 | 7 | α₁₅ | 0.133 | F |
| 10 | 0.05 | 8 | α₂ | 0.067 | F |

In this case,

$${\sum }_{q = 1}^{m} {w}^{q} {{I}_{S}}_{1}^{q} = {w}^{1} {I}_{S1}^{1} = ( .067 ) ( 1 ) = 0.067 ;$$

$${\sum }_{q = 1}^{m} {w}^{q} {{I}_{S}}_{2}^{q} = {w}^{5} {I}_{S2}^{5} + {w}^{7} {I}_{S2}^{7} = ( .133 ) ( 1 ) + ( 0.267 ) ( 1 ) = 0.400 ;$$

$${\sum }_{q = 1}^{m} {w}^{q} {{I}_{S}}_{13}^{q} = 0 ;$$

$${\sum }_{q = 1}^{m} {w}^{q} {{I}_{S}}_{15}^{q} = {w}^{4} {I}_{S15}^{4} = ( .133 ) ( 1 ) = 0.133 ;$$

$${\sum }_{q = 1}^{m} {w}^{q} {{I}_{F}}_{1}^{q} = {w}^{3} {I}_{F1}^{3} = ( .067 ) ( 1 ) = 0.067 ;$$

$${\sum }_{q = 1}^{m} {w}^{q} {{I}_{F}}_{2}^{q} = {w}^{10} {I}_{F2}^{10} = ( .067 ) ( 1 ) = 0.067 ;$$

$${\sum }_{q = 1}^{m} {w}^{q} {{I}_{F}}_{13}^{q} = {w}^{8} {I}_{F13}^{8} = ( 0.133 ) ( 1 ) = 0.133$$

$${\sum }_{q = 1}^{m} {w}^{q} {{I}_{F}}_{15}^{q} = {w}^{9} {I}_{F15}^{9} = ( .133 ) ( 1 ) = 0.133 ;$$

and thus, equation [21] can be broken down to:

for actions α₁, α₂, α₁₃, α₁₅:

$${p}_{1} ( k + 1 ) = {p}_{1} ( k ) + 0.067 {\sum }_{{j = 1}_{j \neq i }}^{n} {g}_{j} ( p ( k ) ) - 0.067 {\sum }_{{j = 1}_{j \neq i }}^{n} {h}_{j} ( p ( k ) ) - 0.533 {g}_{1} ( p ( k ) ) + 0.333 {h}_{1} ( p ( k ) )$$

$${p}_{2} ( k + 1 ) = {p}_{2} ( k ) + 0.400 {\sum }_{{j = 1}_{j \neq i }}^{n} {g}_{j} ( p ( k ) ) - 0.067 {\sum }_{{j = 1}_{j \neq i }}^{n} {h}_{j} ( p ( k ) ) - 0.200 {g}_{2} ( p ( k ) ) + 0.333 {h}_{2} ( p ( k ) )$$

$${p}_{13} ( k + 1 ) = {p}_{13} ( k ) - 0.133 {\sum }_{{j = 1}_{j \neq i }}^{n} {h}_{j} ( p ( k ) ) - 0.600 {g}_{13} ( p ( k ) ) + 0.267 {h}_{13} ( p ( k ) )$$

$${p}_{15} ( k + 1 ) = {p}_{15} ( k ) + 0.133 {\sum }_{{j = 1}_{j \neq i }}^{n} {g}_{j} ( p ( k ) ) - 0.133 {\sum }_{{j = 1}_{j \neq i }}^{n} {h}_{j} ( p ( k ) ) - 0.467 {g}_{15} ( p ( k ) ) + 0.267 {h}_{15} ( p ( k ) )$$

for actions α₃-α₁₂, α₁₄, and α₁₆-α₁₇:

pᵢ(k+1)=pᵢ(k)−0.600gᵢ(p(k))+0.400hᵢ(p(k))

It should be noted that the number of players and game actions αᵢ may be dynamically altered in the game program 1200. For example, the game program 800 may eliminate weak players by learning the weakest moves of a player and reducing the game score for that player. Once a particular metric is satisfied, such as, e.g., the game score for the player reaches zero or the player loses five times in row, that player is eliminated. As another example, the game program 800 may learn each players' weakest and strongest moves, and then add a game action αᵢ for the corresponding duck if the player executes a weak move, and eliminate a game action αᵢ for the corresponding duck if the player executes a strong move. In effect, the number of variables within the learning automaton can be increased or decreased. For this we can employ the pruning/growing (expanding) learning algorithms.

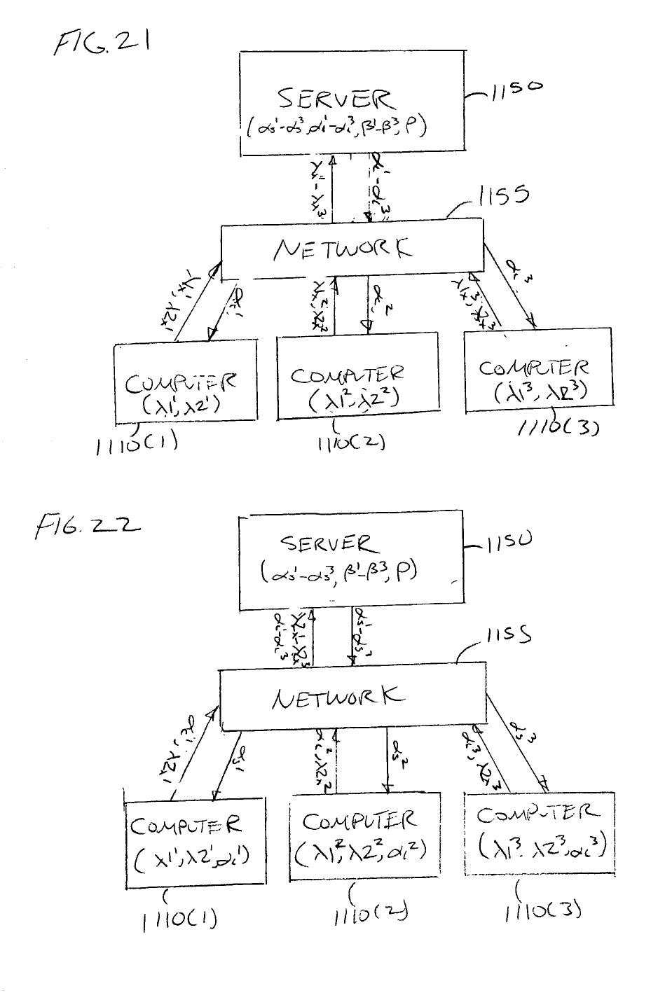

Having now described the structure of the game program 1200, the steps performed by the game program 1200 will be described with reference to FIG. 20. First, the probability update module 1220 initializes the action probability distribution p and current player actions λ2ₓ¹-λ2ₓ³ (step 1305) similarly to that described in step 405 of FIG. 9. Then, the action selection module 1225 determines whether any of the player actions λ2ₓ¹-λ2ₓ³ have been performed, and specifically whether the guns 1125(1)-(3) have been fired (step 1310). If any of the λ2ₓ¹, λ2ₓ², and λ2ₓ³ have been performed, the outcome evaluation module 1230 generates the corresponding outcome values β¹-β³, as represented by s(k), r(k) and m values (unweighted case) or I_{S}^{q} and I_{F}^{q} occurrences (weighted case), for the performed ones of the player actions λ2ₓ¹-λ2ₓ³ and corresponding game actions αᵢ¹-αᵢ³ (step 1315), and the intuition module 1215 then updates the corresponding player scores 1160(1)-(3) and duck scores 1165(1)-(3) based on the outcome values β¹-β³ (step 1320), similarly to that described in steps 415 and 420 of FIG. 9. The intuition module 1215 then determines if the given time period to which the player actions λ2ₓ¹-λ2ₓ³ are synchronized has expired (step 1321). If the time period has not expired, the game program 1200 will return to step 1310 where the action selection module 1225 determines again if any of the player actions λ2ₓ¹-λ2ₓ³ have been performed. If the time period has expired, the probability update module 1220 then, using the unweighted MIMO equation [20] or the weighted MIMO equation [21], updates the action probability distribution p based on the outcome values β¹-β³ (step 1325). Alternatively, rather than synchronize the asynchronous performance of the player actions λ2ₓ¹-λ2ₓ³ to the time period at step 1321, the probability update module 1220 can update the action probability distribution p after each of the asynchronous player actions λ2ₓ¹-λ2ₓ³ is performed using any of the techniques described with respect to the game program 300.

After step 1325, or if none of the player actions λ2ₓ¹-λ2ₓ³ has been performed at step 1310, the action selection module 1225 determines if any of the player actions λ1ₓ¹-λ1ₓ³ have been performed, i.e., guns 1125(1)-(3), have breached the gun detection regions 1170(1)-(3) (step 1330). If none of the guns 1125(1)-(3) have breached the gun detection regions 1170(1)-(3), the action selection module 1225 does not select any of the game actions αᵢ¹-αᵢ³ from the respective game action sets α¹-α³, and the ducks 1120(1)-(3) remain in the same location (step 1335). Alternatively, the game actions αᵢ¹-αᵢ³ may be randomly selected, respectively allowing the ducks 1120(1)-(3) to dynamically wander. The game program 1200 then returns to step 1310 where it is again determined if any of the player actions λ1ₓ¹-λ1ₓ³ have been performed. If any of the guns 1125(1)-(3) have breached the gun detection regions 1170(1)-(3) at step 1330, the intuition module 1215 modifies the functionality of the action selection module 1225, and the action selection module 1225 selects the game actions αᵢ¹-αᵢ³ from the game action sets α¹-α³ that correspond to the breaching guns 1125(1)-(3) based on the corresponding performance indexes φ¹-φ³ in the manner previously described with respect to steps 440-470 of FIG. 9 (step 1340).

It should be noted that, rather than use the action subset selection technique, other afore-described techniques used to dynamically and continuously match the skill level of the players 1115(1)-(3) with the skill level of the game 1100, such as that illustrated in FIG. 10, can be alternatively or optionally be used as well in the game.

Referring back to FIG. 18, it is noted that the network 1155 is used to transmit information between the user computers 1110(1)-(3) and the server 1150. The nature of this information will depend on how the various modules are distributed amongst the user computers 1110(1)-(3) and the server 1150. In the preferred embodiment, the intuition module 1215 and probability update module 1220 are located within the memory 1130 of the server 1150. Depending on the processing capability of the CPU 1135 of the server 1150 and the anticipated number of players, the action selection module 1225 and/or game evaluation module 1230 can be located within the memory 1130 of the server 1150 or within the computers 1110(1)-1110(3).

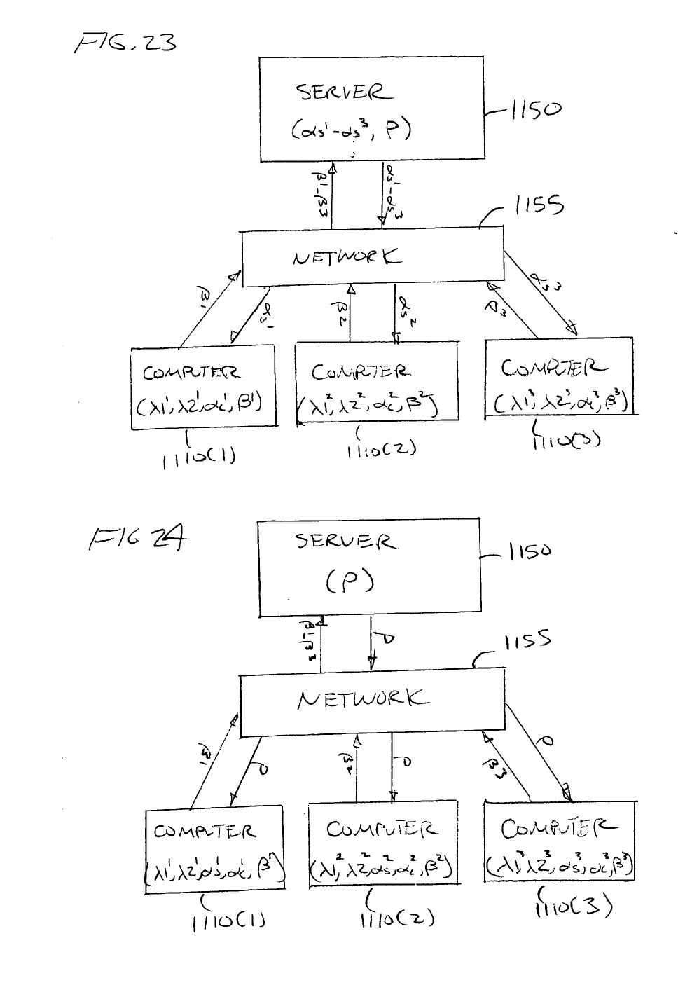

For example, if the CPU 1135 has a relatively quick processing capability and the anticipated number of players is low, all modules can be located within the server 1150. In this case, and with reference to FIG. 21, all processing, such as, e.g., selecting game actions αᵢ¹-αᵢ³, generating outcome values β¹-β³, and updating the action probability distribution p, will be performed in the server 1150. Over the network 1155, selected game actions αᵢ¹-αᵢ³ will be transmitted from the server 1150 to the respective user computers 1110(1)-(3), and performed player actions λ1ₓ¹-λ1ₓ³ and actions λ2ₓ¹-λ2ₓ³ will be transmitted from the respective user computers 1110(1)-(3) to the server 1150.

Referring now to FIG. 22, if it is desired to off-load some of the processing functions from the server 1150 to the computers 1110(1)-(3), the action selection modules 1225 can be stored in the computers 1110(1)-(3), in which case, game action subsets αₛ¹-αₛ³ can be selected by the server 1150 and then transmitted to the respective user computers 1110(1)-(3) over the network 1155. The game actions αᵢ¹-αᵢ³ can then be selected from the game action subsets αₛ¹-αₛ³ by the respective computers 1110(1)-(3) and transmitted to the server 1150 over the network 1155. In this case, performed player actions λ1ₓ¹-λ1ₓ³ need not be transmitted from the user computers 1110(1)-(3) to the server 1150 over the network 1155, since the game actions αᵢ¹-αᵢ³ are selected within the user computers 1110(1)-(3).

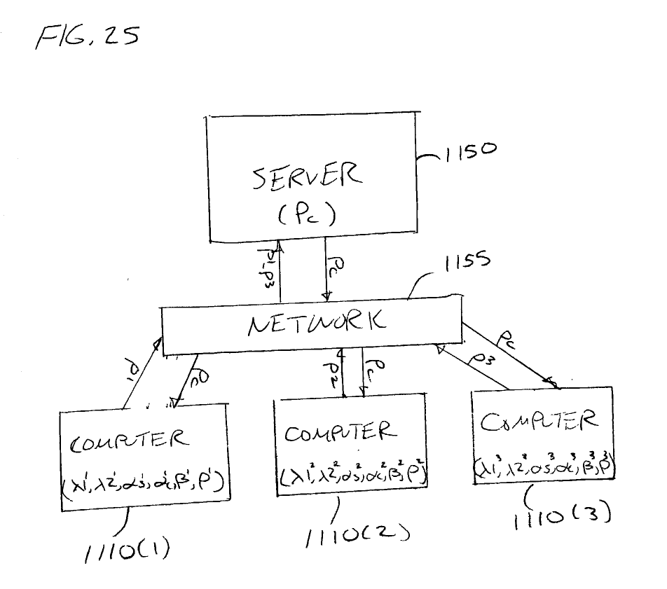

Referring to FIG. 23, alternatively or in addition to action selection modules 1225, outcome evaluation modules 1230 can be stored in the user computers 1110(1)-(3), in which case, outcome values β¹-β³ can be generated in the respective user computers 1110(1)-(3) and then be transmitted to the server 1150 over the network 1155. It is noted that in this case, performed player actions λ2ₓ¹-λ2ₓ³ need not be transmitted from the user computers 1110(1)-(3) to the server 1150 over the network 1155.

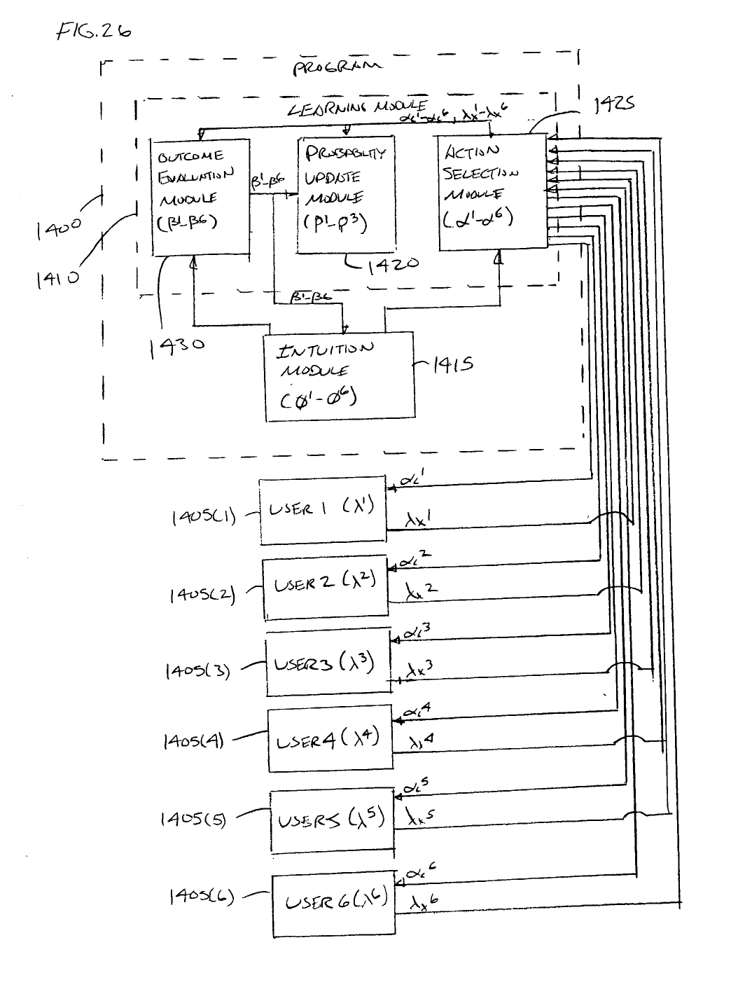

Referring now to FIG. 24, if it is desired to off-load even more processing functions from the server 1150 to the computers 1110(1)-(3), portions of the intuition module 1215 may be stored in the respective computers 1110(1)-(3). In this case, the probability distribution p can be transmitted from the server 1150 to the respective computers 1110(1)-(3) over the network 1155. The respective computers 1110(1)-(3) can then select game action subsets αₛ¹-αₛ³, and select game actions αᵢ¹-αᵢ³ from the selected game action subsets αₛ¹-αₛ³. If the outcome evaluation module 1230 is stored in the server 1150, the respective computers 1110(1)-(3) will then transmit the selected game actions αᵢ¹-αᵢ³ to the server 1150 over the network 1155. If outcome evaluation modules 1230 are stored in the respective user computers 1110(1)-(3), however, the computers 1110(1)-(3) will instead transmit outcome values β¹-β³ to the server 1150 over the network 1155.

To even further reduce the processing needs for the server 1150, information is not exchanged over the network 1155 in response to each performance of player actions λ2ₓ¹-λ2ₓ³, but rather only after a number of player actions λ2ₓ¹-λ2ₓ³ has been performed. For example, if all processing is performed in the server 1150, the performed player actions λ2ₓ¹-λ2ₓ³ can be accumulated in the respective user computers 1110(1)-(3) and then transmitted to the server 1150 over the network 1155 only after several player actions λ2ₓ¹-λ2ₓ³ have been performed. If the action selection modules 1225 are located in the respective user computers 1110(1)-(3), both performed player actions λ2ₓ¹-λ2ₓ³ and selected game actions αᵢ¹-αᵢ³ can be accumulated in the user computers 1110(1)-(3) and then transmitted to the server 1150 over the network 1155. If the outcome evaluation modules 1230 are located in respective user computers 1110(1)-(3), outcome values β¹-β³ can be accumulated in the user computers 1110(1)-(3) and then transmitted to the server 1150 over the network 1155. In all of these cases, the server 1150 need only update the action probability distribution p periodically, thereby reducing the processing of the server 1150.

Like the previously described probability update module 820, the probability update module 1220 may alternatively update the action probability distribution p as each player participates by employing SISO equations [4] and [5]. In the scenario, the SISO equations [4] and [5] will typically be implemented in a single device that serves the players 1115(1)-(3), such as the server 1150. Alternatively, to reduce the processing requirements in the server 1150, the SISO equations [4] and [5] can be implemented in devices that are controlled by the players 1115(1)-(3), such as the user computers 1110(1)-(3).

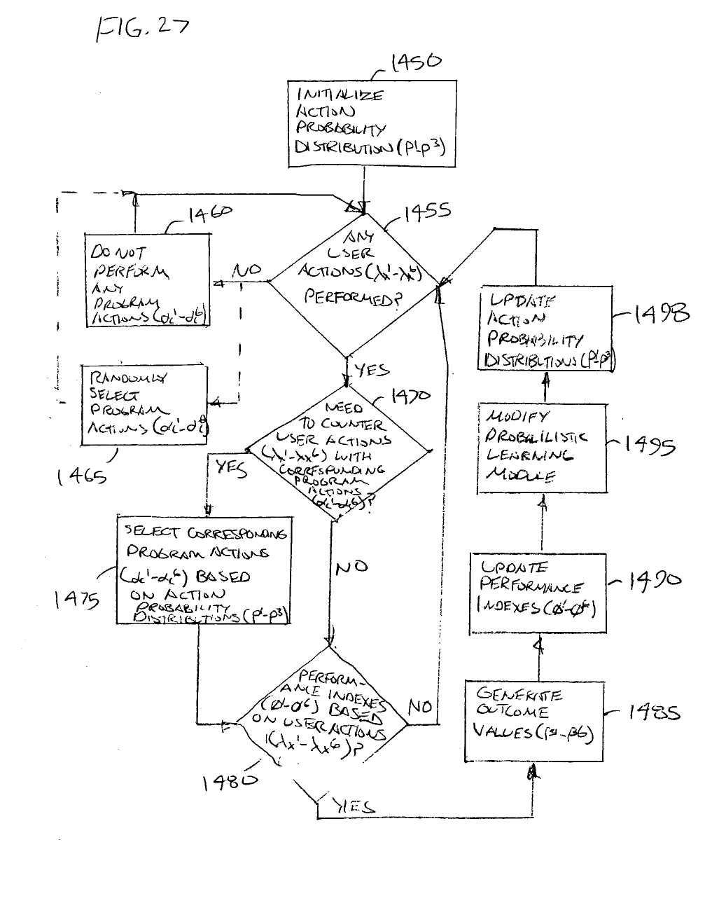

In this case, and with reference to FIG. 25, separate probability distribution p¹-p³ are generated and updated in the respective user computers 1110(1)-(3) using SISO equations. Thus, all of the basic functionality, such as performing player actions λ1ₓ¹-λ1ₓ³ and λ2ₓ¹-λ2ₓ³, subdividing and selecting action subsets αₛ¹-αₛ³ and αᵢ¹-αᵢ³, and updating the action probability distributions p¹-p³, are performed in the user computers 1110(1)-(3). For each of the user computers 1110(1)-(3), this process can be the same as those described above with respect to FIGS. 9 and 10. The server 1150 is used to maintain some commonality amongst different action probability distributions p¹-p³ being updated in the respective user computers 1110(1)-(3). This may be useful, e.g., if the players 1115(1)-(3) are competing against each other and do not wish to be entirely handicapped by exhibiting a relatively high level of skill. Thus, after several iterative updates, the respective user computers 1110(1)-(3) can periodically transmit their updated probability distributions p¹-p³ to the server 1150 over the network 1155. The server 1150 can then update a centralized probability distribution p_{c} based on the recently received probability distributions p¹-p³, and preferably a weighted average of the probability distributions p¹-p³. The weights of the action probability distributions p¹-p³ may depend on, e.g., the number of times the respective action probability distributions p¹-p³ have been updated at the user computers 1110(1)-(3).

Thus, as the number of player actions λ2ₓ performed at a particular user computer 1110 increases relative to other user computers 1110, the effect that the iteratively updated action probability distribution p transmitted from this user computer 1110 to the server 1150 has on central action probability distribution p_{c} will correspondingly increase. Upon generating the centralized probability distribution p_{c}, the server 1150 can then transmit it to the respective user computers 1110(1)-(3). The user computers 1110(1)-(3) can then use the centralized probability distribution p_{c} as their initial action probability distributions p¹-p³, which are then iteratively updated. This process will then repeated.

Generalized Multi-User Learning Program With Multiple Learning Modules

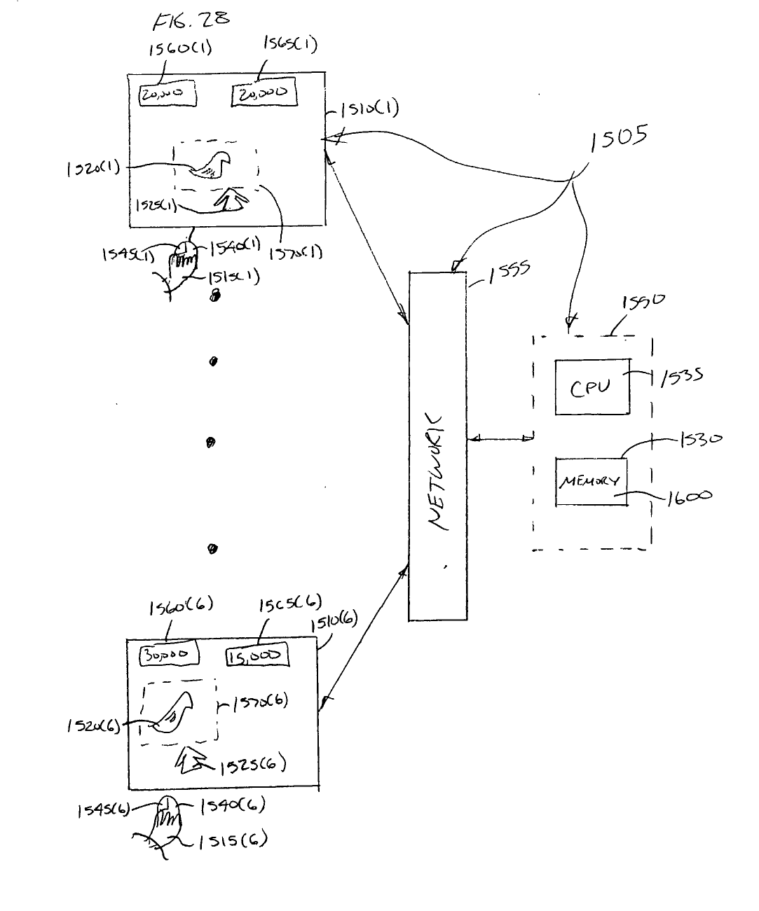

Referring to FIG. 26, another multi-user learning program 1400 developed in accordance with the present inventions can be generally implemented to provide intuitive learning capability to any variety of processing devices. Multiple sets of users 1405(1)-(2), 1405(3)-(4), and 1405(5)-(6) (here three sets of two users each) interact with the program 1400 by respectively receiving program actions αᵢ¹-αᵢ⁶ from respective program action sets α¹-α⁶ within the program 1400, selecting user actions λₓ¹-λₓ⁶ from the respective user action sets λ¹-λ⁶ based on the received program actions αᵢ¹-αᵢ⁶, and transmitting the selected user actions λₓ¹-λₓ⁶ to the program 1400. Again, in alternative embodiments, the users 1405 need not receive the program actions αᵢ¹-αᵢ⁶, the selected user actions λₓ¹-λₓ⁶ need not be based on the received program actions αᵢ¹-αᵢ⁶, and/or the program actions αᵢ¹-αᵢ⁶ may be selected in response to the selected user actions λₓ¹-λₓ⁶. The significance is that program actions αᵢ¹-αᵢ⁶ and user actions λₓ¹-λₓ⁶ are selected.

The program 1400 is capable of learning based on the measured success or failure of the selected program actions αᵢ¹-αᵢ⁶ based on selected user actions λₓ¹-λₓ⁶, which, for the purposes of this specification, can be measured as outcome values β¹-β⁶. As will be described in further detail below, program 1400 directs its learning capability by dynamically modifying the model that it uses to learn based on performance indexes φ¹-φ⁶ to achieve one or more objectives.

To this end, the program 1400 generally includes a probabilistic learning module 1410 and an intuition module 1415. The probabilistic learning module 1410 includes a probability update module 1420, an action selection module 1425, and an outcome evaluation module 1430. The program 1400 differs from the program 1000 in that the probability update module 1420 is configured to generate and update multiple action probability distributions p¹-p³ (as opposed to a single probability distribution p) based on respective outcome values β¹-β², β³-β⁴, and β⁵-β⁶. In this scenario, the probability update module 1420 uses multiple stochastic learning automatons, each with multiple inputs to a multi-teacher environment (with the users 1405(1)-(6) as the teachers), and thus, a MIMO model is assumed for each learning automaton. Thus, users 1405(1)-(2), users 1405(3)-(4), and users 1405(5)-(6) are respectively associated with action probability distributions p¹-p³, and therefore, the program 1400 can independently learn for each of the sets of users 1405(1)-(2), users 1405(3)-(4), and users 1405(5)-(6). It is noted that although the program 1400 is illustrated and described as having a multiple users and multiple inputs for each learning automaton, multiple users with single inputs to the users can be associated with each learning automaton, in which case a SIMO model is assumed for each learning automaton, or a single user with a single input to the user can be associated with each learning automaton, in which case a SISO model can be associated for each learning automaton.

The action selection module 1425 is configured to select the program actions αᵢ¹-αᵢ², αᵢ³-αᵢ⁴, and αᵢ⁵-αᵢ⁶ from respective action sets α¹-α², α³-α⁴, a α⁵-α⁶ based on the probability values contained within the respective action probability distributions p¹-p³ internally generated and updated in the probability update module 1420. The outcome evaluation module 1430 is configured to determine and generate the outcome values β¹-β⁶ based on the respective relationship between the selected program actions αᵢ¹-αᵢ⁶ and user actions λₓ¹-λₓ⁶. The intuition module 1415 modifies the probabilistic learning module 1410 (e.g., selecting or modifying parameters of algorithms used in learning module 1410) based on the generated performance indexes φ¹-φ⁶ to achieve one or more objectives. As previously described, the performance indexes φ¹-φ⁶ can be generated directly from the outcome values β¹-β⁶ or from something dependent on the outcome values β¹-β⁶, e.g., the action probability distributions p¹-p³, in which case the performance indexes φ¹-φ², φ³-φ⁴, and φ⁵-φ⁶ maybe a function of the action probability distributions p¹-p³, or the action probability distributions p¹-p³ may be used as the performance indexes φ¹-φ², φ³-φ⁴, and φ⁵-φ⁶.

The modification of the probabilistic learning module 1410 is generally accomplished similarly to that described with respect to the afore-described probabilistic learning module 110. That is, the functionalities of (1) the probability update module 1420 (e.g., by selecting from a plurality of algorithms used by the probability update module 1420, modifying one or more parameters within an algorithm used by the probability update module 1420, transforming or otherwise modifying the action probability distributions p¹-p³); (2) the action selection module 1425 (e.g., limiting or expanding selection of the program actions αᵢ¹-αᵢ², αᵢ³-αᵢ⁴, and αᵢ⁵-αᵢ⁶ corresponding to subsets of probability values contained within the action probability distributions p¹-p³); and/or (3) the outcome evaluation module 1430 (e.g., modifying the nature of the outcome values β¹-β⁶ or otherwise the algorithms used to determine the outcome values β¹-β⁶), are modified.

The various different types of learning methodologies previously described herein can be applied to the probabilistic learning module 1410. The steps performed by the program 1400 are similar to that described with respect to FIG. 17, with the exception that the game program 1400 will independently perform the steps of the flow diagram for each of the sets of users 1405(1)-(2), 1405(3)-(4), and 1405(5)-(6). For example, the program 1400 will execute one pass through the flow for users 1405(1)-(2) (and thus the first probability distribution p¹), then one pass through the flow for users 1405(3)-(4) (and thus the first probability distribution p2), and then one pass through the flow for users 1405(5)-(6) (and thus the first probability distribution p³).

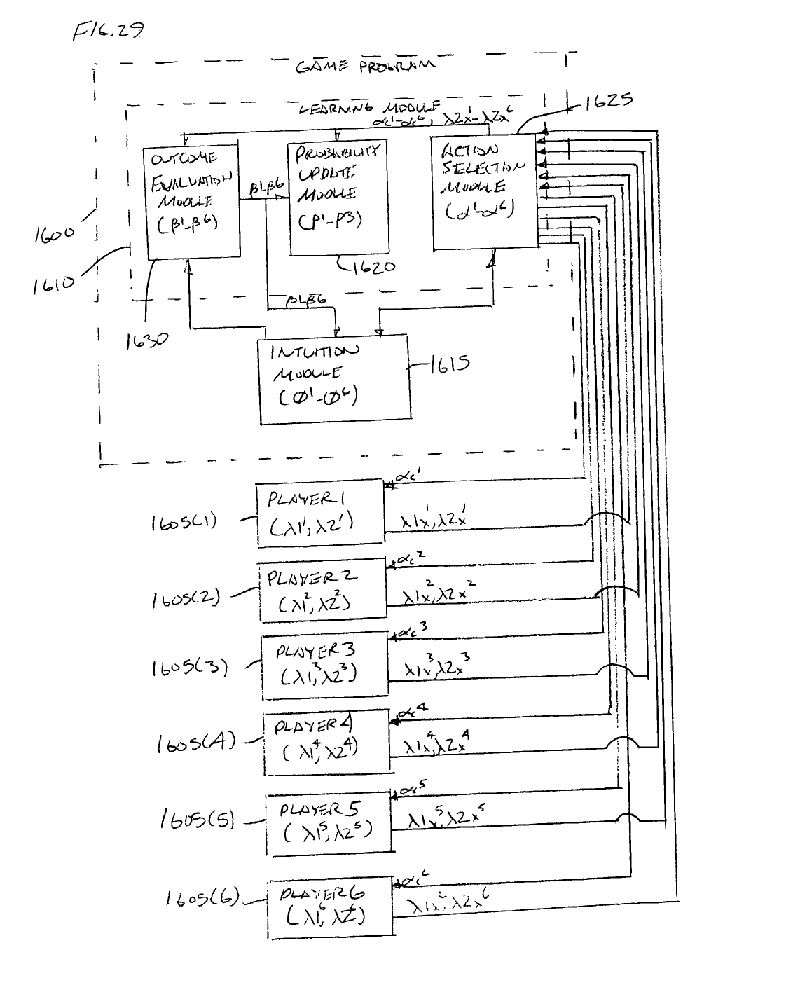

Alternatively, the program 1400 can combine the steps of the flow diagram for the users 1405(1)-(6). For example, referring to FIG. 27, the probability update module 1420 initializes the action probability distributions p¹-p³ (step 1450) similarly to that described with respect to step 150 of FIG. 4. The action selection module 1425 then determines if one or more of the user actions λₓ¹-λₓ⁶ have been selected from the respective user action sets λ¹-λ⁶ (step 1455). If not, the program 1400 does not select the program actions αᵢ¹-αᵢ⁶ from the program action sets α¹-α⁶ (step 1460), or alternatively selects program actions αᵢ¹-αᵢ⁶, e.g., randomly, notwithstanding that none of the user actions λₓ¹-λₓ⁶ have been selected (step 1465), and then returns to step 1455 where it again determines if one or more of the user actions λₓ¹-λₓ⁶ have been selected. If one or more of the user actions λₓ¹-λₓ⁶ have been selected at step 1455, the action selection module 1425 determines the nature of the selected ones of the user actions λₓ¹-λₓ⁶.

Specifically, the action selection module 1425 determines whether any of the selected ones of the user actions λₓ¹-λₓ⁶ are of the type that should be countered with the corresponding ones of the program actions αᵢ¹-αᵢ⁶ (step 1470). If so, the action selection module 1425 selects program actions αᵢ from the corresponding program action sets α¹-α², α³-α⁴, and α⁵-α⁶ based on the corresponding one of the action probability distributions p¹-p³ (step 1475). Thus, if either of the user actions λₓ¹ and λₓ² is selected and is of the type that should be countered with a program action αᵢ, program actions αᵢ¹ and αᵢ² will be selected from the corresponding program action sets α¹ and α² based on the probability distribution p¹. If either of the user actions λₓ³ and λₓ⁴ is selected and is of the type that should be countered with a program action αᵢ, program actions αᵢ³ and αᵢ⁴ will be selected from the corresponding program action sets α³ and α⁴ based on the probability distribution p². If either of the user actions λₓ⁵ and λₓ⁶ is selected and is of the type that should be countered with a program action αᵢ, program actions αᵢ⁵ and αᵢ⁶ will be selected from the corresponding program action sets α⁵ and α⁶ based on the probability distribution p³. After the performance of step 1475 or if the action selection module 1425 determines that none of the selected ones of the user actions λₓ¹-λₓ⁶ is of the type that should be countered with a program action αᵢ, the action selection module 1425 determines if any of the selected ones of the user actions λₓ¹-λₓ⁶ are of the type that the performance indexes φ¹-φ⁶ are based on (step 1480).

If not, the program 1400 returns to step 1455 to determine again whether any of the user actions λₓ¹-λₓ⁶ have been selected. If so, the outcome evaluation module 1430 quantifies the performance of the previously corresponding selected program actions αᵢ¹-αᵢ⁶ relative to the selected ones of the current user actions λₓ¹-λₓ⁶, respectively, by generating outcome values β¹-β⁶ (step 1485). The intuition module 1415 then updates the performance indexes φ¹-φ⁶ based on the outcome values β¹-β⁶, unless the performance indexes φ¹-φ⁶ are instantaneous performance indexes that are represented by the outcome values β¹-β⁶ themselves (step 1490), and modifies the probabilistic learning module 1410 by modifying the functionalities of the probability update module 1420, action selection module 1425, or outcome evaluation module 1430 (step 1495). The probability update module 1420 then, using any of the updating techniques described herein, updates the respective action probability distributions p¹-p³based on the generated outcome values β¹-β², β³-β⁴, and β⁵-β⁶ (step 1498).

The program 1400 then returns to step 1455 to determine again whether any of the user actions λₓ¹-λₓ⁶ have been selected. It should also be noted that the order of the steps described in FIG. 27 may vary depending on the specific application of the program 1400.

Multi-Player Learning Game Program With Multiple Learning Modules

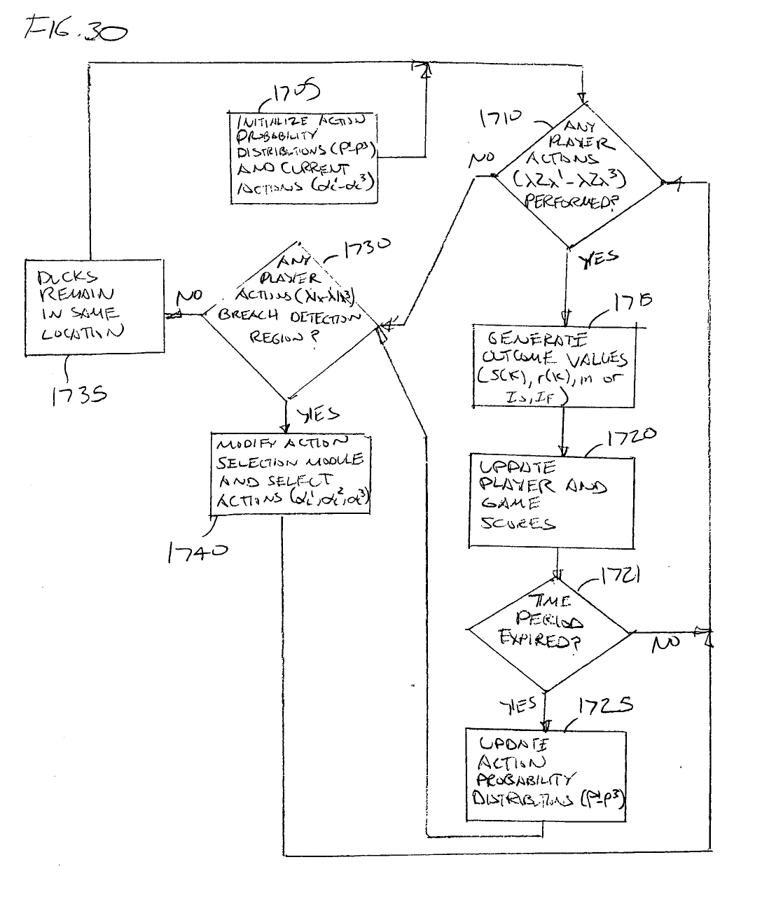

Having now generally described the components and functionality of the learning program 1400, we now describe one of its various applications. Referring to FIG. 28, a multiple-player learning software game program 1600 developed in accordance with the present inventions is described in the context of a duck hunting game 1500. The game 1500 is similar to the previously described game 1100 with the exception that three sets of players (players 1515(1)-(2), 1515(3)-(4), and 1515(5)-(6)) are shown interacting with a computer system 1505, which like the computer system 1105, can be used in an Internet-type scenario. Thus, the computer system 1505 includes multiple computers 1510(1)-(6), which display computer animated ducks 1520(1)-(6) and guns 1525(1)-(6). The computer system 1505 further comprises a server 1550, which includes memory 1530 for storing the game program 1600, and a CPU 1535 for executing the game program 1600. The server 1550 and computers 1510(1)-(6) remotely communicate with each other over a network 1555, such as the Internet. The computer system 1505 further includes computer mice 1540(1)-(6) with respective mouse buttons 1545(1)-(6), which can be respectively manipulated by the players 1515(1)-(6) to control the operation of the guns 1525(1)-(6). The ducks 1520(1)-(6) are surrounded by respective gun detection regions 1570(1)-(6). The game 1500 maintains respective scores 1560(1)-(6) for the players 1515(1)-(6) and respective scores 1565(1)-(6) for the ducks 1520(1)-(6).

As will be described in further detail below, the players 1515(1)-(6) are divided into three sets based on their skill levels (e.g., novice, average, and expert). The game 1500 treats the different sets of players 1515(1)-(6) differently in that it is capable of playing at different skill levels to match the respective skill levels of the players 1515(1)-(6). For example, if players 1515(1)-(2) exhibit novice skill levels, the game 1500 will naturally play at a novice skill level for players 1515(1)-(2). If players 1515(3)-(4) exhibit average skill levels, the game 1500 will naturally play at an average skill level for players 1515(3)-(4). If players 1515(5)-(6) exhibit expert skill levels, the game 1500 will naturally play at an expert skill level for players 1515(5)-(6). The skill level of each of the players 1515(1)-(6) can be communicated to the game 1500 by, e.g., having each player manually input his or her skill level prior to initiating play with the game 1500, and placing the player into the appropriate player set based on the manual input, or sensing each player's skill level during game play and dynamically placing that player into the appropriate player set based on the sensed skill level. In this manner, the game 1500 is better able to customize itself to each player, thereby sustaining the interest of the players 1515(1)-(6) notwithstanding the disparity of skill levels amongst them.

Referring further to FIG. 29, the game program 1600 generally includes a probabilistic learning module 1610 and an intuition module 1615, which are specifically tailored for the game 1500. The probabilistic learning module 1610 comprises a probability update module 1620, an action selection module 1625, and an outcome evaluation module 1630. The probabilistic learning module 1610 and intuition module 1615 are configured in a manner similar to the learning module 1210 and intuition module 1215 of the game program 1200.

To this end, the action selection module 1625 is configured to receive player actions λ1ₓ¹-λ1ₓ⁶ from the players 1515(1)-(6), which take the form of mouse 1540(1)-(6) positions, i.e., the positions of the guns 1525(1)-(6) at any given time. Based on this, the action selection module 1625 detects whether any one of the guns 1525(1)-(6) is within the detection regions 1570(1)-(6), and if so, selects game actions αᵢ¹-αᵢ⁶ from the respective game action sets α¹-α⁶ and specifically, one of the seventeen moves that the ducks 1520(1)-(6) will make. The action selection module 1625 respectively selects the game actions αᵢ¹-αᵢ², αᵢ³-αᵢ⁴, and αᵢ⁵-αᵢ⁶ based on action probability distributions p¹-p³ received from the probability update module 1620. Like the intuition module 1215, the intuition module 1615 modifies the functionality of the action selection module 1625 by subdividing the game action set α¹-α⁶ into pluralities of action subsets αₛ¹-αₛ⁶ and selecting one of each of the pluralities of action subsets as αₛ¹-αₛ⁶ based on the respective score difference values Δ¹-Δ⁶. The action selection module 1625 is configured to pseudo-randomly select game actions αᵢ¹-αᵢ⁶ from the selected ones of the action subsets αₛ¹-αₛ⁶.

The action selection module 1625 is further configured to receive player actions λ2ₓ¹-λ2ₓ⁶ from the players 1515(1)-(6) in the form of mouse button 1545(1)-(6) click/mouse 1540(1)-(6) position combinations, which indicate the positions of the guns 1525(1)-(6) when they are fired. The outcome evaluation module 1630 is further configured to determine and output outcome values β¹-β⁶ that indicate how favorable the selected game actions αᵢ¹-αᵢ⁶ in comparison with the received player actions λ2ₓ¹-λ2ₓ⁶, respectively.

The probability update module 1620 is configured to receive the outcome values β¹-β⁶ from the outcome evaluation module 1630 and output an updated game strategy (represented by action probability distributions p¹-p³) that the ducks 1520(1)-(6) will use to counteract the players' 1515(1)-(6) strategy in the future. Like the action probability distribution p updated by the probability update module 1220, updating of the action probability distributions p¹-p³ is synchronized to a time period. As previously described with respect to the game 1100, the functions of the learning module 1510 can be entirely centralized within the server 1550 or portions thereof can be distributed amongst the user computers 1510(1)-(6). When updating each of the action probability distributions p¹-p³, the game program 1600 may employ, e.g., the unweighted P-type MIMO learning methodology defined by equation [20] or the weighted P-type MIMO learning methodology defined by equation [21].

The steps performed by the game program 1600 are similar to that described with respect to FIG. 20, with the exception that the game program 1600 will independently perform the steps of the flow diagram for each of the sets of game players 1515(1)-(2), 1515(3)-(4), and 1515(5)-(6). For example, the game program 1600 will execute one pass through the flow for game players 1515(1)-(2) (and thus the first probability distribution p¹), then one pass through the flow for game players 1515(3)-(4) (and thus the second probability distribution p²), and then one pass through the flow for game players 1515(5)-(6) (and thus the third probability distribution p³).

Alternatively, the game program 1600 can combine the steps of the flow diagram for the game players 1515(1)-(6). For example, referring to FIG. 30, the probability update module 1620 will first initialize the action probability distributions p¹-p² and current player actions λ2ₓ¹-λ2ₓ⁶ (step 1705) similarly to that described in step 405 of FIG. 9. Then, the action selection module 1625 determines whether any of the player actions λ2ₓ¹-λ2ₓ⁶ have been performed, and specifically whether the guns 1525(1)-(6) have been fired (step 1710). If any of player actions λ2ₓ¹-λ2ₓ⁶ have been performed, the outcome evaluation module 1630 generates the corresponding outcome values β¹-β⁶ for the performed ones of the player actions λ2ₓ¹-λ2ₓ⁶ and corresponding game actions αᵢ¹-αᵢ⁶ (step 1715). For each set of player actions λ2ₓ¹-λ2ₓ², λ2ₓ³-λ2ₓ⁴, and λ2ₓ⁵-λ2ₓ⁶, the corresponding outcome values β¹-β², β³-β⁴, and β⁵-β⁶ can be represented by different sets of s(k), r(k) and m values (unweighted case) or I_{S}^{q} and I_{F}^{q} occurrences (weighted case). The intuition module 1615 then updates the corresponding player scores 1560(1)-(6) and duck scores 1565(1)-(6) based on the outcome values β¹-β⁶ (step 1720), similarly to that described in steps 415 and 420 of FIG. 9. The intuition module 1615 then determines if the given time period to which the player actions λ2ₓ¹-λ2ₓ⁶ are synchronized has expired (step 1721). If the time period has not expired, the game program 1600 will return to step 1710 where the action selection module 1625 determines again if any of the player actions λ2ₓ¹-λ2ₓ⁶ have been performed. If the time period has expired, the probability update module 1620 then, using the unweighted MIMO equation [20] or the weighted MIMO equation [21], updates the action probability distributions p¹-p³ based on the respective outcome values β¹-β², β³-β⁴, and β⁵-β⁶ (step 1725). Alternatively, rather than synchronize the asynchronous performance of the player actions λ2ₓ¹-λ2ₓ⁶ to the time period at step 1721, the probability update module 1620 can update the pertinent one of the action probability distribution p¹-p³ after each of the asynchronous player actions λ2ₓ¹-λ2ₓ⁶ is performed using any of the techniques described with respect to the game program 300.

After step 1725, or if none of the player actions λ2ₓ¹-λ2ₓ⁶ has been performed at step 1710, the action selection module 1625 determines if any of the player actions λ1ₓ¹-λ1ₓ⁶ have been performed, i.e., guns 1525(1)-(6), have breached the gun detection regions 1570(1)-(6) (step 1730). If none of the guns 1525(1)-(6) have breached the gun detection regions 1570(1)-(6), the action selection module 1625 does not select any of the game actions αᵢ¹-αᵢ⁶ from the respective game action sets α¹-α⁶, and the ducks 1520(1)-(6) remain in the same location (step 1735). Alternatively, the game actions αᵢ¹-αᵢ⁶ may be randomly selected, respectively allowing the ducks 1520(1)-(6) to dynamically wander. The game program 1600 then returns to step 1710 where it is again determined if any of the player actions λ1ₓ¹-λ1ₓ⁶ have been performed. If any of the guns 1525(1)-(6) have breached the gun detection regions 1570(1)-(6) at step 1730, the intuition module 1615 modifies the functionality of the action selection module 1625, and the action selection module 1625 selects the game actions αᵢ¹-αᵢ², αᵢ³-αᵢ⁴, and αᵢ⁵-αᵢ⁶ from the game action sets α¹-α², α³-α⁴, and α⁵-α⁶ that correspond to the breaching guns 1525(1)-(2), 1525(3)-(4), and 1525(5)-(6) based on the corresponding performance indexes φ¹-φ³ in the manner previously described with respect to steps 440-470 of FIG. 9 (step 1740).

It should be noted that, rather than use the action subset selection technique, other afore-described techniques used to dynamically and continuously match the skill level of the players 1515(1)-(6) with the skill level of the game 1500, such as that illustrated in FIG. 10, can be alternatively or optionally be used as well in the game. It should also be noted that, as described with respect to FIGS. 21-25, the various modules can be distributed amongst the user computers 1410(1)-(3) and the server 1550 in a manner that optimally distributes the processing power.

Generalized Multi-User Learning Program (Single Processor Action-Maximum Probability of Majority Approval)

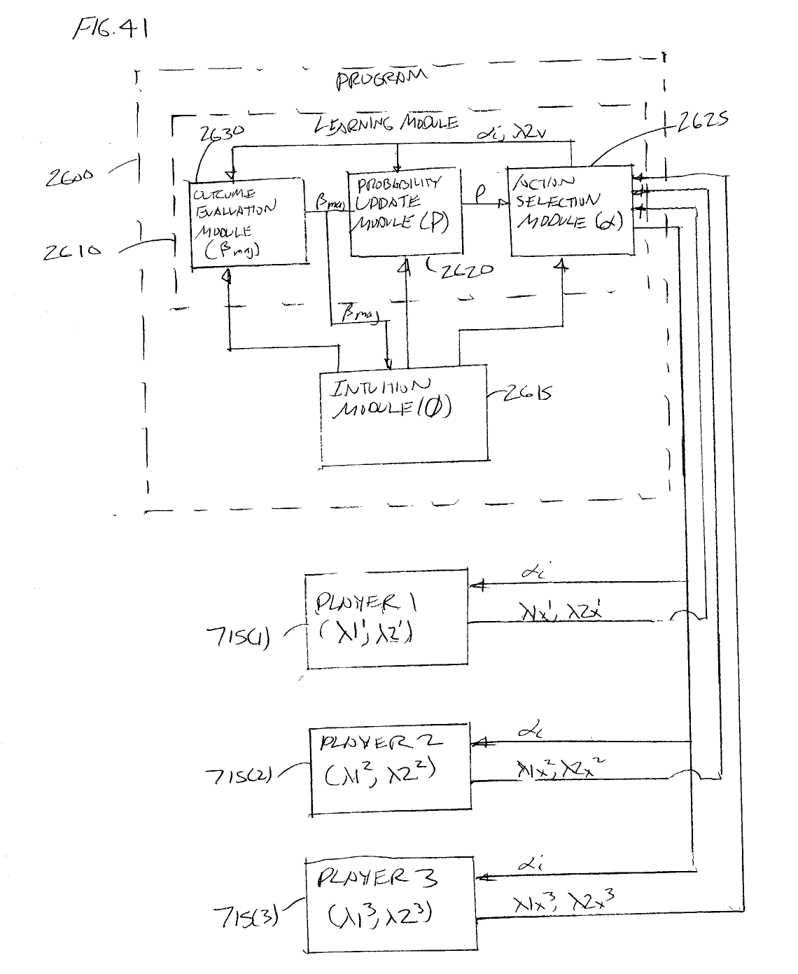

Referring to FIG. 39, still another multi-user learning program 2500 developed in accordance with the present inventions can be generally implemented to provide intuitive learning capability to any variety of processing devices. In the previous multiple user action embodiments, each user action incrementally affected the relevant action probability distribution. The learning program 2500 is similar to the SIMO-based program 600 in that multiple users 2505(1)-(3) (here, three) interact with the program 2500 by receiving the same program action αᵢ from a program action set α within the program 2500, and each independently select corresponding user actions λₓ¹-λₓ³ from respective user action sets λ¹-λ³ based on the received program action αᵢ. Again, in alternative embodiments, the users 2505 need not receive the program action αᵢ, the selected user actions λₓ¹-λₓ³ need not be based on the received program action αᵢ, and/or the program actions αᵢ may be selected in response to the selected user actions λₓ¹-λₓ³. The significance is that a program action αᵢ and user actions λₓ¹-λₓ³ are selected.

The program 2500 is capable of learning based on the measured success ratio (e.g., minority, majority, super majority, unanimity) of the selected program action αᵢ relative to the selected user actions λₓ¹-λₓ³, as compared to a reference success ratio, which for the purposes of this specification, can be measured as a single outcome value βₘₐⱼ In essence, the selected user actions λₓ¹-λₓ³ are treated as a selected action vector λᵥ. For example, if the reference success ratio for the selected program action αᵢ is a majority, βₘₐⱼ may equal “1” (indicating a success) if the selected program action αᵢ is successful relative to two or more of the three selected user actions λₓ¹-λₓ³, and may equal “0” (indicating a failure) if the selected program action αᵢ is successful relative to one or none of the three selected user actions λₓ¹-λₓ³. It should be noted that the methodology contemplated by the program 2500 can be applied to a single user that selects multiple user actions to the extent that the multiple actions can be represented as an action vector λᵥ, in which case, the determination of the outcome value βₘₐⱼ can be performed in the same manner. As will be described in further detail below, the program 2500 directs its learning capability by dynamically modifying the model that it uses to learn based on a performance index φ to achieve one or more objectives.

To this end, the program 2500 generally includes a probabilistic learning module 2510 and an intuition module 2515. The probabilistic learning module 2510 includes a probability update module 2520, an action selection module 2525, and an outcome evaluation module 2530. Briefly, the probability update module 2520 uses learning automata theory as its learning mechanism, and is configured to generate and update an action probability distribution p based on the outcome value βₘₐⱼ. In this scenario, the probability update module 2520 uses a single stochastic learning automaton with a single input to a single-teacher environment (with the users 2505(1)-(3), in combination, as a single teacher), or alternatively, a single stochastic learning automaton with a single input to a single-teacher environment with multiple outputs that are treated as a single output), and thus, a SISO model is assumed. The significance is that multiple outputs, which are generated by multiple users or a single user, are quantified by a single outcome value βₘₐⱼ. Alternatively, if the users 2505(1)-(3) receive multiple program actions α₁, some of which are different, multiple SISO models can be assumed. For example if three users receive program action α₁, and two users receive program action α₂, the action probability distribution p can be sequentially updated based on the program action α₁, and then updated based on the program action α₂, or updated in parallel, or in combination thereof. Exemplary equations that can be used for the SISO model will be described in further detail below.

The action selection module 2525 is configured to select the program action αᵢ from the program action set α based on the probability values pᵢ contained within the action probability distribution p internally generated and updated in the probability update module 2520. The outcome evaluation module 2530 is configured to determine and generate the outcome value βₘₐⱼ based on the relationship between the selected program action αᵢ and the user action vector λᵥ. The intuition module 2515 modifies the probabilistic learning module 2510 (e.g., selecting or modifying parameters of algorithms used in learning module 2510) based on one or more generated performance indexes φ to achieve one or more objectives. As previously discussed with respect to the outcome value β, the performance index φ can be generated directly from the outcome value βₘₐⱼ or from something dependent on the outcome value βₘₐⱼ, e.g., the action probability distribution p, in which case the performance index φ may be a function of the action probability distribution p, or the action probability distribution p may be used as the performance index φ. Alternatively, the intuition module 2515 may be non-existent, or may desire not to modify the probability learning module 2510 depending on the objective of the program 2500.

The modification of the probabilistic learning module 2510 is generally accomplished similarly to that described with respect to the afore-described probabilistic learning module 110.

That is, the functionalities of (1) the probability update module 2520 (e.g., by selecting from a plurality of algorithms used by the probability update module 2520, modifying one or more parameters within an algorithm used by the probability update module 2520, transforming or otherwise modifying the action probability distribution p); (2) the action selection module 2525 (e.g., limiting or expanding selection of the action αᵢ corresponding to a subset of probability values contained within the action probability distribution p); and/or (3) the outcome evaluation module 2530 (e.g., modifying the nature of the outcome value βₘₐⱼ or otherwise the algorithms used to determine the outcome values βₘₐⱼ), are modified. Specific to the learning program 2500, the intuition module 2515 may modify the outcome evaluation module 2530 by modifying the reference success ratio of the selected program action αᵢ. For example, for an outcome value βₘₐⱼ to indicate a success, the intuition module 2515 may modify the reference success ratio of the selected program action αᵢ from, e.g., a super-majority to a simple majority, or vice versa.

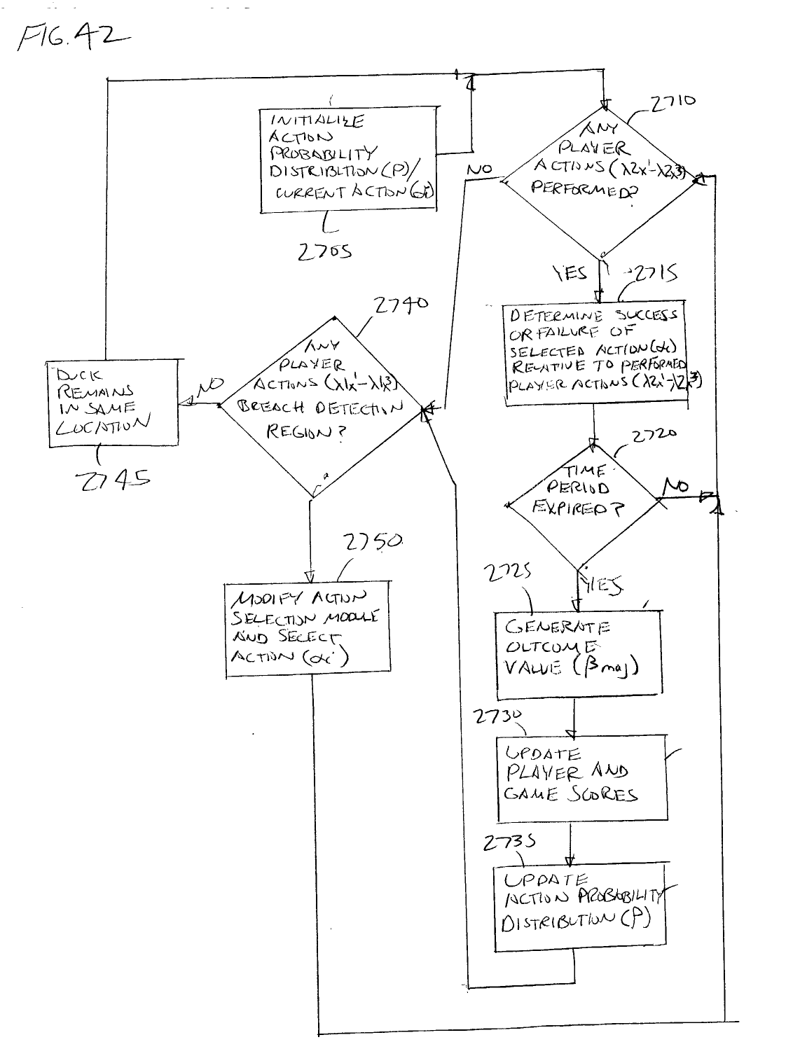

The various different types of learning methodologies previously described herein can be applied to the probabilistic learning module 2510. The operation of the program 2500 is similar to that of the program 600 described with respect to FIG. 12, with the exception that, rather than updating the action probability distribution p based on several outcome values β¹-β³ for the users 2505, the program 2500 updates the action probability distribution p based on a single outcome value βₘₐⱼ derived from the measured success of the selected program action αᵢ relative to the selected user actions λₓ¹λₓ³, as compared to a reference success ratio. Specifically, referring to FIG. 40, the probability update module 2520 initializes the action probability distribution p (step 2550) similarly to that described with respect to step 150 of FIG. 4. The action selection module 2525 then determines if one or more of the user actions λₓ¹-λₓ³ have been selected from the respective user action sets λ¹-λ³ (step 2555). If not, the program 2500 does not select a program action αᵢ from the program action set α (step 2560), or alternatively selects a program action αᵢ, e.g., randomly, notwithstanding that none of the user actions λₓ¹-λₓ³ has been selected (step 2565), and then returns to step 2555 where it again determines if one or more of the user actions λₓ¹-λₓ³ have been selected. If one or more of the user actions λₓ¹-λₓ³ have been performed at step 2555, the action selection module 2525 determines the nature of the selected ones of the user actions λₓ¹-λₓ³.

Specifically, the action selection module 2525 determines whether any of the selected ones of the user actions λₓ¹-λₓ³ should be countered with a program action αᵢ (step 2570). If so, the action selection module 2525 selects a program action αᵢ from the program action set α based on the action probability distribution p (step 2575). After the performance of step 2575 or if the action selection module 2525 determines that none of the selected user actions λₓ¹-λₓ³ is of the type that should be countered with a program action αᵢ, the action selection module 2525 determines if any of the selected user actions λₓ¹-λₓ³ are of the type that the performance index φ is based on (step 2580).

If not, the program 2500 returns to step 2555 to determine again whether any of the user actions λₓ¹-λₓ³ have been selected. If so, the outcome evaluation module 2530 quantifies the performance of the previously selected program action αᵢ relative to the reference success ratio (minority, majority, supermajority, etc.) by generating a single outcome value βₘₐⱼ (step 2585). The intuition module 2515 then updates the performance index φ based on the outcome value βₘₐⱼ, unless the performance index φ is an instantaneous performance index that is represented by the outcome value βₘₐⱼ itself (step 2590). The intuition module 2515 then modifies the probabilistic learning module 2510 by modifying the functionalities of the probability update module 2520, action selection module 2525, or outcome evaluation module 2530 (step 2595). The probability update module 2520 then, using any of the updating techniques described herein, updates the action probability distribution p based on the generated outcome value βₘₐⱼ (step 2598).

The program 2500 then returns to step 2555 to determine again whether any of the user actions λₓ¹-λₓ³ have been selected. It should be noted that the order of the steps described in FIG. 40 may vary depending on the specific application of the program 2500.

Multi-Player Learning Game Program (Single Game Action-Maximum Probability of Majority Approval)

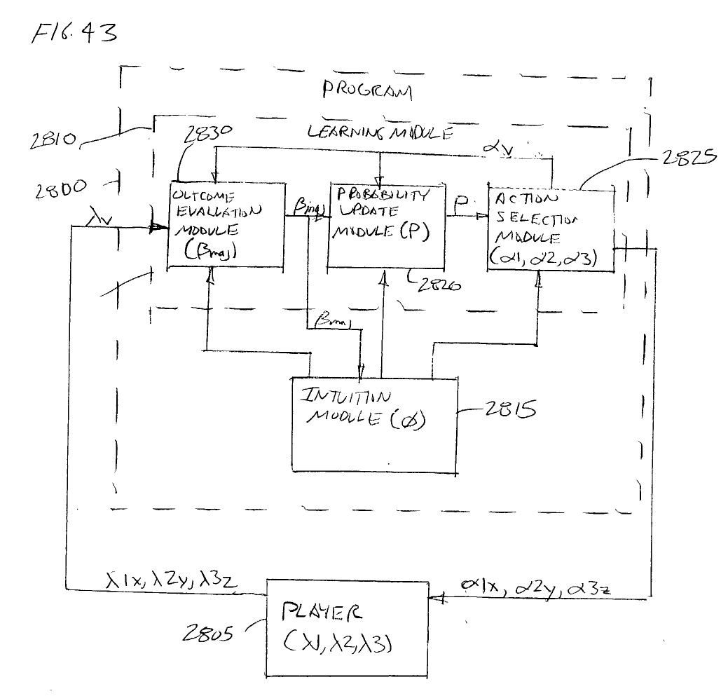

Having now generally described the components and functionality of the learning program 2500, we now describe one of its various applications. Referring to FIG. 41, a multiple-player learning software game program 2600 developed in accordance with the present inventions is described in the context of the previously described duck hunting game 700 (see FIG. 13). Because the game program 2600 will determine the success or failure of a selected game action based on the player actions as a group, in this version of the duck hunting game 700, the players 715(1)-(3) play against the duck 720 as a team, such that there is only one player score 760 and duck score 765 that is identically displayed on all three computers 760(1)-(3).

The game program 2600 generally includes a probabilistic learning module 2610 and an intuition module 2615, which are specifically tailored for the game 700. The probabilistic learning module 2610 comprises a probability update module 2620, an action selection module 2625, and an outcome evaluation module 2630, which are similar to the previously described probability update module 820, action selection module 825, and outcome evaluation module 830, with the exception that they operate on the player actions λ2ₓ¹-λ2ₓ³ as a player action vector λ2ᵥ and determine and output a single outcome value βₘₐⱼ that indicates how favorable the selected game action αᵢ in comparison with the received player action vector λ2ᵥ.

As previously discussed, the action probability distribution p is updated periodically, e.g., every second, during which each of any number of the players 715(1)-(3) may provide a corresponding number of player actions λ2ₓ¹-λ2ₓ³, so that the player actions λ2ₓ¹-λ2ₓ³ asynchronously performed by the players 715(1)-(3) may be synchronized to a time period as a single player action vector λ2ᵥ. It should be noted that in other types of games, where the player actions λ2ₓ need not be synchronized to a time period, such as, e.g., strategy games, the action probability distribution p may be updated after all players have performed a player action λ2ₓ.

The game program 2600 may employ the following P-type Maximum Probability Majority Approval (MPMA) SISO equations:

$$\begin{matrix}{p}_{i} ( k + 1 ) = {p}_{i} ( k ) + {\sum }_{{j = 1}_{j \neq i }}^{n} {g}_{j} ( p ( k ) ) ; and & [ 22 ] \\ {p}_{j} ( k + 1 ) = {p}_{j} ( k ) - {g}_{j} ( p ( k ) ) , when {β}_{maj} ( k ) = 1 and {α}_{i} is selected & [ 23 ] \\ {p}_{i} ( k + 1 ) = {p}_{i} ( k ) - {\sum }_{{j = 1}_{j \neq i }}^{n} {h}_{j} ( p ( k ) ) ; and & [ 24 ] \\ {p}_{j} ( k + 1 ) = {p}_{j} ( k ) + {h}_{j} ( p ( k ) ) , when {β}_{maj} ( k ) = 0 and {α}_{i} is selected & [ 25 ]\end{matrix}$$

where

pᵢ(k+1), pᵢ(k), gⱼ(p(k)), hⱼ(p(k)), i, j, k, and n have been previously defined, and

βₘₐⱼ(k) is the outcome value based on a majority success ratio of the participating players.

As an example, if there are a total of ten players, seven of which have been determined to be participating, and if two of the participating players shoot the duck 720 and the other five participating players miss the duck 720, βₘₐⱼ(k)=1, since a majority of the participating players missed the duck 720. If, on the hand, four of the participating players shoot the duck 720 and the other three participating players miss the duck 720, βₘₐⱼ(k)=0, since a majority of the participating players hit the duck 720. Of course, the outcome value βₘₐⱼ need not be based on a simple majority, but can be based on a minority, supermajority, unanimity, or equality of the participating players. In addition, the players can be weighted, such that, for any given player action λ2ₓ, a single player may be treated as two, three, or more players when determining if the success ratio has been achieved. It should be noted that a single player may perform more than one player action λ2ₓ in a single probability distribution updating time period, and thus be counted as multiple participating players. Thus, if there are three players, more than three participating players may be considered in equation.

Having now described the structure of the game program 2600, the steps performed by the game program 2600 will be described with reference to FIG. 42. First, the probability update module 2620 initializes the action probability distribution p and current action αᵢ (step 2705) similarly to that described in step 405 of FIG. 9. Then, the action selection module 2625 determines whether any of the player actions λ2ₓ¹-λ2ₓ³ have been performed, and specifically whether the guns 725(1)-(3) have been fired (step 2710). If any of the player actions λ2ₓ¹-λ2ₓ³ have been performed, the outcome evaluation module 2630 determines the success or failure of the currently selected game action αᵢ relative to the performed ones of the player actions λ2ₓ¹-λ2ₓ³ (step 2715). The intuition module 2615 then determines if the given time period to which the player actions λ2ₓ¹-λ2ₓ³ are synchronized has expired (step 2720). If the time period has not expired, the game program 2600 will return to step 2710 where the action selection module 2625 determines again if any of the player actions λ2ₓ¹-λ2ₓ³ have been performed. If the time period has expired, the outcome evaluation module 2630 determines the outcome value βₘₐⱼ for the player actions λ2ₓ¹-λ2ₓ³, i.e., the player action vector λ2ᵥ (step 2725). The intuition module 2615 then updates the combined player score 760 and duck scores 765 based on the outcome value βₘₐⱼ (step 2730). The probability update module 2620 then, using the MPMA SISO equations [22]-[25], updates the action probability distribution p based on the generated outcome value βₘₐⱼ (step 2735).

After step 2735, or if none of the player actions λ2ₓ¹-λ2ₓ³ has been performed at step 2710, the action selection module 2625 determines if any of the player actions λ1ₓ¹-λ1ₓ³ have been performed, i.e., guns 725(1)-(3), have breached the gun detection region 270 (step 2740). If none of the guns 725(1)-(3) has breached the gun detection region 270, the action selection module 2625 does not select a game action αᵢ from the game action set α and the duck 720 remains in the same location (step 2745). Alternatively, the game action αᵢ may be randomly selected, allowing the duck 720 to dynamically wander. The game program 2600 then returns to step 2710 where it is again determined if any of the player actions λ1ₓ¹-λ1ₓ³ has been performed.

If any of the guns 725(1)-(3) have breached the gun detection region 270 at step 2740, the intuition module 2615 modifies the functionality of the action selection module 2625 based on the performance index φ, and the action selection module 2625 selects a game action αᵢ from the game action set α in the manner previously described with respect to steps 440-470 of FIG. 9 (step 2750). It should be noted that, rather than use the action subset selection technique, other afore-described techniques used to dynamically and continuously match the skill level of the players 715(1)-(3) with the skill level of the game 700, such as that illustrated in FIG. 10, can be alternatively or optionally be used as well in the game program 2600. Also, the intuition module 2615 may modify the functionality of the outcome evaluation module 2630 by modifying the reference success ratio of the selection program action αᵢ on which the single outcome value βₘₐⱼ is based.

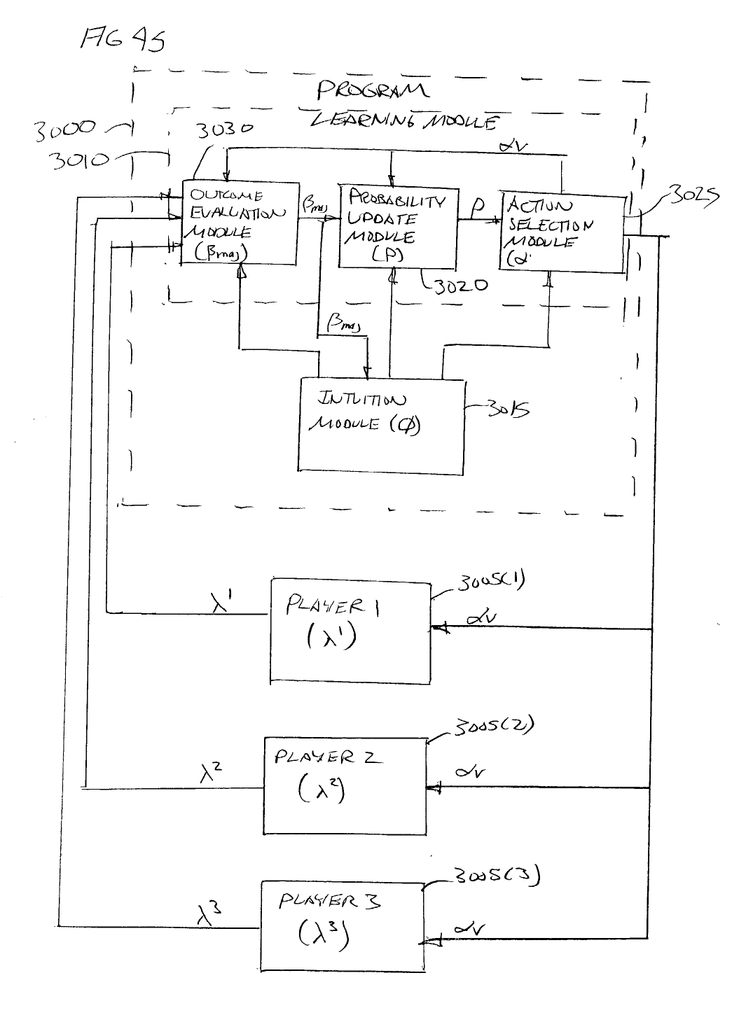

The learning program 2500 can also be applied to single-user scenarios, such as, e.g., strategy games, where the user performs several actions at a time. For example, referring to FIG. 43, a learning software game program 2800 developed in accordance with the present inventions is described in the context of a war game, which can be embodied in any one of the previously described computer systems. In the war game, a player 2805 can select any one of a variety of combinations of weaponry to attack the game's defenses. For example, in the illustrated embodiment, the player 2805 may be able to select three weapons at a time, and specifically, one of two types of bombs (denoted by λ1₁ and λ1₂) from a bomb set λ1, one of three types of guns (denoted by λ2₁, λ2₂, and λ2₃) from a gun set λ2, and one of two types of arrows (denoted by λ3₁ and λ3₂) from an arrow set λ3. Thus, the selection of three weapons can be represented by weapon vector λᵥ (λ1ₓ, λ2_{y}, and Aλ3_{z}) that will be treated as a single action. Given that three weapons will be selected in combination, there will be a total of twelve weapon vectors λᵥ available to the player 2805, as illustrated in the following Table 5.

TABLE 5
Exemplary Weapon Combinations for War Game

| λᵥ | λ1ₓ | λ2_{y} | λ3_{z} |
|---|---|---|---|
| Bomb 1, Gun 1, Arrow 1 (λ₁) | Bomb 1 | Gun 1 (λ2₁) | Arrow 1 (λ3₁) |
| | (λ1₁) | | |
| Bomb 1, Gun 1, Arrow 2 (λ₂) | Bomb 1 | Gun 1 (λ2₁) | Arrow 2 (λ3₂) |
| | (λ1₁) | | |
| Bomb 1, Gun 2, Arrow 1 (λ₂) | Bomb 1 | Gun 2 (λ2₂) | Arrow 1 (λ3₁) |
| | (λ1₁) | | |
| Bomb 1, Gun 2, Arrow 2 (λ₄) | Bomb 1 | Gun 2 (λ2₂) | Arrow 2 (λ3₂) |
| | (λ1₁) | | |
| Bomb 1, Gun 3, Arrow 1 (λ₅) | Bomb 1 | Gun 3 (λ2₃) | Arrow 1 (λ3₁) |
| | (λ1₁) | | |
| Bomb 1, Gun 3, Arrow 2 (λ₆) | Bomb 1 | Gun 3 (λ2₃) | Arrow 2 (λ3₂) |
| | (λ1₁) | | |
| Bomb 2, Gun 1, Arrow 1 (λ₇) | Bomb 2 | Gun 1 (λ2₁) | Arrow 1 (λ3₁) |
| | (λ1₂) | | |
| Bomb 2, Gun 1, Arrow 2 (λ₈) | Bomb 2 | Gun 1 (λ2₁) | Arrow 2 (λ3₂) |
| | (λ1₂) | | |
| Bomb 2, Gun 2, Arrow 1 (λ₉) | Bomb 2 | Gun 2 (λ2₂) | Arrow 1 (λ3₁) |
| | (λ1₂) | | |
| Bomb 2, Gun 2, Arrow 2 (λ₁₀) | Bomb 2 | Gun 2 (λ2₂) | Arrow 2 (λ3₂) |
| | (λ1₂) | | |
| Bomb 2, Gun 3, Arrow 1 (λ₁₁) | Bomb 2 | Gun 3 (λ2₃) | Arrow 1 (λ3₁) |
| | (λ1₂) | | |
| Bomb 2, Gun 3, Arrow 2 (λ₁₂) | Bomb 2 | Gun 3 (λ2₃) | Arrow 2 (λ3₂) |
| | (λ1₂) | | |

An object of the game (such as a monster or warrior) may be able to select three defenses at a time, and specifically, one of two types of bomb defusers (denoted by α1₁ and α1₂) from a bomb defuser set α1 against the player's bombs, one of three types of body armor (denoted by α2₁, α2₂, and α2₃) from a body armor set α2 against the players' guns, and one of two types of shields (denoted by α1₁ and α1₂) from a shield set α3 against the players' arrows. Thus, the selection of three defenses can be represented by game action vector αᵥ (α1ₓ, α2_{y}, and α3_{z}) that will be treated as a single action. Given that three defenses will be selected in combination, there will be a total of twelve game action vectors αᵥ available to the game, as illustrated in the following Table 6.

TABLE 6
Exemplary Defense Combinations for War Game

| αᵥ | α1ₓ | α2_{y} | α3_{z} |
|---|---|---|---|
| Defuser 1, Armor 1, | Defuser 1 (λ1₁) | Armor 1 (λ2₁) | Shield 1 (λ3₁) |
| Shield 1 (λ₁) | | | |
| Defuser 1, Armor 1, | Defuser 1 (λ1₁) | Armor 1 (λ2₁) | Shield 2 (λ3₂) |
| Shield 2 (λ₂) | | | |
| Defuser 1, Armor 2, | Defuser 1 (λ1₁) | Armor 2 (λ2₂) | Shield 1 (λ3₁) |
| Shield 1 (λ₃) | | | |
| Defuser 1, Armor 2, | Defuser 1 (λ1₁) | Armor 2 (λ2₂) | Shield 2 (λ3₂) |
| Shield 2 (λ₄) | | | |
| Defuser 1, Armor 3, | Defuser 1 (λ1₁) | Armor 3 (λ2₃) | Shield 1 (λ3₁) |
| Shield 1 (λ₅) | | | |
| Defuser 1, Armor 3, | Defuser 1 (λ1₁) | Armor 3 (λ2₃) | Shield 2 (λ3₂) |
| Shield 2 (λ₆) | | | |
| Defuser 2, Armor 1, | Defuser 2 (λ1₂) | Armor 1 (λ2₁) | Shield 1 (λ3₁) |
| Shield 1 (λ₇) | | | |
| Defuser 2, Armor 1, | Defuser 2 (λ1₂) | Armor 1 (λ2₁) | Shield 2 (λ3₂) |
| Shield 2 (λ₈) | | | |
| Defuser 2, Armor 2, | Defuser 2 (λ1₂) | Armor 2 (λ2₂) | Shield 1 (λ3₁) |
| Shield 1 (λ₉) | | | |
| Defuser 2, Armor 2, | Defuser 2 (λ1₂) | Armor 2 (λ2₂) | Shield 2 (λ3₂) |
| Shield 2 (λ₁₀) | | | |
| Defuser 2, Armor 3, | Defuser 2 (λ1₂) | Armor 3(λ2₃) | Shield 1 (λ3₁) |
| Shield 1 (λ₁₁) | | | |
| Defuser 2, Armor 4, | Defuser 2 (λ1₂) | Armor 3 (λ2₃) | Shield 2 (λ3₂) |
| Shield 2 (λ₁₂) | | | |

The game maintains a score for the player and a score for the game. To this end, if the selected defenses α of the game object fail to prevent one of the weapons λ selected by the player from hitting or otherwise damaging the game object, the player score will be increased. In contrast, if the selected defenses α of the game object prevent one of the weapons λ selected by the player from hitting or otherwise damaging the game object, the game score will be increased. In this game, the selected defenses α of the game, as represented by the selected game action vector αᵥ will be successful if the game object is damaged by one or none of the selected weapons λ (thus resulting in an increased game score), and will fail, if the game object is damaged by two or all of the selected weapons λ (thus resulting in an increased player score). As previously discussed with respect to the game 200, the increase in the score can be fixed, one of a multitude of discrete values, or a value within a continuous range of values.

As will be described in further detail below, the game increases its skill level by learning the player's strategy and selecting the weapons based thereon, such that it becomes more difficult to damage the game object as the player becomes more skillful. The game optionally seeks to sustain the player's interest by challenging the player. To this end, the game continuously and dynamically matches its skill level with that of the player by selecting the weapons based on objective criteria, such as, e.g., the difference between the player and game scores. In other words, the game uses this score difference as a performance index φ in measuring its performance in relation to its objective of matching its skill level with that of the game player. Alternatively, the performance index φ can be a function of the action probability distribution p.

The game program 2800 generally includes a probabilistic learning module 2810 and an intuition module 2815, which are specifically tailored for the war game. The probabilistic learning module 2810 comprises a probability update module 2820, an action selection module 2825, and an outcome evaluation module 2830. Specifically, the probability update module 2820 is mainly responsible for learning the player's strategy and formulating a counterstrategy based thereon, with the outcome evaluation module 2830 being responsible for evaluating the selected defense vector αᵥ relative to the weapon vector λᵥ selected by the player 2805. The action selection module 2825 is mainly responsible for using the updated counterstrategy to select the defenses in response to weapons selected by the game object. The intuition module 2815 is responsible for directing the learning of the game program 2800 towards the objective, and specifically, dynamically and continuously matching the skill level of the game with that of the player. In this case, the intuition module 2815 operates on the action selection module 2825, and specifically selects the methodology that the action selection module 2825 will use to select the defenses α1ₓ, α2_{y}, and α3_{z} from defense sets α1, α2, and α3, i.e., one of the twelve defense vectors αᵥ. Optionally, the intuition module 2815 may operate on the outcome evaluation module 2830, e.g., by modifying the reference success ratio of the selected defense vector αᵥ, i.e., the ratio of hits to the number of weapons used. Of course if the immediate objective is to merely determine the best defense vector αᵥ, the intuition module 2815 may simply decide to not modify the functionality of any of the modules.

To this end, the outcome evaluation module 2830 is configured to receive weapons λ1ₓ, λ2_{y}, and λ3_{z} from the player, i.e., one of the twelve weapon vectors λᵥ. The outcome evaluation module 2830 then determines whether the previously selected defenses α1ₓ, α2_{y}, and α3_{z}, i.e., one of the twelve defense vectors αᵥ, were able to prevent damage incurred from the received weapons λ1ₓ, λ2_{y}, and λ3_{z}, with the outcome value βₘₐⱼ equaling one of two predetermined values, e.g., “1” if two or more of the defenses α1ₓ, α2_{y}, and α3_{z} were successful, or “0” if two or more of the defenses α1ₓ, α2_{y}, and α3_{z} were unsuccessful.

The probability update module 2820 is configured to receive the outcome values βₘₐⱼ from the outcome evaluation module 2830 and output an updated game strategy (represented by action probability distribution p) that the game object will use to counteract the player's strategy in the future. The probability update module 2820 updates the action probability distribution p using the P-type MPMA SISO equations [22]-[25], with the action probability distribution p containing twelve probability values pᵥ corresponding to the twelve defense vectors αᵥ. The action selection module 2825 pseudo-randomly selects the defense vector αᵥ based on the updated game strategy, and is thus, further configured to receive the action probability distribution p from the probability update module 2820, and selecting the defense vector αᵥ based thereon.

The intuition module 2815 is configured to modify the functionality of the action selection module 2825 based on the performance index φ, and in this case, the current skill level of the players relative to the current skill level of the game. In the preferred embodiment, the performance index φ is quantified in terms of the score difference value Δ between the player score and the game object score. In the manner described above with respect to game 200, the intuition module 2815 is configured to modify the functionality of the action selection module 2825 by subdividing the set of twelve defense vectors αᵥ into a plurality of defense vector subsets, and selecting one of the defense vectors subsets based on the score difference value Δ. The action selection module 2825 is configured to pseudo-randomly select a single defense vector αᵥ from the selected defense vector subset. Alternatively, the intuition module 2815 modifies the maximum number of defenses α in the defense vector αᵥ that must be successful from two to one, e.g., if the relative skill level of the game object is too high, or from two to three, e.g., if the relative skill level of the game object is too low. Even more alternatively, the intuition module 2815 does not exist or determines not to modify the functionality of any of the modules, and the action selection module 2825 automatically selects the defense vector αᵥ corresponding to the highest probability value pᵥ to always find the best defense for the game object.

Having now described the structure of the game program 2800, the steps performed by the game program 2800 will be described with reference to FIG. 44. First, the probability update module 2820 initializes the action probability distribution p and current defense vector αᵥ (step 2905) similarly to that described in step 405 of FIG. 9. Then, the intuition module 2815 modifies the functionality of the action selection module 2825 based on the performance index φ, and the action selection module 2825 selects a defense vector αᵥ from the defense vector set α in the manner previously described with respect to steps 440-470 of FIG. 9 (step 2910). It should be noted that, rather than use the action subset selection technique, other afore-described techniques used to dynamically and continuously match the skill level of the player 2805 with the skill level of the game, such as that illustrated in FIG. 10, can be alternatively or optionally be used as well in the game program 2800. Also, the intuition module 2815 may modify the functionality of the outcome evaluation module 2830 by modifying the success ratio of the selected defense vector αᵥ on which the single outcome value βₘₐⱼ is based. Even more alternatively, the intuition module 2815 may not modify the functionalities of any of the modules, e.g., if the objective is to find the best defense vector αᵥ.

Then, the action selection module 2825 determines whether the weapon vector λᵥ has been selected (step 2915). If no weapon vector λᵥ has been selected at step 2915, the game program 2800 then returns to step 2915 where it is again determined if a weapon vector λᵥ has been selected. If the a weapon vector λᵥ has been selected, the outcome evaluation module 2830 then determines how many of the defenses in the previously selected defense vector αᵥ were successful against the respective weapons of the selected weapon vector λᵥ, and generates the outcome value βₘₐⱼ in response thereto (step 2920). The intuition module 2815 then updates the player scores and game object score based on the outcome values βₘₐⱼ (step 2925). The probability update module 2820 then, using the MPMA SISO equations [22]-[25], updates the action probability distribution pᵥ based on the generated outcome value β (step 2930). The game program 2800 then returns to step 2910 where another defense vector αᵥ is selected.

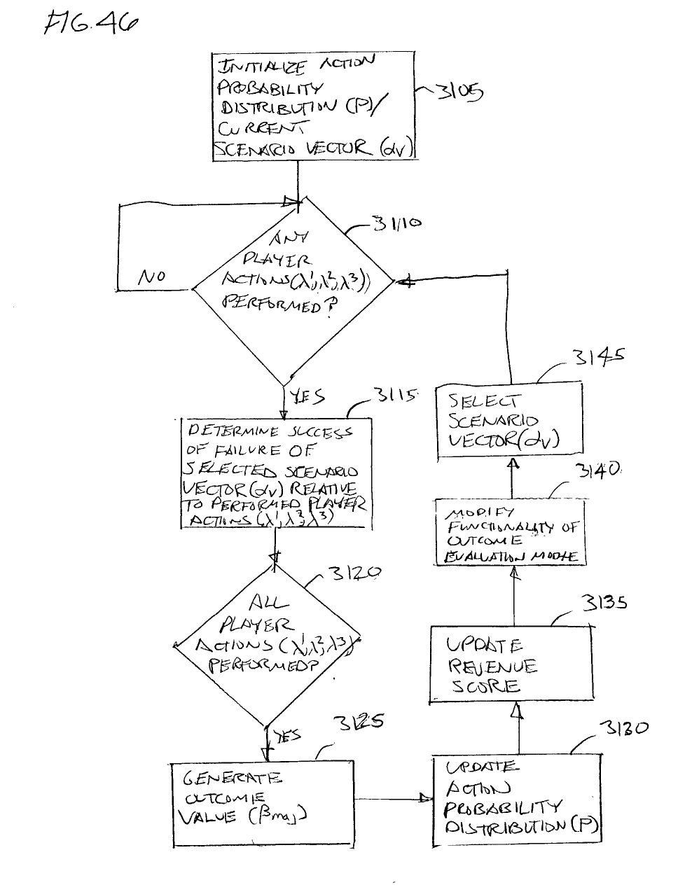

The learning program 2500 can also be applied to the extrinsic aspects of games, e.g., revenue generation from the games. For example, referring to FIG. 45, a learning software revenue program 3000 developed in accordance with the present inventions is described in the context of an internet computer game that provides five different scenarios (e.g., forest, mountainous, arctic, ocean, and desert) with which three players 3005(1)-(3) can interact. The objective the program 3000 is to generate the maximum amount of revenue as measured by the amount of time that each player 3005 plays the computer game. The program 3000 accomplishes this by providing the players 3005 with the best or more enjoyable scenarios. Specifically, the program 3000 selects three scenarios designated from the five scenario set α at time for each player 3005 to interact with. Thus, the selection of three scenarios can be represented by a scenario vector αᵥ that will be treated as a single action. Given that three scenarios will be selected in combination from five scenarios, there will be a total of ten scenario vectors αᵥ available to the players 3005, as illustrated in the following Table 7.

TABLE 7
Exemplary Scenario Combinations for
the Revenue Generating Computer Game
α_{V}
Forest, Mountainous, Arctic (α₁)
Forest, Mountainous, Ocean (α₂)
Forest, Mountainous, Desert (α₃)
Forest, Arctic, Ocean (α₄)
Forest, Arctic, Desert (α₅)
Forest, Ocean, Desert (α₆)
Mountainous, Arctic, Ocean (α₇)
Mountainous, Arctic, Desert (α₈)
Mountainous, Ocean, Desert (α₉)
Arctic, Ocean, Desert (α₁₀)

In this game, the selected scenarios α of the game, as represented by the selected game action vector αᵥ, will be successful if two or more of the players 3005 play the game for at least a predetermined time period (e.g., 30 minutes), and will fail, if one or less of the players 3005 play the game for at least the predetermined time period. In this case, the player action λ can be considered a continuous period of play. Thus, three players 3005(1)-(3) will produce three respective player actions λ¹-λ³. The revenue program 3000 maintains a revenue score, which is a measure of the target incremental revenue with the current generated incremental revenue. The revenue program 3000 uses this revenue as a performance index φ in measuring its performance in relation to its objective of generating the maximum revenue.

The revenue program 3000 generally includes a probabilistic learning module 3010 and an intuition module 3015, which are specifically tailored to obtain the maximum revenue. The probabilistic learning module 3010 comprises a probability update module 3020, an action selection module 3025, and an outcome evaluation module 3030. Specifically, the probability update module 3020 is mainly responsible for learning the players' 3005 favorite scenarios, with the outcome evaluation module 3030 being responsible for evaluating the selected scenario vector αᵥ relative to the favorite scenarios as measured by the amount of time that game is played. The action selection module 3025 is mainly responsible for using the learned scenario favorites to select the scenarios. The intuition module 3015 is responsible for directing the learning of the revenue program 3000 towards the objective, and specifically, obtaining maximum revenue. In this case, the intuition module 3015 operates on the outcome evaluation module 3030, e.g., by modifying the success ratio of the selected scenario vector αᵥ, or the time period of play that dictates the success or failure of the selected defense vector αᵥ. Alternatively, the intuition module 3015 may simply decide to not modify the functionality of any of the modules.

To this end, the outcome evaluation module 3030 is configured to player actions λ¹-λ³ from the respective players 3005(1)-(3). The outcome evaluation module 3030 then determines whether the previously selected scenario vector αᵥ was played by the players 3005(1)-(3) for the predetermined time period, with the outcome value βₘₐⱼ equaling one of two predetermined values, e.g., “1” if the number of times the selected scenario vector αᵥ exceeded the predetermined time period was two or more times, or “0” if the number of times the selected scenario vector αᵥ exceeded the predetermined time period was one or zero times.

The probability update module 3020 is configured to receive the outcome values βₘₐⱼ from the outcome evaluation module 3030 and output an updated game strategy (represented by action probability distribution p) that will be used to select future scenario vectors αᵥ. The probability update module 3020 updates the action probability distribution p using the P-type MPMA SISO equations [22]-[25], with the action probability distribution p containing ten probability values pᵥ corresponding to the ten scenario vectors αᵥ. The action selection module 3025 pseudo-randomly selects the scenario vector αᵥ based on the updated revenue strategy, and is thus, further configured to receive the action probability distribution p from the probability update module 3020, and selecting the scenario vector αᵥ based thereon.

The intuition module 3015 is configured to modify the functionality of the outcome evaluation module 3030 based on the performance index φ, and in this case, the revenue score. The action selection module 3025 is configured to pseudo-randomly select a single scenario vector αᵥ from the ten scenario vectors αᵥ. For example, the intuition module 3015 can modify the maximum number of times the play time for the scenario vector αᵥ exceeds the predetermined period of time from two to one or from two to three. Even more alternatively, the intuition module 3015 does not exist or determines not to modify the functionality of any of the modules.

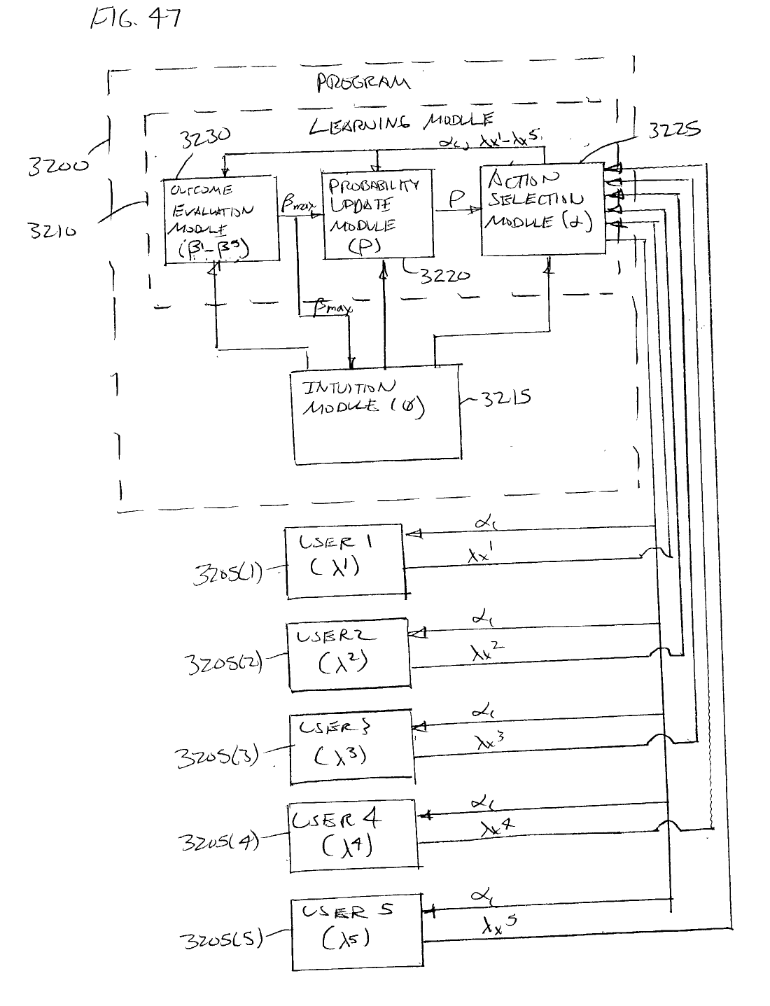

Having now described the structure of the game program 3000, the steps performed by the game program 3000 will be described with reference to FIG. 46. First, the probability update module 3020 initializes the action probability distribution p and current scenario vector αᵥ (step 3105). Then, the action selection module 3025 determines whether any of the player actions λ¹-λ³ have been performed, and specifically whether play has been terminated by the players 3005(1)-(3) (step 3110). If none of the player actions λ¹-λ³ has been performed, the program 3000 returns to step 3110 where it again determines if any of the player λ¹-λ³ have been performed. If any of the player actions λ¹-λ³ have been performed, the outcome evaluation module 3030 determines the success or failure of the currently selected scenario vector αᵥ relative to continuous play period corresponding to the performed ones of the player actions λ¹-λ³, i.e., whether any of the players 3005(1)-(3) terminated play (step 3115). The intuition module 3115 then determines if all three of the player actions λ¹-λ³ have been performed (step 3120). If not, the game program 3000 will return to step 3110 where the action selection module 3025 determines again if any of the player actions λ¹-λ³ have been performed. If all three of the player actions λ¹-λ³ have been performed, the outcome evaluation module 3030 then determines how many times the play time for the selected scenario vector αᵥ exceeded the predetermined time period, and generates the outcome value βₘₐⱼ in response thereto (step 3120). The probability update module 3020 then, using the MPMA SISO equations [22]-[25], updates the action probability distribution p based on the generated outcome value βₘₐⱼ (step 3125). The intuition module 2615 then updates the revenue score based on the outcome value βₘₐⱼ (step 3130), and then modifies the functionality of the outcome evaluation module 3030 (step 3140). The action selection module 2625 then pseudo-randomly selects a scenario vector αᵥ (step 3145).

Generalized Multi-User Learning Program (Single Processor Action-Maximum Number of Teachers Approving)

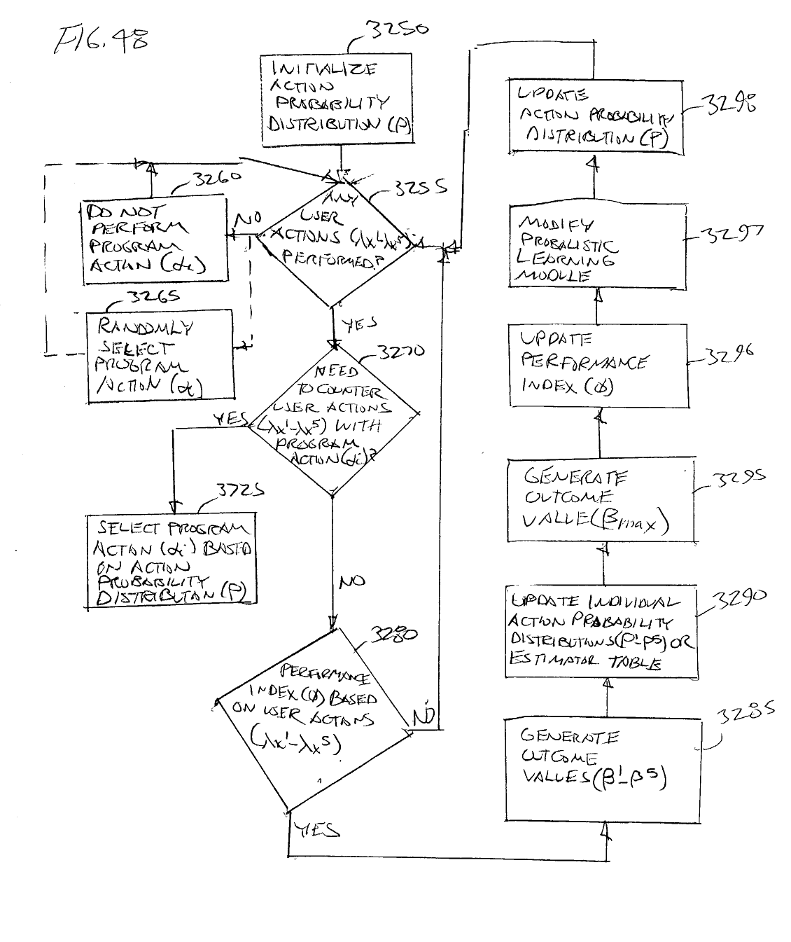

Referring to FIG. 47, yet another multi-user learning program 3200 developed in accordance with the present inventions can be generally implemented to provide intuitive learning capability to any variety of processing devices. The learning program 3200 is similar to the program 2500 in that multiple users 3205(1)-(5) (here, five) interact with the program 3200 by receiving the same program action αᵢ from a program action set α within the program 3200, and each independently selecting corresponding user actions λₓ¹-λₓ⁵ from respective user action sets λ¹-λ⁵ based on the received program action αᵢ. The learning program 3200 differs from the program 2500 in that, rather than learning based on the measured success ratio of a selected program action αᵢ relative to a reference success ratio, it learns based on whether the selected program action αᵢ has a relative success level (in the illustrated embodiment, the greatest success) out of program action set α for the maximum number of users 3205. For example, βₘₐⱼ may equal “1” (indicating a success) if the selected program action αᵢ is the most successful for the maximum number of users 3205, and may equal “0” (indicating a failure) if the selected program action αᵢ if the selected program action αᵢ is not the most successful for the maximum number of users 3205. To determine which program action αᵢ is the most successful, individual outcome values β¹-β⁵ are generated and accumulated for the user actions λₓ¹-λₓ⁵ relative to each selected action αᵢ. As will be described in further detail below, the program 3200 directs its learning capability by dynamically modifying the model that it uses to learn based on a performance index φ to achieve one or more objectives.

To this end, the program 3200 generally includes a probabilistic learning module 3210 and an intuition module 3215. The probabilistic learning module 3210 includes a probability update module 3220, an action selection module 3225, and an outcome evaluation module 3230. Briefly, the probability update module 3220 uses learning automata theory as its learning mechanism, and is configured to generate and update a single action probability distribution p based on the outcome value βₘₐₓ. In this scenario, the probability update module 3220 uses a single stochastic learning automaton with a single input to a single-teacher environment (with the users 3205(1)-(5), in combination, as a single teacher), and thus, a SISO model is assumed. Alternatively, if the users 3205(1)-(5) receive multiple program actions αᵢ, some of which are different, multiple SISO models can be assumed, as previously described with respect to the program 2500. Exemplary equations that can be used for the SISO model will be described in further detail below.

The action selection module 3225 is configured to select the program action αᵢ from the program action set α based on the probability values pᵢ contained within the action probability distribution p internally generated and updated in the probability update module 3220. The outcome evaluation module 3230 is configured to determine and generate the outcome values β¹-β⁵ based on the relationship between the selected program action αᵢ and the user actions λₓ¹-λₓ⁵. The outcome evaluation module 3230 is also configured to determine the most successful program action αᵢ for the maximum number of users 3205(1)-(5), and generate the outcome value βₘₐₓ based thereon.

The outcome evaluation module 3230 can determine the most successful program action αᵢ for the maximum number of users 3205(1)-(5) by reference to action probability distributions p¹-p⁵ maintained for the respective users 3205(1)-(5). Notably, these action probability distributions p¹-p⁵ would be updated and maintained using the SISO model, while the single action probability distribution p described above will be separately updated and maintained using a Maximum Number of Teachers Approving (MNTA) model, which uses the outcome value βₘₐₓ. For example, Table 8 illustrates exemplary probability distributions p₁-p⁵ for the users 3205(1)-(5), with each of the probability distributions p¹-p⁵ having seven probability values pᵢ corresponding to seven program actions αᵢ. As shown, the highest probability values, and thus, the most successful program actions αᵢ for the respective users 3205(1)-(5), are α₄ (p₄=0.92) for user 3205(1), α₅ (p=0.93) for user 3205(2), α₄ (p₄=0.94) for user 3205(3), α₄ (p₄=0.69) for user 3205(4), and α₄ (p₇=0.84) for user 3205(5). Thus, for the exemplary action probability distributions p shown in Table 8, the most successful program action αᵢ for the maximum number of users 3205(1)-(5) (in this case, users 3205(1), 3205(3), and 3205(4)) will be program action λ₄, and thus, if the action selected is α₄, βₘₐₓ will equal “1”, resulting an increase in the action probability value p₄, and if the action selected is other than α₄, βₘₐₓ will equal “0”, resulting in a decrease in the action probability value p₄.

TABLE 8
Exemplary Probability Values for Action
Probability Distributions Separately
Maintained for Five Users

| p | p₁ | p₂ | p₃ | p₄ | p₅ | p₆ | p₇ |
|---|---|---|---|---|---|---|---|
| 1 | 0.34 | 0.78 | 0.48 | 0.92 | 0.38 | 0.49 | 0.38 |
| 2 | 0.93 | 0.39 | 0.28 | 0.32 | 0.76 | 0.68 | 0.69 |
| 3 | 0.39 | 0.24 | 0.13 | 0.94 | 0.83 | 0.38 | 0.38 |
| 4 | 0.39 | 0.38 | 0.39 | 0.69 | 0.38 | 0.32 | 0.48 |
| 5 | 0.33 | 0.23 | 0.23 | 0.39 | 0.30 | 0.23 | 0.84 |

The outcome evaluation module 3230 can also determine the most successful program action αᵢ for the maximum number of users 3205(1)-(5) by generating and maintaining an estimator table of the successes and failures of each of the program action αᵢ relative to the user actions user actions λₓ¹-λₓ⁵. This is actually the preferred method, since it will more quickly converge to the most successful program action αᵢ for any given user 3205, and requires less processing power. For example, Table 9 illustrates exemplary success to total number ratios rᵢ for each of the seven program actions αᵢ and for each of the users 3205(1)-(5). As shown, the highest probability values, and thus, the most successful program actions αᵢ for the respective users 3205(1)-(5), are α₄ (r₄=4/5) for user 3205(1), α₆ (r₆=9/10) for user 3205(2), α₄ (r₆=8/10) for user 3205(3), α₇ (r₇=6/7) for user 3205(4), and α₂ (r₂=5/6) for user 3205(5). Thus, for the exemplary success to total number ratios r shown in Table 9, the most successful program action αᵢ for the maximum number of users 3205(1)-(5) (in this case, users 3205(2) and 3205(3)) will be program action α₆, and thus, if the action selected is α₆, βₘₐₓ will equal “1”, resulting an increase in the action probability value p₆ for the single action probability distribution p, and if the action selected is other than α₆, βₘₐₓ will equal “0”, resulting in a decrease in the action probability value p₆ for the single action probability distribution p.

TABLE 9
Exemplary Estimator Table For Five Users

| r | r₁ | r₂ | r₃ | r₄ | r₅ | r₆ | r₇ |
|---|---|---|---|---|---|---|---|
| 1 | 3/10 | 2/6 | 9/12 | 4/5 | 2/9 | 4/10 | 4/7 |
| 2 | 6/10 | 4/6 | 4/12 | 3/5 | 4/9 | 9/10 | 5/7 |
| 3 | 7/10 | 3/6 | 8/12 | 2/5 | 6/9 | 8/10 | 3/7 |
| 4 | 5/10 | 4/6 | 2/12 | 4/5 | 5/9 | 6/10 | 6/7 |
| 5 | 3/10 | 5/6 | 6/12 | 3/5 | 2/9 | 5/10 | 4/7 |

The intuition module 3215 modifies the probabilistic learning module 3210 (e.g., selecting or modifying parameters of algorithms used in learning module 3210) based on one or more generated performance indexes φ to achieve one or more objectives. As previously discussed, the performance index φ can be generated directly from the outcome values β¹-β⁵ or from something dependent on the outcome values β¹-β⁵, e.g., the action probability distributions p¹-p⁵, in which case the performance index φ may be a function of the action probability distributions p¹-p⁵, or the action probability distributions p¹-p⁵ may be used as the performance index φ. Alternatively, the intuition module 3215 may be non-existent, or may desire not to modify the probability learning module 3210 depending on the objective of the program 3200.

The modification of the probabilistic learning module 3210 is generally accomplished similarly to that described with respect to the afore-described probabilistic learning module 110. That is, the functionalities of (1) the probability update module 3220 (e.g., by selecting from a plurality of algorithms used by the probability update module 3220, modifying one or more parameters within an algorithm used by the probability update module 3220, transforming or otherwise modifying the action probability distribution p); (2) the action selection module 3225 (e.g., limiting or expanding selection of the action αᵢ corresponding to a subset of probability values contained within the action probability distribution p); and/or (3) the outcome evaluation module 3230 (e.g., modifying the nature of the outcome values β¹-β⁵, or otherwise the algorithms used to determine the outcome values β¹-β⁵), are modified. Specific to the learning program 3200, the intuition module 3215 may modify the outcome evaluation module 3230 to indicate which program action αᵢ is the least successful or average successful program action αᵢ for the maximum number of users 3205.

The various different types of learning methodologies previously described herein can be applied to the probabilistic learning module 3210. The operation of the program 3200 is similar to that of the program 600 described with respect to FIG. 12, with the exception that, rather than updating the action probability distribution p based on several outcome values β¹-β⁵ for the users 3205, the program 3200 updates the action probability distribution p based on the outcome value βₘₐₓ.

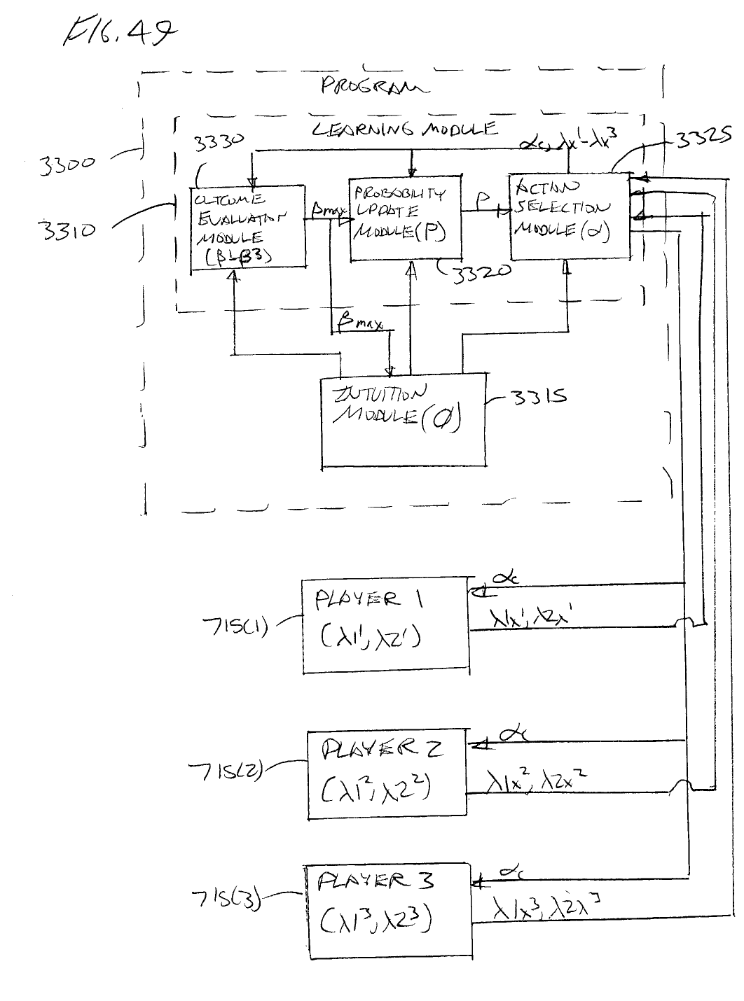

Specifically, referring to FIG. 48, the probability update module 3220 initializes the action probability distribution p (step 3250) similarly to that described with respect to step 150 of FIG. 4. The action selection module 3225 then determines if one or more of the users 3205(1)-(5) have selected a respective one or more of the user actions λₓ¹-λₓ⁵ (step 3255). If not, the program 3200 does not select a program action αᵢ from the program action set α (step 3260), or alternatively selects a program action αᵢ, e.g., randomly, notwithstanding that none of the users 3205 has selected a user actions λₓ (step 3265), and then returns to step 3555 where it again determines if one or more of the users 3205 have selected the respective one or more of the user actions λₓ¹-λₓ⁵.

If so, the action selection module 3225 determines whether any of the selected user actions λₓ¹-λₓ⁵ should be countered with a program action αᵢ (step 3270). If they should, the action selection module 3225 selects a program action αᵢ from the program action set α based on the action probability distribution p (step 3275). After the selection of step 3275 or if the action selection module 3225 determines that none of the selected user actions λₓ¹-λₓ⁵ should be countered with a program action αᵢ, the outcome evaluation module 3230, the action selection module 3225 determines if any of the selected user actions λₓ¹-λₓ⁵ are of the type that the performance index φ is based on (step 3280).

If not the program 3200 returns to step 3255. If so, the outcome evaluation module 3230 quantifies the selection of the previously selected program action αᵢ relative to the selected ones of the user actions λₓ¹-λₓ⁵ by generating the respective ones of the outcome values β¹-β⁵ (step 3285). The probability update module 3220 then updates the individual action probability distributions p¹-p⁵ or estimator table for the respective users 3205 (step 3290), and the outcome evaluation module 3230 then determines the most successful program action αᵢ for the maximum number of users 3205, and generates outcome value βₘₐₓ (step 3295).

The intuition module 3215 then updates the performance index φ based on the relevant outcome values β¹-β⁵, unless the performance index φ is an instantaneous performance index that is represented by the outcome values β¹-β⁵ themselves (step 3296). The intuition module 3215 then modifies the probabilistic learning module 3210 by modifying the functionalities of the probability update module 3220, action selection module 3225, or outcome evaluation module 3230 (step 3297). The probability update module 3220 then, using any of the updating techniques described herein, updates the action probability distribution p based on the generated βₘₐₓ (step 3298).

The program 3200 then returns to step 3255 to determine again whether one or more of the users 3205(1)-(5) have selected a respective one or more of the user actions λₓ¹-λₓ⁵. It should be noted that the order of the steps described in FIG. 48 may vary depending on the specific application of the program 3200.

Multi-Player Learning Game Program (Single Game Action-Maximum Number of Teachers Approving)

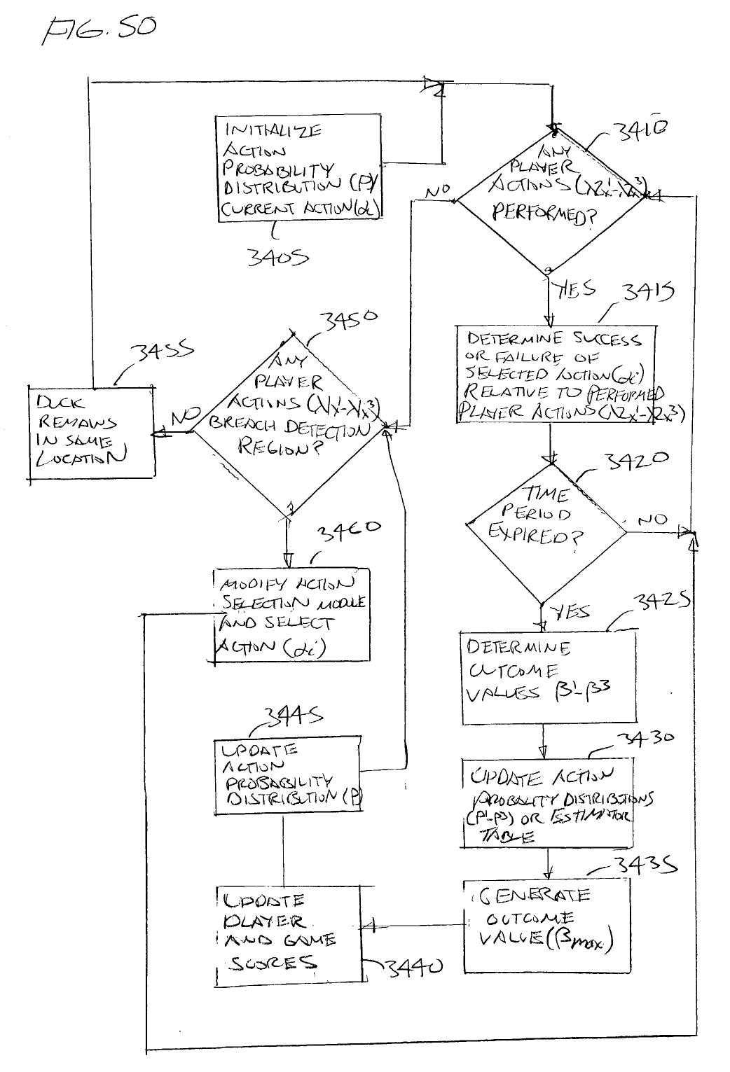

Having now generally described the components and functionality of the learning program 3200, we now describe one of its various applications. Referring to FIG. 49, a multiple-player learning software game program 3300 developed in accordance with the present inventions is described in the context of the previously described duck hunting game 700 (see FIG. 13). Because the game program 3300 will determine the success or failure of a selected game action based on the player actions as a group, in this version of the duck hunting game 700, the players 715(1)-(3) play against the duck 720 as a team, such that there is only one player score 760 and duck score 765 that is identically displayed on all three computers 760(1)-(3).

The game program 3300 generally includes a probabilistic learning module 3310 and an intuition module 3315, which are specifically tailored for the game 700. The probabilistic learning module 3310 comprises a probability update module 3320, an action selection module 3325, and an outcome evaluation module 3330, which are similar to the previously described probability update module 2620, action selection module 2625, and outcome evaluation module 2630, with the exception that it does not operate on the player actions λ2ₓ¹-λ2ₓ³ as a vector, but rather generates multiple outcome values β¹-β³ for the player actions λ2ₓ¹-λ2ₓ³, determines the program action αᵢ that is the most successful out of program action set α for the maximum number of players 715(1)-(3), and then generates an outcome value βₘₐₓ.

As previously discussed, the action probability distribution p is updated periodically, e.g., every second, during which each of any number of the players 715(1)-(3) may provide a corresponding number of player actions λ2ₓ¹-λ2ₓ³, so that the player actions λ2ₓ¹-λₓ³ asynchronously performed by the players 715(1)-(3) may be synchronized to a time period. It should be noted that in other types of games, where the player actions λ2ₓ need not be synchronized to a time period, such as, e.g., strategy games, the action probability distribution p may be updated after all players have performed a player action λ2ₓ.

The game program 3300 may employ the following P-type Maximum Number of Teachers Approving (MNTA) SISO equations:

$$\begin{matrix}{p}_{i} ( k + 1 ) = {p}_{i} ( k ) + {\sum }_{{j = 1}_{j \neq i }}^{n} {g}_{j} ( p ( k ) ) ; and & [ 26 ] \\ {p}_{j} ( k + 1 ) = {p}_{j} ( k ) - {g}_{j} ( p ( k ) ) , when {β}_{max} ( k ) = 1 and {α}_{i} is selected & [ 27 ] \\ {p}_{i} ( k + 1 ) = {p}_{i} ( k ) - {\sum }_{{j = 1}_{j \neq i }}^{n} {h}_{j} ( p ( k ) ) ; and & [ 28 ] \\ {p}_{j} ( k + 1 ) = {p}_{j} ( k ) + {h}_{j} ( p ( k ) ) , when {β}_{max} ( k ) = 0 and {α}_{i} is selected & [ 29 ]\end{matrix}$$

where

pᵢ(k+1), pᵢ(k), gⱼ(p(k)), hⱼ(p(k)), i,j, k, and n have been previously defined, and βₘₐₓ(k) is the outcome value based on a maximum number of the players for which the selected action αᵢ is successful.

The game action αᵢ that is the most successful for the maximum number of players can be determined based on a cumulative success/failure analysis of the duck hits and misses relative to all of the game action αᵢ as derived from action probability distributions p maintained for each of the players, or from the previously described estimator table. As an example, assuming the game action α₄ was selected and there are a total of ten players, if game action α₄ is the most successful for four of the players, game action α₁ is the most successful for three of the players, game action α₇ is the most successful for two of the players, and game action α₄ is the most successful for one of the players, βₘₐₓ(k)=1, since the game action α₄ is the most successful for the maximum number (four) of players. If, however, game action α₄ is the most successful for two of the players, game action α₁ is the most successful for three of the players, game action α₇ is the most successful for four of the players, and game action α₄ is the most successful for one of the players, βₘₐₓ(k)=0, since the game action α₄ is not the most successful for the maximum number of players.

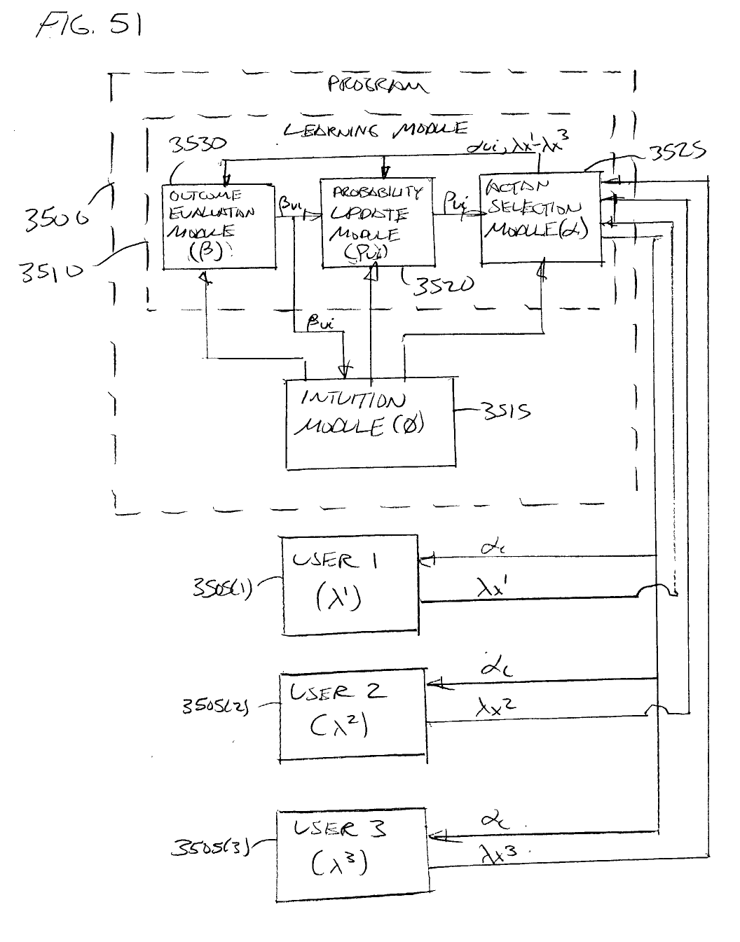

Having now described the structure of the game program 3300, the steps performed by the game program 3300 will be described with reference to FIG. 50. First, the probability update module 3320 initializes the action probability distribution p and current action αᵢ (step 3405) similarly to that described in step 405 of FIG. 9. Then, the action selection module 3325 determines whether any of the player actions λ2ₓ¹-λ2ₓ³ have been performed, and specifically whether the guns 725(1)-(3) have been fired (step 3410). If any of the player actions λ2ₓ¹-λ2ₓ³ have been performed, the outcome evaluation module 3330 determines the success or failure of the currently selected game action αᵢ relative to the performed ones of the player actions λ2ₓ¹-λ2ₓ³ (step 3415). The intuition module 3315 then determines if the given time period to which the player actions λ2ₓ¹-λ2ₓ³ are synchronized has expired (step 3420). If the time period has not expired, the game program 3300 will return to step 3410 where the action selection module 3325 determines again if any of the player actions λ2ₓ¹-λ2ₓ³ have been performed. If the time period has expired, the outcome evaluation module 3330 determines the outcome values β¹-β³ for the performed one of the player actions λ2ₓ¹-λ2ₓ³ (step 3425). The probability update module 3320 then updates the action probability distributions p¹-p³ for the players 3305(1)-(3) or updates the estimator table (step 3430). The outcome evaluation module 3330 then determines the most successful game action αᵢ for each of the players 3305 (based on the separate probability distributions p¹-p³ or estimator table), and then generates the outcome value βₘₐₓ (step 3435). The intuition module 3315 then updates the combined player score 760 and duck scores 765 based on the separate outcome values β¹-β³ (step 3440). The probability update module 3320 then, using the MNTA SISO equations [26]-[29], updates the action probability distribution p based on the generated outcome value βₘₐₓ (step 3445).

After step 3445, or if none of the player actions λ2ₓ¹-λ2ₓ³ has been performed at step 3410, the action selection module 3325 determines if any of the player actions λ1ₓ¹-λ1ₓ³ have been performed, i.e., guns 725(1)-(3), have breached the gun detection region 270 (step 3450). If none of the guns 725(1)-(3) has breached the gun detection region 270, the action selection module 3325 does not select a game action αᵢ from the game action set α and the duck 720 remains in the same location (step 3455). Alternatively, the game action αᵢ may be randomly selected, allowing the duck 720 to dynamically wander. The game program 3300 then returns to step 3410 where it is again determined if any of the player actions λ1ₓ¹-λ1ₓ³ have been performed. If any of the guns 725(1)-(3) have breached the gun detection region 270 at step 3450, the intuition module 3315 may modify the functionality of the action selection module 3325 based on the performance index φ, and the action selection module 3325 selects a game action αᵢ from the game action set α in the manner previously described with respect to steps 440-470 of FIG. 9 (step 3460). It should be noted that, rather than use the action subset selection technique, other afore-described techniques used to dynamically and continuously match the skill level of the players 715(1)-(3) with the skill level of the game 700, such as that illustrated in FIG. 10, can be alternatively or optionally be used as well in the game program 3300. Also, the intuition module 3315 may modify the functionality of the outcome evaluation module 3330 by changing the most successful game action to the least or average successful αᵢ for each of the players 3305.

Generalized Multi-User Learning Program (Single Processor Action-Teacher Action Pair)

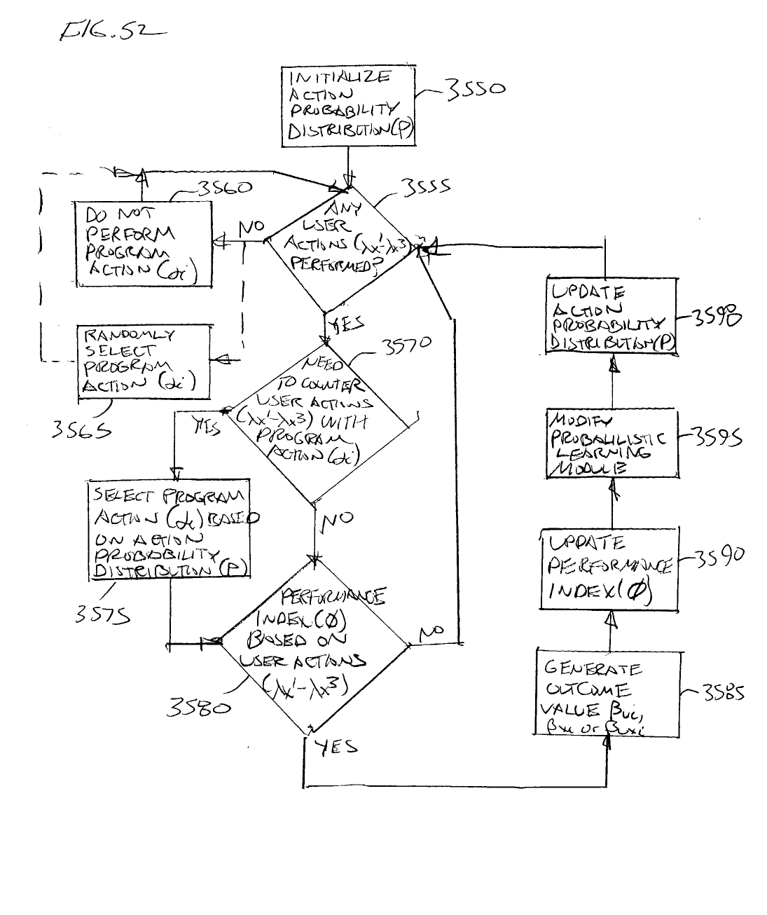

Referring to FIG. 51, still another multi-user learning program 3500 developed in accordance with the present inventions can be generally implemented to provide intuitive learning capability to any variety of processing devices. Unlike the previous embodiments, the learning program 3500 may link program actions with user parameters (such as, e.g., users or user actions) to generate action pairs, or trios or higher numbered groupings.

The learning program 3500 is similar to the SIMO-based program 600 in that multiple users 3505(1)-(3) (here, three) interact with the program 3500 by receiving the same program action αᵢ from a program action set α within the program 3500, each independently selecting corresponding user actions λₓ¹-λₓ³ from respective user action sets λ¹-λ³ based on the received program action αᵢ. Again, in alternative embodiments, the users 3505 need not receive the program action αᵢ, the selected user actions λₓ¹-λₓ³ need not be based on the received program action αᵢ, and/or the program actions αᵢ may be selected in response to the selected user actions λₓ¹-λₓ³. The significance is that a program action αᵢ and user actions λₓ¹-λₓ³ are selected.

The program 3500 is capable of learning based on the measured success or failure of combination of user/program action pairs αᵤᵢ, which for the purposes of this specification, can be measured as outcome values βᵤᵢ, where u is the index for a specific user 3505, and i is the index for the specific program action αᵢ. For example, if the program action set α includes seventeen program actions aᵢ, than the number of user/program action pairs αᵤᵢ will equal fifty-one (three users 3505 multiplied by seventeen program actions αᵢ). As an example, if selected program action α₈ is successful relative to a user action λₓ selected by the second user 3505(2), then β_{2,8} may equal “1” (indicating a success), and if program action α₈ is not successful relative to a user action λₓ selected by the second user 3505(2), then β_{2,8} may equal “0” (indicating a failure).

It should be noted that other action pairs are contemplated. For example, instead of linking the users 3505 with the program actions αᵢ, the user actions λₓ can be linked to the program actions αᵢ, to generate user action/program action pairs αₓᵢ, which again can be measured as outcome values βₓᵢ, where i is the index for the selected action αᵢ, and x is the index for the selected action λₓ. For example, if the program action set α includes seventeen program actions αᵢ, and the user action set λ includes ten user actions λₓ, than the number of user action/program action pairs αₓᵢ will equal one hundred seventy (ten user actions λₓ multiplied by seventeen program actions αᵢ). As an example, if selected program action α₁₂ is successful relative to user action λ₆ selected by a user 3505 (either a single user or one of a multiple of users), then β_{6,12} may equal “1” (indicating a success), and if selected program action α₁₂ is not successful relative to user action λ₆ selected by a user 3505, then β_{6,12} may equal “0” (indicating a failure).

As another example, the users 3505, user actions λₓ, and program actions αᵢ, can be linked together to generate user/user action/program action trios αᵤₓᵢ, which can be measured as outcome values βᵤₓᵢ, where u is the index for the user 3505, i is the index for the selected action αᵢ, and x is the index for the selected user action λₓ. For example, if the program action set α includes seventeen program actions αᵢ, and the user action set λ includes ten user actions λₓ, than the number of user/user action/program action trios αᵤₓᵢ will equal five hundred ten (three users 3505 multiplied by ten user actions λₓ multiplied by seventeen program actions αᵢ). As an example, if selected program action α₁₂ is successful relative to user action λ₆ selected by the third user 3505(3) (either a single user or one of a multiple of users), then β_{3,6,12} may equal “1” (indicating a success), and if selected program action α₁₂ is not successful relative to user action λ₆ selected by the third user 3505(3), then β_{3,6,12} may equal “0” (indicating a failure).

It should be noted that the program 3500 can advantageously make use of estimator tables should the number of program action pairs or trio become too numerous. The estimator table will keep track of the number of successes and failures for each of the action pairs or trios. In this manner, the processing required for the many program actions pairs or trios can be minimized. The action probability distribution p can then be periodically updated based on the estimator table.

To this end, the program 3500 generally includes a probabilistic learning module 3510 and an intuition module 3515. The probabilistic learning module 3510 includes a probability update module 3520, an action selection module 3525, and an outcome evaluation module 3530. Briefly, the probability update module 3520 uses learning automata theory as its learning mechanism, and is configured to generate and update an action probability distribution p containing probability values (either pᵤᵢ or pₓᵢ or pᵤₓᵢ) based on the outcome values βᵤᵢ or βₓᵢ in the case of action pairs, or based on outcome values βᵤₓᵢ, in the case of action trios. In this scenario, the probability update module 3520 uses a single stochastic learning automaton with a single input to a single-teacher environment (with the users 3505(1)-(3), in combination, as a single teacher), or alternatively, a single stochastic learning automaton with a single input to a single-teacher environment with multiple outputs that are treated as a single output), and thus, a SISO model is assumed. The significance is that the user actions, program actions, and/or the users are linked to generate action pairs or trios, each of which can be quantified by a single outcome value β. Exemplary equations that can be used for the SISO model will be described in further detail below.

The action selection module 3525 is configured to select the program action αᵢ from the program action set α based on the probability values (either pᵤᵢ or pₓᵢ or pᵤₓᵢ) contained within the action probability distribution p internally generated and updated in the probability update module 3520. The outcome evaluation module 3530 is configured to determine and generate the outcome value β (either βᵤᵢ or βₓᵢ or βᵤₓᵢ) based on the relationship between the selected program action αᵢ and the selected user action λₓ. The intuition module 3515 modifies the probabilistic learning module 3510 (e.g., selecting or modifying parameters of algorithms used in learning module 3510) based on one or more generated performance indexes φ to achieve one or more objectives. As previously discussed, the performance index φ can be generated directly from the outcome value β or from something dependent on the outcome value β, e.g., the action probability distribution p, in which case the performance index φ may be a function of the action probability distribution p, or the action probability distribution p may be used as the performance index φ. Alternatively, the intuition module 3515 may be non-existent, or may desire not to modify the probability learning module 3510 depending on the objective of the program 3500.

The modification of the probabilistic learning module 3510 is generally accomplished similarly to that described with respect to the afore-described probabilistic learning module 110. That is, the functionalities of (1) the probability update module 3520 (e.g., by selecting from a plurality of algorithms used by the probability update module 3520, modifying one or more parameters within an algorithm used by the probability update module 3520, transforming or otherwise modifying the action probability distribution p); (2) the action selection module 3525 (e.g., limiting or expanding selection of the action αᵢ corresponding to a subset of probability values contained within the action probability distribution p); and/or (3) the outcome evaluation module 3530 (e.g., modifying the nature of the outcome value β or otherwise the algorithms used to determine the outcome values β, are modified.

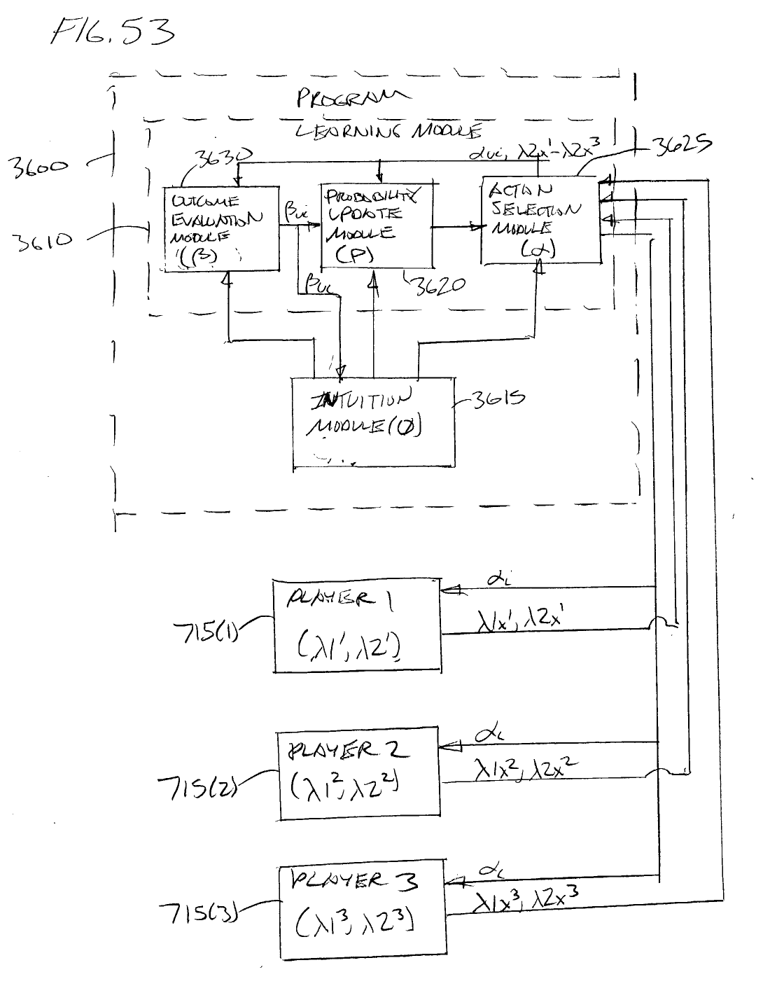

The various different types of learning methodologies previously described herein can be applied to the probabilistic learning module 3510. The operation of the program 3500 is similar to that of the program 600 described with respect to FIG. 12, with the exception that the program 3500 treats an action pair or trio as an action. Specifically, referring to FIG. 52, the probability update module 3520 initializes the action probability distribution p (step 3550) similarly to that described with respect to step 150 of FIG. 4. The action selection module 3525 then determines if one or more of the user actions λₓ¹-λₓ³ have been selected by the users 3505(1)-(3) from the respective user action sets λ¹-λ³ (step 3555). If not, the program 3500 does not select a program action αᵢ from the program action set α (step 3560), or alternatively selects a program action αᵢ, e.g., randomly, notwithstanding that none of the user actions λₓ¹-λₓ³ has been selected (step 3565), and then returns to step 3555 where it again determines if one or more of the user actions λₓ¹-λₓ³ have been selected. If one or more of the user actions λₓ¹-λₓ³ have been performed at step 3555, the action selection module 3525 determines the nature of the selected ones of the user actions λₓ¹-λₓ³.

Specifically, the action selection module 3525 determines whether any of the selected ones of the user actions λₓ¹-λₓ³ are of the type that should be countered with a program action αᵢ (step 3570). If so, the action selection module 3525 selects a program action αᵢ from the program action set α based on the action probability distribution p (step 3575). The probability values pᵤᵢ within the action probability distribution p will correspond to the user/program action pairs αᵤᵢ. Alternatively, an action probability distribution p containing probability values pᵤₓᵢ corresponding to user/user action/program action trios αᵤₓᵢ can be used, or in the case of a single user, probability values pₓᵢ corresponding to user action/program action pairs aₓᵢ. After the performance of step 3575, or if the action selection module 3525 determines that none of the selected user actions λₓ¹-λₓ³ is of the type that should be countered with a program action αᵢ, the action selection module 3525 determines if any of the selected user actions λₓ¹-λₓ³ are of the type that the performance index φ is based on (step 3580).

If not, the program 3500 returns to step 3555 to determine again whether any of the user actions λₓ¹-λₓ³ have been selected. If so, the outcome evaluation module 3530 quantifies the performance of the previously selected program action αᵢ relative to the currently selected user actions λₓ¹-λₓ³ by generating outcome values β(βᵤᵢ, βₓᵢ or βᵤₓᵢ) (step 3585). The intuition module 3515 then updates the performance index φ based on the outcome values β unless the performance index φ is an instantaneous performance index that is represented by the outcome values β themselves (step 3590), and modifies the probabilistic learning module 3510 by modifying the functionalities of the probability update module 3520, action selection module 3525, or outcome evaluation module 3530 (step 3595). The probability update module 3520 then, using any of the updating techniques described herein, updates the action probability distribution p based on the generated outcome values β (step 3598).

The program 3500 then returns to step 3555 to determine again whether any of the user actions λₓ¹-λₓ³ have been selected. It should be noted that the order of the steps described in FIG. 52 may vary depending on the specific application of the program 3500.

Multi-Player Learning Game Program (Single Game Action-Teacher Action Pair)

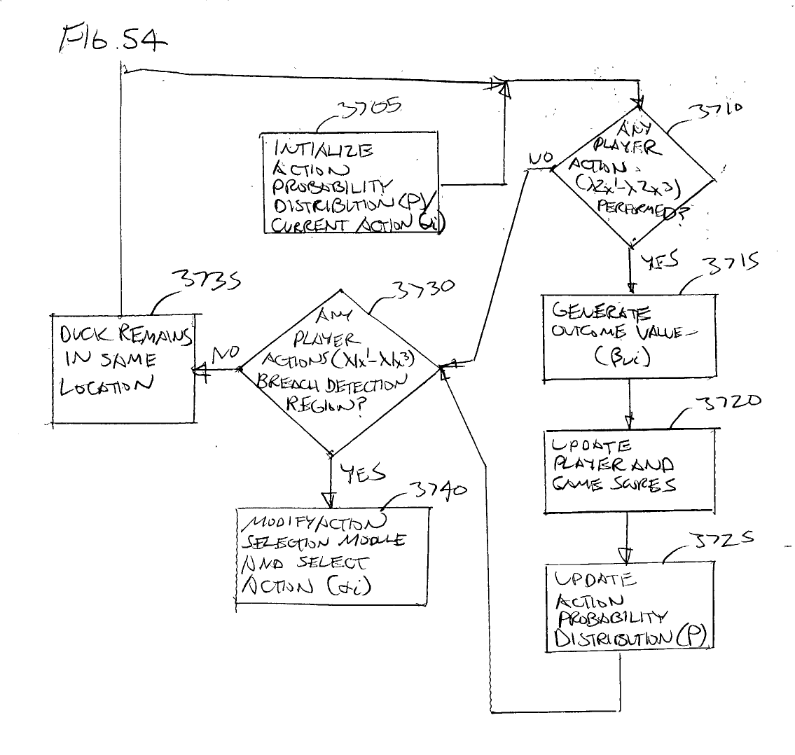

Having now generally described the components and functionality of the learning program 3500, we now describe one of its various applications. Referring to FIG. 53, a multiple-player learning software game program 3600 developed in accordance with the present inventions is described in the context of the previously described duck hunting game 700 (see FIG. 13).

The game program 3600 generally includes a probabilistic learning module 3610 and an intuition module 3615, which are specifically tailored for the game 700. The probabilistic learning module 3610 comprises a probability update module 3620, an action selection module 3625, and an outcome evaluation module 3630 that are similar to the previously described probability update module 820, action selection module 825, and outcome evaluation module 830, with the exception that the probability update module 3620 updates probability values corresponding to player/program action pairs, rather than single program actions. The action probability distribution p that the probability update module 3620 generates and updates can be represented by the following equation:

p(k)=[p_{1,1}(k), p_{1,2}(k), p_{1,3}(k) . . . p_{2,1}(k), p_{2,2}(k), p_{2,3}(k) . . . pₘₙ(k)], [30]

where

pᵤᵢ is the action probability value assigned to a specific player/program action pair aᵤᵢ; m is the number of players; n is the number of program actions αᵢ within the program action set α, and k is the incremental time at which the action probability distribution was updated.

The game program 3600 may employ the following P-type Teacher Action Pair (TAP) SISO equations:

$$\begin{matrix}{p}_{ui} ( k + 1 ) = {p}_{ui} ( k ) + {\sum }_{{t , s = 1 , 1}_{t , s \neq u , i }}^{n , m} {g}_{ts} ( p ( k ) ) ; if α ( k ) = {α}_{ui} and {β}_{ui} ( k ) = 1 & [ 31 ] \\ {p}_{ui} ( k + 1 ) = {p}_{ui} ( k ) - {g}_{ui} ( p ( k ) ) , if α ( k ) \neq {α}_{ui} and {β}_{ui} ( k ) = 1 & [ 32 ] \\ {p}_{ui} ( k + 1 ) = {p}_{ui} ( k ) - {\sum }_{{t , s = 1 , 1}_{t , s \neq u , i }}^{n , m} {h}_{ts} ( p ( k ) ) ; if α ( k ) = {α}_{ui} and {β}_{ui} ( k ) = 0 & [ 33 ] \\ {p}_{ui} ( k + 1 ) = {p}_{ui} ( k ) + {h}_{ui} ( p ( k ) ) , if α ( k ) \neq {α}_{ui} and {β}_{ui} ( k ) = 0 & [ 34 ]\end{matrix}$$

where

pᵤᵢ(k+1) and pᵤᵢ(k), m, and n have been previously defined, gᵤᵢ(p(k)) and hᵤᵢ(p(k)) are respective reward and penalty functions, u is an index for the player, i is an index for the currently selected program action αᵢ, and βᵤᵢ(k) is the outcome value based on a selected program action αᵢrelative to a user action λₓ selected by the player.

As an example, if there are a total of three players and ten actions, the action probability distribution p will have probability values pᵤᵢ corresponding to player/action pairs αᵤᵢ, as set forth in Table 10.

TABLE 10
Probability Values for Player/Action
Pairs Given Ten Actions and Three Players

| | α₁ | α₂ | α₃ | α₄ | α₅ | α₆ | α₇ | α₈ | α₉ | α₁₀ |
|---|---|---|---|---|---|---|---|---|---|---|
| P1 | p_{1,1} | p_{1,2} | p_{1,3} | p_{1,4} | p_{1,5} | p_{1,6} | p_{1,7} | p_{1,8} | p_{1,9} | p_{1,10} |
| P2 | p_{2,1} | p_{2,2} | p_{2,3} | p_{2,4} | p_{2,5} | p_{2,6} | p_{2,7} | p_{2,8} | p_{2,9} | p_{2,10} |
| P3 | p_{3,1} | p_{3,2} | p_{3,3} | p_{3,4} | p_{3,5} | p_{3,6} | p_{3,7} | p_{3,8} | p_{3,9} | p_{3,10} |

Having now described the structure of the game program 3600, the steps performed by the game program 3600 will be described with reference to FIG. 54. First, the probability update module 3620 initializes the action probability distribution p and current action αᵢ (step 3705) similarly to that described in step 405 of FIG. 9. Then, the action selection module 3625 determines whether one of the player actions λ2ₓ¹-λ2ₓ³ has been performed, and specifically whether one of the guns 725(1)-(3) has been fired (step 3710). If one of the player actions λ2ₓ¹-λ2ₓ³ has been performed, the outcome evaluation module 3630 generates the corresponding outcome value βᵤᵢ for the performed one of the player actions λ2ₓ¹-λ2ₓ³ (step 3715), and the intuition module 3615 then updates the corresponding one of the player scores 760(1)-(3) and duck scores 765(1)-(3) based on the outcome value βᵤᵢ (step 3720), similarly to that described in steps 415 and 420 of FIG. 9. The probability update module 3620 then, using the TAP SISO equations [31]-[34], updates the action probability distribution p based on the generated outcome value βᵤᵢ (step 3725).

After step 3725, or if none of the player actions λ2ₓ¹-λ2ₓ³ has been performed at step 3710, the action selection module 3625 determines if any of the player actions λ1ₓ¹-λ1ₓ³ have been performed, i.e., guns 725(1)-(3), have breached the gun detection region 270 (step 3730). If none of the guns 725(1)-(3) has breached the gun detection region 270, the action selection module 3625 does not select a game action αᵢ from the game action set α and the duck 720 remains in the same location (step 3735). Alternatively, the game action αᵢ may be randomly selected, allowing the duck 720 to dynamically wander. The game program 3600 then returns to step 3710 where it is again determined if any of the player actions λ1ₓ¹-λ1ₓ³ has been performed. If any of the guns 725(1)-(3) have breached the gun detection region 270 at step 3730, the intuition module 3615 modifies the functionality of the action selection module 3625 based on the performance index φ, and the action selection module 3625 selects a game action αᵢ from the game action set α in the manner previously described with respect to steps 440-470 of FIG. 9 (step 3740). It should be noted that, rather than use the action subset selection technique, other afore-described techniques used to dynamically and continuously match the skill level of the players 715(1)-(3) with the skill level of the game 700, such as that illustrated in FIG. 10, can be alternatively or optionally be used as well in the game program 2600.

Single-User Learning Phone Number Listing Program

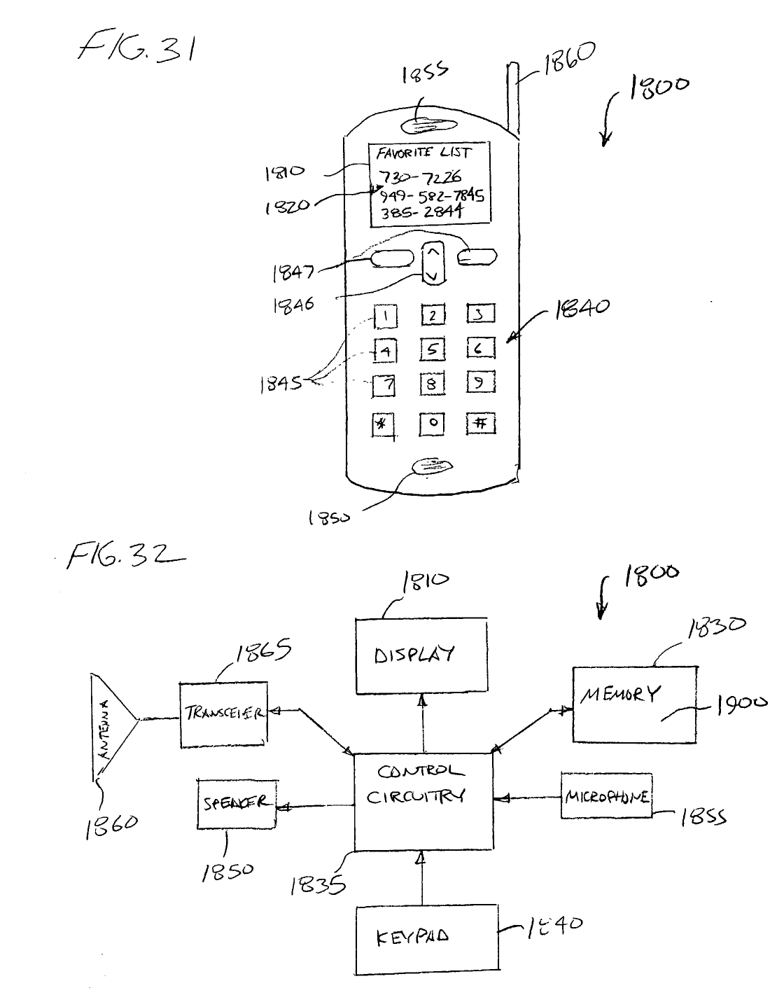

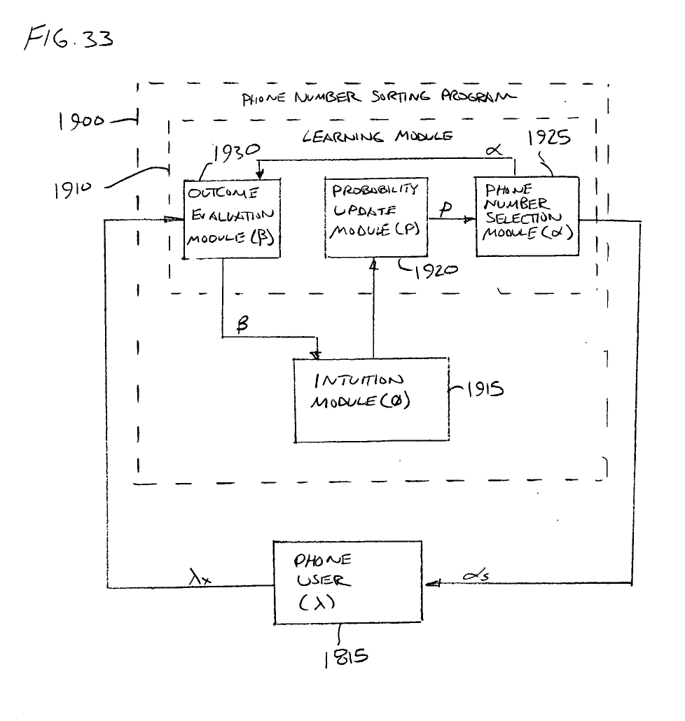

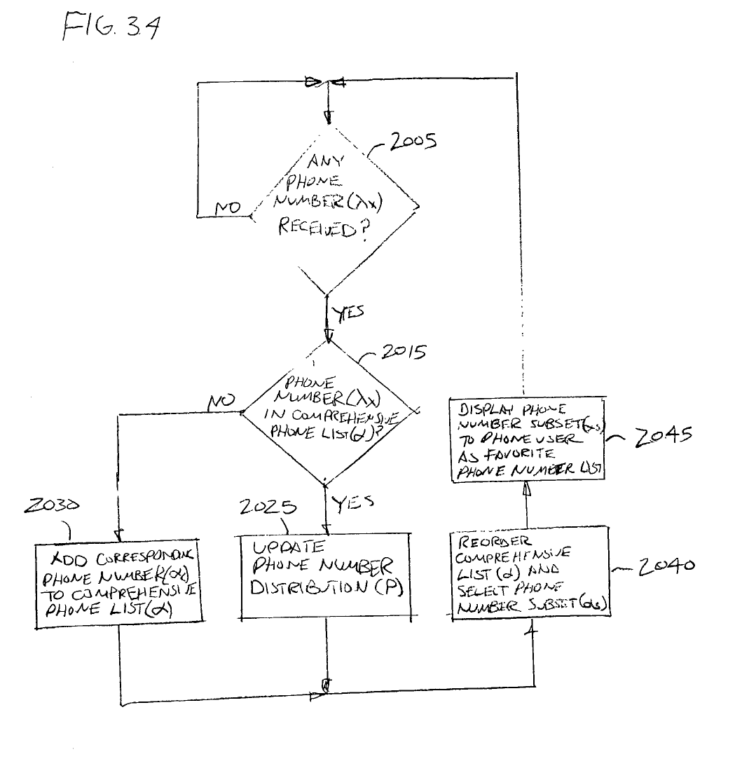

Although game applications have only been described in detail so far, the learning program 100 can have other applications. For example, referring to FIGS. 31 and 32, a priority listing program 1900 (shown in FIG. 33) developed in accordance with the present inventions is described in the context of a mobile phone 1800. The mobile phone 1800 comprises a display 1810 for displaying various items to a phone user 1815 (shown in FIG. 33). The mobile phone 1800 further comprises a keypad 1840 through which the phone user 1815 can dial phone numbers and program the functions of the mobile phone 1800. To the end, the keypad 1840 includes number keys 1845, a scroll key 1846, and selection keys 1847. The mobile phone 1800 further includes a speaker 1850, microphone 1855, and antenna 1860 through which the phone user 1815 can wirelessly carry on a conversation. The mobile phone 1800 further includes control circuitry 1835, memory 1830, and a transceiver 1865. The control circuitry 1835 controls the transmission and reception of call and voice signals. During a transmission mode, the control circuitry 1835 provides a voice signal from the microphone 1855 to the transceiver 1865. The transceiver 1865 transmits the voice signal to a remote station (not shown) for communication through the antenna 1860. During a receiving mode, the transceiver 1865 receives a voice signal from the remote station through the antenna 1860. The control circuitry 1835 then provides the received voice signal from the transceiver 1865 to the speaker 1850, which provides audible signals for the phone user 1815. The memory 1830 stores programs that are executed by the control circuitry 1835 for basic functioning of the mobile phone 1800. In many respects, these elements are standard in the industry, and therefore their general structure and operation will not be discussed in detail for purposes of brevity.

In addition to the standard features that typical mobile phones have, however, the mobile phone 1800 displays a favorite phone number list 1820 from which the phone user 1815 can select a phone number using the scroll and select buttons 1846 and 1847 on the keypad 1840. In the illustrated embodiment, the favorite phone number list 1820 has six phone numbers 1820 at any given time, which can be displayed to the phone user 1815 respective sets of two and four numbers. It should be noted, however, that the total number of phone numbers with the list 1820 may vary and can be displayed to the phone user 1815 in any variety of manners.

The priority listing program 1900, which is stored in the memory 1830 and executed by the control circuitry 1835, dynamically updates the telephone number list 1820 based on the phone user's 1815 current calling habits. For example, the program 1900 maintains the favorite phone number list 1820 based on the number of times a phone number has been called, the recent activity of the called phone number, and the time period (e.g., day, evening, weekend, weekday) in which the phone number has been called, such that the favorite telephone number list 1820 will likely contain a phone number that the phone user 1815 is anticipated to call at any given time. As will be described in further detail below, the listing program 1900 uses the existence or non-existence of a currently called phone number on a comprehensive phone number list as a performance index φ in measuring its performance in relation to its objective of ensuring that the favorite phone number list 1820 will include future called phone numbers, so that the phone user 1815 is not required to dial the phone number using the number keys 1845. In this regard, it can be said that the performance index φ is instantaneous. Alternatively or optionally, the listing program 1900 can also use the location of the phone number in the comprehensive phone number list as a performance index φ.

Referring now to FIG. 33, the listing program 1900 generally includes a probabilistic learning module 1910 and an intuition module 1915, which are specifically tailored for the mobile phone 1800. The probabilistic learning module 1910 comprises a probability update module 1920, a phone number selection module 1925, and an outcome evaluation module 1930. Specifically, the probability update module 1920 is mainly responsible for learning the phone user's 1815 calling habits and updating a comprehensive phone number list a that places phone numbers in the order that they are likely to be called in the future during any given time period. The outcome evaluation module 1930 is responsible for evaluating the comprehensive phone number list a relative to current phone numbers λₓ called by the phone user 1815. The phone number selection module 1925 is mainly responsible for selecting a phone number subset αₛ from the comprehensive phone number list α for eventual display to the phone user 1815 as the favorite phone number list 1820. The intuition module 1915 is responsible for directing the learning of the listing program 1900 towards the objective, and specifically, displaying the favorite phone number list 1820 that is likely to include the phone user's 1815 next called phone number. In this case, the intuition module 1915 operates on the probability update module 1920, the details of which will be described in further detail below.

To this end, the phone number selection module 1925 is configured to receive a phone number probability distribution p from the probability update module 1920, which is similar to equation [1] and can be represented by the following equation:

p(k)=[p₁(k), p₂(k), p₃(k) . . . pₙ(k)], [1-2]

where

pᵢ is the probability value assigned to a specific phone number αᵢ; n is the number of phone numbers aᵢ within the comprehensive phone number list α, and k is the incremental time at which the action probability distribution was updated.

Based on the phone number probability distribution p, the phone number selection module 1925 generates the comprehensive phone number list α, which contains the listed phone numbers αᵢ ordered in accordance with their associated probability values pᵢ. For example, the first listed phone number αᵢ will be associated with the highest probability value pᵢ, while the last listed phone number αᵢ will be associated with the lowest probability value pᵢ. Thus, the comprehensive phone number list α contains all phone numbers ever called by the phone user 1815 and is unlimited. Optionally, the comprehensive phone number list α can contain a limited amount of phone numbers, e.g., 100, so that the memory 1830 is not overwhelmed by seldom called phone numbers. In this case, seldom called phone numbers αᵢ may eventually drop of the comprehensive phone number list α.

It should be noted that a comprehensive phone number list α separate from the phone number probability distribution p, but rather the phone number probability distribution p can be used as the comprehensive phone number list α to the extent that it contains a comprehensive list of all of the called phone numbers. However, it is conceptually easier to explain the aspects of the listing program 1900 in the context of a comprehensive phone number list that is ordered in accordance with the corresponding probability values pᵢ, rather than in accordance with the order in which they are listed in the phone number probability distribution p.

From the comprehensive phone number list α, the phone number selection module 1925 selects the phone number subset αₛ (in the illustrated embodiment, six phone numbers αᵢ) that will be displayed to the phone user 1815 as the favorite phone number list 1820. In the preferred embodiment, the selected phone number subset αₛ will contain those phone numbers αᵢ that correspond to the highest probability values pᵢ, i.e., the top six phone numbers αᵢ in the comprehensive phone number list α.

As an example, consider Table 11, which sets forth in exemplary comprehensive phone number list α with associated probability values pᵢ.

TABLE 11
Exemplary Probability Values for
Comprehensive Phone Number List

| Number | Listed Phone Numbers (αᵢ) | Probability Values (pᵢ) |
|---|---|---|
| 1 | 949-339-2932 | 0.253 |
| 2 | 343-3985 | 0.183 |
| 3 | 239-3208 | 0.128 |
| 4 | 239-2908 | 0.102 |
| 5 | 343-1098 | 0.109 |
| 6 | 349-0085 | 0.073 |
| 7 | 239-3833 | 0.053 |
| 8 | 239-4043 | 0.038 |
| . | . | . |
| . | . | . |
| . | . | . |
| 96 | 213-483-3343 | 0.009 |
| 97 | 383-303-3838 | 0.007 |
| 98 | 808-483-3984 | 0.007 |
| 99 | 398-3838 | 0.005 |
| 100 | 239-3409 | 0.002 |

In this exemplary case, phone numbers 949-339-2932, 343-3985, 239-3208, 239-2908, 343-1098, and 349-0085 will be selected as the favorite phone number list 1220, since that are ed with the top six probability values pᵢ.

The outcome evaluation module 1930 is configured to receive a called phone number λₓ from the phone user 1815 via the keypad 1840. For example, the phone user 1815 can dial the phone number λₓ using the number keys 1845 of the keypad 1840, selecting the phone number λₓ from the favorite phone number list 1820 by operating the scroll and selection keys 1846 and 1847 of the keypad 1840, or through any other means. In this embodiment, the phone number λₓ can be selected from a virtual infinite set of phone numbers λ, i.e., all valid phone numbers that can be called by the mobile phone 1800. The outcome evaluation module 1930 is further configured to determine and output an outcome value β that indicates if the currently called phone number λₓ is on the comprehensive phone number list α. In the illustrated embodiment, the outcome value β equals one of two predetermined values: “1” if the currently called phone number λₓ is on the comprehensive phone number list α, and “0” if the currently called phone number λₓ is not on the comprehensive phone number list α.

It can be appreciated that unlike in the duck game 300 where the outcome value β is partially based on the selected game action αᵢ, the outcome value β is technically not based on listed phone numbers αᵢ selected by the phone number selection module 1925, i.e., the phone number subset αₛ, but rather whether a called phone number λₓ is on the comprehensive phone number list α irrespective of whether it is in the phone number subset αₛ. It should be noted, however, that the outcome value β can optionally or alternatively be partially based on the selected phone number subset αₛ, as will be described in further detail below.

The intuition module 1915 is configured to receive the outcome value β from the outcome evaluation module 1930 and modify the probability update module 1920, and specifically, the phone number probability distribution p, based thereon. Specifically, if the outcome value β equals “0,” indicating that the currently called phone number λₓ was not found in the comprehensive phone number list α, the intuition module 1915 adds the called phone number λₓ to the comprehensive phone number list α as a listed phone number αᵢ.

The called phone number λₓ can be added to the comprehensive phone number list α in a variety of ways. In general, the location of the added phone number αᵢ within the comprehensive phone number list α depends on the probability value pᵢ assigned or some function of the probability value pᵢ assigned.

For example, in the case, where the number of phone numbers αᵢ is not limited, or the number of phone numbers αᵢ has not reached its limit, the called phone number λₓ may be added by assigning a probability value pᵢ to it and renormalizing the phone number probability distribution p in accordance with the following equations:

pᵢ(k+1)=f(x); [35]

pⱼ(k+1)=pⱼ(k)(1−f(x)); j≈i [36]

where

i is the added index corresponding to the newly added phone number α₁, pᵢ is the probability value corresponding to phone number αᵢ, added to the comprehensive phone number list α, f(x) is the probability value pᵢ assigned to the newly added phone number αᵢ, pⱼ is each probability value corresponding to the remaining phone numbers αⱼ in the comprehensive phone number list α, and k is the incremental time at which the action probability distribution was updated.

In the illustrated embodiment, the probability value pᵢ assigned to the added phone number αᵢ is simply the inverse of the number of phone numbers αᵢ in the comprehensive phone number list α, and thus f(x) equals 1/(n+1), where n is the number of phone numbers in the comprehensive phone number list α prior to adding the phone number αᵢ. Thus, equations [35] and [36] break down to:

$$\begin{matrix}{p}_{i} ( k + 1 ) = \frac{1}{n + 1} ; & \text{[35-1]} \\ {p}_{j} ( k + 1 ) = {p}_{j} ( k ) \frac{1}{n + 1} ; j \neq i & \text{[36-1]}\end{matrix}$$

In the case, where the number of phone numbers αᵢ is limited and the number of phone numbers αᵢ has reached its limit, the phone number α with the lowest corresponding priority value pᵢ is replaced with the newly called phone number λₓ by assigning a probability value pᵢ to it and renormalizing the phone number probability distribution p in accordance with the following equations:

$$\begin{matrix}{p}_{i} ( k + 1 ) = f ( x ) ; & [ 37 ] \\ {p}_{j} ( k + 1 ) = \frac{{p}_{j} ( k )}{{\sum }_{j \neq i}^{n} {p}_{j} ( k )} ( 1 - f ( x ) ) ; j \neq i & [ 38 ]\end{matrix}$$

where

i is the index used by the removed phone number αᵢ, pᵢ is the probability value corresponding to phone number αᵢ added to the comprehensive phone number list α, f(x) is the probability value pₘ assigned to the newly added phone number αᵢ, pⱼ is each probability value corresponding to the remaining phone numbers αⱼ in the comprehensive phone number list α, and k is the incremental time at which the action probability distribution was updated.

As previously stated, in the illustrated embodiment, the probability value pᵢ assigned to the added phone number αᵢ is simply the inverse of the number of phone numbers αᵢ in the comprehensive phone number list α, and thus f(x) equals 1/n, where n is the number of phone numbers in the comprehensive phone number list α. Thus, equations [35] and [36] break down to:

$$\begin{matrix}{p}_{i} ( k + 1 ) = \frac{1}{n} ; & \text{[35-1]} \\ {p}_{j} ( k + 1 ) = \frac{{p}_{j} ( k ) }{{\sum }_{j \neq 1}^{n} {p}_{j} ( k )} ( \frac{n - 1}{n} ) ; j \neq i & \text{[36-1]}\end{matrix}$$

It should be appreciated that the speed in which the automaton learns can be controlled by adding the phone number αᵢ to specific locations within the phone number probability distribution p. For example, the probability value pᵢ assigned to the added phone number αᵢ can be calculated as the mean of the current probability values pᵢ, such that the phone number αᵢ will be added to the middle of the comprehensive phone number list α to effect an average learning speed. The probability value pᵢ assigned to the added phone number αᵢ can be calculated as an upper percentile (e.g. 25%) to effect a relatively quick learning speed. Or the probability value pᵢ assigned to the added phone number αᵢ can be calculated as a lower percentile (e.g. 75%) to effect a relatively slow learning speed. It should be noted that if there is a limited number of phone numbers αᵢ on the comprehensive phone number list α, thereby placing the lowest phone numbers αᵢ in the likelihood position of being deleted from the comprehensive phone number list α, the assigned probability value pᵢ should be not be so low as to cause the added phone number αᵢ to oscillate on and off of the comprehensive phone number list α when it is alternately called and not called.

In any event, if the outcome value β received from the outcome evaluation module 1930 equals “1,” indicating that the currently called phone number λₓ was found in the comprehensive phone number list α, the intuition module 1915 directs the probability update module 1920 to update the phone number probability distribution p using a learning methodology. In the illustrated embodiment, the probability update module 1920 utilizes a linear reward-inaction P-type update.

As an example, assume that a currently called phone number λₓ corresponds with a phone number α₁₀ in the comprehensive phone number list α, thus creating an outcome value β=1, Assume also that the comprehensive phone number list α currently contains 50 phone numbers αᵢ. In this case, general updating equations [6] and [7] can be expanded using equations [10] and [11], as follows:

$$\begin{matrix}{p}_{10} ( k + 1 ) = {p}_{10} ( k ) + {\sum }_{j = 1 \\ j \neq 10}^{50} {ap}_{j} ( k ) ; \\ {p}_{1} ( k + 1 ) = {p}_{1} ( k ) - {ap}_{1} ( k ) ; \\ {p}_{2} ( k + 1 ) = {p}_{2} ( k ) - {ap}_{2} ( k ) ; \\ {p}_{4} ( k + 1 ) = {p}_{4} ( k ) - {ap}_{4} ( k ) ; \\ ⋮ \\ {p}_{50} ( k + 1 ) = {p}_{50} ( k ) - {ap}_{50} ( k )\end{matrix}$$

Thus, the corresponding probability value p₁₀ is increased, and the phone number probability values pᵢ corresponding to the remaining phone numbers αᵢ are decreased. The value of α is selected based on the desired learning speed. The lower the value of α, the slower the learning speed, and the higher the value of α, the higher the learning speed. In the preferred embodiment, the value of a has been chosen to be 0.02. It should be noted that the penalty updating equations [8] and [9] will not be used, since in this case, a reward-penalty P-type update is not used.

Thus, it can be appreciated that, in general, the more a specific listed phone number αᵢ is called relative to other listed phone numbers αᵢ, the more the corresponding probability value pᵢ is increased, and thus the higher that listed phone number αᵢ is moved up on the comprehensive phone number list α. As such, the chances that the listed phone number αᵢ will be contained in the selected phone number subset αₛ and displayed to the phone user 1815 as the favorite phone number list 1820 will be increased. In contrast, the less a specific listed phone number αᵢ is called relative to other listed phone numbers αᵢ, the more the corresponding probability value pᵢ is decreased (by virtue of the increased probability values pᵢ corresponding to the more frequently called listed phone numbers αᵢ), and thus the lower that listed phone number αᵢ is moved down on the comprehensive phone number list α. As such, the chances that the listed phone number αᵢ will be contained in the phone number subset αₛ selected by the phone number selection module 1925 and displayed to the phone user 1815 as the favorite phone number list 1820 will be decreased.

It can also be appreciated that due to the nature of the learning automaton, the relative movement of a particular listed phone number αᵢ is not a matter of how many times the phone number αᵢ is called, and thus, the fact that the total number of times that a particular listed phone number αᵢ has been called is high does not ensure that it will be contained in the favorite phone number list 1820. In reality, the relative placement of a particular listed phone number αᵢ within the comprehensive phone number list αₛ is more of a function of the number of times that the listed phone number αᵢ has been recently called. For example, if the total number of times a listed phone number αᵢ is called is high, but it has not been called in the recent past, the listed phone number αᵢ may be relatively low in the comprehensive phone number list α, and thus it may not be contained in the favorite phone number list 1820. In contrast, if the total number of times a listed phone number αᵢ is called is low, but it has been called in the recent past, the listed phone number αᵢ may be relatively high in the comprehensive phone number list α, and thus it may be contained in the favorite phone number list 1820. As such, it can be appreciated that the learning automaton quickly adapts to the changing calling patterns of a particular phone user 1815.

It should be noted, however, that a phone number probability distribution p can alternatively be purely based on the frequency of each of the phone numbers λₓ. For example, given a total of n phone calls made, and a total number of times that each phone number is received f₁, f₂, f₃ . . . , the probability values pᵢ for the corresponding listed phone calls αᵢ can be:

$${p}_{i} ( k + 1 ) = \frac{fi}{n} \qquad [ 37 ]$$

Noteworthy, each probability value pᵢ is not a function of the previous probability value pᵢ (as characterized by learning automaton methodology), but rather the frequency of the listed phone number αᵢ and total number of phone calls n. With the purely frequency-based learning methodology, when a new phone number αᵢ is added to the phone list α, it corresponding probability value pᵢ will simply be 1/n, or alternatively, some other function of the total number of phone calls n. Optionally, the total number of phone calls n is not absolute, but rather represents the total number of phone calls n made in a specific time period, e.g., the last three months, last month, or last week. In other words, the action probability distribution p can be based on a moving average. This provides more the frequency-based learning methodology with more dynamic characteristics.

In any event, as described above, a single comprehensive phone number list α that contains all phone numbers called regardless of the time and day of the week is generated and updated. Optionally, several comprehensive phone number lists α can be generated and updated based on the time and day of the week. For example, Tables 12 and 13 below set forth exemplary comprehensive phone number lists α1 and α2 that respectively contain phone numbers α1ᵢ and α2ᵢ that are called during the weekdays and weekend.

TABLE 12
Exemplary Probability Values for
Comprehensive Weekday Phone Number List

| | Listed Weekday Phone | |
|---|---|---|
| Number | Numbers (α1ᵢ) | Probability Values (pᵢ) |
| 1 | 349-0292 | 0.223 |
| 2 | 349-0085 | 0.213 |
| 3 | 343-3985 | 0.168 |
| 4 | 343-2922 | 0.122 |
| 5 | 328-2302 | 0.111 |
| 6 | 928-3882 | 0.086 |
| 7 | 343-1098 | 0.073 |
| 8 | 328-4893 | 0.032 |
| . | . | . |
| . | . | . |
| . | . | . |
| 96 | 493-3832 | 0.011 |
| 97 | 383-303-3838 | 0.005 |
| 98 | 389-3898 | 0.005 |
| 99 | 272-3483 | 0.003 |
| 100 | 213-483-3343 | 0.001 |

TABLE 13
Exemplary Probability Values for
Comprehensive Weekend Phone Number List

| | Listed Weekend Phone | |
|---|---|---|
| Number | Numbers (α2ᵢ) | Probability Values (pᵢ) |
| 1 | 343-3985 | 0.238 |
| 2 | 343-1098 | 0.194 |
| 3 | 949-482-2382 | 0.128 |
| 4 | 343-2922 | 0.103 |
| 5 | 483-4838 | 0.085 |
| 6 | 349-0292 | 0.073 |
| 7 | 349-4929 | 0.062 |
| 8 | 493-4893 | 0.047 |
| . | . | . |
| . | . | . |
| . | . | . |
| 96 | 202-3492 | 0.014 |
| 97 | 213-403-9232 | 0.006 |
| 98 | 389-3893 | 0.003 |
| 99 | 272-3483 | 0.002 |
| 100 | 389-3898 | 0.001 |

Notably, the top six locations of the exemplary comprehensive phone number lists α1 and α2 contain different phone numbers α1ᵢ and α2ᵢ, presumably because certain phone numbers α1ᵢ (e.g., 349-0085, 328-2302, and 928-3882) were mostly only called during the weekdays, and certain phone numbers α2ᵢ (e.g., 343-1098, 949-482-2382 and 483-4838) were mostly only called during the weekends. The top six locations of the exemplary comprehensive phone number lists α1 and α2 also contain common phone numbers α1ᵢ and α2ᵢ, presumably because certain phone numbers α1ᵢ and α2ᵢ (e.g., 349-0292, 343-3985, and 343-2922) were called during the weekdays and weekends. Notably, these common phone numbers α1ᵢ and α2ᵢ are differently ordered in the exemplary comprehensive phone number lists α1 and α2, presumably because the phone user's 1815 weekday and weekend calling patterns have differently influenced the ordering of these phone numbers. Although not shown, the comprehensive phone number lists α1 and α2 can be further subdivided, e.g., by day and evening.

When there are multiple comprehensive phone number lists α that are divided by day and/or time, the phone selection module 1925, outcome evaluation module 1930, probability update module 1920, and intuition module 1915 operate on the comprehensive phone number lists α based on the current day and/or time (as obtained by a clock or calendar stored and maintained by the control circuitry 1835). Specifically, the intuition module 1915 selects the particular comprehensive list α that will be operated on. For example, during a weekday, the intuition module 1915 will select the comprehensive phone number lists α1, and during the weekend, the intuition module 1915 will select the comprehensive phone number lists α2.

The phone selection module 1925 will maintain the ordering of all of the comprehensive phone number lists α, but will select the phone number subset αₛ from the particular comprehensive phone number lists α selected by the intuition module 1915. For example, during a weekday, the phone selection module 1925 will select the favorite phone number list αₛ from the comprehensive phone number list α1, and during the weekend, the phone selection module 1925 will select the favorite phone number list αₛ from the comprehensive phone number list α2. Thus, it can be appreciated that the particular favorite phone number list 1820 displayed to the phone user 1815 will be customized to the current day, thereby increasing the chances that the next phone number λₓ called by the phone user 1815 will be on the favorite phone number list 1820 for convenient selection by the phone user 1815.

The outcome evaluation module 1930 will determine if the currently called phone number λₓ is contained in the comprehensive phone number list α selected by the intuition module 1915 and generate an outcome value β based thereon, and the intuition module 1915 will accordingly modify the phone number probability distribution p corresponding to the selected comprehensive phone number list α. For example, during a weekday, the outcome evaluation module 1930 determines if the currently called phone number λₓ is contained on the comprehensive phone number list α1, and the intuition module 1915 will then modify the phone number probability distribution p corresponding to the comprehensive phone number list α1. During a weekend, the outcome evaluation module 1930 determines if the currently called phone number λₓ is contained on the comprehensive phone number list α2, and the intuition module 1915 will then modify the phone number probability distribution p corresponding to the comprehensive phone number list α2.

In the illustrated embodiment, the outcome evaluation module 1930, probability update module 1920, and intuition module 1915 only operated on the comprehensive phone number list α and were not concerned with the favorite phone number list αₛ. It was merely assumed that a frequently and recently called phone number αᵢ that was not currently on the selected phone number subset αₛ would eventually work its way into the favorite phone number list 1820, and a seldom called phone number αᵢ that was currently on the selected phone number subset αₛ would eventually work its way off of the favorite phone number list 1820.

Optionally, the outcome evaluation module 1930, probability update module 1920, and intuition module 1915 can be configured to provide further control over this process to increase the changes that the next called phone number λₓ will be in the selected phone number list αₛ for display to the user 1815 as the favorite phone number list 1820.

For example, the outcome evaluation module 1930 may generate an outcome value β equal to “1” if the currently called phone number λₓ is on the previously selected phone number subset αₛ, “0” if the currently called phone number λₓ is not on the comprehensive phone number list α, and “2” if the currently called phone number λₓ is on the comprehensive phone number list α, but not in the previously selected number list αₛ. If the outcome value is “0” or “1”, the intuition module 1915 will direct the probability update module 1920 as previously described. If the outcome value is “2”, however, the intuition module 1915 will not direct the probability update module 1920 to update the phone number probability distribution p using a learning methodology, but instead will assign a probability value pᵢ to the listed phone number αᵢ. For example, the assigned probability value pᵢ may be higher than that corresponding to the last phone number αᵢ in the selected phone number subset αₛ, in effect, replacing that last phone number αᵢ with the listed phone number αᵢ corresponding to the currently called phone number λₓ. The outcome evaluation module 1930 may generate an outcome value β equal to other values, e.g., “3” if the a phone number λₓ corresponding to a phone number αᵢ not in the selected phone number subset αₛ has been called a certain number of times within a defined period, e.g., 3 times in one day or 24 hours. In this case, the intuition module 1915 may direct the probability update module 1920 to assign a probability value pᵢ to the listed phone number αᵢ, perhaps placing the corresponding phone number αᵢ on the favorite phone number list αₛ.

As another example to provide better control over the learning process, the phone number probability distribution p can be subdivided into two sub-distributions p₁ and p₂ with the first sub-distribution p₁ corresponding to the selected phone number subset αₛ, and the second sub-distribution p₂ corresponding to the remaining phone numbers αᵢ on the comprehensive phone number list α. In this manner, the first and second sub-distributions p₁ and p₂ will not affect each other, thereby preventing the relatively high probability values pᵢ corresponding to the favorite phone number list αₛ from overwhelming the remaining probability values pᵢ, which might otherwise slow the learning of the automaton. Thus, each of the first and second sub-distributions p₁ and p₂ are independently updated with the same or even different learning methodologies. Modification of the probability update module 1920 can be accomplished by the intuition module 1915 in the foregoing manners.

The intuition module 1915 may also prevent any one probability value pᵢ from overwhelming the remaining probability values pᵢ by limiting it to a particular value, e.g., 0.5. In this sense, the learning module 1910 will not converge to any particular probability value pᵢ, which is not the objective of the mobile phone 1800. That is, the objective is not to find a single favorite phone number, but rather a list of favorite phone numbers that dynamically changes with the phone user's 1815 changing calling patterns. Convergence to a single probability value pᵢ would defeat this objective.

So far, it has been explained that the listing program 1900 uses the instantaneous outcome value β as a performance index φ in measuring its performance in relation to its objective of maintaining favorite phone number list 1820 to contain future called telephone numbers. It should be appreciated, however, that the performance of the listing program 1900 can also be based on a cumulative performance index φ. For example, the listing program 1900 can keep track of a percentage of the called phone numbers λₓ that are found in the selected phone number subset αₛ or a consecutive number of called phone numbers λₓ that are not found in the selected phone number subset αₛ, based on the outcome value β, e.g., whether the outcome value β equals “2.” Based on this cumulative performance index p, the intuition module 1915 can modify the learning speed or nature of the learning module 1910.

It has also been described that the phone user 1815 actions encompass phone numbers λₓ from phone calls made by the mobile phone 1800 (i.e., outgoing phone calls) that are used to generate the outcome values β. Alternatively or optionally, the phone user 1815 actions can also encompass other information to improve the performance of the listing program 1900. For example, the phone user 1815 actions can include actual selection of the called phone numbers λₓ from the favorite phone number list αₛ. With this information, the intuition module 1915 can, e.g., remove phone numbers αᵢ that have not been selected by the phone user 1815, but are nonetheless on the favorite phone number list 1820. Presumably, in these cases, the phone user 1815 prefers to dial this particular phone number λₓ using the number keys 1845 and feels he or she does not need to select it, e.g., if the phone number is well known to the phone user 1815. Thus, the corresponding listed phone number αᵢ will be replaced on the favorite phone number list αₛ with another phone number αᵢ.

As another example, the phone user 1815 actions can include phone numbers from phone calls received by the mobile phone 1800 (i.e., incoming phone calls), which presumably correlate with the phone user's 1815 calling patterns to the extent that the phone number that is received represents a phone number that will likely be called in the future. In this case, the listing program 1900 may treat the received phone number similar to the manner in which it treats a called phone number λₓ, e.g., the outcome evaluation module 1930 determines whether the received phone number is found on the comprehensive phone number list α and/or the selected phone number subset αₛ, and the intuition module 1915 accordingly modifies the phone number probability distribution p based on this determination. Alternatively, a separate comprehensive phone number list can be maintained for the received phone numbers, so that a separate favorite phone number list associated with received phone numbers can be displayed to the user.

As still another example, the phone user 1815 can be time-based in that the cumulative time of a specific phone call (either incoming or outgoing) can be measured to determine the quality of the phone call, assuming that the importance of a phone call is proportional to its length. If the case of a relatively lengthy phone call, the intuition module 1915 can assign a probability value (if not found in the comprehensive phone number list α) or increase the probability value (if found in the comprehensive phone number list α) of the corresponding phone number higher than would otherwise be assigned or increased. In contrast, in the case of a relatively short phone call, the intuition module 1915 can assign a probability value (if not found in the comprehensive phone number list α) or increase the probability value (if found in the comprehensive phone number list α) of the corresponding phone number lower than would otherwise be assigned or increased. When measuring the quality of the phone call, the processing can be performed after the phone call is terminated.

Having now described the structure of the listing program 1900, the steps performed by the listing program 1900 will be described with reference to FIG. 34. In this process, the intuition module 1915 does not distinguish between phone numbers αᵢ that are listed in the phone number subset αₛ and those that are found on the remainder of the comprehensive phone number list α.

First, the outcome evaluation module 1930 determines whether a phone number λₓ has been called (step 2005). Alternatively or optionally, the evaluation module 1930 may also determine whether a phone number λₓ has been received. If a phone number λₓ has not been received, the program 1900 goes back to step 2005. If a phone number λₓ has been called and/or received, the outcome evaluation module 1930 determines whether it is on the comprehensive phone number list α and generates an outcome value β in response thereto (step 2015). If so β=1), the intuition module 1915 directs the probability update module 1920 to update the phone number probability distribution p using a learning methodology to increase the probability value pᵢ corresponding to the listed phone number αᵢ (step 2025). If not β=0), the intuition module 1915 generates a corresponding phone number αᵢ and assigns a probability value pᵢ to it, in effect, adding it to the comprehensive phone number list α (step 2030).

The phone number selection module 1925 then reorders the comprehensive phone number list α, and selects the phone number subset αs therefrom, and in this case, the listed phone numbers αᵢ with the highest probability values pᵢ (e.g., the top six) (step 2040). The phone number subset αₛ is then displayed to the phone user 1815 as the favorite phone number list 1820 (step 2045). The listing program 1900 then returns to step 2005, where it is determined again if phone number λₓ has been called and/or received.

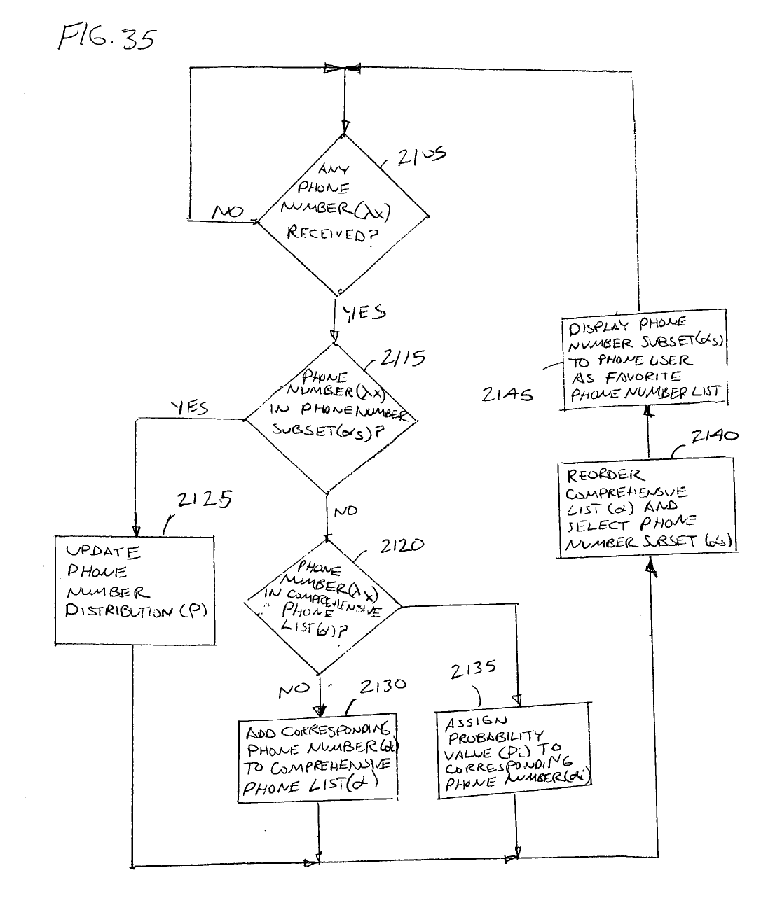

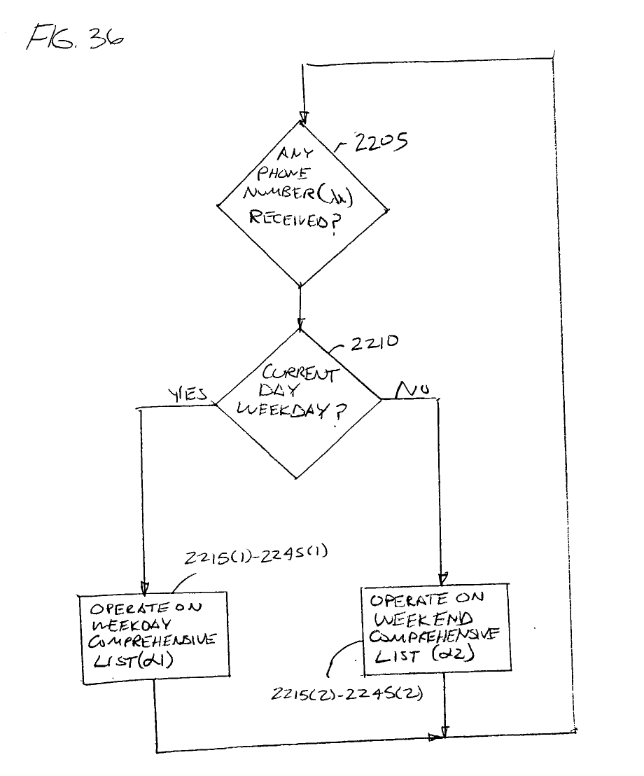

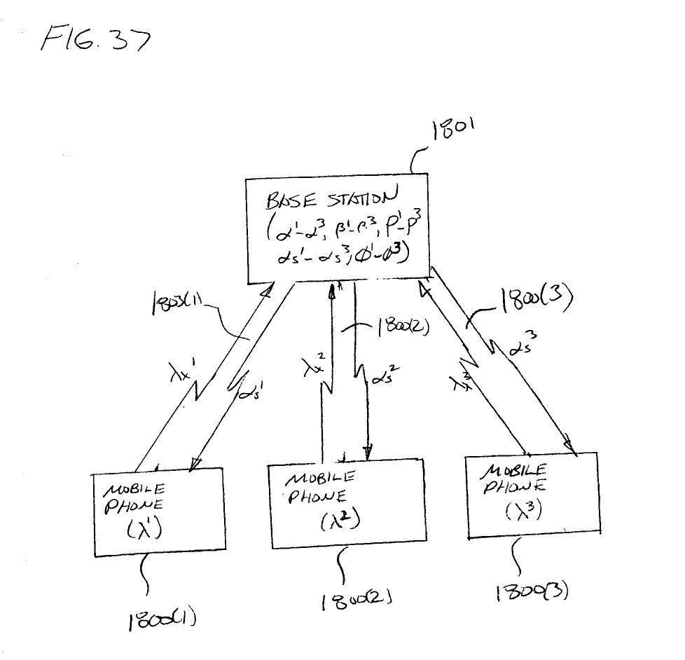

Referring to FIG. 35, the operation of the listing program 1900 will be described, wherein the intuition module 1915 does distinguish between phone numbers αᵢ that are listed in the phone number subset αₛ and those that are found on the remainder of the comprehensive phone number list α.

First, the outcome evaluation module 1930 determines whether a phone number λₓ has been called and/or received (step 2105). If a phone number λₓ has been called and/or received, the outcome evaluation module 1930 determines whether it is in either of the phone number subset αₛ (in effect, the favorite phone number list 1820) or the comprehensive phone number list α and generates an outcome value β in response thereto (steps 2115 and 2120). If the phone number λₓ is on the favorite phone number list αₛ (β=1), the intuition module 1915 directs the probability update module 1920 to update the phone number probability distribution p (or phone number probability sub-distributions p1 and p2) using a learning methodology to increase the probability value pᵢ corresponding to the listed phone number αᵢ (step 2125). If the phone number λₓ is not on the comprehensive phone number list (β=0), the intuition module 1915 generates a corresponding phone number αᵢ and assigns a probability value pᵢ to it, in effect, adding it to the comprehensive phone number list α (step 2130). If the phone number λₓ is not on the favorite phone number list αₛ, but is on the comprehensive phone number list α (β=2), the intuition module 1915 assigns a probability value pᵢ to the already listed phone number αᵢ to, e.g., place the listed phone number αᵢ within or near the favorite phone number list αₛ (step 2135).

The phone number selection module 1925 then reorders the comprehensive phone number list α, and selects the phone number subset αₛ therefrom, and in this case, the listed phone numbers αᵢ with the highest probability values pᵢ (e.g., the top six) (step 2140). The phone number subset αₛ is then displayed to the phone user 1815 as the favorite phone number list 1820 (step 2145). The listing program 1900 then returns to step 2105, where it is determined again if phone number λₓ has been called and/or received.

Referring to FIG. 36, the operation of the listing program 1900 will be described, wherein the intuition module 1915 distinguishes between weekday and weekend phone calls.

First, the outcome evaluation module 1930 determines whether a phone number λₓ has been called (step 2205). Alternatively or optionally, the evaluation module 1930 may also determine whether a phone number λₓ has been received. If a phone number λₓ has not been received, the program 1900 goes back to step 2105. If a phone number λₓ has been called and/or received, the intuition module 1915 determines whether the current day is a weekend day or a weekend (step 2010). If the current day is a weekday, the weekday comprehensive phone list α1 is operated on in steps 2215(1)-2245(1) in a similar manner as the comprehensive phone list α is operated on in steps 2015-2040 in FIG. 35. In this manner, a favorite phone number list 1820 customized to weekday calling patterns is displayed to the phone user 1815. If the current day is a weekend day, the weekend comprehensive phone list α2 is operated on in steps 2215(2)-2245(2) in a similar manner as the comprehensive phone list α is operated on in steps 2015-2040 in FIG. 35. In this manner, a favorite phone number list 1820 customized to weekend calling patterns is displayed to the phone user 1815. Optionally, rather than automatically customizing the favorite phone number list 1820 to the weekday or weekend for display to the phone user 1815, the phone user 1815 can select which customized favorite phone number list 1820 will be displayed. The listing program 1900 then returns to step 2205, where it is determined again if phone number λₓ has been called and/or received.

More specific details on the above-described operation of the mobile phone 1800 can found in the Computer Program Listing Appendix attached hereto and previously incorporated herein by reference. It is noted that the file “Intuition Intelligence-mobilephone-outgoing.doc” generates a favorite phone number list only for outgoing phone calls, that is, phone calls made by the mobile phone. It does not distinguish between the favorite phone number list and the remaining phone numbers on the comprehensive list when generating outcome values, but does distinguish between weekday phone calls and weekend phone calls. The file “Intuition Intelligence-mobilephone-incoming.doc” generates a favorite phone number list only for incoming phone calls; that is, phone calls received by the mobile phone. It does not distinguish between the favorite phone number list and the remaining phone numbers on the comprehensive list when generating outcome values, and does not distinguish between weekday phone calls and weekend phone calls.

It should be noted that the files “Intuition Intelligence-mobilephone-outgoing.doc” and “Intuition Intelligence-mobilephone-incoming.doc” simulation programs to emulate real-world scenarios and to demonstrate the learning capability of the priority listing program. To this end, the software simulation is performed on a personal computer with Linux Operating System Mandrake Version 8.2. This operating system was selected because the MySQL database, PHP and Apache Web Server are natively built in. The MySQL database acts as a repository and stores the call logs and tables utilized in the programs. The MySQL database is a very fast, multi-user relational database management system that is used for storing and retrieving information. The PHP is a cross-platform, Hyper Text Markup Language (HTML)-embedded, server-side, web scripting language to provide and process dynamic content. The Apache Web Server is a public-domain web server that receives a request, processes a request, and sends the response back to the requesting entity. Because a phone simulator was not immediately available, the phone call simulation was performed using a PyWeb Deckit Wireless Application Protocol (WAP) simulator, which is a front-end tool/browser that emulates the mobile phone, and is used to display wireless language content debug the code. It is basically a browser for handheld devices. The Deckit transcoding technology is built-in to allow one to test and design the WAP site offline. The transcoding is processed locally on the personal computer.

Multiple-User Learning Priority Listing Program with Multiple Learning Modules

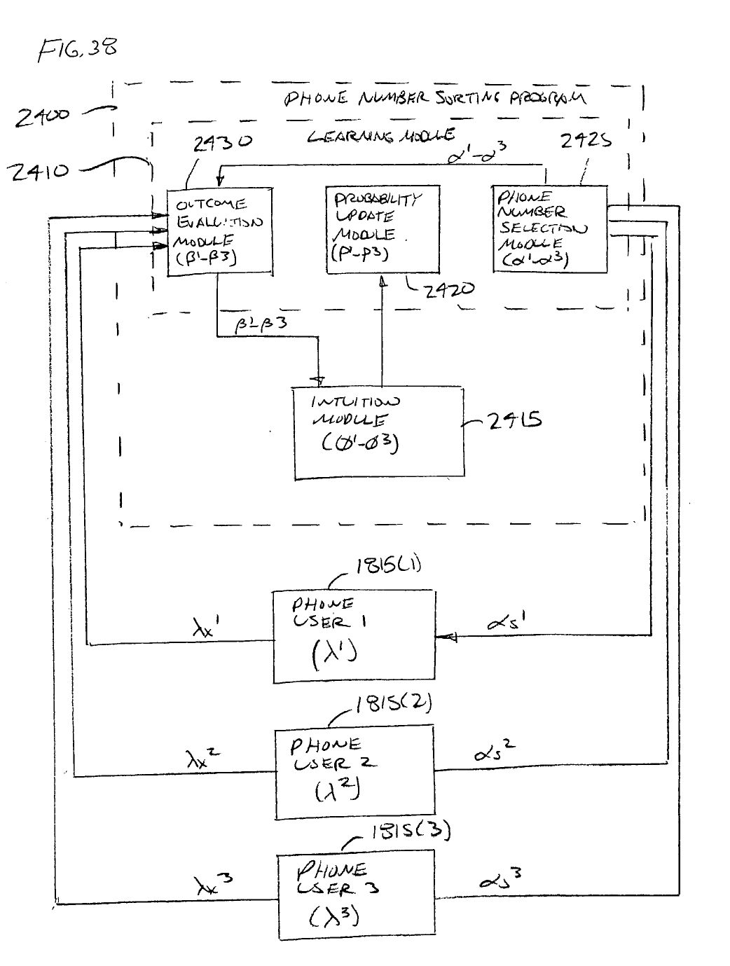

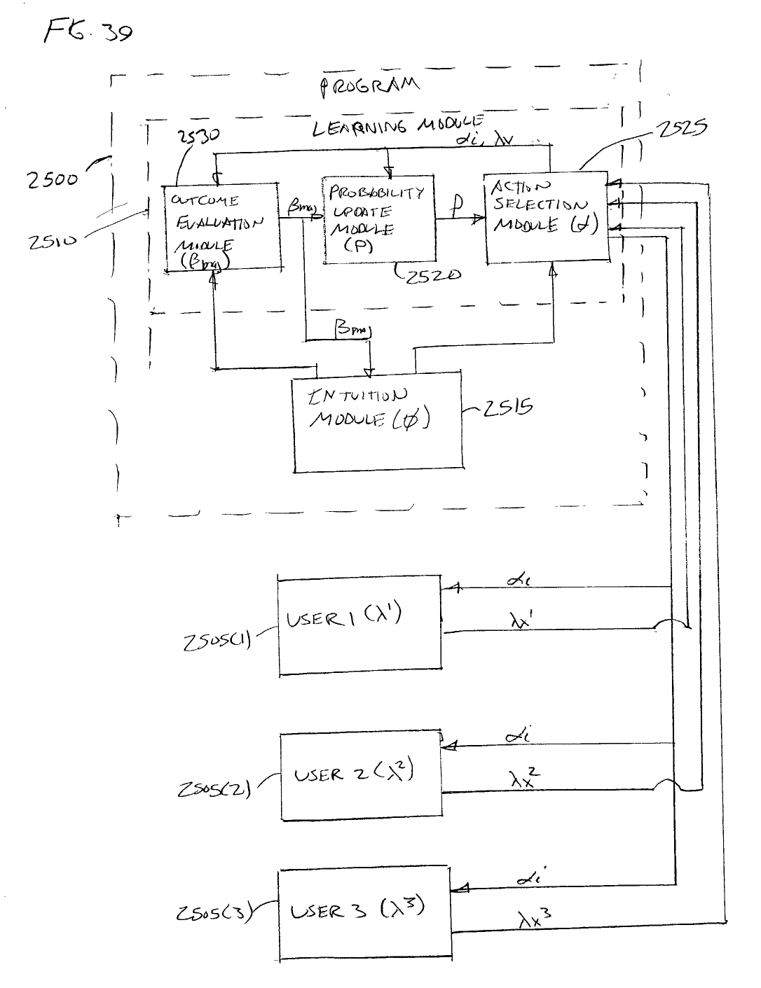

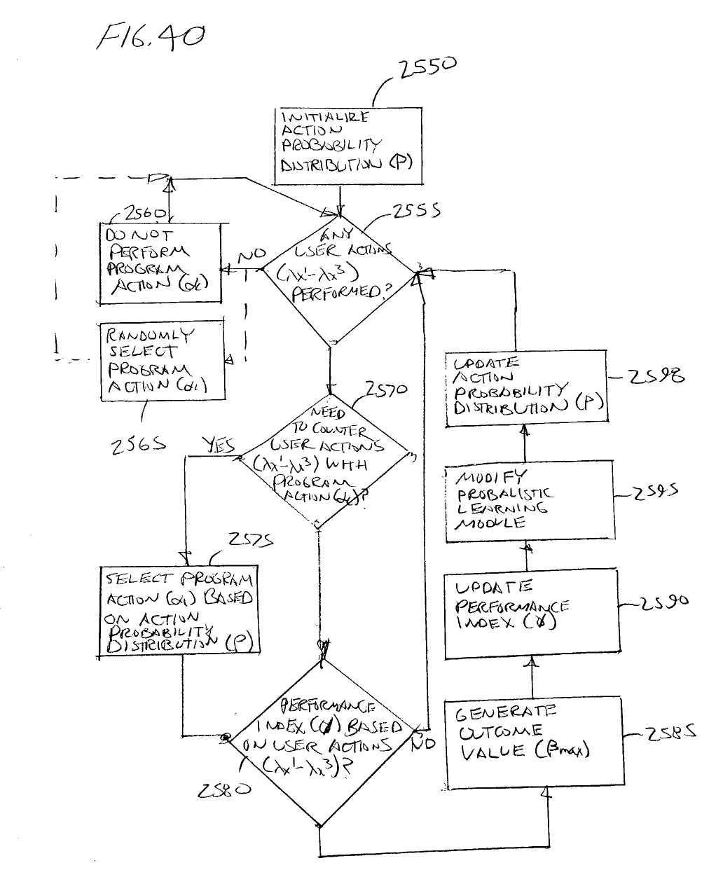

Although the listing program 1900 has been described as being self-contained in the mobile phone 1800, a priority listing program can be distributed amongst several components or can be contained in a component separate from the mobile phone 1800. For example, referring to FIG. 37, a priority listing program 2400 (shown in FIG. 38) is stored in a base station 1801, which services several mobile phones 1800(1)-(3) (three shown here) via respective wireless links 1803(1)-(3). The listing program 2400 is similar to the previously described listing program 1900, with the exception that it can generate a favorite phone number list for several mobile phones 1800(1)-(3).

Referring further to FIG. 38, the listing program 2400 generally includes a probabilistic learning module 2410 and an intuition module 2415. The probabilistic learning module 2410 comprises a probability update module 2420, a phone number selection module 2425, and an outcome evaluation module 2430. Specifically, the probability update module 2420 is mainly responsible for learning each of the phone users' 1815(1)-(3) calling habits and updating comprehensive phone number lists α¹-α³ using probability distributions p¹-p³ that, for each of the users' 1815(1)-(3), place phone numbers in the order that they are likely to be called in the future during any given time period. The outcome evaluation module 2430 is responsible for evaluating each of the comprehensive phone number lists α¹-α³ relative to current phone numbers λx¹-λx³ called by the phone users 1815(1)-(3).

The base station 1801 obtains the called phone numbers λx¹-λx³ when the mobile phones 1800(1)-(3) place phone calls to the base station 1801 via the wireless links 1803(1)-(3). The phone number selection module 2425 is mainly responsible for selecting phone number subsets αₛ¹-αₛ ³ from the respective comprehensive phone number lists α¹-α³ for eventual display to the phone users 1815(1)-(3) as favorite phone number lists. These phone number subsets αₛ¹-αₛ³ are wirelessly transmitted to the respective mobile phones 1800(1)-(3) via the wireless links 1803(1)-(3) when the phone calls are established. The intuition module 2415 is responsible for directing the learning of the listing program 2400 towards the objective, and specifically, displaying the favorite phone number lists that are likely to include the phone users' 1815(1)-1815(3) next called phone numbers. The intuition module 2415 accomplishes this based on respective performance indexes φ¹-φ³ (and in this case, instantaneous performance indexes φ¹-φ³ represented as respective outcome values β¹-β³).

It should be noted that the listing program 2400 can process the called phone numbers λx¹-λx³ on an individual basis, resulting in the generation and transmission of respective phone number subsets αₛ¹-αₛ³ to the mobile phones 1800(1)-(3) in response thereto, or optionally to minimize processing time, the listing program 2400 can process the called phone numbers λx¹-λx³ in a batch mode, which may result in the periodic (e.g., once a day) generation and transmission of respective phone number subsets αₛ¹-αₛ³ to the mobile phones 1800(1)-(3). In the batch mode, the phone number subsets αₛ¹-αₛ³ can be transmitted to the respective mobile phones 1800(1)-(3) during the next phone calls from the mobile phones 1800(1)-(3). The detailed operation of the listing program 2400 modules have previously been described, and will therefore not be reiterated here for purposes of brevity. It should also be noted that all of the processing need not be located in the base station 1801, and certain modules of the program 1900 can be located within the mobile phones 1800(1)-(3).

As will be appreciated, the phone need not be a mobile phone, but can be any phone or device that can display phone numbers to a phone user. The present invention particularly lends itself to use with mobile phones, however, because they are generally more complicated and include many more features than standard phones. In addition, mobile phone users are generally more busy and pressed for time and may not have the external resources, e.g., a phone book, that are otherwise available to phone users of home phone users. Thus, mobile phone users generally must rely on information contained in the mobile phone itself. As such, a phone that learns the phone user's habits, e.g., the phone user's calling pattern, becomes more significant in the mobile context.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims. All publications, patents, and patent applications cited herein are hereby incorporated by reference in their entirety for all purposes.

What is claimed is:

1. A method of providing learning capability to a processing device having one or more objectives, comprising:
receiving an action performed by a user;
selecting one of a plurality of processor actions based on an action probability distribution comprising a plurality of probability values corresponding to said plurality of processor actions;
determining an outcome value based on one or both of said user action and said selected processor action;
updating said action probability distribution using a learning automaton based on said outcome value; and
modifying one or more subsequent processor action selections, outcome value determinations, and action probability distribution updates based on said one or more objectives.

2. The method of claim 1, wherein said outcome value is determined based on said user action.

3. The method of claim 1, wherein said outcome value is determined based on said selected processor action.

4. The method of claim 1, wherein said outcome value is determined based on both said user action and said selected processor action.

5. The method of claim 1, wherein said selected processor action is selected in response to said user action.

6. The method of claim 1, further comprising generating a performance index indicative of a performance of said processing device relative to said one or more objectives, wherein said modification is based on said performance index.

7. The method of claim 1, wherein said performance index is updated when said outcome value is determined.

8. The method of claim 6, wherein said performance index is derived from said outcome value.

9. The method of claim 6, wherein said performance index is derived indirectly from said outcome value.

10. The method of claim 6, wherein said performance index is a function of said action probability distribution.

11. The method of claim 6, wherein said performance index is a cumulative value.

12. The method of claim 6, wherein said performance index is an instantaneous value.

13. The method of claim 1, wherein said modification is performed deterministically.

14. The method of claim 1, wherein said modification is performed quasi-deterministically.

15. The method of claim 1, wherein said modification is performed probabilistically.

16. The method of claim 1, wherein said modification is performed using artificial intelligence.

17. The method of claim 1, wherein said modification is performed using an expert system.

18. The method of claim 1, wherein said modification is performed using a neural network.

19. The method of claim 1, wherein said modification is performed using fuzzy logic.

20. The method of claim 1, wherein said modification comprises modifying a subsequently performed action selection step.

21. The method of claim 1, wherein said modification comprises modifying a subsequently performed outcome value determination step.

22. The method of claim 1, wherein said modification comprises modifying a subsequently performed action probability distribution update step.

23. The method of claim 1, wherein said modification comprises selecting one of a predetermined plurality of algorithms employed by said one or more subsequently performed processor action selection, outcome value determination, and action probability distribution update steps.

24. The method of claim 1, wherein said modification comprises modifying a parameter of an algorithm employed by said one or more subsequently performed processor action selection, outcome value determination, and action probability distribution update steps.

25. The method of claim 1, wherein said outcome value is selected from only two values.

26. The method of claim 25, wherein said outcome value is selected from the integers “zero” and “one.”

27. The method of claim 1, wherein said outcome value is selected from a finite range of real numbers.

28. The method of claim 1, wherein said outcome value is selected from a range of continuous values.

29. The method of claim 1, wherein said outcome value is determined for said selected processor action.

30. The method of claim 1, wherein said outcome value is determined for a previously selected processor action.

31. The method of claim 1, wherein said outcome value is determined for a subsequently selected processor action.

32. The method of claim 1, further comprising initially generating said action probability distribution with equal probability values.

33. The method of claim 1, further comprising initially generating said action probability distribution with unequal probability values.

34. The method of claim 1, wherein said action probability distribution update comprises a linear update.

35. The method of claim 1, wherein said action probability distribution update comprises a linear reward-penalty update.

36. The method of claim 1, wherein said action probability distribution update comprises a linear reward-inaction update.

37. The method of claim 1, wherein said action probability distribution update comprises a linear inaction-penalty update.

38. The method of claim 1, wherein said action probability distribution update comprises a nonlinear update.

39. The method of claim 1, wherein said action probability distribution update comprises an absolutely expedient update.

40. The method of claim 1, wherein said action probability distribution is normalized.

41. The method of claim 1, wherein said selected processor action corresponds to the highest probability value within said action probability distribution.

42. The method of claim 1, wherein said selected processor action is pseudo-randomly selected from said plurality of processor actions.

43. The method of claim 1, wherein said processing device is a computer game, said user action is a player action, and said processor actions are game actions.

44. The method of claim 1, wherein said processing device is a telephone system, said user action is a called phone number, and said processor actions are listed phone numbers.

45. A processing device having one or more objectives, comprising:
a probabilistic learning module having a learning automaton configured for learning a plurality of processor actions in response to a plurality of actions performed by a user; and
an intuition module configured for modifying a functionality of said probabilistic learning module based on said one or more objectives.

46. The processing device of claim 45, wherein said intuition module is further configured for generating a performance index indicative of a performance of said probabilistic learning module relative to said one or more objectives, and for modifying said probabilistic learning module functionality based on said performance index.

47. The processing device of claim 45, wherein said intuition module is deterministic.

48. The processing device of claim 45, wherein said intuition module is quasi-deterministic.

49. The processing device of claim 45, wherein said intuition module is probabilistic.

50. The processing device of claim 45, wherein said intuition module comprises artificial intelligence.

51. The processing device of claim 45, wherein said intuition module comprises an expert system.

52. The processing device of claim 45, wherein said intuition module comprises a neural network.

53. The processing device of claim 45, wherein said intuition module comprises fuzzy logic.

54. The processing device of claim 45, wherein said probabilistic learning module comprises:
an action selection module configured for selecting one of a plurality of processor actions, said action selection being based on an action probability distribution comprising a plurality of probability values corresponding to said plurality of processor actions;
an outcome evaluation module configured for determining an outcome value based on one or both of said user action and said selected processor action; and
a probability update module configured for updating said action probability distribution based on said outcome value.

55. The processing device of claim 54, wherein said outcome value is determined based on said user action.

56. The processing device of claim 54, wherein said outcome value is determined based on said selected processor action.

57. The processing device of claim 54, wherein said outcome value is determined based on both said user action and said selected processor action.

58. The processing device of claim 54, wherein said intuition module is configured for modifying a functionality of said action selection module based on said one or more objectives.

59. The processing device of claim 54, wherein said intuition module is configured for modifying a functionality of said outcome evaluation module based on said one or more objectives.

60. The processing device of claim 54, wherein said intuition module is configured for modifying a functionality of said probability update module based on said one or more objectives.

61. The processing device of claim 45, wherein said intuition module is configured for selecting one of a predetermined plurality of algorithms employed by said learning module.

62. The processing device of claim 44, wherein said intuition module is configured for modifying a parameter of an algorithm employed by said learning module.

63. A method of providing learning capability to a computer game having an objective of matching a skill level of said computer game with a skill level of a game player, comprising:
receiving an action performed by said game player;
selecting one of a plurality of game actions based on an action probability distribution comprising a plurality of probability values corresponding to said plurality of game actions;
determining an outcome value based on said player action and said selected game action;
updating said action probability distribution based on said outcome value; and
modifying one or more subsequent game action selections, outcome value determinations, and action probability distribution updates based on said objective.

64. The method of claim 63, wherein said selected game action is selected in response to said player action.

65. The method of claim 63, further comprising generating a performance index indicative of a performance of said computer game relative to said objective, wherein said modification is based on said performance index.

66. The method of claim 65, wherein said performance index comprises a relative score value between said game player and said computer game.

67. The method of claim 63, wherein said performance index is updated when said outcome value is determined.

68. The method of claim 65, wherein said performance index is derived from said outcome value.

69. The method of claim 65, wherein said performance index is derived indirectly from said outcome value.

70. The method of claim 65, wherein said performance index is a function of said action probability distribution.

71. The method of claim 65, wherein said performance index is a cumulative value.

72. The method of claim 65, wherein said performance index is an instantaneous value.

73. The method of claim 63, wherein said modification is performed deterministically.

74. The method of claim 63, wherein said modification is performed quasi-deterministically.

75. The method of claim 63, wherein said modification is performed probabilistically.

76. The method of claim 63, wherein said modification is performed using artificial intelligence.

77. The method of claim 63, wherein said modification is performed using an expert system.

78. The method of claim 63, wherein said modification is performed using a neural network.

79. The method of claim 63, wherein said modification is performed using fuzzy logic.

80. The method of claim 63, wherein said modification comprises modifying a subsequently performed action selection step.

81. The method of claim 80, wherein said plurality of game actions are organized into a plurality of game action subsets, said selected game action is selected from one of said plurality of game action subsets, and said subsequent action selection comprises selecting another of said plurality of game action subsets.

82. The method of claim 81, wherein said subsequently performed action selection comprises selecting another game action from said another of said plurality of game action subsets in response to another player action.

83. The method of claim 63, wherein said modification comprises modifying a subsequently performed outcome value determination step.

84. The method of claim 63, wherein said modification comprises modifying a subsequently performed action probability distribution update step.

85. The method of claim 63, wherein said modification comprises selecting one of a predetermined plurality of algorithms employed by said one or more subsequently performed game action selection, outcome value determination, and action probability distribution update steps.

86. The method of claim 63, wherein said modification comprises modifying a parameter of an algorithm employed by said one or more subsequently performed game action selection, outcome value determination, and action probability distribution update steps.

87. The method of claim 63, wherein said outcome value is selected from only two values.

88. The method of claim 87, wherein said outcome value is selected from the integers “zero” and “one.”

89. The method of claim 63, wherein said outcome value is selected from a finite range of real numbers.

90. The method of claim 63, wherein said outcome value is selected from a range of continuous values.

91. The method of claim 63, wherein said outcome value is determined for said selected game action.

92. The method of claim 63, wherein said outcome value is determined for a previously selected game action.

93. The method of claim 63, wherein said outcome value is determined for a subsequently selected game action.

94. The method of claim 63, wherein said outcome value is determined by performing a collision technique on said player action and said selected game action.

95. The method of claim 63, further comprising initially generating said action probability distribution with equal probability values.

96. The method of claim 63, further comprising initially generating said action probability distribution with unequal probability values.

97. The method of claim 63, wherein said action probability distribution update comprises a linear update.

98. The method of claim 63, wherein said action probability distribution update comprises a linear reward-penalty update.

99. The method of claim 63, wherein said action probability distribution update comprises a linear reward-inaction update.

100. The method of claim 63, wherein said action probability distribution update comprises a linear inaction-penalty update.

101. The method of claim 63, wherein said action probability distribution update comprises a nonlinear update.

102. The method of claim 63, wherein said action probability distribution update comprises an absolutely expedient update.

103. The method of claim 63, wherein said action probability distribution is normalized.

104. The method of claim 63, wherein said selected game action corresponds to the highest probability value within said action probability distribution.

105. The method of claim 63, wherein said selected game action is pseudo-randomly selected from said plurality of processor actions.

106. The method of claim 63, wherein said plurality of game actions is performed by a game-manipulated object, and said player action is performed by a user-manipulated object.

107. The method of claim 106, wherein said plurality of game actions comprises discrete movements of said game-manipulated object.

108. The method of claim 106, wherein said plurality of game actions comprises a plurality of delays related to a movement of said game-manipulated object.

109. The method of claim 106, wherein said player action comprises a simulated shot taken by said user-manipulated object.

110. The method of claim 106, wherein said game-manipulated object and said user-manipulated object are visual to said game player.

111. The method of claim 63, wherein said action probability distribution is updated using a learning automaton.

112. A computer game having an objective of for matching a skill level of said computer game with a skill level of a game player, comprising:
a probabilistic learning module configured for learning a plurality of game actions in response to a plurality of actions performed by a game player; and
an intuition module configured for modifying a functionality of said probabilistic learning module based on said objective.

113. The computer game of claim 112, wherein said intuition module is further configured for generating a performance index indicative of a performance of said probabilistic learning module relative to said objective, and for modifying said probabilistic learning module functionality based on said performance index.

114. The computer game of claim 113, wherein said performance index comprises a relative score value between said game player and said computer game.

115. The computer game of claim 112, wherein said intuition module is deterministic.

116. The computer game of claim 112, wherein said intuition module is quasi-deterministic.

117. The computer game of claim 112, wherein said intuition module is probabilistic.

118. The computer game of claim 112, wherein said intuition module comprises artificial intelligence.

119. The computer game of claim 112, wherein said intuition module comprises an expert system.

120. The computer game of claim 112, wherein said intuition module comprises a neural network.

121. The computer game of claim 112, wherein said intuition module comprises fuzzy logic.

122. The computer game of claim 112, wherein said probabilistic learning module comprises:
an action selection module configured for selecting one of a plurality of game actions, said action selection being based on an action probability distribution comprising a plurality of probability values corresponding to said plurality of game actions;
an outcome evaluation module configured for determining an outcome value based on said player action and said selected game action; and
a probability update module configured for updating said action probability distribution based on said outcome value.

123. The computer game of claim 122, wherein said intuition module is configured for modifying a functionality of said action selection module based on said objective.

124. The computer game of claim 122, wherein said intuition module is configured for modifying a functionality of said outcome evaluation module based on said objective.

125. The computer game of claim 122, wherein said intuition module is configured for modifying a functionality of said probability update module based on said objective.

126. The computer game of claim 122, wherein said intuition module is configured for selecting one of a predetermined plurality of algorithms employed by said learning module.

127. The computer game of claim 122, wherein said intuition module is configured for modifying a parameter of an algorithm employed by said learning module.

128. The computer game of claim 122, wherein said plurality of game actions is performed by a game-manipulated object, and said user action is performed by a user-manipulated object.

129. The computer game of claim 128, wherein said plurality of game actions comprises discrete movements of said game-manipulated object.

130. The computer game of claim 128, wherein said plurality of game actions comprises a plurality of delays related to a movement of said game-manipulated object.

131. The computer game of claim 128, wherein said player action comprises a simulated shot taken by said user-manipulated object.

132. The computer game of claim 128, wherein said game-manipulated object and said user-manipulated object are visual to said game player.

133. The computer game of claim 112, wherein said probability learning module comprises a learning automaton.

134. A method of providing learning capability to a processing device, comprising:
generating an action probability distribution comprising a plurality of probability values organized among a plurality of action subsets, said plurality of probability values corresponding to a plurality of processor actions;
selecting one of said plurality of action subsets; and
selecting one of said plurality of processor actions from said selected action subset.

135. The method of claim 133, wherein said selected processor action is selected in response to said user action.

136. The method of claim 133, further comprising:
receiving an action performed by a user,
determining an outcome value based on said user action and said selected processor action; and
updating said action probability distribution based on said outcome value.

137. The method of claim 133, wherein said processing device has one or more objectives, the method further comprising generating a performance index indicative of a performance of said processing device relative to said one or more objectives, wherein said action subset selection is based on said performance index.

138. The method of claim 133, wherein said selected action subset is selected deterministically.

139. The method of claim 133, wherein said selected action subset is selected quasi-deterministically.

140. The method of claim 133, wherein said selected action subset is selected probabilistically.

141. The method of claim 133, wherein said selected processor action is pseudo-randomly selected from said selected action subset.

142. The method of claim 133, wherein said selected action subset corresponds to a series of probability values within said action probability distribution.

143. The method of claim 133, wherein said selected action subset corresponds to the highest probability values within said action probability distribution.

144. The method of claim 133, wherein said selected action subset corresponds to the lowest probability values within said action probability distribution.

145. The method of claim 133, wherein said selected action subset corresponds to the middlemost probability values within said action probability distribution.

146. The method of claim 133, wherein said selected action subset corresponds to an average of probability values relative to a threshold value.

147. The method of claim 146, wherein said threshold value is a median probability value within said action probability distribution.

148. The method of claim 146, wherein said threshold value is dynamically adjusted.

149. The method of claim 146, wherein said selected action subset corresponds to an average of probability values greater than said threshold value.

150. The method of claim 146, wherein said selected action subset corresponds to an average of probability values less than said threshold value.

151. The method of claim 146, wherein said selected action subset corresponds to an average of probability values substantially equal to said threshold value.

152. The method of claim 133, wherein said action probability distribution is updated using a learning automaton.

153. A method of providing learning capability to a computer game, comprising:
generating an action probability distribution comprising a plurality of probability values organized among a plurality of action subsets, said plurality of probability values corresponding to a plurality of game actions;
selecting one of said plurality of action subsets; and
selecting one of said plurality of game actions from said selected action subset.

154. The method of claim 153, wherein said selected game action is selected in response to said player action.

155. The method of claim 153, further comprising:
receiving an action performed by a game player;
determining an outcome value based on said player action and said selected game action; and
updating said action probability distribution based on said outcome value.

156. The method of claim 155, wherein said plurality of game actions is performed by a game-manipulated object, and said player action is performed by a user-manipulated object.

157. The method of claim 156, wherein said plurality of game actions comprises discrete movements of said game-manipulated object.

158. The method of claim 156, wherein said plurality of game actions comprises a plurality of delays related to a movement of said game-manipulated object.

159. The method of claim 156, wherein said player action comprises a simulated shot taken by said user-manipulated object.

160. The method of claim 156, wherein said game-manipulated object and said user-manipulated object are visual to said game player.

161. The method of claim 153, wherein said selected action subset is selected deterministically.

162. The method of claim 153, wherein said selected action subset is selected quasi-deterministically.

163. The method of claim 153, wherein said selected action subset is selected probabilistically.

164. The method of claim 153, wherein said selected processor action is pseudo-randomly selected from said selected action subset.

165. The method of claim 153, wherein said selected action subset corresponds to a series of probability values within said action probability distribution.

166. The method of claim 153, wherein said selected action subset corresponds to the highest probability values within said action probability distribution.

167. The method of claim 153, wherein said selected action subset corresponds to the lowest probability values within said action probability distribution.

168. The method of claim 153, wherein said selected action subset corresponds to the middlemost probability values within said action probability distribution.

169. The method of claim 153, wherein said selected action subset corresponds to an average of probability values relative to a threshold level.

170. The method of claim 169, wherein said threshold level is a median probability value within said action probability distribution.

171. The method of claim 169, wherein said threshold level is dynamically adjusted.

172. The method of claim 169, wherein said selected action subset corresponds to an average of probability values greater than said threshold level.

173. The method of claim 169, wherein said selected action subset corresponds to an average of probability values less than said threshold level.

174. The method of claim 169, wherein said selected action subset corresponds to an average of probability values substantially equal to said threshold level.

175. The method of claim 153, wherein said selected action subset is selected based on a skill level of a game player relative to a skill level of said computer game.

176. The method of claim 175, wherein said relative skill level is obtained from a difference between a game player score and a computer game score.

177. The method of claim 175, wherein said action subset is selected to correspond to the highest probability values within said action probability distribution if said relative skill level is greater than a threshold level.

178. The method of claim 175, wherein said action subset is selected to correspond to the lowest probability values within said action probability distribution if said relative skill level is less than a threshold level.

179. The method of claim 175, wherein said action subset is selected to correspond to the middlemost probability values within said action probability distribution if said relative skill level is within a threshold range.

180. The method of claim 175, wherein said game action subset is selected to correspond to an average of probability values relative to a threshold level.

181. The method of claim 180, wherein said threshold level is a median probability value within said action probability distribution.

182. The method of claim 180, wherein said threshold level is dynamically adjusted based on said relative skill level.

183. The method of claim 180, wherein said game action subset is selected to correspond to an average of probability values greater than said threshold level if said relative skill level value is greater than a relative skill threshold level.

184. The method of claim 180, wherein said game action subset is selected to correspond to an average of probability values less than said relative skill threshold level.

185. The method of claim 180, wherein said game action subset is selected to correspond to an average of probability values substantially equal to said threshold level.

186. The method of claim 153, wherein said action probability distribution is updated using a learning automaton.

187. A method of providing learning capability to a processing device, comprising:
generating an action probability distribution using one or more learning algorithms, said action probability distribution comprising a plurality of probability values corresponding to a plurality of processor actions;
modifying said one or more learning algorithms; and
updating said action probability distribution using said modified one or more learning algorithms.

188. The method of claim 187, further comprising:
receiving an action performed by a user;
selecting one of said plurality of processor actions; and
determining an outcome value based on one or both of said user action and said selected processor action, wherein said action probability distribution update is based on said outcome value.

189. The method of claim 188, wherein said outcome value is determined based on said user action.

190. The method of claim 188, wherein said outcome value is determined based on said selected processor action.

191. The method of claim 188, wherein said outcome value is determined based on both said user action and said selected processor action.

192. The method of claim 188, wherein said selected processor action is selected in response to said user action.

193. The method of claim 187, wherein said processing device has one or more objectives, the method further comprising generating a performance index indicative of a performance of said processing device relative to said one or more objectives, wherein said algorithm modification is based on said performance index.

194. The method of claim 187, wherein said one or more learning algorithms are modified deterministically.

195. The method of claim 187, wherein said one or more learning algorithms are modified quasi-deterministically.

196. The method of claim 187, wherein said one or more learning algorithms are modified probabilistically.

197. The method of claim 187, wherein said one or more algorithms comprises one or more parameters, and said algorithm modification comprises modifying said one or more parameters.

198. The method of claim 197, wherein said one or more parameters comprises a reward parameter.

199. The method of claim 197, wherein said one or more parameters comprises a penalty parameter.

200. The method of claim 197, wherein said one or more parameters comprises one or more of a reward parameter and penalty parameter.

201. The method of claim 200, wherein said one or more of a reward parameter and penalty parameter are increased.

202. The method of claim 200, wherein said one or more of a reward parameter and penalty parameter are decreased.

203. The method of claim 200, wherein said one or more of a reward parameter and penalty parameter are modified to a negative number.

204. The method of claim 197, wherein said one or more parameters comprises a reward parameter and a penalty parameter.

205. The method of claim 204, wherein said reward parameter and said penalty parameter are both increased.

206. The method of claim 204, wherein said reward parameter and said penalty parameter are both decreased.

207. The method of claim 204, wherein said reward parameter and said penalty parameter are modified to a negative number.

208. The method of claim 187, wherein said one or more algorithms is linear.

209. The method of claim 187, wherein said action probability distribution is updated using a learning automaton.

210. A method of providing learning capability to a computer game, comprising:
generating an action probability distribution using one or more learning algorithms, said action probability distribution comprising a plurality of probability values corresponding to a plurality of game actions;
modifying said one or more learning algorithms; and
updating said action probability distribution using said modified one or more learning algorithms.

211. The method of claim 210, further comprising:
receiving an action performed by a game player;
selecting one of said plurality of game actions; and
determining an outcome value based on one or both of said player action and said selected game action, wherein said action probability distribution update is based on said outcome value.

212. The method of claim 211, wherein said outcome value is determined based on said player action.

213. The method of claim 211, wherein said outcome value is determined based on said selected game action.

214. The method of claim 211, wherein said outcome value is determined based on both said player action and said selected game action.

215. The method of claim 211, wherein said selected game action is selected in response to said player action.

216. The method of claim 210, wherein said plurality of game actions is performed by a game-manipulated object, and said player action is performed by a user-manipulated object.

217. The method of claim 216, wherein said plurality of game actions comprises discrete movements of said game-manipulated object.

218. The method of claim 216, wherein said plurality of game actions comprises a plurality of delays related to a movement of said game-manipulated object.

219. The method of claim 216, wherein said player action comprises a simulated shot taken by said user-manipulated object.

220. The method of claim 216, wherein said game-manipulated object and said user-manipulated object are visual to said game player.

221. The method of claim 210, wherein said one or more learning algorithms are modified deterministically.

222. The method of claim 210, wherein said one or more learning algorithms are modified quasi-deterministically.

223. The method of claim 210, wherein said one or more learning algorithms are modified probabilistically.

224. The method of claim 210, wherein said one or more algorithms comprises one or more parameters, and said algorithm modification comprises modifying said one or more parameters.

225. The method of claim 224, wherein said one or more parameters are modified in accordance with a function.

226. The method of claim 224, wherein said one or more parameters comprises a reward parameter.

227. The method of claim 224, wherein said one or more parameters comprises a penalty parameter.

228. The method of claim 224, wherein said one or more parameters comprises one or more of a reward parameter and penalty parameter.

229. The method of claim 228, wherein said one or more of a reward parameter and penalty parameter are increased.

230. The method of claim 228, wherein said one or more of a reward parameter and penalty parameter are decreased.

231. The method of claim 228, wherein said one or more of a reward parameter and penalty parameter are modified to a negative number.

232. The method of claim 224, wherein said one or more parameters comprises a reward parameter and a penalty parameter.

233. The method of claim 232, wherein said reward parameter and said penalty parameter are both increased.

234. The method of claim 232, wherein said reward parameter and said penalty parameter are both decreased.

235. The method of claim 232, wherein said reward parameter and said penalty parameter are modified to a negative number.

236. The method of claim 224, wherein said modified one or more algorithms is modified based on a skill level of a game player relative to a skill level of said computer game.

237. The method of claim 224, wherein said relative skill level is obtained from a difference between a game player score and a computer game score.

238. The method of claim 224, wherein said one or more algorithms comprises one or more of a reward parameter and a penalty parameter, and said algorithm modification comprises modifying said one or more of a reward parameter and a penalty parameter based on a skill level of game player relative to a skill level of said computer game.

239. The method of claim 238, wherein said relative skill level is obtained from a difference between a game player score and a computer game score.

240. The method of claim 238, wherein said one or more of a reward parameter and a penalty parameter is increased if said relative skill level is greater than a threshold level.

241. The method of claim 238, wherein said one or more of a reward parameter and a penalty parameter is decreased if said relative skill level is less than a threshold level.

242. The method of claim 238, wherein said one or more of a reward parameter and a penalty parameter is modified to be a negative number if said relative skill level is less than a threshold level.

243. The method of claim 210, wherein said one or more algorithms is linear.

244. The method of claim 210, wherein said one or more algorithms comprises a reward parameter and a penalty parameter, and said algorithm modification comprises modifying both of said reward parameter and said penalty parameter based on a skill level of game player relative to a skill level of said computer game.

245. The method of claim 244, wherein said relative skill level is obtained from a difference between a game player score and a computer game score.

246. The method of claim 244, wherein both of said reward parameter and said penalty parameter are increased if said relative skill level is greater than a threshold level.

247. The method of claim 244, wherein both of said reward parameter and said penalty parameter are decreased if said relative skill level is less than a threshold level.

248. The method of claim 244, wherein both of said reward parameter and said penalty parameter are modified to be a negative number if said relative skill level is less than a threshold level.

249. The method of claim 244, wherein said one or more algorithms is linear.

250. The method of claim 210, wherein said action probability distribution is updated using a learning automaton.

251. A method of matching a skill level of game player with a skill level of a computer game, comprising:
receiving an action performed by said game player;
selecting one of a plurality of game actions based on an action probability distribution comprising a plurality of probability values corresponding to said plurality of game actions;
determining if said selected game action is successful;
determining a current skill level of said game player relative to a current skill level of said computer game; and
updating said action probability distribution using a reward algorithm if said selected game action is successful and said relative skill level is relatively high, or if said selected game action is unsuccessful and said relative skill level is relatively low.

252. The method of claim 251, wherein said selected game action is selected in response to said player action.

253. The method of claim 251, wherein said relative skill level is obtained from a difference between a game player score and a computer game score.

254. The method of claim 251, wherein said relative skill level is determined to be relatively high if greater than a first threshold value, and relatively low if lower than a second threshold value.

255. The method of claim 251, wherein said reward algorithm is linear.

256. The method of claim 251, further comprising modifying said reward algorithm based on said successful game action determination.

257. The method of claim 251, wherein said plurality of game actions is performed by a game-manipulated object, and said player action is performed by a user-manipulated object.

258. The method of claim 257, wherein said plurality of game actions comprises discrete movements of said game-manipulated object.

259. The method of claim 257, wherein said plurality of game actions comprises a plurality of delays related to a movement of said game-manipulated object.

260. The method of claim 257, wherein said player action comprises a simulated shot taken by said user-manipulated object.

261. The method of claim 257, wherein said game-manipulated object and said user-manipulated object are visual to said game player.

262. The method of claim 251, wherein said action probability distribution is updated using a learning automaton.

263. A method of matching a skill level of game player with a skill level of a computer game, comprising:
receiving an action performed by said game player;
selecting one of a plurality of game actions based on an action probability distribution comprising a plurality of probability values corresponding to said plurality of game actions;
determining if said selected game action is successful;
determining a current skill level of said game player relative to a current skill level of said computer game; and
updating said action probability distribution using a penalty algorithm if said selected game action is unsuccessful and said relative skill level is relatively high, or if said selected game action is successful and said relative skill level is relatively low.

264. The method of claim 263, wherein said selected game action is selected in response to said player action.

265. The method of claim 263, wherein said relative skill level is obtained from a difference between a game player score and a computer game score.

266. The method of claim 263, wherein said relative skill level is determined to be relatively high if greater than a first threshold value, and relatively low if lower than a second threshold value.

267. The method of claim 263, wherein said penalty algorithm is linear.

268. The method of claim 263, further comprising modifying said penalty algorithm based on said successful game action determination.

269. The method of claim 263, wherein said plurality of game actions is performed by a game-manipulated object, and said player action is performed by a user-manipulated object.

270. The method of claim 269, wherein said plurality of game actions comprises discrete movements of said game-manipulated object.

271. The method of claim 269, wherein said plurality of game actions comprises a plurality of delays related to a movement of said game-manipulated object.

272. The method of claim 269, wherein said player action comprises a simulated shot taken by said user-manipulated object.

273. The method of claim 269, wherein said game-manipulated object and said user-manipulated object are visual to said game player.

274. The method of claim 263, wherein said action probability distribution is updated using a learning automaton.

275. A method of matching a skill level of game player with a skill level of a computer game, comprising:
receiving an action performed by said game player;
selecting one of a plurality of game actions based on an action probability distribution comprising a plurality of probability values corresponding to said plurality of game actions;
determining if said selected game action is successful;
determining a current skill level of said game player relative to a current skill level of said computer game;
updating said action probability distribution using a reward algorithm if said selected game action is successful and said relative skill level is relatively high, or if said selected game action is unsuccessful and said relative skill level is relatively low; and
updating said action probability distribution using a penalty algorithm if said selected game action is unsuccessful and said relative skill level is relatively high, or if said selected game action is successful and said relative skill level is relatively low.

276. The method of claim 275, wherein said selected game action is selected in response to said player action.

277. The method of claim 275, wherein said relative skill level is obtained from a difference between a game player score and a computer game score.

278. The method of claim 275, wherein said relative skill level is determined to be relatively high if greater than a first threshold value, and relatively low if lower than a second threshold value.

279. The method of claim 275, wherein said reward algorithm and said penalty algorithm are linear.

280. The method of claim 275, further comprising modifying said reward algorithm and said penalty algorithm based on said successful game action determination.

281. The method of claim 275, wherein said plurality of game actions is performed by a game-manipulated object, and said player action is performed by a user-manipulated object.

282. The method of claim 281, wherein said plurality of game actions comprises discrete movements of said game-manipulated object.

283. The method of claim 281, wherein said plurality of game actions comprises a plurality of delays related to a movement of said game-manipulated object.

284. The method of claim 281, wherein said player action comprises a simulated shot taken by said user-manipulated object.

285. The method of claim 281, wherein said game-manipulated object and said user-manipulated object are visual to said game player.

286. The method of claim 275, wherein said action probability distribution is updated using a learning automaton.

287. A method of matching a skill level of game player with a skill level of a computer game, comprising:
receiving an action performed by said game player;
selecting one of a plurality of game actions based on an action probability distribution comprising a plurality of probability values corresponding to said plurality of game actions;
determining if said selected game action is successful;
determining a current skill level of said game player relative to a current skill level of said computer game;
generating a successful outcome value if said selected game action is successful and said relative skill level is relatively high, or if said selected game action is unsuccessful and said relative skill level is relatively low; and
updating said action probability distribution based on said successful outcome value.

288. The method of claim 287, wherein said selected game action is selected in response to said player action.

289. The method of claim 287, wherein said relative skill level is obtained from a difference between a game player score and a computer game score.

290. The method of claim 287, wherein said relative skill level is determined to be relatively high if greater than a first threshold value, and relatively low if lower than a second threshold value.

291. The method of claim 287, wherein said successful outcome value equals the value “1.”

292. The method of claim 287, wherein said successful outcome value equals the value “0.”

293. The method of claim 287, wherein said plurality of game actions is performed by a game-manipulated object, and said player action is performed by a user-manipulated object.

294. The method of claim 293, wherein said plurality of game actions comprises discrete movements of said game-manipulated object.

295. The method of claim 293, wherein said plurality of game actions comprises a plurality of delays related to a movement of said game-manipulated object.

296. The method of claim 293, wherein said player action comprises a simulated shot taken by said user-manipulated object.

297. The method of claim 293, wherein said game-manipulated object and said user-manipulated object are visual to said game player.

298. The method of claim 287, wherein said action probability distribution is updated using a learning automaton.

299. A method of matching a skill level of game player with a skill level of a computer game, comprising:
receiving an action performed by said game player;
selecting one of a plurality of game actions based on an action probability distribution comprising a plurality of probability values corresponding to said plurality of game actions;
determining if said selected game action is successful;
determining a current skill level of said game player relative to a current skill level of said computer game;
generating an unsuccessful outcome value if said selected game action is unsuccessful and said relative skill level is relatively high, or if said selected game action is successful and said relative skill level is relatively low; and
updating said action probability distribution based on said unsuccessful outcome value.

300. The method of claim 299, wherein said selected game action is selected in response to said player action.

301. The method of claim 299, wherein said relative skill level is obtained from a difference between a game player score and a computer game score.

302. The method of claim 299, wherein said relative skill level is determined to be relatively high if greater than a first threshold value, and relatively low if lower than a second threshold value.

303. The method of claim 299, wherein said unsuccessful outcome value equals the value “1.”

304. The method of claim 299, wherein said unsuccessful outcome value equals the value “0.”

305. The method of claim 299, wherein said plurality of game actions is performed by a game-manipulated object, and said player action is performed by a user-manipulated object.

306. The method of claim 305, wherein said plurality of game actions comprises discrete movements of said game-manipulated object.

307. The method of claim 305, wherein said plurality of game actions comprises a plurality of delays related to a movement of said game-manipulated object.

308. The method of claim 305, wherein said player action comprises a simulated shot taken by said user-manipulated object.

309. The method of claim 305, wherein said game-manipulated object and said user-manipulated object are visual to said game player.

310. The method of claim 299, wherein said action probability distribution is updated using a learning automaton.

311. A method of matching a skill level of game player with a skill level of a computer game, comprising:
receiving an action performed by said game player;
selecting one of a plurality of game actions based on an action probability distribution comprising a plurality of probability values corresponding to said plurality of game actions;
determining if said selected game action is successful;
determining a current skill level of said game player relative to a current skill level of said computer game;
generating a successful outcome value if said selected game action is successful and said relative skill level is relatively high, or if said selected game action is successful and said relative skill level is relatively low;
generating an unsuccessful outcome value if said selected game action is unsuccessful and said relative skill level is relatively high, or if said selected game action is successful and said relative skill level is relatively low; and
updating said action probability distribution based on said successful outcome value and said unsuccessful outcome value.

312. The method of claim 311, wherein said selected game action is selected in response to said player action.

313. The method of claim 311, wherein said relative skill level is obtained from a difference between a game player score and a computer game score.

314. The method of claim 311, wherein said relative skill level is determined to be relatively high if greater than a first threshold value, and relatively low if lower than a second threshold value.

315. The method of claim 311, wherein said successful outcome value equals the value “1”, and said unsuccessful outcome value equal the value “0.”

316. The method of claim 311, wherein said successful outcome value equals the value “0,” and said unsuccessful outcome value equal the value “1.”

317. The method of claim 311, wherein said plurality of game actions is performed by a game-manipulated object, and said player action is performed by a user-manipulated object.

318. The method of claim 317, wherein said plurality of game actions comprises discrete movements of said game-manipulated object.

319. The method of claim 317, wherein said plurality of game actions comprises a plurality of delays related to a movement of said game-manipulated object.

320. The method of claim 317, wherein said player action comprises a simulated shot taken by said user-manipulated object.

321. The method of claim 317, wherein said game-manipulated object and said user-manipulated object are visual to said game player.

322. The method of claim 311, wherein said action probability distribution is updated using a learning automaton.

323. A method of providing learning capability to a processing device, comprising:
generating an action probability distribution comprising a plurality of probability values corresponding to a plurality of processor actions; and
transforming said action probability distribution.

324. The method of claim 323, further comprising:
receiving an action performed by a user;
selecting one of said plurality of processor actions;
determining an outcome value based on said user action and said selected processor action; and
updating said action probability distribution prior to said action probability distribution transformation, said action probability distribution update being based on said outcome value.

325. The method of claim 324, wherein said selected user action is selected in response to said user action.

326. The method of claim 323, wherein said processing device has one or more objectives, the method further comprising generating a performance index indicative of a performance of said processing device relative to said one or more objectives, wherein said action probability distribution transformation is based on said performance index.

327. The method of claim 323, wherein said transformation is performed deterministically.

328. The method of claim 323, wherein said transformation is performed modified quasi-deterministically.

329. The method of claim 323, wherein said transformation is performed probabilistically.

330. The method of claim 323, wherein said action probability distribution transformation comprises assigning a value to one or more of said plurality of probability values.

331. The method of claim 323, wherein said action probability distribution transformation comprises switching a higher probability value and a lower probability value.

332. The method of claim 323, wherein said action probability distribution transformation comprises switching a set of highest probability values and a set lowest probability values.

333. The method of claim 323, wherein said action probability distribution is updated using a learning automaton.

334. A method of providing learning capability to a computer game, comprising:
generating an action probability distribution comprising a plurality of probability values corresponding to a plurality of game actions; and
transforming said action probability distribution.

335. The method of claim 334, further comprising:
receiving an action performed by a game player;
selecting one of said plurality of game actions;
determining an outcome value based on said player action and said selected processor action; and
updating said action probability distribution prior to said action probability distribution transformation, said action probability distribution update being based on said outcome value.

336. The method of claim 335, wherein said selected game action is selected in response to said player action.

337. The method of claim 334, wherein said plurality of game actions is performed by a game-manipulated object, and said player action is performed by a user-manipulated object.

338. The method of claim 337, wherein said plurality of game actions comprises discrete movements of said game-manipulated object.

339. The method of claim 337, wherein said plurality of game actions comprises a plurality of delays related to a movement of said game-manipulated object.

340. The method of claim 337, wherein said player action comprises a simulated shot taken by said user-manipulated object.

341. The method of claim 337, wherein said game-manipulated object and said user-manipulated object are visual to said game player.

342. The method of claim 334, wherein said transformation is performed deterministically.

343. The method of claim 334, wherein said transformation is performed modified quasi-deterministically.

344. The method of claim 334, wherein said transformation is performed probabilistically.

345. The method of claim 334, wherein said action probability distribution transformation comprises assigning a value to one or more of said plurality of probability values.

346. The method of claim 334, wherein said action probability distribution transformation comprises switching a higher probability value and a lower probability value.

347. The method of claim 334, wherein said action probability distribution transformation comprises switching a set of highest probability values and a set lowest probability values.

348. The method of claim 334, wherein said relative skill level is obtained from a difference between a game player score and a computer game score.

349. The method of claim 334, wherein said action probability distribution is transformed based on a skill level of a game player relative to a skill level of said computer game.

350. The method of claim 349, wherein said action probability distribution transformation comprises switching a higher probability value and a lower probability value if said relative skill level is greater than a threshold level.

351. The method of claim 349, wherein said action probability distribution transformation comprises switching a set of highest probability values and a set of lowest probability values if said relative skill level is greater than a threshold level.

352. The method of claim 349, wherein said action probability distribution transformation comprises switching a higher probability value and a lower probability value if said relative skill level is less than a threshold level.

353. The method of claim 349, wherein said action probability distribution transformation comprises switching a set of highest probability values and a set of lowest probability values if said relative skill level is less than a threshold level.

354. The method of claim 334, wherein said action probability distribution is updated using a learning automaton.

355. A method of providing learning capability to a processing device, comprising:
generating an action probability distribution comprising a plurality of probability values corresponding to a plurality of processor actions; and
limiting one or more of said plurality of probability values.

356. The method of claim 355, further comprising:
receiving an action performed by a user;
selecting one of said plurality of processor actions;
determining an outcome value based on one or more said user action and said selected processor action; and
updating said action probability distribution based on said outcome value.

357. The method of claim 356, wherein said outcome value is determined based on said user action.

358. The method of claim 356, wherein said outcome value is determined based on said selected processor action.

359. The method of claim 356, wherein said outcome value is determined based on both said user action and said selected processor action.

360. The method of claim 356, wherein said selected user action is selected in response to said user action.

361. The method of claim 355, wherein said processing device has one or more objectives, the method further comprising generating a performance index indicative of a performance of said processing device relative to said one or more objectives, wherein said probability value limitation is based on said performance index.

362. The method of claim 355, wherein said one or more probability values are limited to a high value.

363. The method of claim 355, wherein said one or more probability values are limited to a low value.

364. The method of claim 355, wherein said plurality of probability values is limited.

365. The method of claim 355, wherein said action probability distribution is updated using a learning automaton.

366. A method of providing learning capability to a computer game, comprising:
generating an action probability distribution comprising a plurality of probability values corresponding to a plurality of game actions; and
limiting one or more of said plurality of probability values.

367. The method of claim 366, further comprising:
receiving an action performed by a game player;
selecting one of said plurality of game actions;
determining an outcome value based on said player action and said selected processor action; and
updating said action probability distribution based on said outcome value.

368. The method of claim 367, wherein said selected game action is selected in response to said player action.

369. The method of claim 367, wherein said plurality of game actions is performed by a game-manipulated object, and said player action is performed by a user-manipulated object.

370. The method of claim 367, wherein said plurality of game actions comprises discrete movements of said game-manipulated object.

371. The method of claim 367, wherein said plurality of game actions comprises a plurality of delays related to a movement of said game-manipulated object.

372. The method of claim 367, wherein said player action comprises a simulated shot taken by said user-manipulated object.

373. The method of claim 367, wherein said game-manipulated object and said user-manipulated object are visual to said game player.

374. The method of claim 366, wherein said one or more probability values are limited to a high value.

375. The method of claim 366, wherein said one or more probability values are limited to a low value.

376. The method of claim 366, wherein said plurality of probability values is limited.

377. The method of claim 366, wherein said one or more probability values is limited based on a skill level of a game player relative to a skill level of said computer game.

378. The method of claim 377, wherein said relative skill level is obtained from a difference between a game player score and a computer game score.

379. The method of claim 366, wherein said action probability distribution is updated using a learning automaton.

380. A method of providing learning capability to a processing device, comprising:
receiving an action performed by a user;
selecting one of a plurality of processor actions based on an action probability distribution comprising a plurality of probability values corresponding to said plurality of processor actions;
determining an outcome value based on one or both of said user action and said selected processor action;
updating said action probability distribution based on said outcome value; and
repeating said foregoing steps, wherein said action probability distribution is prevented from substantially converging to a single probability value.

381. The method of claim 380, wherein said outcome value is determined based on said user action.

382. The method of claim 380, wherein said outcome value is determined based on said selected processor action.

383. The method of claim 380, wherein said outcome value is determined based on both said user action and said selected processor action.

384. The method of claim 380, wherein said selected processor action is selected in response to said user action.

385. The method of claim 380, wherein said outcome value is selected from only two values.

386. The method of claim 385, wherein said outcome value is selected from the integers “zero” and “one.”

387. The method of claim 380, wherein said outcome value is selected from a finite range of real numbers.

388. The method of claim 380, wherein said outcome value is selected from a range of continuous values.

389. The method of claim 380, wherein said outcome value is determined for said selected processor action.

390. The method of claim 380, wherein said outcome value is determined for a previously selected processor action.

391. The method of claim 380, wherein said outcome value is determined for a subsequently selected processor action.

392. The method of claim 380, further comprising initially generating said action probability distribution with equal probability values.

393. The method of claim 380, further comprising initially generating said action probability distribution with unequal probability values.

394. The method of claim 380, wherein said action probability distribution update comprises a linear update.

395. The method of claim 380, wherein said action probability distribution update comprises a linear reward-penalty update.

396. The method of claim 380, wherein said action probability distribution update comprises a linear reward-inaction update.

397. The method of claim 380, wherein said action probability distribution update comprises a linear inaction-penalty update.

398. The method of claim 380, wherein said action probability distribution update comprises a nonlinear update.

399. The method of claim 380, wherein said action probability distribution update comprises an absolutely expedient update.

400. The method of claim 380, wherein said action probability distribution is normalized.

401. The method of claim 380, wherein said selected processor action corresponds to the highest probability value within said action probability distribution.

402. The method of claim 380, wherein said selected processor action is pseudo-randomly selected from said plurality of processor actions.

403. The method of claim 380, wherein said processing device is a computer game, said user action is a player action, and said processor actions are game action.

404. The method of claim 380, wherein said processing device is a telephone system, said user action is a called phone number, and said processor actions are listed phone numbers.

405. The method of claim 380, wherein said action probability distribution is updated using a learning automaton.

406. A processing device, comprising:
a probabilistic learning module configured for learning a plurality of processor actions in response to a plurality of actions performed by a user; and
an intuition module configured for preventing said probabilistic learning module from substantially converging to a single processor action.

407. The processing device of claim 406, wherein said intuition module is deterministic.

408. The processing device of claim 406, wherein said intuition module is quasi-deterministic.

409. The processing device of claim 406, wherein said intuition module is probabilistic.

410. The processing device of claim 406, wherein said intuition module comprises artificial intelligence.

411. The processing device of claim 406, wherein said intuition module comprises an expert system.

412. The processing device of claim 406, wherein said intuition module comprises a neural network.

413. The processing device of claim 406, wherein said intuition module comprises fuzzy logic.

414. The processing device of claim 406, wherein said probabilistic learning module comprises:
an action selection module configured for selecting one of a plurality of processor actions, said action selection being based on an action probability distribution comprising a plurality of probability values corresponding to said plurality of processor actions;
an outcome evaluation module configured for determining an outcome value based on one or both of said user action and said selected processor action; and
a probability update module configured for updating said action probability distribution based on said outcome value.

415. The processing device of claim 414, wherein said outcome value is determined based on said user action.

416. The processing device of claim 414, wherein said outcome value is determined based on said selected processor action.

417. The processing device of claim 414, wherein said outcome value is determined based on both said user action and said selected processor action.

418. The processing device of claim 406, wherein said probability learning module is comprises a learning automaton.

419. A method of providing learning capability to an electronic device having a function independent of determining an optimum action, comprising:
receiving an action performed by a user;
selecting one of a plurality of processor actions, said action selection being based on an action probability distribution comprising a plurality of probability values corresponding to said plurality of processor actions, wherein said selected processor action affects said electronic device function;
determining an outcome value based on said user action and said selected processor action; and
updating said action probability distribution based on said outcome value.

420. The method of claim 419, wherein said selected processor action is selected in response to said user action.

421. The method of claim 419, wherein said outcome value is selected from only two values.

422. The method of claim 421, wherein said outcome value is selected from the integers “zero” and “one.”

423. The method of claim 419, wherein said outcome value is selected from a finite range of real numbers.

424. The method of claim 419, wherein said outcome value is selected from a range of continuous values.

425. The method of claim 419, wherein said outcome value is determined for said selected processor action.

426. The method of claim 419, wherein said outcome value is determined for a previously selected processor action.

427. The method of claim 419, wherein said outcome value is determined for a subsequently selected processor action.

428. The method of claim 419, further comprising initially generating said action probability distribution with equal probability values.

429. The method of claim 419, further comprising initially generating said action probability distribution with unequal probability values.

430. The method of claim 419, wherein said action probability distribution update comprises a linear update.

431. The method of claim 419, wherein said action probability distribution update comprises a linear reward-penalty update.

432. The method of claim 419, wherein said action probability distribution update comprises a linear reward-inaction update.

433. The method of claim 419, wherein said action probability distribution update comprises a linear inaction-penalty update.

434. The method of claim 419, wherein said action probability distribution update comprises a nonlinear update.

435. The method of claim 419, wherein said action probability distribution update comprises an absolutely expedient update.

436. The method of claim 419, wherein said action probability distribution is normalized.

437. The method of claim 419, wherein said selected processor action corresponds to the highest probability value within said action probability distribution.

438. The method of claim 419, wherein said selected processor action is pseudo-randomly selected from said plurality of processor actions.

439. The method of claim 419, wherein said processing device is a computer game, said user action is a player action, and said processor actions are game actions.

440. The method of claim 419, wherein said processing device is a telephone system, said user action is a called phone number, and said processor actions are listed phone numbers.

441. The method of claim 419, wherein said processing device is a consumer electronics device.

442. The method of claim 419, wherein said processing device is a personal digital assistant.

443. The method of claim 419, wherein said processing device is an audio/video device.

444. The method of claim 419, wherein said action probability distribution is updated using a learning automaton.

445. A processing device having a function independent of determining an optimum action, comprising:
an action selection module configured for selecting one of a plurality of processor actions, said action selection being based on an action probability distribution comprising a plurality of probability values corresponding to said plurality of processor actions, wherein said selected processor action affects said electronic device function;
an outcome evaluation module configured for determining an outcome value based on one or both of said user action and said selected processor action; and
a probability update module configured for updating said action probability distribution based on said outcome value.

446. The processing device of claim 445, wherein said outcome value is determined based on said user action.

447. The processing device of claim 445, wherein said outcome value is determined based on said selected processor action.

448. The processing device of claim 445, wherein said outcome value is determined based on both said user action and said selected processor action.

449. The processing device of claim 445, wherein said processing device is a computer game.

450. The processing device of claim 445, wherein said processing device is a consumer electronics device.

451. The processing device of claim 445, wherein said processing device is a mobile phone.

452. The processing device of claim 445, wherein said processing device is a personal digital assistant.

453. The processing device of claim 445, wherein said processing device is an audio/video device.

454. The processing device of claim 445, wherein said probability learning module comprises a learning automaton.

455. A method of providing learning capability to a processing device having one or more objectives, comprising:
receiving actions from a plurality of users;
selecting one or more of a plurality of processor actions based on an action probability distribution comprising a plurality of probability values corresponding to said plurality of processor actions;
determining one or more outcome values based on one or both of said plurality of user actions and said selected one or more processor actions;
updating said action probability distribution using one or more learning automatons based on said one or more outcome values; and
modifying one or more subsequent processor action selections, outcome value determinations, and action probability distribution updates based on said one or more objectives.

456. The method of claim 455, wherein said one or more outcome values are based on said plurality of user actions.

457. The method of claim 455, wherein said one or more outcome values are based on said selected one or more processor actions.

458. The method of claim 455, wherein said one or more outcome values are based on both said plurality of user actions and said selected one or more processor actions.

459. The method of claim 455, wherein said selected one or more processor actions comprises a single processor action corresponding to said plurality of user actions.

460. The method of claim 455, wherein said selected one or more processor actions comprises a plurality of processor actions respectively corresponding to said plurality of user actions.

461. The method of claim 455, wherein said one or more outcome values comprises a single outcome value corresponding to said plurality of user actions.

462. The method of claim 455, wherein said one or more outcome values comprises a plurality of outcome values respectively corresponding to said plurality of user actions.

463. The method of claim 455, wherein said action probability distribution is updated when a predetermined period of time has expired.

464. The method of claim 455, wherein said action probability distribution is updated in response to the receipt of each user action.

465. The method of claim 455, wherein said selected processor action is selected in response to said plurality of user actions.

466. The method of claim 455, further comprising generating one or more performance indexes indicative of a performance of said processing device relative to said one or more objectives, wherein said modification is based on said one or more performance indexes.

467. The method of claim 466, wherein said one or more performance indexes comprises a single performance index corresponding to said plurality of user actions.

468. The method of claim 466, wherein said one or more performance indexes comprises a plurality of performance indexes respectively corresponding to said plurality of user actions.

469. The method of claim 455, wherein said modification comprises modifying a subsequently performed action selection.

470. The method of claim 455, wherein said modification comprises modifying a subsequently performed outcome value determination.

471. The method of claim 455, wherein said modification comprises modifying a subsequently performed action probability distribution update.

472. The method of claim 455, wherein said modification comprises selecting one of a predetermined plurality of algorithms employed by said one or more subsequent processor action selections, outcome value determinations, and action probability distribution updates.

473. The method of claim 455, wherein said modification comprises modifying a parameter of an algorithm employed by said one or more subsequent processor action selections, outcome value determinations, and action probability distribution updates.

474. The method of claim 455, wherein outcome value determination is performed only after several iterations of said user action receiving and processor action selection.

475. The method of claim 455, wherein said probability distribution update is performed only after several iterations of said user action receiving and processor action selection.

476. The method of claim 455, wherein said probability distribution update is performed only after several iterations of said user action receiving, processor action selection, and outcome value determination.

477. The method of claim 455, wherein said processing device is a computer game, said user actions are player actions, and said processor actions are game actions.

478. A method of providing learning capability to a processing device having one or more objectives, comprising:
receiving actions from users divided amongst a plurality of user sets;
for each of said user sets:
selecting one or more of a plurality of processor actions based on an action probability distribution comprising a plurality of probability values corresponding to said plurality of processor actions;
determining one or more outcome values based on one or more actions from said each user set and said selected one or more processor actions;
updating said action probability distribution using a learning automaton based on said one or more outcome values; and
modifying one or more subsequent processor action selections, outcome value determinations, and action probability distribution updates based on said one or more objectives.

479. The method of claim 478, wherein each user set comprises a single user.

480. The method of claim 478, wherein each user set comprises a plurality of users.

481. The method of claim 480, wherein said selected one or more processor actions comprises a single processor action corresponding to actions from said plurality of users.

482. The method of claim 480, wherein said selected one or more processor actions comprises a plurality of processor actions respectively corresponding to actions from said plurality of users.

483. The method of claim 480, wherein said one or more outcome values comprises a single outcome value corresponding to actions from said plurality of users.

484. The method of claim 480, wherein said one or more outcome values comprises a plurality of outcome values respectively corresponding to actions from said plurality of users.

485. The method of claim 478, wherein said action probability distribution is updated when a predetermined period of time has expired.

486. The method of claim 478, wherein said action probability distribution is updated in response to the receipt of each user action.

487. The method of claim 478, wherein said selected one or more processor actions is selected in response to said user actions.

488. The method of claim 478, further comprising generating one or more performance indexes indicative of a performance of said processing device relative to said one or more objectives, wherein said modification is based on said one or more performance indexes.

489. The method of claim 480, further comprising generating a single performance index indicative of a performance of said processing device relative to said one or more objectives, wherein said single performance index corresponds to said plurality of user actions and said modification is based on said single performance index.

490. The method of claim 480, further comprising generating a plurality of performance indexes indicative of a performance of said processing device relative to said one or more objectives, wherein said plurality of performance indexes corresponds to said plurality of user actions and said modification is based on said plurality of performance indexes.

491. The method of claim 478, wherein said modification comprises modifying a subsequently performed action selection.

492. The method of claim 478, wherein said modification comprises modifying a subsequently performed outcome value determination.

493. The method of claim 478, wherein said modification comprises modifying a subsequently performed action probability distribution update.

494. The method of claim 478, wherein said modification comprises selecting one of a predetermined plurality of algorithms employed by said one or more subsequent processor action selections, outcome value determinations, and action probability distribution updates.

495. The method of claim 478, wherein said modification comprises modifying a parameter of an algorithm employed by said one or more subsequent processor action selections, outcome value determinations, and action probability distribution updates.

496. The method of claim 478, wherein outcome value determination is performed only after several iterations of said user action receiving and processor action selection.

497. The method of claim 478, wherein said probability distribution update is performed only after several iterations of said user action receiving and processor action selection.

498. The method of claim 478, wherein said probability distribution update is performed only after several iterations of said user action receiving, processor action selection, and outcome value determination.

499. The method of claim 478, wherein said processing device is a computer game, said user actions are player actions, and said processor actions are game actions.

500. The method of claim 478, wherein said processing device is a telephone system, said user actions are called phone numbers, and said processor actions are listed phone numbers.

501. A processing device having one or more objectives, comprising:
a probabilistic learning module having a learning automaton configured for learning a plurality of processor actions in response to actions from a plurality of users; and
an intuition module configured for modifying a functionality of said probabilistic learning module based on said one or more objectives.

502. The processing device of claim 501, wherein said intuition module is further configured for generating one or more performance indexes indicative of a performance of said probabilistic learning module relative to said one or more objectives, and for modifying said probabilistic learning module functionality based on said one or more performance indexes.

503. The processing device of claim 502, wherein said one or more performance indexes comprises a single performance index corresponding to said plurality of users.

504. The processing device of claim 502, wherein said one or more performance indexes comprises a plurality of performance indexes respectively corresponding to said plurality of users.

505. The processing device of claim 501, wherein said one or more outcome values comprises a single outcome value corresponding to said plurality of user actions.

506. The processing device of claim 501, wherein said one or more outcome values comprises a plurality of outcome values respectively corresponding to said plurality of user actions.

507. The processing device of claim 501, wherein said intuition module is configured for selecting one of a predetermined plurality of algorithms employed by said learning module.

508. The processing device of claim 501, wherein said intuition module is configured for modifying a parameter of an algorithm employed by said learning module.

509. The processing device of claim 501, wherein said probabilistic learning module comprises:
one or more action selection modules configured for selecting one or more of a plurality of processor actions, said action selection being based on an action probability distribution comprising a plurality of probability values corresponding to said plurality of processor actions;
one or more outcome evaluation modules configured for determining one or more outcome values based on one or both of said plurality of user actions and said selected one or more processor actions; and
a probability update module configured for updating said action probability distribution based on said one or more outcome values.

510. The processing device of claim 509, wherein said one or more outcome values are based on said plurality of user actions.

511. The processing device of claim 509, wherein said one or more outcome values are based on said selected one or more processor actions.

512. The processing device of claim 509, wherein said one or more outcome values are based on both said plurality of user actions and said selected one or more processor actions.

513. The processing device of claim 509, wherein said selected one or more processor actions comprises a single processor action corresponding to said plurality of user actions.

514. The processing device of claim 509, wherein said selected one or more processor actions comprises a plurality of processor actions respectively corresponding to said plurality of user actions.

515. The processing device of claim 509, wherein said intuition module is configured for modifying a functionality of said one or more action selection modules based on said one or more objectives.

516. The processing device of claim 509, wherein said intuition module is configured for modifying a functionality of said one or more outcome evaluation modules based on said one or more objectives.

517. The processing device of claim 509, wherein said intuition module is configured for modifying a functionality of said probability update module based on said one or more objectives.

518. The processing device of claim 509, further comprising:
a server storing said one or more action selection modules, said one or more outcome evaluation modules, and said probability update module;
a plurality of computers configuring for respectively generating said plurality of user actions; and
a network configured for transmitting said plurality of user actions from said plurality of computers to said server and for transmitting said selected one or more processor actions from said server to said plurality of computers.

519. The processing device of claim 509, wherein said one or more action selection modules comprises a plurality of action selection modules, and said selected one or more processor actions comprises a plurality of processor actions, the processing device further comprising:
a server storing said one or more outcome evaluation modules, and said probability update module;
a plurality of computers configuring for respectively generating said plurality of user actions, said plurality of computers respectively storing said plurality of action selection modules; and
a network configured for transmitting said plurality of user actions and said selected plurality of processor actions from said plurality of computers to said server.

520. The processing device of claim 509, wherein said one or more action selection modules comprises a plurality of action selection modules, said selected one or more processor actions comprises a plurality of processor actions, said one or more outcome evaluation modules comprises a plurality of outcome evaluation modules, and said one or more outcome values comprises a plurality of outcome values, the processing device further comprising:
a server storing said probability update module;
a plurality of computers configuring for respectively generating said plurality of user actions, said plurality of computers respectively storing said plurality of action selection modules and said plurality of outcome evaluation modules; and
a network configured for transmitting said plurality of outcome values from said plurality of computers to said server.

521. The processing device of claim 501, wherein said plurality of users are divided amongst a plurality of user sets, and wherein said probabilistic learning module comprises:
one or more action selection modules configured for, each user set, selecting one or more of a plurality of processor actions, said action selection being based on an action probability distribution comprising a plurality of probability values corresponding to said plurality of processor actions;
one or more outcome evaluation modules configured for, for said each user set, determining one or more outcome values based on one or both of one or more user actions and said selected one or more processor actions; and
one or more probability update modules configured for, for said each user set, updating said action probability distribution based on said one or more outcome values.

522. The processing device of claim 521, wherein said one or more outcome values are based on said plurality of user actions.

523. The processing device of claim 521, wherein said one or more outcome values are based on said selected one or more processor actions.

524. The processing device of claim 521, wherein said one or more outcome values are based on both said plurality of user actions and said selected one or more processor actions.

525. The processing device of claim 521, wherein each user set comprises a single user.

526. The processing device of claim 521, wherein each user set comprises a plurality of users.

527. The processing device of claim 521, wherein said selected one or more processor actions comprises a single processor action corresponding to said plurality of user actions.

528. The processing device of claim 521, wherein said selected one or more processor actions comprises a plurality of processor actions respectively corresponding to said plurality of user actions.

529. The processing device of claim 521, wherein said intuition module is configured for modifying a functionality of said one or more action selection modules based on said one or more objectives.

530. The processing device of claim 521, wherein said intuition module is configured for modifying a functionality of said one or more outcome evaluation modules based on said one or more objectives.

531. The processing device of claim 521, wherein said intuition module is configured for modifying a functionality of said probability update module based on said one or more objectives.

532. The processing device of claim 521, further comprising:
a server storing said one or more action selection modules, said one or more outcome evaluation modules, and said one or more probability update modules;
a plurality of computers configuring for respectively generating said plurality of user actions; and
a network configured for transmitting said plurality of user actions from said plurality of computers to said server and for transmitting said selected one or more processor actions from said server to said plurality of computers.

533. The processing device of claim 521, wherein said one or more action selection modules comprises a plurality of action selection modules, and said selected one or more processor actions comprises a plurality of processor actions, the processing device further comprising:
a server storing said one or more outcome evaluation modules and said one or more probability update modules;
a plurality of computers configuring for respectively generating said plurality of user actions, said plurality of computers respectively storing said plurality of action selection modules; and
a network configured for transmitting said plurality of user actions and said selected plurality of processor actions from said plurality of computers to said server.

534. The processing device of claim 521, wherein said one or more action selection modules comprises a plurality of action selection modules, said selected one or more processor actions comprises a plurality of processor actions, said one or more outcome evaluation modules comprises a plurality of outcome evaluation modules, and said one or more outcome values comprises a plurality of outcome values, the processing device further comprising:
a server storing said one or more probability update modules;
a plurality of computers configuring for respectively generating said plurality of user actions, said plurality of computers respectively storing said plurality of action selection modules and said plurality of outcome evaluation modules; and
a network configured for transmitting said plurality of outcome values from said plurality of computers to said server.

535. The processing device of claim 520, wherein said one or more action selection modules comprises a plurality of action selection modules, said selected one or more processor actions comprises a plurality of processor actions, said one or more outcome evaluation modules comprises a plurality of outcome evaluation modules, and said one or more outcome values comprises a plurality of outcome values, said one or more probability update modules comprises a plurality of update modules for updating said plurality of action probability distributions, the processing device further comprising:
a server storing said a module for generating a centralized action probability distribution based on said plurality of action probability distributions, said centralized action probability distribution used to initialize a subsequent plurality of action probability distributions;
a plurality of computers configuring for respectively generating said plurality of user actions, said plurality of computers respectively storing said plurality of action selection modules, said plurality of outcome evaluation modules, and said plurality of probability update modules; and
a network configured for transmitting said plurality of action probability distributions from said plurality of computers to said server, and said centralized action probability distribution from said server to said plurality of computers.

536. A method of providing learning capability to a processing device having one or more objectives, comprising:
receiving a plurality of user actions;
selecting one or more of a plurality of processor actions based on an action probability distribution comprising a plurality of probability values corresponding to said plurality of processor actions;
weighting said plurality of user actions;
determining one or more outcome values based on said selected one or more processor actions and said plurality of weighted user actions; and
updating said action probability distribution based on said outcome value.

537. The method of claim 536, wherein said plurality of user actions is received from a plurality of users.

538. The method of claim 537, wherein said weighting is based on a skill level of said plurality of users.

539. The method of claim 536, wherein said one or more selected processor actions is selected in response to said plurality of user actions.

540. The method of claim 536, wherein said selected one or more processor actions comprises a single processor action corresponding to said plurality of user actions.

541. The method of claim 536, wherein said selected one or more processor actions comprises a plurality of processor actions respectively corresponding to said plurality of user actions.

542. The method of claim 536, wherein said one or more outcome values comprises a single outcome value corresponding to said plurality of user actions.

543. The method of claim 536, wherein said one or more outcome values comprises a plurality of outcome values respectively corresponding to said plurality of user actions.

544. The method of claim 536, further comprising modifying one or more subsequent processor action selections, outcome value determinations, and action probability distribution updates based on said one or more objectives.

545. The method of claim 544, further comprising generating one or more performance indexes indicative of a performance of said processing device relative to said one or more objectives, wherein said modification is based on said one or more performance indexes.

546. The method of claim 544, wherein said one or more performance indexes comprises a single performance index corresponding to said plurality of user actions.

547. The method of claim 544, wherein said one or more performance indexes comprises a plurality of performance indexes respectively corresponding to said plurality of user actions.

548. The method of claim 544, wherein said modification comprises modifying said weighting of said plurality of user actions.

549. The method of claim 544, wherein said modification comprises modifying a subsequently performed action selection.

550. The method of claim 544, wherein said modification comprises modifying a subsequently performed outcome value determination.

551. The method of claim 544, wherein said modification comprises modifying a subsequently performed action probability distribution update.

552. The method of claim 544, wherein said modification comprises selecting one of a predetermined plurality of algorithms employed by said one or more subsequent processor action selections, outcome value determinations, and action probability distribution updates.

553. The method of claim 544, wherein said modification comprises modifying a parameter of an algorithm employed by said one or more subsequent processor action selections, outcome value determinations, and action probability distribution updates.

554. The method of claim 536, wherein said action probability distribution is updated using a learning automaton.

555. The method of claim 536, wherein said processing device is a computer game, said user actions are player actions, and said processor actions are game actions.

556. A processing device having one or more objectives, comprising:
an action selection module configured for selecting one or more of a plurality of processor actions based on an action probability distribution comprising a plurality of probability values corresponding to said plurality of processor actions;
an outcome evaluation module configured for weighting a plurality of received user actions, and for determining one or more outcome values based on said selected one or more processor actions and said plurality of weighted user actions; and
a probability update module configured for updating said action probability distribution based on said outcome value.

557. The processing device of claim 556, wherein said plurality of user actions is received from a plurality of users.

558. The processing device of claim 557, wherein said weighting is based on a skill level of said plurality of users.

559. The processing device of claim 556, wherein said action selection module is configured for selecting said one or more selected processor actions in response to said plurality of user actions.

560. The processing device of claim 556, wherein said selected one or more processor actions comprises a single processor action corresponding to said plurality of user actions.

561. The processing device of claim 556, wherein said selected one or more processor actions comprises a plurality of processor actions respectively corresponding to said plurality of user actions.

562. The processing device of claim 556, wherein said one or more outcome values comprises a single outcome value corresponding to said plurality of user actions.

563. The processing device of claim 556, wherein said one or more outcome values comprises a plurality of outcome values respectively corresponding to said plurality of user actions.

564. The processing device of claim 556, further comprising an intuition module configured for modifying one or more subsequent processor action selections, outcome value determinations, and action probability distribution updates based on said one or more objectives.

565. The processing device of claim 564, wherein said intuition module is further configured for generating one or more performance indexes indicative of a performance of said processing device relative to said one or more objectives, wherein said modification is based on said one or more performance indexes.

566. The processing device of claim 564, wherein said one or more performance indexes comprises a single performance index corresponding to said plurality of user actions.

567. The processing device of claim 564, wherein said one or more performance indexes comprises a plurality of performance indexes respectively corresponding to said plurality of user actions.

568. The processing device of claim 564, wherein said intuition module is configured for modifying a functionality of said action selection module based on said one or more objectives.

569. The processing device of claim 564, wherein said intuition module is configured for modifying a functionality of said outcome evaluation module based on said one or more objectives.

570. The processing device of claim 564, wherein said intuition module is configured for modifying a functionality of said probability update module based on said one or more objectives.

571. The processing device of claim 556, wherein said probability update module comprises a learning automaton.

572. A method of providing learning capability to a processing device having one or more objectives, comprising:
receiving a plurality of user actions;
selecting one of a plurality of processor actions based on an action probability distribution comprising a plurality of probability values corresponding to said plurality of processor actions;
determining a success ratio of said selected processor action relative to said plurality of user actions;
comparing said determined success ratio to a reference success ratio;
determining an outcome value based on said success ratio comparison; and
updating said action probability distribution based on said outcome value.

573. The method of claim 572, wherein said plurality of user actions is received from a plurality of users.

574. The method of claim 572, wherein said plurality of user actions is received from a single user.

575. The method of claim 572, wherein said reference success ratio is a simple majority.

576. The method of claim 572, wherein said reference success ratio is a minority.

577. The method of claim 572, wherein said reference success ratio is a super majority.

578. The method of claim 572, wherein said reference success ratio is a unanimity.

579. The method of claim 572, wherein said reference success ratio is an equality.

580. The method of claim 572, wherein said selected processor action is selected in response to said plurality of user actions.

581. The method of claim 572, further comprising modifying one or more subsequent processor action selections, outcome value determinations, and action probability distribution updates based on said one or more objectives.

582. The method of claim 581, further comprising generating one or more performance indexes indicative of a performance of said processing device relative to said one or more objectives, wherein said modification is based on said one or more performance indexes.

583. The method of claim 581, wherein said modification comprises modifying said reference success ratio.

584. The method of claim 581, wherein said modification comprises modifying a subsequently performed action selection.

585. The method of claim 581, wherein said modification comprises modifying a subsequently performed outcome value determination.

586. The method of claim 581, wherein said modification comprises modifying a subsequently performed action probability distribution update.

587. The method of claim 581, wherein said modification comprises selecting one of a predetermined plurality of algorithms employed by said one or more subsequent processor action selections, outcome value determinations, and action probability distribution updates.

588. The method of claim 581, wherein said modification comprises modifying a parameter of an algorithm employed by said one or more subsequent processor action selections, outcome value determinations, and action probability distribution updates.

589. The method of claim 572, wherein said action probability distribution is updated using a learning automaton.

590. The method of claim 572, wherein said processing device is a computer game, said user actions are player actions, and said processor actions are game actions.

591. A processing device having one or more objectives, comprising:
an action selection module configured for selecting one of a plurality of processor actions based on an action probability distribution comprising a plurality of probability values corresponding to said plurality of processor actions;
an outcome evaluation module configured for determining a success ratio of said selected processor action relative to a plurality of user actions, for comparing said determined success ratio to a reference success ratio, and for determining an outcome value based on said success ratio comparison; and
a probability update module configured for updating said action probability distribution based on said outcome value.

592. The processing device of claim 591, wherein said plurality of user actions is received from a plurality of users.

593. The processing device of claim 591, wherein said plurality of user actions is received from a single user.

594. The processing device of claim 591, wherein said reference success ratio is a simple majority.

595. The processing device of claim 591, wherein said reference success ratio is a minority.

596. The processing device of claim 591, wherein said reference success ratio is a super majority.

597. The processing device of claim 591, wherein said reference success ratio is a unanimity.

598. The processing device of claim 591, wherein said reference success ratio is an equality.

599. The processing device of claim 591, wherein said action selection module is configured for selecting said processor action in response to said plurality of user actions.

600. The processing device of claim 591, further comprising an intuition module configured for modifying one or more subsequent processor action selections, outcome value determinations, and action probability distribution updates based on said one or more objectives.

601. The processing device of claim 600, wherein said intuition module is further configured for generating one or more performance indexes indicative of a performance of said processing device relative to said one or more objectives, wherein said modification is based on said one or more performance indexes.

602. The processing device of claim 600, wherein said one or more performance indexes comprises a single performance index corresponding to said plurality of user actions.

603. The processing device of claim 600, wherein said one or more performance indexes comprises a plurality of performance indexes respectively corresponding to said plurality of user actions.

604. The processing device of claim 600, wherein said intuition module is configured for modifying a functionality of said action selection module based on said one or more objectives.

605. The processing device of claim 600, wherein said intuition module is configured for modifying a functionality of said outcome evaluation module based on said one or more objectives.

606. The processing device of claim 600, wherein said intuition module is configured for modifying a functionality of said probability update module based on said one or more objectives.

607. The processing device of claim 591, wherein said probability update module comprises a learning automaton.

608. A method of providing learning capability to a processing device having one or more objectives, comprising:
receiving actions from a plurality of users;
selecting one of a plurality of processor actions based on an action probability distribution comprising a plurality of probability values corresponding to said plurality of processor actions;
determining if said selected processor action has a relative success level for a majority of said plurality of users;
determining an outcome value based on said success determination; and
updating said action probability distribution based on said outcome value.

609. The method of claim 608, wherein said reference success level is a greatest success.

610. The method of claim 608, wherein said reference success level is a least success.

611. The method of claim 608, wherein said reference success level is an average success.

612. The method of claim 608, further comprising maintaining separate action probability distributions for said plurality of users, wherein said relative success level of said selected processor action is determined from said separate action probability distributions.

613. The method of claim 608, further comprising maintaining an estimator success table for said plurality of users, wherein said relative success level of said selected processor action is determined from said estimator table.

614. The method of claim 608, wherein said selected processor action is selected in response to said plurality of user actions.

615. The method of claim 608, further comprising modifying one or more subsequent processor action selections, outcome value determinations, and action probability distribution updates based on said one or more objectives.

616. The method of claim 615, further comprising generating one or more performance indexes indicative of a performance of said processing device relative to said one or more objectives, wherein said modification is based on said one or more performance indexes.

617. The method of claim 615, wherein said modification comprises modifying said relative success level.

618. The method of claim 615, wherein said modification comprises modifying a subsequently performed action selection.

619. The method of claim 615, wherein said modification comprises modifying a subsequently performed outcome value determination.

620. The method of claim 615, wherein said modification comprises modifying a subsequently performed action probability distribution update.

621. The method of claim 615, wherein said modification comprises selecting one of a predetermined plurality of algorithms employed by said one or more subsequent processor action selections, outcome value determinations, and action probability distribution updates.

622. The method of claim 615, wherein said modification comprises modifying a parameter of an algorithm employed by said one or more subsequent processor action selections, outcome value determinations, and action probability distribution updates.

623. The method of claim 608, wherein said action probability distribution is updated using a learning automaton.

624. The method of claim 608, wherein said processing device is a computer game, said user actions are player actions, and said processor actions are game actions.

625. A processing device having one or more objectives, comprising:
an action selection module configured for selecting one of a plurality of processor actions based on an action probability distribution comprising a plurality of probability values corresponding to said plurality of processor actions;
an outcome evaluation module configured for determining if said selected processor action has a relative success level for a majority of a plurality of users, and for determining an outcome value based on said success determination; and
a probability update module configured for updating said action probability distribution based on said outcome value.

626. The processing device of claim 625, wherein said reference success level is a greatest success.

627. The processing device of claim 625, wherein said reference success level is a least success.

628. The processing device of claim 625, wherein said reference success level is an average success.

629. The processing device of claim 625, wherein said probability update module is further configured for maintaining separate action probability distributions for said plurality of users, and said outcome evaluation module is configured for determining said relative success level of said selected processor action from said separate action probability distributions.

630. The processing device of claim 625, wherein said outcome evaluation module is further configured for maintaining an estimator success table for said plurality of users, and for determining said relative success level of said selected processor action from said estimator table.

631. The processing device of claim 625, wherein said action selection module is configured for selecting said selected processor action in response to said plurality of user actions.

632. The processing device of claim 625, further comprising an intuition module configured for modifying one or more subsequent processor action selections, outcome value determinations, and action probability distribution updates based on said one or more objectives.

633. The processing device of claim 632, wherein said intuition module is further configured for generating one or more performance indexes indicative of a performance of said processing device relative to said one or more objectives, wherein said modification is based on said one or more performance indexes.

634. The processing device of claim 632, wherein said one or more performance indexes comprises a single performance index corresponding to said plurality of user actions.

635. The processing device of claim 632, wherein said one or more performance indexes comprises a plurality of performance indexes respectively corresponding to said plurality of user actions.

636. The processing device of claim 632, wherein said intuition module is configured for modifying a functionality of said action selection module based on said one or more objectives.

637. The processing device of claim 632, wherein said intuition module is configured for modifying a functionality of said outcome evaluation module based on said one or more objectives.

638. The processing device of claim 632, wherein said intuition module is configured for modifying a functionality of said probability update module based on said one or more objectives.

639. The processing device of claim 625, wherein said probability update module comprises a learning automaton.

640. A method of providing learning capability to a processing device having one or more objectives, comprising:
receiving one or more user actions;
selecting one or more of a plurality of processor actions that are respectively linked to a plurality of user parameters, said selection being based on an action probability distribution comprising a plurality of probability values corresponding to said plurality of linked processor actions;
linking said one or more selected process actions with one or more of said plurality of user parameters;
determining one or more outcome values based on said one or more linked processor actions and said one or more user actions; and
updating said action probability distribution based on said one or more outcome values.

641. The method of claim 640, wherein said plurality of user parameters comprises a plurality of user actions.

642. The method of claim 640, wherein said plurality of user parameters comprises a plurality of users.

643. The method of claim 640, wherein said plurality of processor actions is linked to another plurality of user parameters.

644. The method of claim 643, wherein said plurality of user parameters comprises a plurality of user actions, and said other plurality of user parameters comprises a plurality of users.

645. The method of claim 640, wherein said selected one or more processor actions is selected in response to said one or more user actions.

646. The method of claim 640, wherein said one or more user actions comprises a plurality of user actions.

647. The method of claim 646, wherein said selected one or more processor actions comprises a single processor action corresponding to said plurality of user actions.

648. The method of claim 646, wherein said selected one or more processor actions comprises a plurality of processor actions respectively corresponding to said plurality of user actions.

649. The method of claim 646, wherein said one or more outcome values comprises a single outcome value corresponding to said plurality of user actions.

650. The method of claim 646, wherein said one or more outcome values comprises a plurality of outcome values respectively corresponding to said plurality of user actions.

651. The method of claim 640, further comprising modifying one or more subsequent processor action selections, outcome value determinations, and action probability distribution updates based on said one or more objectives.

652. The method of claim 651, further comprising generating one or more performance indexes indicative of a performance of said processing device relative to said one or more objectives, wherein said modification is based on said one or more performance indexes.

653. The method of claim 651, wherein said modification comprises modifying said reference success ratio.

654. The method of claim 651, wherein said modification comprises modifying a subsequently performed action selection.

655. The method of claim 651, wherein said modification comprises modifying a subsequently performed outcome value determination.

656. The method of claim 651, wherein said modification comprises modifying a subsequently performed action probability distribution update.

657. The method of claim 651, wherein said modification comprises selecting one of a predetermined plurality of algorithms employed by said one or more subsequent processor action selections, outcome value determinations, and action probability distribution updates.

658. The method of claim 651, wherein said modification comprises modifying a parameter of an algorithm employed by said one or more subsequent processor action selections, outcome value determinations, and action probability distribution updates.

659. The method of claim 640, wherein said action probability distribution is updated using a learning automaton.

660. The method of claim 640, wherein said processing device is a computer game, said one or more user actions are one or more player actions, and said processor actions are game actions.

661. A processing device having one or more objectives, comprising:
an action selection module configured for selecting one or more of a plurality of processor actions that are respectively linked to a plurality of user parameters, said selection being based on an action probability distribution comprising a plurality of probability values corresponding to said plurality of linked processor actions;
an outcome evaluation module configured for linking said one or more selected process actions with one or more of said plurality of user parameters, and for determining one or more outcome values based on said one or more linked processor actions and one or more user actions; and
a probability update module configured for updating said action probability distribution based on said one or more outcome values.

662. The processing device of claim 661, wherein said plurality of user parameters comprises a plurality of user actions.

663. The processing device of claim 661, wherein said plurality of user parameters comprises a plurality of users.

664. The processing device of claim 661, wherein said outcome evaluation module is configured for linking said plurality of processor actions to another plurality of user parameters.

665. The processing device of claim 664, wherein said plurality of user parameters comprises a plurality of user actions, and said other plurality of user parameters comprises a plurality of users.

666. The processing device of claim 661, wherein said action selection module is configured for selecting said selected one or more processor actions in response to said one or more user actions.

667. The processing device of claim 661, wherein said one or more user actions comprises a plurality of user actions.

668. The processing device of claim 667, wherein said selected one or more processor actions comprises a single processor action corresponding to said plurality of user actions.

669. The processing device of claim 667, wherein said selected one or more processor actions comprises a plurality of processor actions respectively corresponding to said plurality of user actions.

670. The processing device of claim 667, wherein said one or more outcome values comprises a single outcome value corresponding to said plurality of user actions.

671. The processing device of claim 667, wherein said one or more outcome values comprises a plurality of outcome values respectively corresponding to said plurality of user actions.

672. The processing device of claim 661, further comprising an intuition module configured for modifying one or more subsequent processor action selections, outcome value determinations, and action probability distribution updates based on said one or more objectives.

673. The processing device of claim 672, wherein said intuition module is further configured for generating one or more performance indexes indicative of a performance of said processing device relative to said one or more objectives, wherein said modification is based on said one or more performance indexes.

674. The processing device of claim 672, wherein said one or more performance indexes comprises a single performance index corresponding to said plurality of user actions.

675. The processing device of claim 672, wherein said one or more performance indexes comprises a plurality of performance indexes respectively corresponding to said plurality of user actions.

676. The processing device of claim 672, wherein said intuition module is configured for modifying a functionality of said action selection module based on said one or more objectives.

677. The processing device of claim 672, wherein said intuition module is configured for modifying a functionality of said outcome evaluation module based on said one or more objectives.

678. The processing device of claim 672, wherein said intuition module is configured for modifying a functionality of said probability update module based on said one or more objectives.

679. The processing device of claim 661, wherein said probability update module comprises a learning automaton.

680. A method of providing learning capability to a phone number calling system having an objective of anticipating called phone numbers, comprising:
generating a phone list containing at least a plurality of listed phone numbers and a phone number probability distribution comprising a plurality of probability values corresponding to said plurality of listed phone numbers;
selecting a set of phone numbers from said plurality of listed phone numbers based on said phone number probability distribution;
generating a performance index indicative of a performance of said phone number calling system relative to said objective; and
modifying said phone number probability distribution based on said performance index.

681. The method of claim 680, further comprising:
identifying a phone number associated with a phone call; and
determining if said identified phone number matches any listed phone number contained in said phone number list, wherein said performance index is derived from said matching determination.

682. The method of claim 680, wherein said selected phone number set is communicated to a user of said phone number calling system.

683. The method of claim 682, wherein said selected phone number set is displayed to said user.

684. The method of claim 680, wherein said selected phone number set comprises a plurality of selected phone numbers.

685. The method of claim 680, further comprising selecting a phone number from said selected phone number set to make a phone call.

686. The method of claim 680, wherein said selected phone number set corresponds to the highest probability values in said phone number probability distribution.

687. The method of claim 680, further comprising placing said selected phone number set in an order according to corresponding probability values.

688. The method of claim 680, wherein said identified phone number is associated with an outgoing phone call.

689. The method of claim 680, wherein said identified phone number is associated with an incoming phone call.

690. The method of claim 680, wherein said phone number probability distribution is modified by updating said phone number probability distribution.

691. The method of claim 690, wherein said phone number probability distribution update comprises a reward-inaction update.

692. The method of claim 680, wherein said phone number probability distribution is modified by increasing a probability value.

693. The method of claim 680, wherein said phone number probability distribution is modified by adding a probability value.

694. The method of claim 693, wherein said phone number probability distribution is modified by replacing a probability value with said added probability value.

695. The method of claim 680, wherein said plurality of probability values correspond to all phone numbers within said phone number list.

696. The method of claim 680, wherein said plurality of probability values correspond only to said plurality of phone numbers.

697. The method of claim 680, wherein said performance index is instantaneous.

698. The method of claim 680, wherein said performance index is cumulative.

699. The method of claim 681, wherein said phone number probability distribution is modified by updating it if said identified phone number matches said any listed phone number.

700. The method of claim 699, wherein said phone number probability distribution is modified by updating it only if said identified phone number matches a phone number within said selected phone number set.

701. The method of claim 700, wherein said phone number probability distribution update comprises a reward-inaction update.

702. The method of claim 701, wherein a corresponding probability value is rewarded if said identified phone number matches said any listed phone number.

703. The method of claim 681, wherein said phone number probability distribution is modified by increasing a corresponding probability value if said identified phone number matches said any listed phone number.

704. The method of claim 681, further comprising adding a listed phone number corresponding to said identified phone number to said phone list if said identified phone number does not match said any listed phone number, wherein said phone number probability distribution is modified by adding a probability value corresponding to said added listed phone number to said phone number probability distribution.

705. The method of claim 704, wherein another phone number on said phone list is replaced with said added listed phone number, and another probability value corresponding to said replaced listed phone number is replaced with said added probability value.

706. The method of claim 680, wherein said phone number calling system comprises a phone.

707. The method of claim 680, wherein said phone number calling system comprises a mobile phone.

708. The method of claim 680, further comprising:
generating another phone list containing at least another plurality of listed phone numbers and a phone number probability distribution comprising a plurality of probability values corresponding to said other plurality of listed phone numbers; and
selecting another set of phone numbers from said other plurality of phone numbers based on said other phone number probability distribution.

709. The method of claim 708, further comprising:
identifying a phone number associated with a phone call; and
determining if said identified phone number matches any listed phone number contained in said phone number list;
identifying another phone number associated with another phone call; and
determining if said other identified phone number matches any listed phone number contained in said other phone number list;
wherein said performance index is derived from said matching determinations.

710. The method of claim 708, further comprising:
identifying a phone number associated with a phone call;
determining the current day of the week;
selecting one of said phone list and said other phone list based on said current day determination; and
determining if said identified phone number matches any listed phone number contained in said selected phone number list, wherein said performance index is derived from said determination.

711. The method of claim 708, further comprising:
identifying a phone number associated with a phone call;
determining a current time of the day;
selecting one of said phone list and said other phone list based on said current time determination; and
determining if said identified phone number matches any listed phone number contained in said selected phone number list, wherein said performance index is derived from said matching determination.

712. The method of claim 680, wherein said action probability distribution is updated using a learning automaton.

713. The method of claim 680, wherein said action probability distribution is purely frequency based.

714. The method of claim 713, wherein said action probability distribution is based on a moving average.

715. A phone number calling system having an objective of anticipating called phone numbers, comprising:
a probabilistic learning module configured for learning favorite phone numbers of a user in response to phone calls; and
an intuition module configured for modifying a functionality of said probabilistic learning module based on said objective.

716. The phone number calling system of claim 715, wherein said probability learning module is further configured for generating a performance index indicative of a performance of said probabilistic learning module relative to said objective, and said intuition module is configured for modifying said probabilistic learning module functionality based on said performance index.

717. The phone number calling system of claim 715, further comprising a display for displaying said favorite phone numbers.

718. The phone number calling system of claim 715, further comprising one or more selection buttons configured for selecting one of said favorite phone numbers to make a phone call.

719. The phone number calling system of claim 715, wherein said identified phone numbers are associated with outgoing phone calls.

720. The phone number calling system of claim 715, wherein said identified phone numbers are associated with incoming phone calls.

721. The phone number calling system of claim 715, wherein said probabilistic learning module comprises:
an action selection module configured for selecting said favorite phone numbers from a plurality of phone numbers based on a phone number probability distribution comprising a plurality of probability values corresponding to said plurality of listed phone numbers, wherein a phone list contains at least said plurality of phone numbers;
an outcome evaluation module configured for determining if identified phone numbers associated with said phone calls match any listed phone number contained in said phone number list; and
a probability update module, wherein said intuition module is configured for modifying said probability update module based on said matching determinations.

722. The phone number calling system of claim 721, wherein said favorite phone numbers correspond to the highest probability values in said phone number probability distribution.

723. The phone number calling system of claim 721, wherein said phone number selection module is further configured for placing said favorite numbers in an order according to corresponding probability values.

724. The phone number calling system of claim 721, wherein said intuition module is configured for modifying said probability update module by directing it to update said phone number probability distribution if any of said identified phone numbers matches said any listed phone number.

725. The phone number calling system of claim 724, wherein said probability update module is configured for updating said phone number probability using a reward-inaction algorithm.

726. The phone number calling system of claim 725, wherein said probability update module is configured for rewarding a corresponding probability value.

727. The phone number calling system of claim 721, wherein said intuition module is configured for modifying said probability update module by directing it to update said phone number probability distribution only if said identified plurality of phone numbers matches a listed phone number corresponding to one of said favorite phone numbers.

728. The phone number calling system of claim 721, wherein said intuition module is configured for modifying said probability update module by increasing a corresponding probability value if any of said identified phone numbers matches said any listed phone number.

729. The phone number calling system of claim 721, wherein said intuition module is configured for modifying said probability update module by adding a listed phone number corresponding to said identified phone number to said phone list and adding a probability value corresponding to said added listed phone number to said phone number probability distribution if said identified phone number does not match said any listed phone number.

730. The phone number calling system of claim 729, wherein another phone number on said phone list is replaced with said added listed phone number, and another probability value corresponding to said replaced listed phone number is replaced with said added probability value.

731. The phone number calling system of claim 721, wherein said plurality of probability values correspond to all phone numbers within said phone number list.

732. The phone number calling system of claim 721, wherein said plurality of probability values correspond only to said plurality of listed phone numbers.

733. The phone number calling system of claim 716, wherein said performance index is instantaneous.

734. The phone number calling system of claim 716, wherein said performance index is cumulative.

735. The phone number calling system of claim 715, wherein said favorite phone numbers are divided into first and second favorite phone number lists, and said probabilistic learning module is configured for learning said first favorite phone number list in response to phone calls during a first time period, and for learning said second favorite phone number list in response to phone calls during a second time period.

736. The phone number calling system of claim 735, wherein said first time period includes weekdays, and said second time period includes weekends.

737. The phone number calling system of claim 735, wherein said first time period includes days, and said second time period includes evenings.

738. The phone number calling system of claim 715, wherein said probabilistic learning module comprises a learning automaton.

739. The phone number calling system of claim 715, wherein said probabilistic learning module is purely frequency-based.

740. A phone number calling system having an objective of anticipating called phone numbers, comprising:
a probabilistic learning module configured for learning favorite phone numbers of a user in response to phone calls; and
an intuition module configured for modifying a functionality of said probabilistic learning module based on said objective.

741. The phone number calling system of claim 740, wherein said learning module and said intuition module are self-contained in a single device.

742. The phone number calling system of claim 740, wherein said learning module and said intuition module are contained in a telephone.

743. The phone number calling system of claim 742, wherein said telephone is a mobile telephone.

744. The phone number calling system of claim 740, wherein said learning module and said intuition module are contained in a server.

745. The phone number calling system of claim 740, wherein said learning module and said intuition module are distributed within a server and a phone.

746. The phone number calling system of claim 740, wherein said probabilistic learning module comprises a learning automaton.

747. The phone number calling system of claim 740, wherein said probabilistic learning module is purely frequency-based.

748. A method of providing learning capability to a phone number calling system, comprising:
receiving a plurality of phone numbers;
maintaining a phone list containing said plurality of phone numbers and a plurality of priority values respectively associated with said plurality of phone numbers;
selecting a set of phone numbers from said plurality of listed phone numbers based on said plurality of priority values;
communicating said phone number set to a user.

749. The method of claim 748, further comprising updating a phone number probability distribution containing said plurality of priority values using a learning automaton.

750. The method of claim 748, further comprising updating a phone number probability distribution containing said plurality of priority values based purely on the frequency of said plurality of phone numbers.

751. The method of claim 750, wherein each of said plurality of priority values is based on a total number of times said associated phone number is received during a specified time period.

752. The method of claim 748, wherein said selected phone number set is displayed to said user.

753. The method of claim 748, wherein said selected phone number set comprises a plurality of selected phone numbers.

754. The method of claim 748, further comprising selecting a phone number from said selected phone number set to make a phone call.

755. The method of claim 748, wherein said selected phone number set corresponds to the highest priority values.

756. The method of claim 748, further comprising placing said selected phone number set in an order according to corresponding priority values.

757. The method of claim 748, wherein said plurality of phone numbers is associated with outgoing phone calls.

758. The method of claim 748, wherein said plurality of phone numbers is associated with incoming phone calls.

759. The method of claim 748, wherein said phone number calling system comprises a phone.

760. The method of claim 748, wherein said phone number calling system comprises a mobile phone.
